(19) United States
(12) Patent Application Publication
(10) Pub. No.: US 2011/0049444 A1
(43) Pub. Date: Mar. 3, 2011

(54) COLORED RESIN COMPOSITIONS FOR COLOR FILTER, COLOR FILTER, ORGANIC EL DISPLAY, AND LIQUID-CRYSTAL DISPLAY DEVICE

(75) Inventors: Naoki SAKO, Yokohama-shi (JP); Seiji AKIYAMA, Yokohama-shi (JP); Takayuki SHODA, Yokohama-shi (JP); Sae MORIGAKI, Yokohama-shi (JP); Yasushi SHIGA, Yokohama-shi (JP); Toshiaki YOKOO, Yokohama-shi (JP); Mio ISHIDA, Yokohama-shi (JP)

(73) Assignee: MITSUBISHI CHEMICAL CORPORATION, Minato-ku (JP)

(21) Appl. No.: 12/870,140

(22) Filed: Aug. 27, 2010

Related U.S. Application Data
(63) Continuation of application No. PCT/JP2009/053579, filed on Feb. 26, 2009.

(30) Foreign Application Priority Data
Feb. 27, 2008 (JP) 2008-046323
Oct. 9, 2008 (JP) 2008-262952

(51) Int. Cl. G02B 5/23

(52) U.S. Cl. 252/586

(57) ABSTRACT

A colored resin composition is provided which is capable of providing blue pixels of a color filter that have excellent light resistance and which satisfies heat resistance required in color display production steps. A color filter having blue pixels with excellent color purity and transmittance and an organic EL display and a liquid-crystal display device both having satisfactory blue purity are also provided by using the colored resin composition. The colored resin composition for color filter includes (a) a binder resin, (b) a solvent, and a triarylmethane type coloring matter of a specific structure represented by general formula (I). The color filter, organic EL display, and liquid-crystal display device are produced using the colored resin composition.

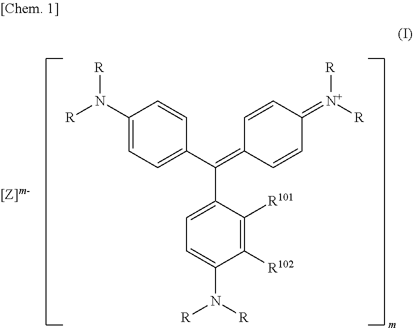

### TECHNICAL FIELD

The present invention relates to colored resin compositions capable of providing blue pixels of a color filter which have excellent spectral characteristics, a color filter having pixels formed using either of the compositions, and an organic EL display and a liquid-crystal display device formed using the color filter.

### BACKGROUND ART

Color liquid-crystal display devices and organic EL displays are recently attracting attention as flat displays. These displays employ color filters.

For example, the color liquid-crystal display devices include, as an example, a transmissive liquid-crystal display device roughly constituted of: a color filter substrate equipped with a black matrix, a colored layer composed of a plurality of colors (usually, three primary colors, i.e., red (R), green (G), and blue (B)), a transparent electrode, and an alignment layer; a counter-electrode substrate equipped with a thin-film transistor (TFT element), pixel electrodes, and an alignment layer; and a liquid-crystal layer formed by disposing the two substrates face to face so as to leave a given spacing therebetween, sealing the periphery of the substrates with a sealing member, and injecting a liquid-crystal material into the space. There also is a reflective liquid-crystal display device, which includes a reflecting layer disposed between the substrate and colored layer of the color filter.

Organic EL displays theoretically are displays having organic EL devices of a structure including an anode, a cathode, and an organic EL luminescent layer sandwiched therebetween. Techniques for practically using organic EL devices to configure an organic EL display capable of color displaying include: (1) a mode in which organic EL devices of three kinds respectively emitting light of the three primary colors are arranged by themselves; (2) a mode in which organic EL devices emitting white light are used in combination with a color filter layer for the three primary colors; and (3) a CCM mode in which organic EL devices emitting blue light are used in combination with color conversion layers (CCM layers) which perform color conversion from blue to green and from blue to red, respectively.

A feature of mode (1) resides, as a matter of course, that the display can exhibit high color reproduction characteristics because of the use of organic EL devices of the three colors. Consequently, it is expected that by disposing a color filter according to the organic EL devices of the three colors, color reproduction characteristics are improved or a contrast improvement based on absorption of reflected light is attained. Mode (1) is hence regarded as one of promising modes.

On the other hand, mode (2), in which white organic EL devices are used in combination with a color filter, and CCM mode (3) have an advantage that since use of one kind of organic EL devices emitting light of the same color suffices, there is no need of employing the characteristics of organic EL devices of the three colors as in the organic EL display in mode (1) described above. Modes (2) and (3) hence make it possible to attain a reduction in the number of steps, material diminution, etc. These modes are full-color display modes which are attracting attention also from the standpoint of production cost.

In organic EL devices employing the color conversion mode in which a color filter, a color conversion filter, and organic light-emitting elements are used as constituent elements, color filters produced by a pigment dispersion process are mainly used as color filters required to have heat resistance necessary in color display production steps, weatherability necessary for use as a display, and the ability to give high-resolution images. A photosensitive-resin solution in which a red, blue, or green pigment has been finely dispersed to a particle diameter of 1 μm or smaller is applied to a glass substrate, and pixels having a desired pattern are then formed therefrom by photolithography (patent documents 1 and 2).

With respect to color filters, there is a desire for improvements in color purity, chroma, and light transmission. For the purpose of improving light transmission, techniques have hitherto been employed in which the content of a coloring pigment based on the photosensitive resin contained in a material for image formation is reduced or the thickness of pixels to be formed from a material for image formation is reduced. However, these techniques have the following problems. The color filter per se has reduced chroma, and this renders the whole display whitish and sacrifices color brightness necessary for displaying. Conversely, when the content of a coloring pigment is increased in order to preferentially improve chroma, the whole display becomes dark. In this case, the quantity of light from the backlight should be increased in order to ensure lightness, resulting in an increase in the power consumption of the display.

A technique for overcoming that problem is known, in which pigment particles are finely dispersed so that the particle diameter thereof is reduced to or below one-half the coloring wavelength at which the pigment has a color, for the purpose of improving light transmission (non-patent document 1). However, since blue pigments have a shorter coloring wavelength than red and green pigments, blue pigments are required to be dispersed more finely in this case. An increase in cost and stability after the dispersion process are hence problematic.

On the other hand, color filters employing dyes as coloring agents are still being developed. For example, a color filter having a blue filter layer containing CI Acid Blue 83 (triallylamine type coloring matter) and CI Solvent Blue 67 (copper phthalocyanine type coloring matter) is described in patent document 3.

However, color filters employing the dyes shown in the document have had a problem that the spectral characteristics, heat resistance, and light resistance thereof are all insufficient.

Furthermore, a color filter obtained using a polymer containing a polymerizable triphenylmethane dye represented by the following formula is described in patent document 4.

However, color filters obtained using the dye described in the document have had a problem that the light resistance thereof is insufficient although the filters have excellent spectral characteristics.

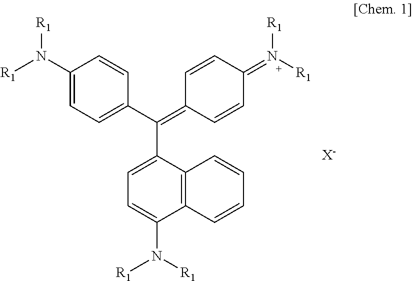

(Among the R₁s in the formula, at least one is a specific polymerizable group containing a carbon-carbon double bond.)

### Patent Document 1: JP-B-4-37987

### Patent Document 2: JP-B-4-39041

### Patent Document 3: JP-A-2002-14222

### Patent Document 4: JP-A-2000-162429

Non-Patent Document 1: Kiyoshi HASHIZUME, Shikizai Kyōkai-shi (December 1967, p. 608)

### DISCLOSURE OF THE INVENTION

### Problems that the Invention is to Solve

An object of the invention is to provide a colored resin composition which is capable of providing blue pixels of a color filter that have excellent light resistance and which satisfies the heat resistance required in color display production steps described above. Another object is to provide a color filter having blue pixels with excellent color purity and transmittance and an organic EL display and a liquid-crystal display device both having satisfactory blue purity, by using the colored resin composition.

### Means for Solving the Problems

The present inventors have found that the problems can be eliminated by using a salt formed from specific compounds as a colorant for forming blue pixels of a color filter. The invention has been thus achieved.

Namely, essential points of the invention reside in the following.

[1] A colored resin composition for color filter which comprises (a) a binder resin, (b) a solvent, and (c) a colorant, the colorant (c) comprising a compound represented by the following general formula (I):

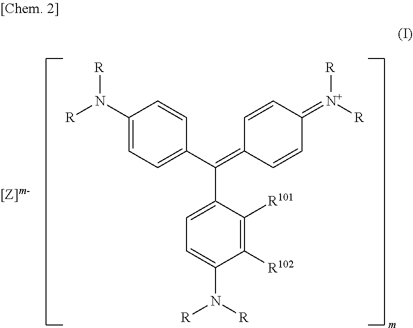

(wherein Z represents an anion having a valence of m and having an anthraquinone framework or phthalocyanine framework; m represents an integer of 1-4;

R represents a hydrogen atom, an alkyl group which has 1-8 carbon atoms and may have a substituent, or a phenyl group which may have a substituent, or adjoining Rs are bonded to each other to form a ring, and the ring may have a substituent and the Rs may be the same or different;

R¹⁰¹ represents an alkyl group which has 1-8 carbon atoms and may have a substituent, an alkenyl group which has 2-6 carbon atoms and may have a substituent, a phenyl group which may have a substituent, or a fluorine atom;

R¹⁰² represents a hydrogen atom, an alkyl group which has 1-8 carbon atoms and may have a substituent, an alkenyl group which has 2-6 carbon atoms and may have a substituent, a phenyl group which may have a substituent, or a fluorine atom;

alternatively, R¹⁰¹ and R¹⁰² may be bonded to each other to form a ring, and the ring may have a substituent; and

the three benzene rings in the cation moiety of general formula (I) each may be substituted with a group other than —NR₂, —R¹⁰¹, and —R¹⁰²;

provided that when a plurality of groups represented by

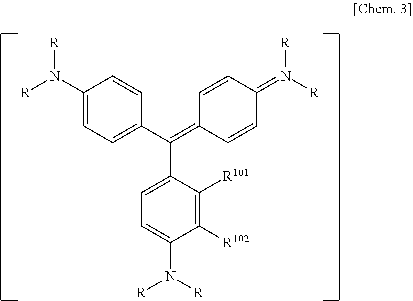

are contained in the molecule, these groups may have the same structure or may have different structures).
[2] The colored resin composition for color filter according to [1] wherein the compound represented by general formula (I) is a compound represented by the following general formula (I′):

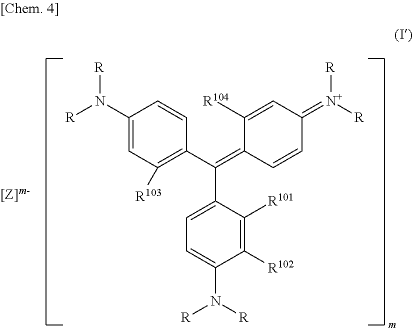

(wherein Z, m, R, R¹⁰¹, and R¹⁰² have the same meanings as in general formula (I), and

R¹⁰³ and R¹⁰⁴ each independently represent a hydrogen atom, a halogen atom, or an alkyl group having 1-8 carbon atoms,

provided that when a plurality of groups represented by

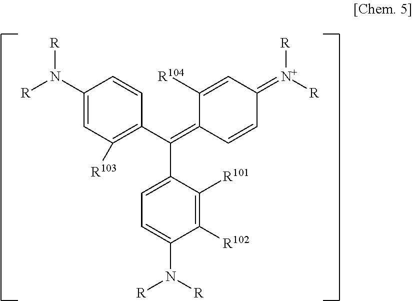

are contained in the molecule, these groups may have the same structure or may have different structures).
[3] The colored resin composition for color filter according to [2] wherein the compound represented by general formula (I′) is a compound represented by the following general formula (II):

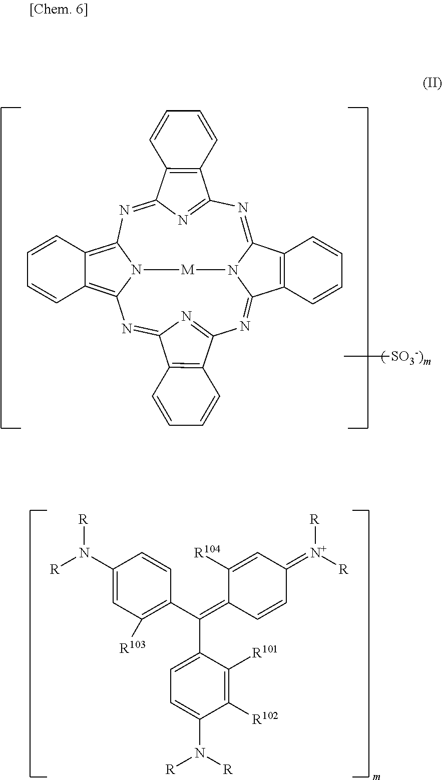

(wherein M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom;

the —SO₃⁻ group in the formula is bonded to any of the carbon atoms constituting the benzene rings included in the phthalocyanine framework; among the carbon atoms constituting the four benzene rings, the carbon atoms having no —SO₃⁻ group bonded thereto may be substituted with any group; and

m, R, and R¹⁰¹ to R¹⁰⁴ have the same meanings as in general formula (I′); provided that when a plurality of groups represented by

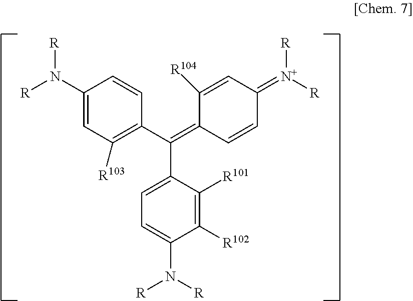

are contained in the molecule, these groups may have the same structure or may have different structures).
[4] The colored resin composition for color filter according to [3] wherein the compound represented by general formula (II) is a compound represented by the following general formula (III):

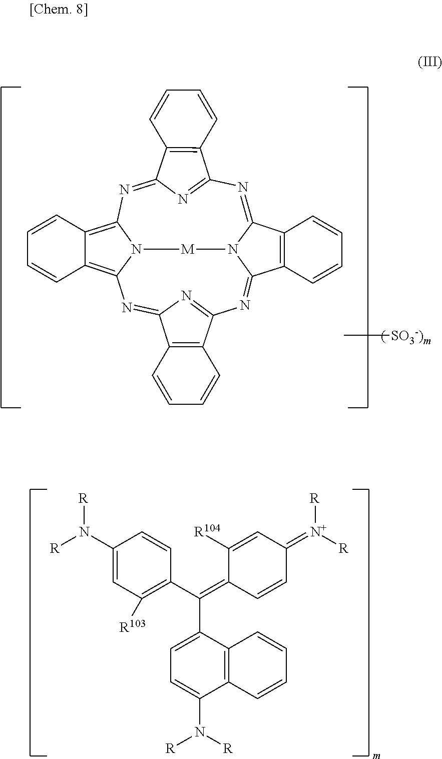

(wherein the —SO₃⁻ group is bonded to any of the carbon atoms constituting the benzene rings included in the phthalocyanine framework; the phthalocyanine framework has no substituents other than the —SO₃⁻ group; and

m, M, R, R¹⁰³, and R¹⁰⁴ have the same meanings as in general formula (II); provided that when a plurality of groups represented by

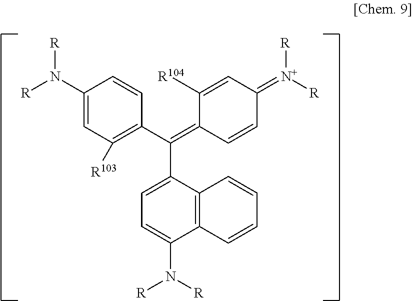

are contained in the molecule, these groups may have the same structure or may have different structures).
[5] The colored resin composition for color filter according to [2] wherein the compound represented by general formula (I′) is a compound represented by the following general formula (IV):

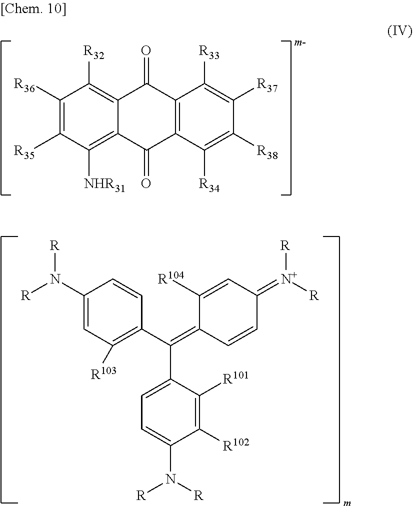

(wherein among the substituents possessed by the anthraquinone framework,

R₃₁ represents a hydrogen atom or a phenyl group which may have a substituent;

R₃₂, R₃₃, and R₃₄ each independently are one of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ is an —NHR₄₁ group;

R₃₅, R₃₆, R₃₇, and R₃₈ each independently represent a hydrogen atom, —SO₃⁻, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms);

the number of —SO₃⁻ groups bonded to each anthraquinone framework is m; and

m, R, and R¹⁰¹ to R¹⁰⁴ have the same meanings as in general formula (I′); provided that when a plurality of groups represented by

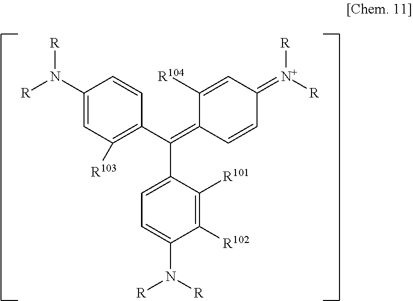

are contained in the molecule, these groups may have the same structure or may have different structures).
[6] The colored resin composition for color filter according to [5] wherein the compound represented by general formula (IV) is a compound represented by the following general formula (IV′):

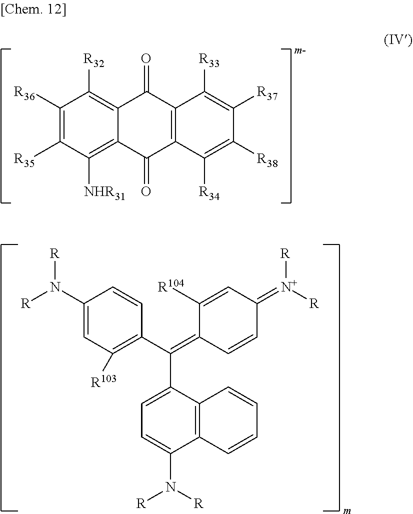

(wherein m, R, R₃₁ to R₃₈, R¹⁰³, and R¹⁰⁴ have the same meanings as in general formula (IV), provided that when a plurality of groups represented by

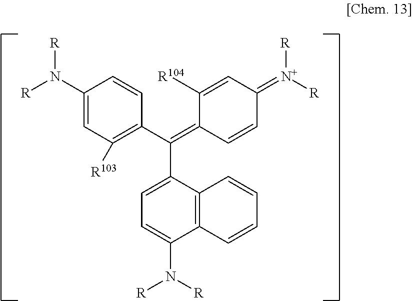

are contained in the molecule, these groups may have the same structure or may have different structures).
[7] The colored resin composition for color filter according to any one of [1] to [6] which contains the compound represented by general formula (I) in an amount of 1-50% by weight based on all solid components.
[8] A colored resin composition for color filter which comprises (a) a binder resin, (b) a solvent, and (c) a colorant, the colorant (c) comprising a compound represented by the following general formula (V):

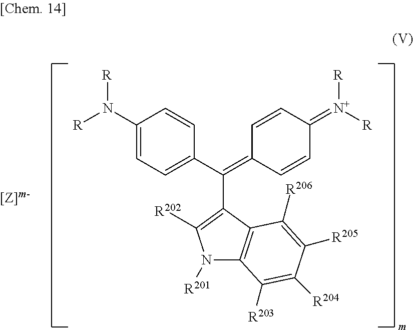

(wherein Z represents an anion having a valence of m and having an anthraquinone framework or phthalocyanine framework; m represents an integer of 1-4;

R represents a hydrogen atom, an alkyl group which has 1-8 carbon atoms and may have a substituent, or a phenyl group which may have a substituent, or adjoining Rs are bonded to each other to form a ring, and the ring may have a substituent and the Rs may be the same or different;

R²⁰¹ represents a hydrogen atom, an alkyl group which has 1-8 carbon atoms and may have a substituent, a benzyl group, a phenyl group which may have a substituent, or a naphthyl group which may have a substituent;

R²⁰² represents an alkyl group which has 1-8 carbon atoms and may have a substituent, a phenyl group which may have a substituent, a naphthyl group which may have a substituent, or an aromatic heterocyclic group which may have a substituent;

R²⁰³, R²⁰⁴, R²⁰⁵, and R²⁰⁶ each independently represent a hydrogen atom, an alkyl group which has 1-8 carbon atoms and may have a substituent, a perfluoroalkyl group having 1-8 carbon atoms, an alkoxy group having 1-12 carbon atoms, a phenoxy group, a naphthyloxy group, a fluorine atom, a phenyl group which may have a substituent, —CO₂R₄₆, —SO₃R₄₇, or —SO₂NHR₄₈ (wherein R₄₆ to R₄₈ each independently represent an alkyl group having 1-6 carbon atoms); and

the two benzene rings in the cation moiety of general formula (V) each may be substituted with a group other than —NR₂;

provided that when a plurality of groups represented by

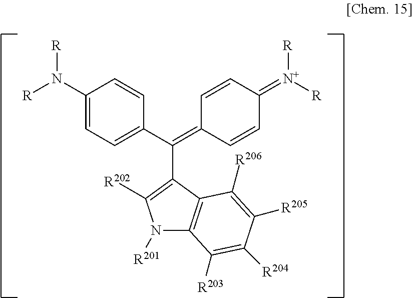

are contained in the molecule, these groups may have the same structure or may have difficult structures).
[9] The colored resin composition for color filter according to [8] wherein the compound represented by general formula (V) is a compound represented by the following general formula (V′):

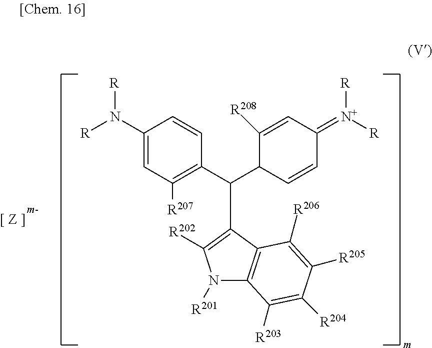

(wherein Z, m, R, and R²⁰¹ to R²⁰⁶ each have the same meaning as in general formula (V), and

R²⁰⁷ and R²⁰⁸ each independently represent a hydrogen atom, a halogen atom, or an alkyl group having 1-8 carbon atoms,

provided that when a plurality of groups represented by

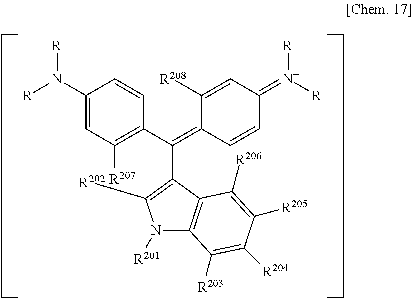

are contained in the molecule, these groups may have the same structure or may have different structures).
[10] The colored resin composition for color filter according to [9] wherein the compound represented by general formula (V′) is a compound represented by the following general formula (VI):

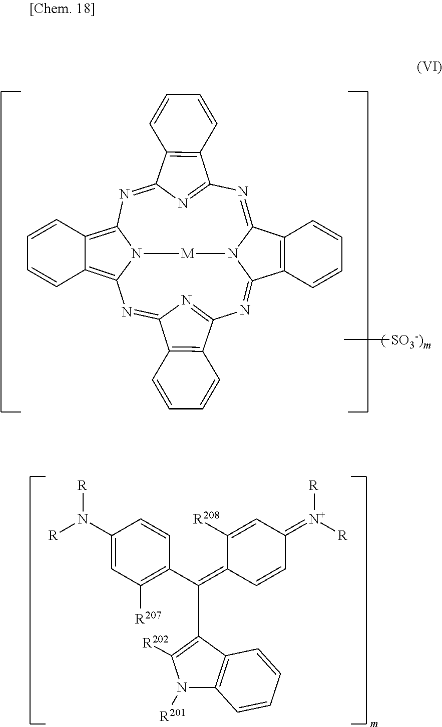

(wherein M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom;

the —SO₃⁻ group in the formula is bonded to any of the carbon atoms constituting the benzene rings included in the phthalocyanine framework; among the carbon atoms constituting the four benzene rings, the carbon atoms having no —SO₃⁻ group bonded thereto may be substituted with any group; and

m, R, R²⁰¹, R²⁰², R²⁰⁷, and R²⁰⁸ have the same meanings as in general formula (V′); provided that when a plurality of groups represented by

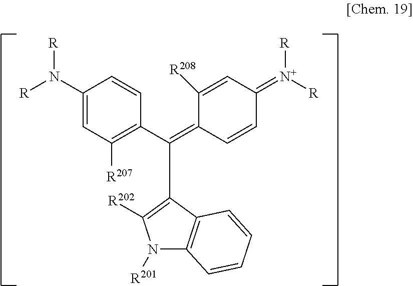

are contained in the molecule, these groups may have the same structure or may have different structures).
[11] The colored resin composition for color filter according to [10] wherein in general formula (VI), the —SO₃⁻ group is bonded to any of the carbon atoms constituting the benzene rings included in the phthalocyanine framework, and the phthalocyanine framework has no substituents other than the —SO₃⁻ group.
[12] The colored resin composition for color filter according to [9] wherein the compound represented by general formula (V′) is a compound represented by the following general formula (VII):

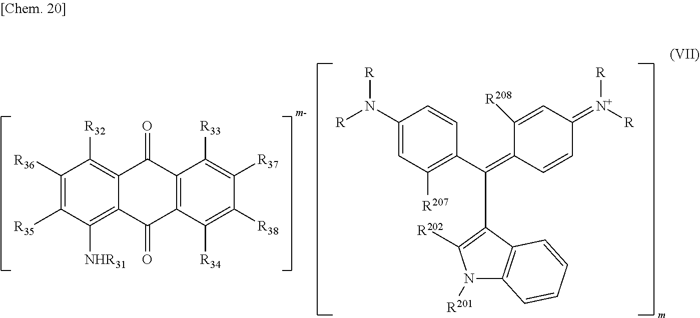

(wherein among the substituents possessed by the anthraquinone framework,

R₃₁ represents a hydrogen atom or a phenyl group which may have a substituent;

R₃₂, R₃₃, and R₃₄ each independently are any of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ is an —NHR₄₁ group;

R₃₅, R₃₆, R₃₇, and R₃₈ each independently represent a hydrogen atom, —SO₃⁻, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms);

the number of —SO₃⁻ groups bonded to each anthraquinone framework is m; and

m, R, R²⁰¹, R²⁰², R²⁰⁷, and R²⁰⁸ have the same meanings as in general formula (V′); provided that when a plurality of groups represented by

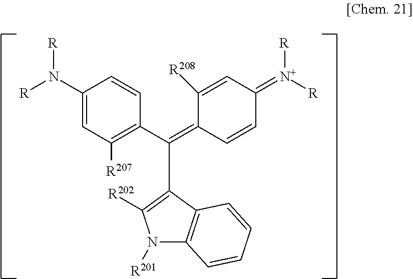

are contained in the molecule, these groups may have the same structure or may have different structures).
[13] The colored resin composition for color filter according to any one of [8] to [12] which contains the compound represented by general formula (V) in an amount of 1-50% by weight based on all solid components.
[14] A colored resin composition for color filter, which comprises (a) a binder resin, (b) a solvent, and (c) a colorant,

the colorant (c) comprising a compound comprising a cationic blue coloring matter (coloring matter 1) and an anionic coloring matter (coloring matter 2), the coloring matter 1 and coloring matter 2 in the compound satisfying the following (A) or (B):

(A) the coloring matter 2 is an even-electron compound; the excitation energy of coloring matter 1 in a minimum singlet excitation state (S₁ state) (ΔE_{S1}(coloring matter 1)) and the excitation energy of coloring matter 2 in a minimum singlet excitation state (S₁ state) (ΔE_{S1}(coloring matter 2)), each excitation energy being obtained through a time-dependent density functional (B3LYP/6-31G(d,p)) calculation, satisfy the following expression (i); and the excitation energy of coloring matter 2 in a minimum triplet excitation state (T₁ state) (ΔE_{T1}(coloring matter 2)) satisfies the following expression (ii);

(B) the coloring matter 2 is an odd-electron compound, and the excitation energy of coloring matter 1 in a minimum singlet excitation state (S₁ state) (ΔE_{S1}(coloring matter 1)) and the excitation energy of coloring matter 2 in an energetically lowest excitation state (ΔE_{lowest}(coloring matter 2)), each excitation energy being obtained through a time-dependent density functional (B3LYP/6-31G(d,p)) calculation, satisfy the following expression (iii).

[Math. 1]

ΔE_{S1}(coloring matter 2)<ΔE_{S1}(coloring matter 1) (i)

ΔE_{T1}(coloring matter 2)<1.5 eV (ii)

ΔE_{lowest}(coloring matter 2)<ΔE_{S1}(coloring matter 1) (iii)

[15] The colored resin composition for color filter according to [14] wherein the coloring matter 1 is a cationic coloring matter which has a framework having a cationic moiety therein or has a cationic substituent as a substituent, and the coloring matter 2 is an anionic coloring matter having an anionic substituent.
[16] The colored resin composition for color filter according to [14] or [15] wherein the coloring matter 2 is an anionic coloring matter having a phthalocyanine framework or an anthraquinone framework.
[17] The colored resin composition for color filter according to any one of [1] to [16] which further comprises (d) a monomer.
[18] The colored resin composition for color filter according to any one of [1] to [17] which further comprises (e) at least one of a photopolymerization initiation system and a heat polymerization initiation system.
[19] The colored resin composition for color filter according to any one of [1] to [18] which further comprises (f) a pigment.
[20] A color filter having pixels formed using the colored resin composition for color filter according to any one of [1] to [19].
[21] An organic EL display equipped with the color filter according to [20].
[22] A liquid-crystal display device equipped with the color filter according to [20].

### EFFECTS OF THE INVENTION

According to the invention, a color filter satisfying light resistance, which is an extremely important item among properties concerning the long-term reliability of color filters, and further having heat resistance required in color display production steps and having blue pixels with excellent color purity and excellent transmittance can be obtained. By using such a color filter, the light emitted by an organic EL display and the light from a backlight for the color filter can be efficiently led out, and an organic EL display and a liquid-crystal display device which combine high color reproducibility and high luminance can be provided. It is also possible to improve the contrast of a liquid-crystal display device.

### BRIEF DESCRIPTION OF THE DRAWINGS

FIG. 1 is a chart showing a transmission spectrum of the UV-cut filter used in the light resistance test in the Examples.

FIG. 2 is a chart showing a transmission spectrum of the polarizer used in the light resistance test in the Examples.

FIG. 3 is a diagrammatic sectional view illustrating one example of organic EL devices equipped with a blue color filter of the invention.

FIG. 4 is a schematic sectional view illustrating the structure of the organic electroluminescent devices produced in the Examples.

### DESCRIPTION OF REFERENCE NUMERALS

1, 10 Transparent substrate
2, 50 Transparent anode
3, 52 Hole-transporting layer
4, 53 Luminescent layer
5 Electron-transporting layer
6, 55 Cathode
100 Organic EL device
20 Blue pixel
30 Organic protective layer
40 Inorganic oxide layer
500 Organic light-emitting element
51 Hole injection layer
54 Electron injection layer

### BEST MODE FOR CARRYING OUT THE INVENTION

Modes for carrying out the invention will be explained below in detail. The following explanations are for embodiments of the invention, and the invention should not be construed as being limited to the embodiments.

In the invention, the term “(meth)acrylic”, “(meth)acrylate”, or the like means “acrylic and/or methacrylic”, “acrylate and/or methacrylate”, or the like. For example, “(meth)acrylic acid” means “acrylic acid and/or methacrylic acid”.

The term “all solid components” means all components of a colored resin composition for color filter of the invention other than the solvent ingredient which will be described later.

The colored resin compositions for color filter of the invention comprise (a) a binder resin, (b) a solvent, and (c) a colorant, and are characterized in that the colorant (c) is one of the following (1) to (3). These colorants each are characterized by being superior in light resistance to conventional colorant compounds.

(1) The colorant includes a compound represented by the following general formula (I)

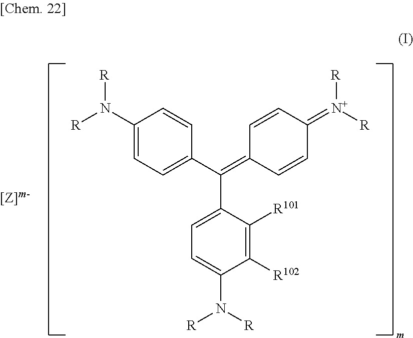

(In general formula (I), Z represents an anion having a valence of m and having an anthraquinone framework or phthalocyanine framework, and m represents an integer of 1-4.

R represents a hydrogen atom, an alkyl group which has 1-8 carbon atoms and may have a substituent, or a phenyl group which may have a substituent, or adjoining Rs are bonded to each other to form a ring. The ring may have a substituent. The Rs may be the same or different.

R¹⁰¹ represents an alkyl group which has 1-8 carbon atoms and may have a substituent, an alkenyl group which has 2-6 carbon atoms and may have a substituent, a phenyl group which may have a substituent, or a fluorine atom.

R¹⁰² represents a hydrogen atom, an alkyl group which has 1-8 carbon atoms and may have a substituent, an alkenyl group which has 2-6 carbon atoms and may have a substituent, a phenyl group which may have a substituent, or a fluorine atom.

Alternatively, R¹⁰¹ and R¹⁰² may be bonded to each other to form a ring, and the ring may have a substituent.

The three benzene rings in the cation moiety of general formula (I) each may be substituted with a group other than —NR₂, —R¹⁰¹, and —R¹⁰².

When a plurality of groups represented by

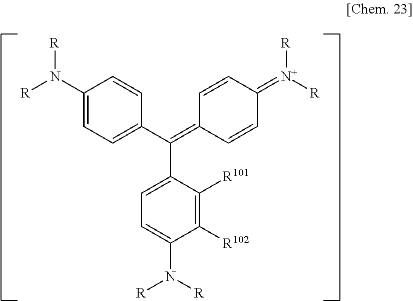

are contained in the molecule, these groups may have the same structure or may have different structures.)
(2) The colorant includes a compound represented by the following general formula (V).

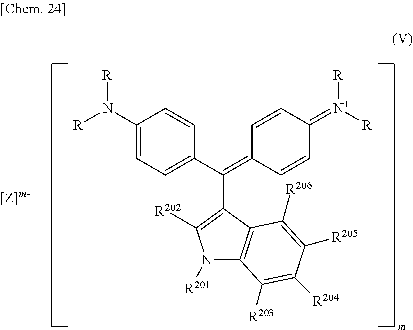

(In general formula (V), Z represents an anion having a valence of m and having an anthraquinone framework or phthalocyanine framework, and m represents an integer of 1-4.

R represents a hydrogen atom, an alkyl group which has 1-8 carbon atoms and may have a substituent, or a phenyl group which may have a substituent, or adjoining Rs are bonded to each other to form a ring. The ring may have a substituent. The Rs may be the same or different.

R²⁰¹ represents a hydrogen atom, an alkyl group which has 1-8 carbon atoms and may have a substituent, a benzyl group, a phenyl group which may have a substituent, or a naphthyl group which may have a substituent.

R²⁰² represents an alkyl group which has 1-8 carbon atoms and may have a substituent, a phenyl group which may have a substituent, a naphthyl group which may have a substituent, or an aromatic heterocyclic group which may have a substituent.

R²⁰³, R²⁰⁴, R²⁰⁵, and R²⁰⁶ each independently represent a hydrogen atom, an alkyl group which has 1-8 carbon atoms and may have a substituent, a perfluoroalkyl group having 1-8 carbon atoms, an alkoxy group having 1-12 carbon atoms, a phenoxy group, a naphthyloxy group, a fluorine atom, a phenyl group which may have a substituent, —CO₂R₄₆, —SO₃R₄₇, or —SO₂NHR₄₈ (wherein R₄₆ to R₄₈ each independently represent an alkyl group having 1-6 carbon atoms).

The two benzene rings in the cation moiety of general formula (V) each may be substituted with a group other than —NR₂.

When a plurality of groups represented by

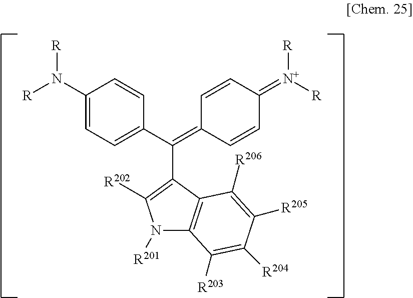

are contained in the molecule, these groups may have the same structure or may have difficult structures.)
(3) The colorant includes a compound composed of a cationic blue coloring matter (coloring matter 1) and an anionic coloring matter (coloring matter 2) (hereinafter, the compound is sometimes referred to as “coloring matter 1/coloring matter 2 compound”), and coloring matter 1 and coloring matter 2 in this coloring matter 1/coloring matter 2 compound satisfy the following (A) or (B).
(A) Coloring matter 2 is an even-electron compound; the excitation energy of coloring matter 1 in a minimum singlet excitation state (S₁ state) (ΔE_{S1}(coloring matter 1)) and the excitation energy of coloring matter 2 in a minimum singlet excitation state (S₁ state) (ΔE_{S1}(coloring matter 2)), each excitation energy being obtained through a time-dependent density functional (B3LYP/6-31G(d,p)) calculation, satisfy the following expression (i); and the excitation energy of coloring matter 2 in a minimum triplet excitation state (T₁ state) (ΔE_{T1}(coloring matter 2)) satisfies the following expression (ii).
(B) Coloring matter 2 is an odd-electron compound, and the excitation energy of coloring matter 1 in a minimum singlet excitation state (S₁ state) (ΔE_{S1}(coloring matter 1)) and the excitation energy of coloring matter 2 in an energetically lowest excitation state (ΔE_{lowest}(coloring matter 2)), each excitation energy being obtained through a time-dependent density functional (B3LYP/6-31G(d,p)) calculation, satisfy the following expression (iii).

[Math. 2]

ΔE_{S1}(coloring matter 2)<ΔE_{S1}(coloring matter 1) (i)

ΔE_{T1}(coloring matter 2)<1.5 eV (ii)

ΔE_{lowest}(coloring matter 2)<ΔE_{S1}(coloring matter 1) (iii)

In the colored resin compositions of the invention, the ingredients other than the colorant (c) may be any ingredients usable as materials for forming color filters. Such materials can be used without particular limitations. For example, the resin compositions may be of any type, such as the thermosetting resin composition described in JP-A-60-184202, etc., or the photopolymerizable resin composition which will be described later. In the case where pixels for a color filter are to be formed by photolithography, use of a thermosetting resin composition necessitates a pattern-forming operation in which a further one layer, e.g., a positive resist layer, is formed to conduct image formation. Because of this, a photopolymerizable resin composition is preferred from the standpoint of process simplicity. On the other hand, in the case where pixels are to be formed by the ink-jet method, a thermosetting resin composition is preferred because use of this composition renders an exposure step and the like unnecessary.

The colored resin compositions for color filter of the invention include (a) a binder resin, (b) a solvent, and (c) a colorant as essential components, and preferably further contain (d) a monomer, (e) a photopolymerization initiation system and/or a heat polymerization initiation system, and (f) a pigment. The compositions may contain other ingredients incorporated according to need.

### [(c) Colorant]

First, the colorants (c) contained in the colored resin compositions for color filter of the invention are explained with respect to each aspect.

### <Colorant (c) According to First Aspect>

The colorant (c) according to the first aspect of the invention includes a compound represented by the following general formula (I). Among the compounds represented by general formula (I), compounds in which R¹⁰¹ and R¹⁰² are not bonded to each other to form a ring, in particular, provide a colored resin composition for color filter which is capable of forming pixels having a satisfactory balance among all of heat resistance, light resistance, and color tone. Furthermore, compounds in which R¹⁰¹ and R¹⁰² are bonded to each other to form a naphthalene ring as in general formula (III), which will be described later, provide a colored resin composition for color filter which is capable of forming pixels having an exceedingly satisfactory color tone.

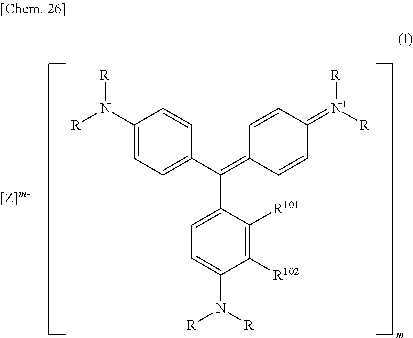

(In general formula (I), Z represents an anion having a valence of m and having an anthraquinone framework or phthalocyanine framework, and m represents an integer of 1-4.

R represents a hydrogen atom, an alkyl group which has 1-8 carbon atoms and may have a substituent, or a phenyl group which may have a substituent, or adjoining Rs are bonded to each other to form a ring. The ring may have a substituent. The Rs may be the same or different.

R¹⁰¹ represents an alkyl group which has 1-8 carbon atoms and may have a substituent, an alkenyl group which has 2-6 carbon atoms and may have a substituent, a phenyl group which may have a substituent, or a fluorine atom.

R¹⁰² represents a hydrogen atom, an alkyl group which has 1-8 carbon atoms and may have a substituent, an alkenyl group which has 2-6 carbon atoms and may have a substituent, a phenyl group which may have a substituent, or a fluorine atom.

Alternatively, R¹⁰¹ and R¹⁰² may be bonded to each other to form a ring, and the ring may have a substituent.

The three benzene rings in the cation moiety of general formula (I) each may be substituted with a group other than —NR₂, —R¹⁰¹, and —R¹⁰².

When a plurality of groups represented by

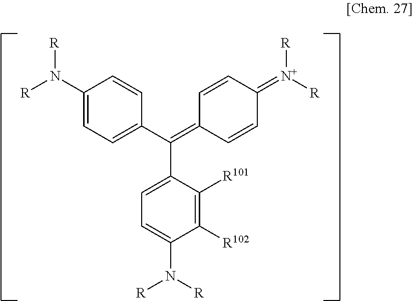

are contained in the molecule, these groups may have the same structure or may have different structures.)

R in general formula (I) represents a hydrogen atom, an alkyl group which has 1-8 carbon atoms and may have a substituent, or a phenyl group which may have a substituent, or adjoining Rs are bonded to each other to form a ring. The multiple Rs in general formula (I) may be the same or different. Consequently, each —NRR group may be symmetrical with respect to the nitrogen atom or may be asymmetrical.

In the case where adjoining Rs are bonded to form a ring, these Rs may be a ring formed by crosslinking with a heteroatom. Examples of this ring include the following. These rings may have a substituent.

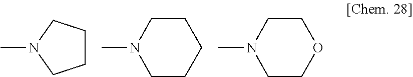

From the standpoint of chemical stability, it is preferred that the Rs each independently be a hydrogen atom, an alkyl group which has 2-8 carbon atoms and may have a substituent, or a phenyl group which may have a substituent or that adjoining Rs should be bonded to each other to form a ring. More preferably, the Rs each independently are an alkyl group which has 2-8 carbon atoms and may have a substituent or a phenyl group which may have a substituent.

R¹⁰¹ represents an alkyl group which has 1-8 carbon atoms and may have a substituent, an alkenyl group which has 2-6 carbon atoms and may have a substituent, a phenyl group which may have a substituent, or a fluorine atom. Especially when R¹⁰¹ has a group other than hydrogen atoms or is bonded to R¹⁰² and thereby constitutes part of a ring, then the benzene ring having R¹⁰¹ bonded thereto has a torsional configuration with respect to the plane involving both the sp2 carbon atom located at the center of the triarylmethine structure and the adjoining benzene ring. Because of this, this compound shows absorption of blue color. The colored composition for color filter which contains this compound has improved spectral characteristics to improve the contrast of a blue display member. This compound is therefore preferred.

R¹⁰² represents a hydrogen atom, an alkyl group which has 1-8 carbon atoms and may have a substituent, an alkenyl group which has 2-6 carbon atoms and may have a substituent, a phenyl group which may have a substituent, or a fluorine atom. From the standpoint of maintaining the planar configuration of the adjoining amino group, it is preferred that R¹⁰² should be a hydrogen atom, an alkyl group which has 1-8 carbon atoms and may have a substituent, or an alkenyl group which has 2-6 carbon atoms and may have a substituent or be bonded to R¹⁰¹ and thereby constitute part of a ring. More preferably, R¹⁰² is a hydrogen atom or is bonded to R¹⁰¹ and thereby constitutes part of a ring.

Incidentally, R¹⁰¹ and R¹⁰² may be bonded to each other to form a ring. Examples of the ring formed by the bonding of R¹⁰¹ and R¹⁰² include the following. The ring may have a substituent.

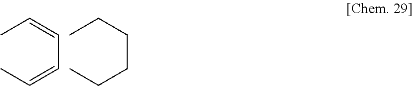

In the case where R is an alkyl group or phenyl group and where R¹⁰¹ and R¹⁰² each independently are an alkyl group, alkenyl group, or phenyl group, these groups may further have a substituent. The ring formed by the bonding of adjoining Rs to each other or by the bonding of R¹⁰¹ to R¹⁰² may also have a substituent.

Examples of the substituents include those enumerated under the following substituent group W.

### (Substituent Group W)

A fluorine atom, chlorine atom, alkyl groups having 1-8 carbon atoms, alkenyl groups having 2-8 carbon atoms, alkoxyl groups having 1-8 carbon atoms, phenyl, mesityl, tolyl, naphthyl, cyano, acetyloxy, alkylcarboxyl groups having 2-9 carbon atoms, sulfonamide groups, alkylsulfamoyl groups having 2-9 carbon atoms, alkylcarbonyl groups having 2-9 carbon atoms, phenethyl, hydroxyethyl, acetylamide group, dialkylaminoethyl groups in which the alkyl groups bonded each have 1-4 carbon atoms, trifluoromethyl, trialkylsilyl groups having 1-8 carbon atoms, nitro, alkylthio groups having 1-8 carbon atoms, and vinyl.

Preferred of those substituents which may be possessed by R, R¹⁰¹, and R¹⁰² are alkyl groups having 2-8 carbon atoms, alkoxyl groups having 2-8 carbon atoms, cyano, acetyloxy, alkylcarboxyl groups having 2-8 carbon atoms, sulfonamide groups, and sulfonalkylamide groups having 2-8 carbon atoms.

Preferred examples of the substituent which may be possessed by the ring formed by the bonding of adjoining Rs to each other or by the bonding of R¹⁰¹ and R¹⁰² include alkyl groups having 1-8 carbon atoms, alkoxyl groups having 1-8 carbon atoms, silyl, carboxyl, cyano, and sulfonamide groups.

In the compound represented by general formula (I), the three benzene rings in the cation moiety each may be substituted with a group other than —NR₂, —R¹⁰¹ and —R¹⁰². Namely, the three benzene rings may have substituents other than those shown in general formula (I), unless such substituents lessen the effects of the invention.

Examples of such substituents include halogen atoms, alkyl groups which have 1-8 carbon atoms and may have a substituent, alkoxy groups which have 1-8 carbon atoms and may have a substituent, and cyano.

Examples of the substituents which may be possessed by those alkyl groups and alkoxy groups include halogen atoms, alkoxy groups having 1-8 carbon atoms, acyl groups having 2-9 carbon atoms, alkoxycarbonyl groups having 2-9 carbon atoms, cyano, phenyl which may be substituted with any of these groups, and naphthyl which may be substituted with any of these groups.

Incidentally, when any of those benzene rings have an excessively bulky group bonded thereto in a position ortho to the carbon atom located at the center of the triarylmethine structure, then the planar configuration of the molecule is impaired, as will be described later, and this tends to reduce the color purity of the compound. It is therefore preferred that the benzene rings should have no substituents in the o-positions or be substituted in each o-position with a halogen atom or an alkyl group having 1-4 carbon atoms.

In general formula (I), m represents an integer of 1-4. There is a tendency that when the value of m is large, the compound obtained is greenish. Because of this, m is preferably 1 or 2, especially preferably 2, from the standpoint of contrast.

The compound represented by general formula (I) preferably is a compound represented by the following general formula (I′).

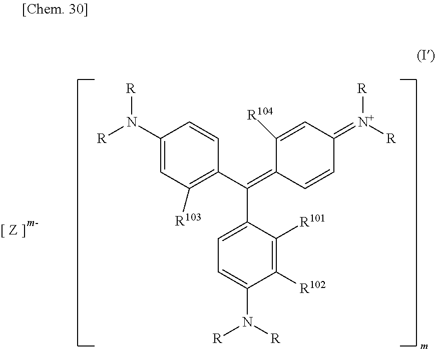

(In general formula (I′), Z, m, R, R¹⁰¹, and R¹⁰² have the same meanings as in general formula (I).

R¹⁰³ and R¹⁰⁴ each independently represent a hydrogen atom, a halogen atom, or an alkyl group having 1-8 carbon atoms.

When a plurality of groups represented by

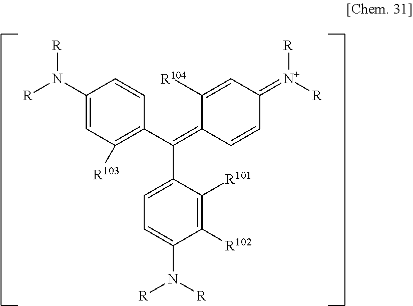

are contained in the molecule, these groups may have the same structure or may have different structures.)

In general formula (I′), R¹⁰³ and R¹⁰⁴ each independently represent a hydrogen atom, a halogen atom, or an alkyl group having 1-8 carbon atoms. In case where R¹⁰³ and R¹⁰⁴ are excessively bulky groups, the planar configuration of the molecule is impaired and there is a tendency that the color tone of the compound changes and this compound hence does not have a blue color with high color purity. It is therefore preferred that when R¹⁰³ and R¹⁰⁴ are not hydrogen atoms, R¹⁰³ and R¹⁰⁴ each should be a halogen atom or an alkyl group having about 1-4 carbon atoms. Namely, it is more preferred that R¹⁰³ and R¹⁰⁴ each independently be a halogen atom or an alkyl group having 1-4 carbon atoms. From the standpoints of color purity and heat resistance, it is especially preferred that R¹⁰³ and R¹⁰⁴ each independently be a hydrogen atom, chlorine atom, or methyl. Of such compounds, a compound in which at least one of R¹⁰³ and R¹⁰⁴ is not a hydrogen atom is preferred because this compound has higher heat resistance.

Especially preferred, from the standpoint of combining high color purity and high heat resistance, is a compound in which one of R¹⁰³ and R¹⁰⁴ is a hydrogen atom and the other is not a hydrogen atom.

The compound represented by general formula (I′) preferably is a compound represented by the following general formula (II) or a compound represented by the following general formula (IV). Especially preferred of the compounds represented by general formula (II) are compounds represented by the following general formula (III). Especially preferred of the compounds represented by general formula (IV) are compounds represented by the following general formula (IV′).

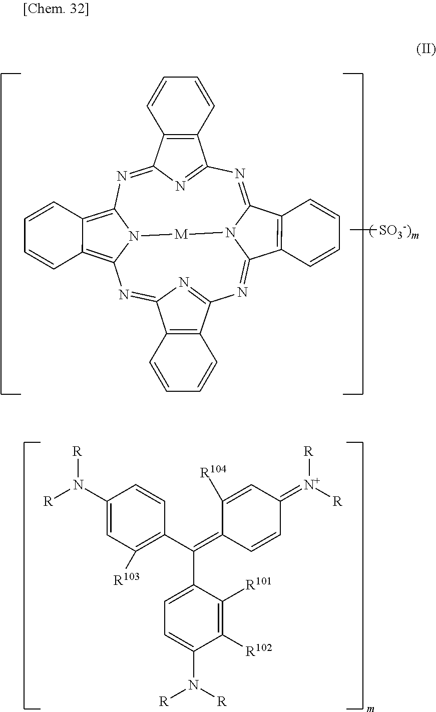

(In general formula (II), M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom.

The —SO₃⁻ group in the formula is bonded to any of the carbon atoms constituting the benzene rings included in the phthalocyanine framework. Among the carbon atoms constituting the four benzene rings, the carbon atoms having no —SO₃⁻ group bonded thereto may be substituted with any group.

Furthermore, m, R, and R¹⁰¹ to R¹⁰⁴ have the same meanings as in general formula (I′). When a plurality of groups represented by

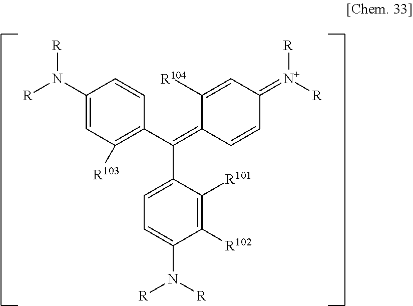

are contained in the molecule, these groups may have the same structure or may have different structures.)

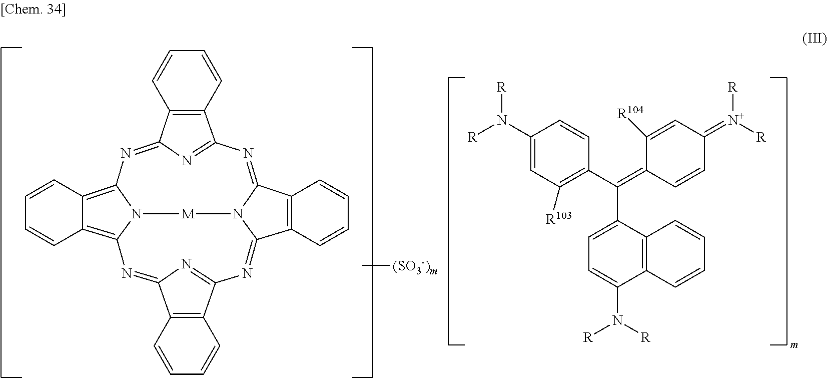

(In general formula (III), the —SO₃⁻ group is bonded to any of the carbon atoms constituting the benzene rings included in the phthalocyanine framework, and the phthalocyanine framework has no substituents other than the —SO₃⁻ group.

Furthermore, m, M, R, R¹⁰³, and R¹⁰⁴ have the same meanings as in general formula (I′). When a plurality of groups represented by

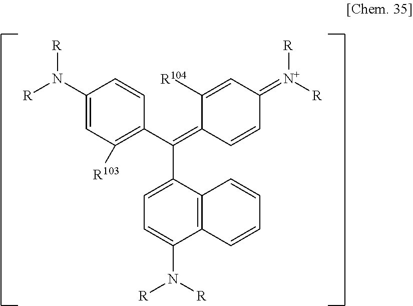

are contained in the molecule, these groups may have the same structure or may have different structures.)

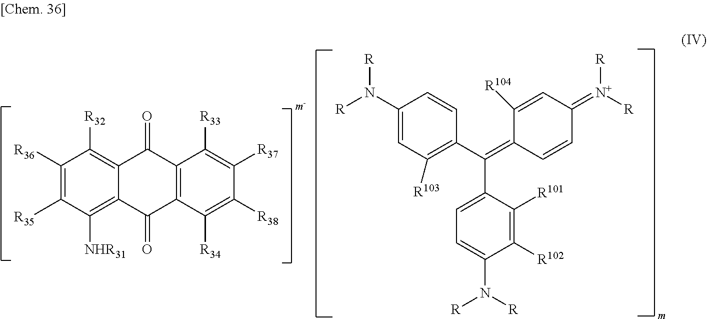

(In general formula (IV), among the substituents possessed by the anthraquinone framework,

R₃₁ represents a hydrogen atom or a phenyl group which may have a substituent.

R₃₂, R₃₃, and R₃₄ each independently are one of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ is an —NHR₄₁ group.

R₃₅, R₃₆, R₃₇, and R₃₈ each independently represent a hydrogen atom, —SO₃⁻, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms).

The number of —SO₃⁻ groups bonded to each anthraquinone framework is m.

Furthermore, m, R, and R¹⁰¹ to R¹⁰⁴ have the same meanings as in general formula (I′). When a plurality of groups represented by

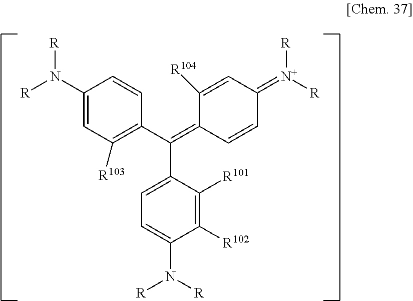

are contained in the molecule, these groups may have the same structure or may have different structures.)

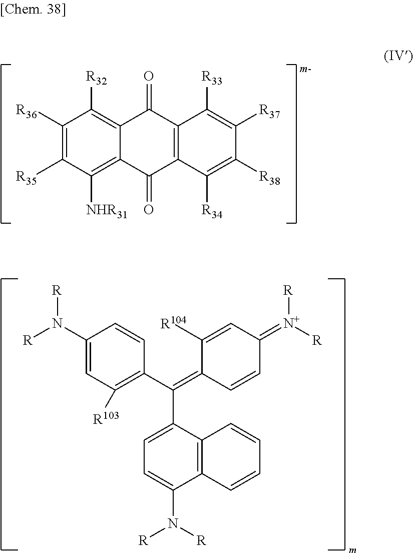

(In general formula (IV′), m, R, R₃₁ to R₃₈, R¹⁰³, and R¹⁰⁴ have the same meanings as in general formula (IV). When a plurality of groups represented by

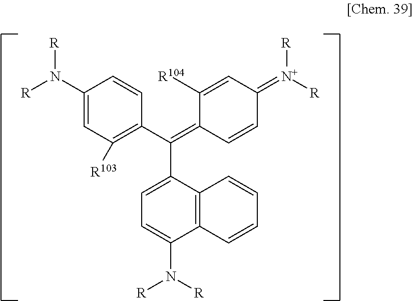

are contained in the molecule, these groups may have the same structure or may have different structures.)

In general formulae (II) and (III), M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom. Preferably, M is two hydrogen atoms, Cu, AlCl, AlOH, Ni, or Co. From the standpoint of improving the contrast of a blue display member, Cu is more preferred of these.

The —SO₃⁻ group in general formula (II) is bonded to any of the carbon atoms constituting the benzene rings included in the phthalocyanine framework. Among the carbon atoms constituting the four benzene rings, the carbon atoms having no —SO₃⁻ group bonded thereto may be substituted with any group.

Examples of the “any desired group” include the substituent group W enumerated above as examples of the substituent which may be possessed by R when the R is an alkyl group or phenyl group. Preferred groups also are the same as those shown hereinabove.

It is especially preferred that each benzene ring in the phthalocyanine framework should be unsubstituted or have no substituents other than the —SO₃⁻ group.

In general formulae (IV) and (IV′), R₃₁ among the substituents possessed by the anthraquinone framework represents a hydrogen atom or a phenyl group which may have a substituent. That substituent is not particularly limited unless it lessens the effects of the invention. However, since the substituent serves also to aid the cationic coloring matter to have the hue thereof, R₃₁ preferably is an alkyl group having 1-8 carbon atoms, —SO₃⁻, benzyl, or —NHCOR₄₀ (R₄₀ represents an alkyl group having 1-3 carbon atoms). It is more preferred that R₃₁ should be a hydrogen atom, an alkyl group having 1-5 carbon atoms, —SO₃⁻, or —NHCOR₄₀.

R₃₂, R₃₃, and R₃₄ each independently are one of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ represents an —NHR₄₁ group. However, R₃₂, R₃₃, and R₃₄ each preferably are a hydrogen atom, hydroxyl, or —NHR₄₁ because R₃₂ to R₃₄ serve also to aid the cationic coloring matter to have the hue thereof.

R₃₅, R₃₆, R₃₇, and R₃₈ each independently represent a hydrogen atom, —SO₃⁻, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms). However, R₃₅, R₃₆, R₃₇, and R₃₈ each preferably are a hydrogen atom or —SO₃⁻ because R₃₅ to R₃₈ serve also to aid the cationic coloring matter to have the hue thereof.

Among the compounds represented by any of general formulae (I) to (IV′) and of general formulae (V) to (VII) which will be described later, the compounds represented by general formula (III) or (IV′), i.e., the compounds in which one of the benzene rings in the triarylmethine structure is a naphthalene ring, especially remarkably have the effect of improving in heat resistance when at least one of R¹⁰³ and R¹⁰⁴ is not a hydrogen atom.

Compounds represented by general formula (I) can be synthesized, for example, according to the method described in J. Chem. Soc., Perkin Trans., 1998, 2, 297 and WO 2006/120205. Because of the nature of the production process, the compounds represented by general formula (I) are necessarily obtained as a mixture of multiple kinds of compounds differing in the value of m. In the colored resin composition for color filter of the invention, a mixture of compounds represented by general formula (I) may be used as the mixture state or a single compound isolated therefrom may be used. In the case of a mixture, it is preferred that the mixture should be one in which one or more compounds satisfying the “preferred” value of m described above are contained in a largest proportion.

Specific examples of the compound represented by general formula (I) include the following compounds. However, the invention should not be construed as being limited to the following examples unless the invention departs from the spirit thereof. In the following examples, C₆H₅— is phenyl and Tₛ represents tosyl.

TABLE 1
(II)

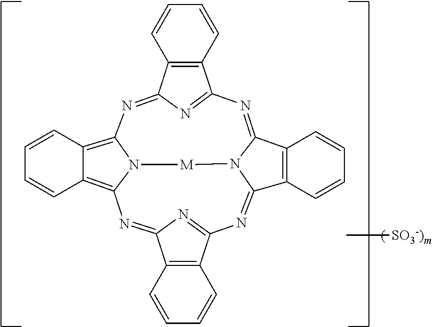

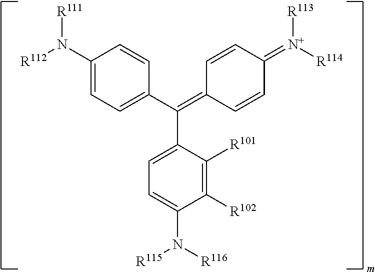

| No. | R¹¹¹ | R¹¹² | R¹¹³ | R¹¹⁴ | R¹¹⁵ | R¹¹⁶ | R¹⁰¹ | R¹⁰² | m |
|---|---|---|---|---|---|---|---|---|---|
| II-1 | C₂H₅— | C₂H₅— | C₂H₅— | C₂H₅— | H— | C₂H₅— | 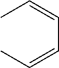 | | 1 |
| II-2 | C₂H₅— | C₂H₅— | C₂H₅— | C₂H₅— | H— | C₂H₅— | 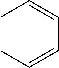 | | 2 |
| II-3 | C₂H₅— | C₂H₅— | C₂H₅— | C₂H₅— | H— | C₂H₅— | 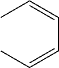 | | 3 |
| II-4 | C₂H₅— | C₂H₅— | C₂H₅— | C₂H₅— | H— | C₂H₅— | 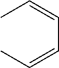 | | 4 |
| II-5 | C₂H₅— | C₂H₅— | C₂H₅— | C₂H₅— | C₂H₅— | C₂H₅— | CH₃— | H— | 1 |
| II-6 | C₂H₅— | C₂H₅— | C₂H₅— | C₂H₅— | C₂H₅— | C₂H₅— | CH₃— | H— | 2 |
| II-7 | C₂H₅— | C₂H₅— | C₂H₅— | C₂H₅— | C₂H₅— | C₂H₅— | CH₃— | H— | 3 |
| II-8 | C₂H₅— | C₂H₅— | C₂H₅— | C₂H₅— | C₂H₅— | C₂H₅— | CH₃— | H— | 4 |

| | | | | | | | | |
|---|---|---|---|---|---|---|---|---|
| II-9 | C₂H₅— | C₂H₅— | C₂H₅— | C₂H₅— | C₂H₅— | C₂H₅— | 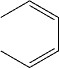 | 1 |
| II-10 | C₂H₅— | C₂H₅— | C₂H₅— | C₂H₅— | C₂H₅— | C₂H₅— | 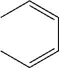 | 2 |

TABLE 2

| | | | | | | | | | |
|---|---|---|---|---|---|---|---|---|---|
| No. | R¹¹¹ | R¹¹² | R¹¹³ | R¹¹⁴ | R¹¹⁵ | R¹¹⁶ | R¹⁰¹ | R¹⁰² | m |

| | | | | | | | | |
|---|---|---|---|---|---|---|---|---|
| II-11 | C₂H₅— | C₂H₅— | C₂H₅— | C₂H₅— | C₂H₅— | C₂H₅— | 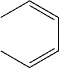 | 3 |
| II-12 | C₂H₅— | C₂H₅— | C₂H₅— | C₂H₅— | C₂H₅— | C₂H₅— | 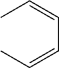 | 4 |
| II-13 | C₄H₉— | C₄H₉— | C₄H₉— | C₄H₉— | H— | C₂H₅— | 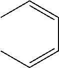 | 1 |
| II-14 | C₄H₉— | C₄H₉— | C₄H₉— | C₄H₉— | H— | C₂H₅— | 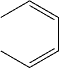 | 2 |
| II-15 | C₄H₉— | C₄H₉— | C₄H₉— | C₄H₉— | H— | C₂H₅— | 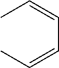 | 3 |
| II-16 | C₄H₉— | C₄H₉— | C₄H₉— | C₄H₉— | H— | C₂H₅— | 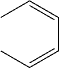 | 4 |

| | | | | | | |
|---|---|---|---|---|---|---|
| II-17 | 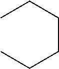 | 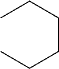 | H— | C₂H₅— | 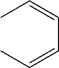 | 1 |
| II-18 | 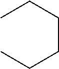 | 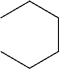 | H— | C₂H₅— | 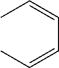 | 2 |
| II-19 | 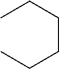 | 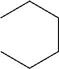 | H— | C₂H₅— | 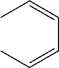 | 3 |
| II-20 | 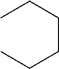 | 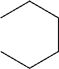 | H— | C₂H₅— | 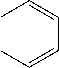 | 4 |
| II-21 | 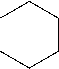 | 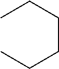 | C₂H₅— | C₂H₅— | 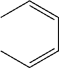 | 1 |
| II-22 | 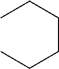 | 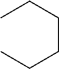 | C₂H₅— | C₂H₅— | 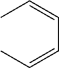 | 2 |

TABLE 3

| | | | | | | | | | |
|---|---|---|---|---|---|---|---|---|---|
| No. | R¹¹¹ | R¹¹² | R¹¹³ | R¹¹⁴ | R¹¹⁵ | R¹¹⁶ | R¹⁰¹ | R¹⁰² | m |

| II-23 | 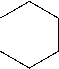 | | 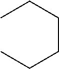 | | C₂H₅— | C₂H₅— | 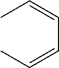 | 3 |
|---|---|---|---|---|---|---|---|---|
| II-24 | 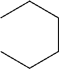 | | 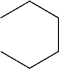 | | C₂H₅— | C₂H₅— | 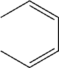 | 4 |
| II-25 | C₂H₅— | C₂H₅— | C₂H₅— | C₂H₅— | H— | C₆H₅— | 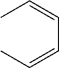 | 1 |
| II-26 | C₂H₅— | C₂H₅— | C₂H₅— | C₂H₅— | H— | C₆H₅— | 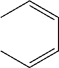 | 2 |
| II-27 | C₂H₅— | C₂H₅— | C₂H₅— | C₂H₅— | H— | C₆H₅— | 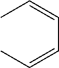 | 3 |
| II-28 | C₂H₅— | C₂H₅— | C₂H₅— | C₂H₅— | H— | C₆H₅— | 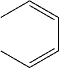 | 4 |
| II-29 | C₄H₉— | C₄H₉— | C₄H₉— | C₄H₉— | H— | C₆H₅— | 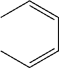 | 1 |
| II-30 | C₄H₉— | C₄H₉— | C₄H₉— | C₄H₉— | H— | C₆H₅— | 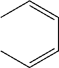 | 2 |
| II-31 | C₄H₉— | C₄H₉— | C₄H₉— | C₄H₉— | H— | C₆H₅— | 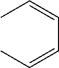 | 3 |
| II-32 | C₄H₉— | C₄H₉— | C₄H₉— | C₄H₉— | H— | C₆H₅— | 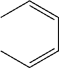 | 4 |
| II-33 | CH₃— | CH₃— | CH₃— | CH₃— | H— | C₂H₅— | 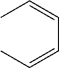 | 1 |
| II-34 | CH₃— | CH₃— | CH₃— | CH₃— | H— | C₂H₅— | 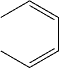 | 2 |

TABLE 4

| | | | | | | | | | |
|---|---|---|---|---|---|---|---|---|---|
| No. | R¹¹¹ | R¹¹² | R¹¹³ | R¹¹⁴ | R¹¹⁵ | R¹¹⁶ | R¹⁰¹ | R¹⁰² | m |

| II-35 | CH₃— | CH₃— | CH₃— | CH₃— | H— | C₂H₅— | 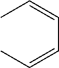 | 3 |
|---|---|---|---|---|---|---|---|---|
| II-36 | CH₃— | CH₃— | CH₃— | CH₃— | H— | C₂H₅— | 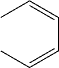 | 4 |
| II-37 | 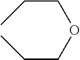 | | 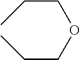 | | H— | C₂H₅— | 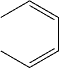 | 1 |
| II-38 | 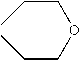 | | 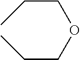 | | H— | C₂H₅— | 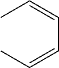 | 2 |
| II-39 | 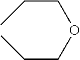 | | 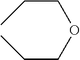 | | H— | C₂H₅— | 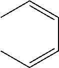 | 3 |
| II-40 | 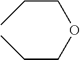 | | 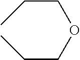 | | H— | C₂H₅— | 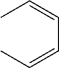 | 4 |
| II-41 | CH₃OC₂H₄— | CH₃OC₂H₄— | CH₃OC₂H₄— | CH₃OC₂H₄— | H— | C₂H₅— | 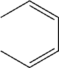 | 1 |
| II-42 | CH₃OC₂H₄— | CH₃OC₂H₄— | CH₃OC₂H₄— | CH₃OC₂H₄— | H— | C₂H₅— | 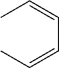 | 2 |
| II-43 | CH₃OC₂H₄— | CH₃OC₂H₄— | CH₃OC₂H₄— | CH₃OC₂H₄— | H— | C₂H₅— | 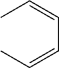 | 3 |
| II-44 | CH₃OC₂H₄— | CH₃OC₂H₄— | CH₃OC₂H₄— | CH₃OC₂H₄— | H— | C₂H₅— | 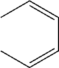 | 4 |
| II-45 | NC—C₂H₄— | NC—C₂H₄— | NC—C₂H₄— | NC—C₂H₄— | H— | C₂H₅— | 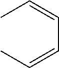 | 1 |
| II-46 | NC—C₂H₄— | NC—C₂H₄— | NC—C₂H₄— | NC—C₂H₄— | H— | C₂H₅— | 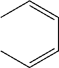 | 2 |

TABLE 5

| | | | | | | | | | |
|---|---|---|---|---|---|---|---|---|---|
| No. | R¹¹¹ | R¹¹² | R¹¹³ | R¹¹⁴ | R¹¹⁵ | R¹¹⁶ | R¹⁰¹ | R¹⁰² | m |

| II-47 | NC—C₂H₄— | NC—C₂H₄— | NC—C₂H₄— | NC—C₂H₄— | H— | C₂H₅— | 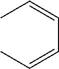 | 3 |
|---|---|---|---|---|---|---|---|---|
| II-48 | NC—C₂H₄— | NC—C₂H₄— | NC—C₂H₄— | NC—C₂H₄— | H— | C₂H₅— | 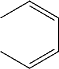 | 4 |
| II-49 | 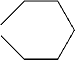 | | 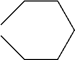 | | H— | C₂H₅— | 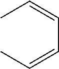 | 1 |
| II-50 | 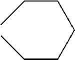 | | 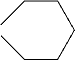 | | H— | C₂H₅— | 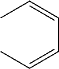 | 2 |
| II-51 | 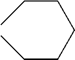 | | 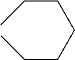 | | H— | C₂H₅— | 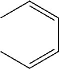 | 3 |
| II-52 | 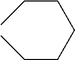 | | 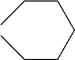 | | H— | C₂H₅— | 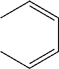 | 4 |
| II-53 | C₂H₅— | C₆H₅— | C₂H₅— | C₆H₅— | H— | C₂H₅— | 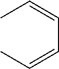 | 1 |
| II-54 | C₂H₅— | C₆H₅— | C₂H₅— | C₆H₅— | H— | C₂H₅— | 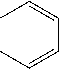 | 2 |
| II-55 | C₂H₅— | C₆H₅— | C₂H₅— | C₆H₅— | H— | C₂H₅— | 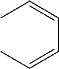 | 3 |
| II-56 | C₂H₅— | C₆H₅— | C₂H₅— | C₆H₅— | H— | C₂H₅— | 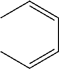 | 4 |
| II-57 | C₂H₅— | C₆H₅CH₂— | C₂H₅— | C₆H₅CH₂— | H— | C₂H₅— | 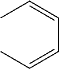 | 1 |
| II-58 | C₂H₅— | C₆H₅CH₂— | C₂H₅— | C₆H₅CH₂— | H— | C₂H₅— | 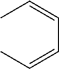 | 2 |

TABLE 6

| | | | | | | | | | |
|---|---|---|---|---|---|---|---|---|---|
| No. | R¹¹¹ | R¹¹² | R¹¹³ | R¹¹⁴ | R¹¹⁵ | R¹¹⁶ | R¹⁰¹ | R¹⁰² | m |

| | | | | | | | | |
|---|---|---|---|---|---|---|---|---|
| II-59 | C₂H₅— | C₆H₅CH₂— | C₂H₅— | C₆H₅CH₂— | H— | C₂H₅— | 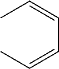 | 3 |
| II-60 | C₂H₅— | C₆H₅CH₂— | C₂H₅— | C₆H₅CH₂— | H— | C₂H₅— | 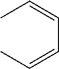 | 4 |
| II-61 | C₂H₅— | C₂H₅OCOCH₂— | C₂H₅— | C₂H₅OCOCH₂— | H— | C₂H₅— | 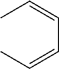 | 1 |
| II-62 | C₂H₅— | C₂H₅OCOCH₂— | C₂H₅— | C₂H₅OCOCH₂— | H— | C₂H₅— | 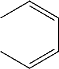 | 2 |
| II-63 | C₂H₅— | C₂H₅OCOCH₂— | C₂H₅— | C₂H₅OCOCH₂— | H— | C₂H₅— | 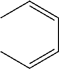 | 3 |
| II-64 | C₂H₅— | C₂H₅OCOCH₂— | C₂H₅— | C₂H₅OCOCH₂— | H— | C₂H₅— | 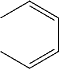 | 4 |
| II-65 | C₂H₅— | NC—C₂H₄— | C₂H₅— | NC—C₂H₄— | H— | C₂H₅— | 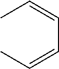 | 1 |
| II-66 | C₂H₅— | NC—C₂H₄— | C₂H₅— | NC—C₂H₄— | H— | C₂H₅— | 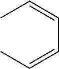 | 2 |
| II-67 | C₂H₅— | NC—C₂H₄— | C₂H₅— | NC—C₂H₄— | H— | C₂H₅— | 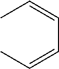 | 3 |
| II-68 | C₂H₅— | NC—C₂H₄— | C₂H₅— | NC—C₂H₄— | H— | C₂H₅— | 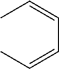 | 4 |
| II-69 | H— | 2-C₂H₅—C₆H₁₂— | H— | 2-C₂H₅—C₆H₁₂— | H— | C₂H₅— | 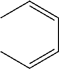 | 1 |
| II-70 | H— | 2-C₂H₅—C₆H₁₂— | H— | 2-C₂H₅—C₆H₁₂— | H— | C₂H₅— | 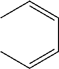 | 2 |

TABLE 7

| No. | R¹¹¹ | R¹¹² | R¹¹³ | R¹¹⁴ | R¹¹⁵ | R¹¹⁶ | R¹⁰¹ | R¹⁰² | m |
|---|---|---|---|---|---|---|---|---|---|
| II-71 | H— | 2-C₂H₅—C₆H₁₂— | H— | 2-C₂H₅—C₆H₁₂— | H— | C₂H₅— | 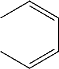 | | 3 |
| II-72 | H— | 2-C₂H₅—C₆H₁₂— | H— | 2-C₂H₅—C₆H₁₂— | H— | C₂H₅— | 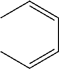 | | 4 |
| II-73 | C₂H₅— | C₂H₅— | C₂H₅— | C₂H₅— | H— | 2-C₂H₅—C₆H₁₂— | 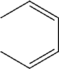 | | 1 |
| II-74 | C₂H₅— | C₂H₅— | C₂H₅— | C₂H₅— | H— | 2-C₂H₅—C₆H₁₂— | 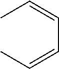 | | 2 |
| II-75 | C₂H₅— | C₂H₅— | C₂H₅— | C₂H₅— | H— | 2-C₂H₅—C₆H₁₂— | 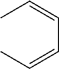 | | 3 |
| II-76 | C₂H₅— | C₂H₅— | C₂H₅— | C₂H₅— | H— | 2-C₂H₅—C₆H₁₂— | 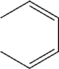 | | 4 |
| II-77 | C₂H₅— | C₂H₅— | C₂H₅— | C₂H₅— | C₂H₅— | C₂H₅— | CF₃— | H— | 1 |
| II-78 | C₂H₅— | C₂H₅— | C₂H₅— | C₂H₅— | C₂H₅— | C₂H₅— | CF₃— | H— | 2 |
| II-79 | C₂H₅— | C₂H₅— | C₂H₅— | C₂H₅— | C₂H₅— | C₂H₅— | CF₃— | H— | 3 |
| II-80 | C₂H₅— | C₂H₅— | C₂H₅— | C₂H₅— | C₂H₅— | C₂H₅— | CF₃— | H— | 4 |
| II-81 | C₂H₅— | C₂H₅— | C₂H₅— | C₂H₅— | C₂H₅— | C₂H₅— | F— | H— | 1 |
| II-82 | C₂H₅— | C₂H₅— | C₂H₅— | C₂H₅— | C₂H₅— | C₂H₅— | F— | H— | 2 |
| II-83 | C₂H₅— | C₂H₅— | C₂H₅— | C₂H₅— | C₂H₅— | C₂H₅— | F— | H— | 3 |
| II-84 | C₂H₅— | C₂H₅— | C₂H₅— | C₂H₅— | C₂H₅— | C₂H₅— | F— | H— | 4 |

| | | | | | | | |
|---|---|---|---|---|---|---|---|
| II-85 | C₂H₅— | C₂H₅— | C₂H₅— | C₂H₅— | 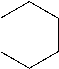 | 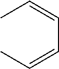 | 1 |

TABLE 8

| No. | R¹¹¹ | R¹¹² | R¹¹³ | R¹¹⁴ | R¹¹⁵ | R¹¹⁶ | R¹⁰¹ | R¹⁰² | m |
|---|---|---|---|---|---|---|---|---|---|
| II-86 | C₂H₅— | C₂H₅— | C₂H₅— | C₂H₅— | 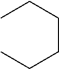 | | 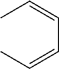 | | 2 |
| II-87 | C₂H₅— | C₂H₅— | C₂H₅— | C₂H₅— | 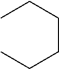 | | 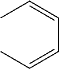 | | 3 |
| II-88 | C₂H₅— | C₂H₅— | C₂H₅— | C₂H₅— | 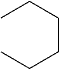 | | 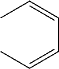 | | 4 |
| II-89 | C₂H₅— | C₂H₅— | C₂H₅— | C₂H₅— | C₂H₅— | C₂H₅— | CH₃— | CH₃— | 1 |
| II-90 | C₂H₅— | C₂H₅— | C₂H₅— | C₂H₅— | C₂H₅— | C₂H₅— | CH₃— | CH₃— | 2 |
| II-91 | C₂H₅— | C₂H₅— | C₂H₅— | C₂H₅— | C₂H₅— | C₂H₅— | CH₃— | CH₃— | 3 |
| II-92 | C₂H₅— | C₂H₅— | C₂H₅— | C₂H₅— | C₂H₅— | C₂H₅— | CH₃— | CH₃— | 4 |
| II-93 | C₂H₅— | C₂H₅— | C₂H₅— | C₂H₅— | C₂H₅— | C₂H₅— | CH₃O— | H— | 1 |
| II-94 | C₂H₅— | C₂H₅— | C₂H₅— | C₂H₅— | C₂H₅— | C₂H₅— | CH₃O— | H— | 2 |
| II-95 | C₂H₅— | C₂H₅— | C₂H₅— | C₂H₅— | C₂H₅— | C₂H₅— | CH₃O— | H— | 3 |
| II-96 | C₂H₅— | C₂H₅— | C₂H₅— | C₂H₅— | C₂H₅— | C₂H₅— | CH₃O— | H— | 4 |
| II-97 | C₂H₅— | C₂H₅— | C₂H₅— | C₂H₅— | CH₃O—C₂H₄— | CH₃O—C₂H₄— | CH₃— | H— | 1 |
| II-98 | C₂H₅— | C₂H₅— | C₂H₅— | C₂H₅— | CH₃O—C₂H₄— | CH₃O—C₂H₄— | CH₃— | H— | 2 |
| II-99 | C₂H₅— | C₂H₅— | C₂H₅— | C₂H₅— | CH₃O—C₂H₄— | CH₃O—C₂H₄— | CH₃— | H— | 3 |
| II-100 | C₂H₅— | C₂H₅— | C₂H₅— | C₂H₅— | CH₃O—C₂H₄— | CH₃O—C₂H₄— | CH₃— | H— | 4 |
| II-101 | C₂H₅— | C₂H₅— | C₂H₅— | C₂H₅— | TsO—C₂H₄— | TsO—C₂H₄— | CH₃— | H— | 1 |
| II-102 | C₂H₅— | C₂H₅— | C₂H₅— | C₂H₅— | TsO—C₂H₄— | TsO—C₂H₄— | CH₃— | H— | 2 |
| II-103 | C₂H₅— | C₂H₅— | C₂H₅— | C₂H₅— | TsO—C₂H₄— | TsO—C₂H₄— | CH₃— | H— | 3 |
| II-104 | C₂H₅— | C₂H₅— | C₂H₅— | C₂H₅— | TsO—C₂H₄— | TsO—C₂H₄— | CH₃— | H— | 4 |
| II-105 | C₂H₅— | C₂H₅— | C₂H₅— | C₂H₅— | C₂H₅— | C₂H₅— | C₂H₅OCO— | H— | 1 |

TABLE 9

| No. | R¹¹¹ | R¹¹² | R¹¹³ | R¹¹⁴ | R¹¹⁵ | R¹¹⁶ | R¹⁰¹ | R¹⁰² | m |
|---|---|---|---|---|---|---|---|---|---|
| II-106 | C₂H₅— | C₂H₅— | C₂H₅— | C₂H₅— | C₂H₅— | C₂H₅— | C₂H₅OCO— | H— | 2 |
| II-107 | C₂H₅— | C₂H₅— | C₂H₅— | C₂H₅— | C₂H₅— | C₂H₅— | C₂H₅OCO— | H— | 3 |
| II-108 | C₂H₅— | C₂H₅— | C₂H₅— | C₂H₅— | C₂H₅— | C₂H₅— | C₂H₅OCO— | H— | 4 |

| II-109 | 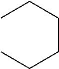 | | 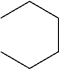 | | 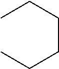 | | 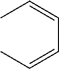 | 1 |
|---|---|---|---|---|---|---|---|---|
| II-110 | 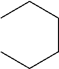 | | 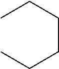 | | 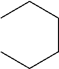 | | 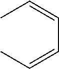 | 2 |
| II-111 | 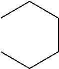 | | 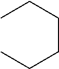 | | 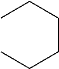 | | 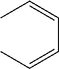 | 3 |
| II-112 | 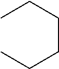 | | 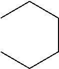 | | 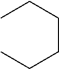 | | 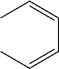 | 4 |
| II-113 | C₂H₅— | C₂H₅— | C₂H₅— | C₂H₅— | C₂H₅— | C₂H₅— | 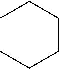 | 1 |
| II-114 | C₂H₅— | C₂H₅— | C₂H₅— | C₂H₅— | C₂H₅— | C₂H₅— | 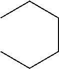 | 2 |
| II-115 | C₂H₅— | C₂H₅— | C₂H₅— | C₂H₅— | C₂H₅— | C₂H₅— | 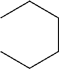 | 3 |
| II-116 | C₂H₅— | C₂H₅— | C₂H₅— | C₂H₅— | C₂H₅— | C₂H₅— | 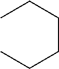 | 4 |

| | | | | | | | |
|---|---|---|---|---|---|---|---|
| II-117 | C₂H₅— | C₂H₅— | 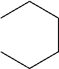 | H— | C₂H₅— | 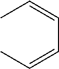 | 1 |
| II-118 | C₂H₅— | C₂H₅— | 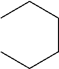 | H— | C₂H₅— | 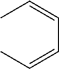 | 2 |

TABLE 10

| No. | R¹¹¹ | R¹¹² | R¹¹³ | R¹¹⁴ | R¹¹⁵ | R¹¹⁶ | R¹⁰¹ | R¹⁰² | m |
|---|---|---|---|---|---|---|---|---|---|
| II-119 | C₂H₅— | C₂H₅— | 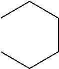 | | H— | C₂H₅— | 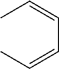 | | 3 |
| II-120 | C₂H₅— | C₂H₅— | 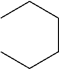 | | H— | C₂H₅— | 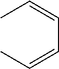 | | 4 |
| II-121 | C₂H₅— | C₂H₅— | C₂H₅— | C₂H₅— | C₄H₉— | C₄H₉— | C₆H₅— | H— | 1 |
| II-122 | C₂H₅— | C₂H₅— | C₂H₅— | C₂H₅— | C₄H₉— | C₄H₉— | C₆H₅— | H— | 2 |
| II-123 | C₂H₅— | C₂H₅— | C₂H₅— | C₂H₅— | C₄H₉— | C₄H₉— | C₆H₅— | H— | 3 |
| II-124 | C₂H₅— | C₂H₅— | C₂H₅— | C₂H₅— | C₄H₉— | C₄H₉— | C₆H₅— | H— | 4 |
| II-125 | C₂H₅— | C₆H₅— | C₂H₅— | C₆H₅— | C₄H₉— | C₄H₉— | C₆H₅— | H— | 1 |
| II-126 | C₂H₅— | C₆H₅— | C₂H₅— | C₆H₅— | C₄H₉— | C₄H₉— | C₆H₅— | H— | 2 |
| II-127 | C₂H₅— | C₆H₅— | C₂H₅— | C₆H₅— | C₄H₉— | C₄H₉— | C₆H₅— | H— | 3 |
| II-128 | C₂H₅— | C₆H₅— | C₂H₅— | C₆H₅— | C₄H₉— | C₄H₉— | C₆H₅— | H— | 4 |
| II-129 | C₂H₅— | C₂H₅— | C₂H₅— | C₂H₅— | H— | 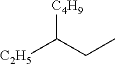 | C₆H₅— | H— | 1 |
| II-130 | C₂H₅— | C₂H₅— | C₂H₅— | C₂H₅— | H— | 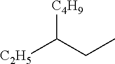 | C₆H₅— | H— | 2 |
| II-131 | C₂H₅— | C₂H₅— | C₂H₅— | C₂H₅— | H— | 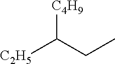 | C₆H₅— | H— | 3 |
| II-132 | C₂H₅— | C₂H₅— | C₂H₅— | C₂H₅— | H— | 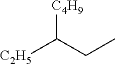 | C₆H₅— | H— | 4 |
| II-133 | C₂H₅— | C₆H₅— | C₂H₅— | C₆H₅— | H— | 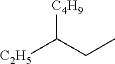 | C₆H₅— | H— | 1 |

TABLE 11

| No. | R¹¹¹ | R¹¹² | R¹¹³ | R¹¹⁴ | R¹¹⁵ | R¹¹⁶ | R¹⁰¹ | R¹⁰² | m |
|---|---|---|---|---|---|---|---|---|---|
| II-134 | C₂H₅— | C₆H₅— | C₂H₅— | C₆H₅— | H— | 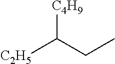 | C₆H₅— | H— | 2 |
| II-135 | C₂H₅— | C₆H₅— | C₂H₅— | C₆H₅— | H— | 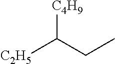 | C₆H₅— | H— | 3 |
| II-136 | C₂H₅— | C₆H₅— | C₂H₅— | C₆H₅— | H— | 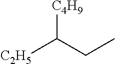 | C₆H₅— | H— | 4 |
| II-137 | C₄H₉— | C₄H₉— | C₄H₉— | C₄H₉— | H— | C₆H₅— | C₆H₅— | H— | 1 |
| II-138 | C₄H₉— | C₄H₉— | C₄H₉— | C₄H₉— | H— | C₆H₅— | C₆H₅— | H— | 2 |
| II-139 | C₄H₉— | C₄H₉— | C₄H₉— | C₄H₉— | H— | C₆H₅— | C₆H₅— | H— | 3 |
| II-140 | C₄H₉— | C₄H₉— | C₄H₉— | C₄H₉— | H— | C₆H₅— | C₆H₅— | H— | 4 |
| II-141 | C₄H₉— | C₄H₉— | C₄H₉— | C₄H₉— | H— | C₆H₅— | C₆H₅— | H— | 1 |
| II-142 | C₄H₉— | C₄H₉— | C₄H₉— | C₄H₉— | H— | C₆H₅— | C₆H₅— | H— | 2 |
| II-143 | C₄H₉— | C₄H₉— | C₄H₉— | C₄H₉— | H— | C₆H₅— | C₆H₅— | H— | 3 |
| II-144 | C₄H₉— | C₄H₉— | C₄H₉— | C₄H₉— | H— | C₆H₅— | C₆H₅— | H— | 4 |
| II-145 | C₄H₉— | C₄H₉— | C₄H₉— | C₄H₉— | H— | C₆H₅— | C₆H₅— | H— | 1 |
| II-146 | C₄H₉— | C₄H₉— | C₄H₉— | C₄H₉— | H— | C₆H₅— | C₆H₅— | H— | 2 |
| II-147 | C₄H₉— | C₄H₉— | C₄H₉— | C₄H₉— | H— | C₆H₅— | C₆H₅— | H— | 3 |
| II-148 | C₄H₉— | C₄H₉— | C₄H₉— | C₄H₉— | H— | C₆H₅— | C₆H₅— | H— | 4 |

TABLE 12
(IVA)

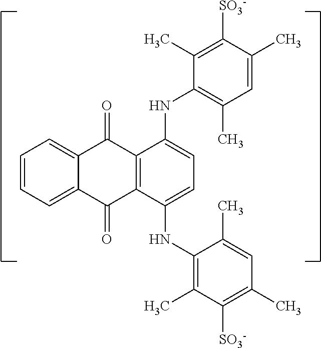

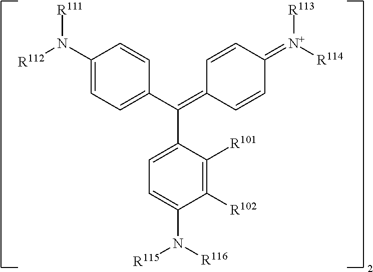

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-1 | C₂H₅— | C₂H₅— | C₂H₅— | C₂H₅— | H— | C₂H₅— | 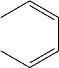 | |
| IV-2 | C₂H₅— | C₂H₅— | C₂H₅— | C₂H₅— | C₂H₅— | C₂H₅— | CH₃— | H— |

| IV-3 | C₂H₅— | C₂H₅— | C₂H₅— | C₂H₅— | C₂H₅— | C₂H₅— | 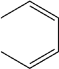 |
|---|---|---|---|---|---|---|---|
| IV-4 | C₄H₉— | C₄H₉— | C₄H₉— | C₄H₉— | H— | C₂H₅— | 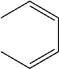 |
| IV-5 | 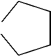 | | 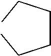 | | H— | C₂H₅— | 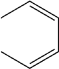 |
| IV-6 | 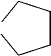 | | 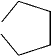 | | C₂H₅— | C₂H₅— | 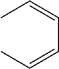 |
| IV-7 | C₂H₅— | C₂H₅— | C₂H₅— | C₂H₅— | H— | C₆H₅— | 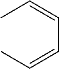 |

TABLE 13

| | | | | | | | | |
|---|---|---|---|---|---|---|---|---|
| No. | R¹¹¹ | R¹¹² | R¹¹³ | R¹¹⁴ | R¹¹⁵ | R¹¹⁶ | R¹⁰¹ | R¹⁰² |

| IV-8 | C₄H₉— | C₄H₉— | C₄H₉— | C₄H₉— | H— | C₂H₅— | 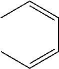 |
|---|---|---|---|---|---|---|---|
| IV-9 | CH₃— | CH₃— | CH₃— | CH₃— | H— | C₂H₅— | 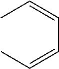 |
| IV-10 | 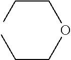 | | 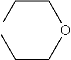 | | H— | C₂H₅— | 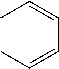 |
| IV-11 | CH₃OC₂H₄— | CH₃OC₂H₄— | CH₃OC₂H₄— | CH₃OC₂H₄— | H— | C₂H₅— | 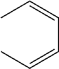 |
| IV-12 | NC—C₂H₄— | NC—C₂H₄— | NC—C₂H₄— | NC—C₂H₄— | H— | C₂H₅— | 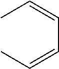 |
| IV-13 | 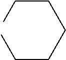 | | 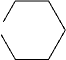 | | H— | C₂H₅— | 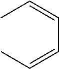 |
| IV-14 | C₂H₅— | C₆H₅— | C₂H₅— | C₆H₅— | H— | C₂H₅— | 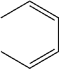 |
| IV-15 | C₂H₅— | C₆H₅CH₂— | C₂H₅— | C₆H₅CH₂— | H— | C₂H₅— | 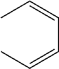 |
| IV-16 | C₂H₅— | C₂H₅OCOCH₂— | C₂H₅— | C₂H₅OCOCH₂— | H— | C₂H₅— | 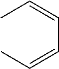 |
| IV-17 | C₂H₅— | NC—C₂H₄— | C₂H₅— | NC—C₂H₄— | H— | C₂H₅— | 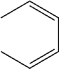 |
| IV-18 | H— | 2-C₂H₅—C₆H₁₂— | H— | 2-C₂H₅—C₆H₁₂— | H— | C₂H₅— | 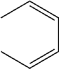 |
| IV-19 | C₂H₅— | C₂H₅— | C₂H₅— | C₂H₅— | H— | 2-C₂H₅—C₆H₁₂— | 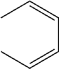 |

TABLE 14

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-20 | C₂H₅— | C₂H₅— | C₂H₅— | C₂H₅— | C₂H₅— | C₂H₅— | CF₃— | H |
| IV-21 | C₂H₅— | C₂H₅— | C₂H₅— | C₂H₅— | C₂H₅— | C₂H₅— | F— | H |
| IV-22 | C₂H₅— | C₂H₅— | C₂H₅— | C₂H₅— | 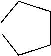 | | 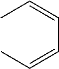 | |
| IV-23 | C₂H₅— | C₂H₅— | C₂H₅— | C₂H₅— | C₂H₅— | C₂H₅— | CH₃— | CH₃— |
| IV-24 | C₂H₅— | C₂H₅— | C₂H₅— | C₂H₅— | C₂H₅— | C₂H₅— | CH₃O— | H— |
| IV-25 | C₂H₅— | C₂H₅— | C₂H₅— | C₂H₅— | CH₃O—C₂H₄— | CH₃O—C₂H₄— | CH₃— | H— |
| IV-26 | C₂H₅— | C₂H₅— | C₂H₅— | C₂H₅— | TsO—C₂H₄— | TsO—C₂H₄— | CH₃— | H— |
| IV-27 | C₂H₅— | C₂H₅— | C₂H₅— | C₂H₅— | C₂H₅— | C₂H₅— | C₂H₅OCO— | H— |
| IV-28 | 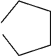 | | 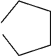 | | 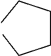 | | 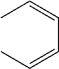 | |
| IV-29 | C₂H₅— | C₂H₅— | C₂H₅— | C₂H₅— | C₂H₅— | C₂H₅— | 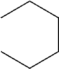 | |
| IV-30 | C₂H₅— | C₂H₅— | 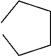 | | H— | C₂H₅— | 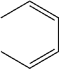 | |
| IV-31 | C₂H₅— | C₂H₅— | C₂H₅— | C₂H₅— | C₄H₉— | C₄H₉— | C₆H₅— | H— |
| IV-32 | C₂H₅— | C₆H₅— | C₂H₅— | C₆H₅— | C₄H₉— | C₄H₉— | C₆H₅— | H— |
| IV-33 | C₂H₅— | C₂H₅— | C₂H₅— | C₂H₅— | H— | 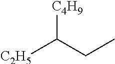 | C₆H₅— | H— |
| IV-34 | C₂H₅— | C₆H₅— | C₂H₅— | C₆H₅— | H— | 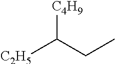 | C₆H₅— | H— |
| IV-35 | C₄H₉— | C₄H₉— | C₄H₉— | C₄H₉— | H— | C₆H₅— | C₆H₅— | H— |
| IV-36 | C₂H₅— | C₂H₅— | C₂H₅— | C₂H₅— | C₄H₉— | C₄H₉— | (CH₃)₂CH— | H— |

TABLE 15

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-37 | C₂H₅— | C₂H₅— | C₂H₅— | C₂H₅— | C₄H₉— | C₄H₉— | C₆F₅— | H— |
| IV-38 | C₂H₅— | C₂H₅— | C₂H₅— | C₂H₅— | C₄H₉— | C₄H₉— | 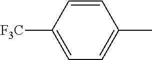 | H— |
| IV-39 | C₂H₅— | C₂H₅— | C₂H₅— | C₂H₅— | C₄H₉— | C₄H₉— | 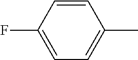 | H— |
| IV-40 | C₂H₅— | C₂H₅— | C₂H₅— | C₂H₅— | C₄H₉— | C₄H₉— | 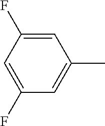 | H— |
| IV-41 | C₂H₅— | C₂H₅— | C₂H₅— | C₂H₅— | C₄H₉— | C₄H₉— | 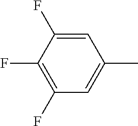 | H— |
| IV-42 | CH₃— | CH₃— | CH₃— | CH₃— | C₄H₉— | C₄H₉— | C₆H₅— | H— |

TABLE 16
(IVB)

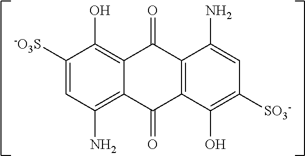

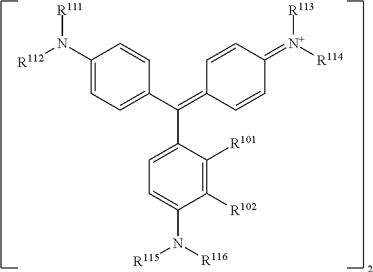

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-43 | C₂H₅— | C₂H₅— | C₂H₅— | C₂H₅— | H— | C₂H₅— | 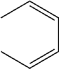 | |
| IV-44 | C₂H₅— | C₂H₅— | C₂H₅— | C₂H₅— | C₂H₅— | C₂H₅— | CH₃— | H— |

| IV-45 | C₂H₅— | C₂H₅— | C₂H₅— | C₂H₅— | C₂H₅— | C₂H₅— | 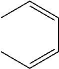 |
|---|---|---|---|---|---|---|---|
| IV-46 | C₄H₉— | C₄H₉— | C₄H₉— | C₄H₉— | H— | C₂H₅— | 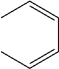 |
| IV-47 | 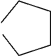 | | 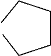 | | H— | C₂H₅— | 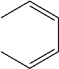 |
| IV-48 | 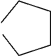 | | 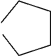 | | C₂H₅— | C₂H₅— | 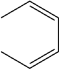 |
| IV-49 | C₂H₅— | C₂H₅— | C₂H₅— | C₂H₅— | H— | C₆H₅— | 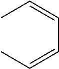 |
| IV-50 | C₄H₉— | C₄H₉— | C₄H₉— | C₄H₉— | H— | C₆H₅— | 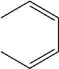 |

TABLE 17

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-51 | CH₃— | CH₃— | CH₃— | CH₃— | H— | C₂H₅— | 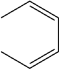 | |
| IV-52 | 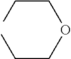 | | 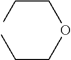 | | H— | C₂H₅— | 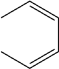 | |
| IV-53 | CH₃OC₂H₄— | CH₃OC₂H₄— | CH₃OC₂H₄— | CH₃OC₂H₄— | H— | C₂H₅— | 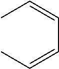 | |
| IV-54 | NC—C₂H₄— | NC—C₂H₄— | NC—C₂H₄— | NC—C₂H₄— | H— | C₂H₅— | 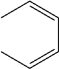 | |
| IV-55 | 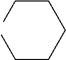 | | 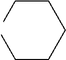 | | H— | C₂H₅— | 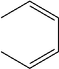 | |
| IV-56 | C₂H₅— | C₆H₅— | C₂H₅— | C₆H₅— | H— | C₂H₅— | 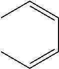 | |
| IV-57 | C₂H₅— | C₆H₅CH₂— | C₂H₅— | C₆H₅CH₂— | H— | C₂H₅— | 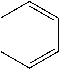 | |
| IV-58 | C₂H₅— | C₂H₅OCOCH₂— | C₂H₅— | C₂H₅OCOCH₂— | H— | C₂H₅— | 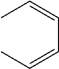 | |
| IV-59 | C₂H₅— | NC—C₂H₄— | C₂H₅— | NC—C₂H₄— | H— | C₂H₅— | 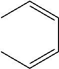 | |
| IV-60 | H— | 2-C₂H₅—C₆H₁₂— | H— | 2-C₂H₅—C₆H₁₂— | H— | C₂H₅— | 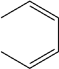 | |
| IV-61 | C₂H₅— | C₂H₅— | C₂H₅— | C₂H₅— | H— | 2-C₂H₅—C₆H₁₂— | 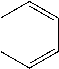 | |
| IV-62 | C₂H₅— | C₂H₅— | C₂H₅— | C₂H₅— | C₂H₅— | C₂H₅— | CF₃— | H— |
| IV-63 | C₂H₅— | C₂H₅— | C₂H₅— | C₂H₅— | C₂H₅— | C₂H₅— | F— | H— |

TABLE 18

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-64 | C₂H₅— | C₂H₅— | C₂H₅— | C₂H₅— | 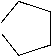 | | 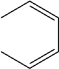 | |
| IV-65 | C₂H₅— | C₂H₅— | C₂H₅— | C₂H₅— | C₂H₅— | C₂H₅— | CH₃— | CH₃— |
| IV-66 | C₂H₅— | C₂H₅— | C₂H₅— | C₂H₅— | C₂H₅— | C₂H₅— | CH₃O— | H— |
| IV-67 | C₂H₅— | C₂H₅— | C₂H₅— | C₂H₅— | CH₃O—C₂H₄— | CH₃O—C₂H₄— | CH₃— | H— |
| IV-68 | C₂H₅— | C₂H₅— | C₂H₅— | C₂H₅— | TsO—C₂H₄— | TsO—C₂H₄— | CH₃— | H— |
| IV-69 | C₂H₅— | C₂H₅— | C₂H₅— | C₂H₅— | C₂H₅— | C₂H₅— | C₂H₅OCO— | H— |
| IV-70 | 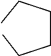 | | 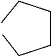 | | 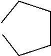 | | 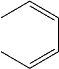 | |
| IV-71 | C₂H₅— | C₂H₅— | C₂H₅— | C₂H₅— | C₂H₅— | C₂H₅— | 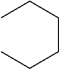 | |
| IV-72 | C₂H₅— | C₂H₅— | 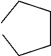 | | H— | C₂H₅— | 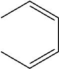 | |
| IV-73 | C₂H₅— | C₂H₅— | C₂H₅— | C₂H₅— | C₄H₉— | C₄H₉— | C₆H₅— | H— |
| IV-74 | C₂H₅— | C₆H₅— | C₂H₅— | C₆H₅— | C₄H₉— | C₄H₉— | C₆H₅— | H— |
| IV-75 | C₂H₅— | C₂H₅— | C₂H₅— | C₂H₅— | H— | 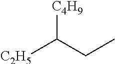 | C₆H₅— | H— |
| IV-76 | C₂H₅— | C₆H₅— | C₂H₅— | C₆H₅— | H— | 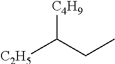 | C₆H₅— | H— |
| IV-77 | C₄H₉— | C₄H₉— | C₄H₉— | C₄H₉— | H— | C₆H₅— | C₆H₅— | H— |
| IV-78 | C₂H₅— | C₂H₅— | C₂H₅— | C₂H₅— | C₄H₉— | C₄H₉— | (CH₃)₂CH— | H— |
| IV-79 | C₂H₅— | C₂H₅— | C₂H₅— | C₂H₅— | C₄H₉— | C₄H₉— | C₆F₅— | H— |

TABLE 19

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-80 | C₂H₅— | C₂H₅— | C₂H₅— | C₂H₅— | C₄H₉— | C₄H₉— | 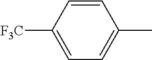 | H— |
| IV-81 | C₂H₅— | C₂H₅— | C₂H₅— | C₂H₅— | C₄H₉— | C₄H₉— | 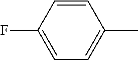 | H— |
| IV-82 | C₂H₅— | C₂H₅— | C₂H₅— | C₂H₅— | C₄H₉— | C₄H₉— | 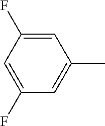 | H— |
| IV-83 | C₂H₅— | C₂H₅— | C₂H₅— | C₂H₅— | C₄H₉— | C₄H₉— | 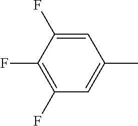 | H— |
| IV-84 | CH₃— | CH₃— | CH₃— | CH₃— | C₄H₉— | C₄H₉— | C₆H₅— | H— |

TABLE 20
(IVC)

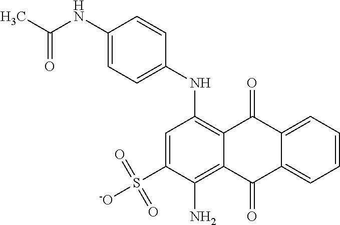

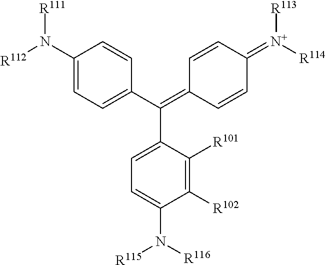

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-85 | C₂H₅— | C₂H₅— | C₂H₅— | C₂H₅— | H— | C₂H₅— | 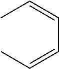 | |
| IV-86 | C₂H₅— | C₂H₅— | C₂H₅— | C₂H₅— | C₂H₅— | C₂H₅— | CH₃— | H— |

| IV-87 | C₂H₅— | C₂H₅— | C₂H₅— | C₂H₅— | C₂H₅— | C₂H₅— | 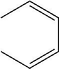 |
|---|---|---|---|---|---|---|---|
| IV-88 | C₄H₉— | C₄H₉— | C₄H₉— | C₄H₉— | H— | C₂H₅— | 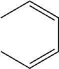 |
| IV-89 | 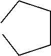 | | 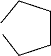 | | H— | C₂H₅— | 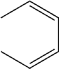 |
| IV-90 | 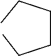 | | 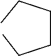 | | C₂H₅— | C₂H₅— | 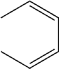 |
| IV-91 | C₂H₅— | C₂H₅— | C₂H₅— | C₂H₅— | H— | C₆H₅— | 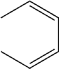 |
| IV-92 | C₄H₉— | C₄H₉— | C₄H₉— | C₄H₉— | H— | C₆H₅— | 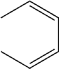 |

TABLE 21

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-93 | CH₃— | CH₃— | CH₃— | CH₃— | H— | C₂H₅— | 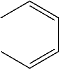 | |
| IV-94 | 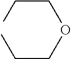 | | 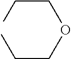 | | H— | C₂H₅— | 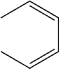 | |
| IV-95 | CH₃OC₂H₄— | CH₃OC₂H₄— | CH₃OC₂H₄— | CH₃OC₂H₄— | H— | C₂H₅— | 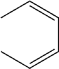 | |
| IV-96 | NC—C₂H₄— | NC—C₂H₄— | NC—C₂H₄— | NC—C₂H₄— | H— | C₂H₅— | 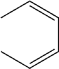 | |
| IV-97 | 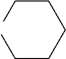 | | 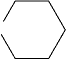 | | H— | C₂H₅— | 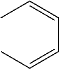 | |
| IV-98 | C₂H₅— | C₆H₅— | C₂H₅— | C₆H₅— | H— | C₂H₅— | 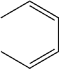 | |
| IV-99 | C₂H₅— | C₆H₅CH₂— | C₂H₅— | C₆H₅CH₂— | H— | C₂H₅— | 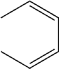 | |
| IV-100 | C₂H₅— | C₂H₅OCOCH₂— | C₂H₅— | C₂H₅OCOCH₂— | H— | C₂H₅— | 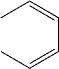 | |
| IV-101 | C₂H₅— | NC—C₂H₄— | C₂H₅— | NC—C₂H₄— | H— | C₂H₅— | 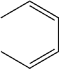 | |
| IV-102 | H— | 2-C₂H₅—C₆H₁₂— | H— | 2-C₂H₅—C₆H₁₂— | H— | C₂H₅— | 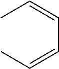 | |
| IV-103 | C₂H₅— | C₂H₅— | C₂H₅— | C₂H₅— | H— | 2-C₂H₅—C₆H₁₂— | 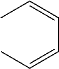 | |
| IV-104 | C₂H₅— | C₂H₅— | C₂H₅— | C₂H₅— | C₂H₅— | C₂H₅— | CF₃— | H— |
| IV-105 | C₂H₅— | C₂H₅— | C₂H₅— | C₂H₅— | C₂H₅— | C₂H₅— | F— | H— |

TABLE 22

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-106 | C₂H₅— | C₂H₅— | C₂H₅— | C₂H₅— | 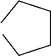 | | 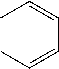 | |
| IV-107 | C₂H₅— | C₂H₅— | C₂H₅— | C₂H₅— | C₂H₅— | C₂H₅— | CH₃— | CH₃— |
| IV-108 | C₂H₅— | C₂H₅— | C₂H₅— | C₂H₅— | C₂H₅— | C₂H₅— | CH₃O— | H— |
| IV-109 | C₂H₅— | C₂H₅— | C₂H₅— | C₂H₅— | CH₃O—C₂H₄— | CH₃O—C₂H₄— | CH₃— | H— |
| IV-110 | C₂H₅— | C₂H₅— | C₂H₅— | C₂H₅— | TsO—C₂H₄— | TsO—C₂H₄— | CH₃— | H— |
| IV-111 | C₂H₅— | C₂H₅— | C₂H₅— | C₂H₅— | C₂H₅— | C₂H₅— | C₂H₅OCO— | H— |
| IV-112 | 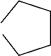 | | 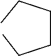 | | 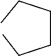 | | 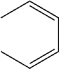 | |
| IV-113 | C₂H₅— | C₂H₅— | C₂H₅— | C₂H₅— | C₂H₅— | C₂H₅— | 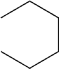 | |
| IV-114 | C₂H₅— | C₂H₅— | 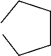 | | H— | C₂H₅— | 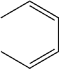 | |
| IV-115 | C₂H₅— | C₂H₅— | C₂H₅— | C₂H₅— | C₄H₉— | C₄H₉— | C₆H₅— | H— |
| IV-116 | C₂H₅— | C₆H₅— | C₂H₅— | C₆H₅— | C₄H₉— | C₄H₉— | C₆H₅— | H— |
| IV-117 | C₂H₅— | C₂H₅— | C₂H₅— | C₂H₅— | H— | 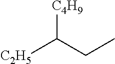 | C₆H₅— | H— |
| IV-118 | C₂H₅— | C₆H₅— | C₂H₅— | C₆H₅— | H— | 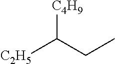 | C₆H₅— | H— |
| IV-119 | C₄H₉— | C₄H₉— | C₄H₉— | C₄H₉— | H— | C₆H₅— | C₆H₅— | H— |
| IV-120 | C₂H₅— | C₂H₅— | C₂H₅— | C₂H₅— | C₄H₉— | C₄H₉— | (CH₃)₂CH— | H— |
| IV-121 | C₂H₅— | C₂H₅— | C₂H₅— | C₂H₅— | C₄H₉— | C₄H₉— | C₆F₅— | H— |

TABLE 23

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-122 | C₂H₅— | C₂H₅— | C₂H₅— | C₂H₅— | C₄H₉— | C₄H₉— | 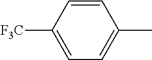 | H— |
| IV-123 | C₂H₅— | C₂H₅— | C₂H₅— | C₂H₅— | C₄H₉— | C₄H₉— | 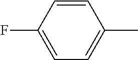 | H— |
| IV-124 | C₂H₅— | C₂H₅— | C₂H₅— | C₂H₅— | C₄H₉— | C₄H₉— | 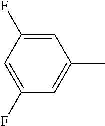 | H— |
| IV-125 | C₂H₅— | C₂H₅— | C₂H₅— | C₂H₅— | C₄H₉— | C₄H₉— | 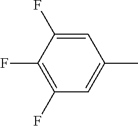 | H— |
| IV-126 | CH₃— | CH₃— | CH₃— | CH₃— | C₄H₉— | C₄H₉— | C₆H₅— | H— |

TABLE 24
(IVD)

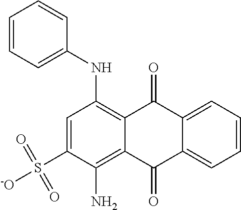

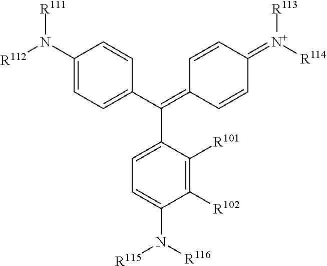

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-127 | C₂H₅— | C₂H₅— | C₂H₅— | C₂H₅— | H— | C₂H₅— | 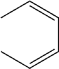 | |
| IV-128 | C₂H₅— | C₂H₅— | C₂H₅— | C₂H₅— | C₂H₅— | C₂H₅— | CH₃— | H— |

| IV-129 | C₂H₅— | C₂H₅— | C₂H₅— | C₂H₅— | C₂H₅— | C₂H₅— | 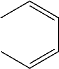 |
|---|---|---|---|---|---|---|---|
| IV-130 | C₄H₉— | C₄H₉— | C₄H₉— | C₄H₉— | H— | C₂H₅— | 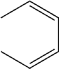 |
| IV-131 | 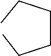 | | 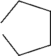 | | H— | C₂H₅— | 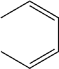 |
| IV-132 | 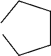 | | 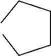 | | C₂H₅— | C₂H₅— | 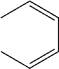 |
| IV-133 | C₂H₅— | C₂H₅— | C₂H₅— | C₂H₅— | H— | C₆H₅— | 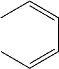 |
| IV-134 | C₄H₉— | C₄H₉— | C₄H₉— | C₄H₉— | H— | C₆H₅— | 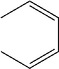 |

TABLE 25

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-135 | CH₃— | CH₃— | CH₃— | CH₃— | H— | C₂H₅— | 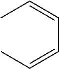 | |
| IV-136 | 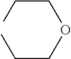 | | 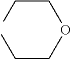 | | H— | C₂H₅— | 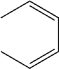 | |
| IV-137 | CH₃OC₂H₄— | CH₃OC₂H₄— | CH₃OC₂H₄— | CH₃OC₂H₄— | H— | C₂H₅— | 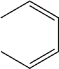 | |
| IV-138 | NC—C₂H₄— | NC—C₂H₄— | NC—C₂H₄— | NC—C₂H₄— | H— | C₂H₅— | 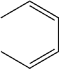 | |
| IV-139 | 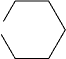 | | 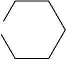 | | H— | C₂H₅— | 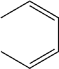 | |
| IV-140 | C₂H₅— | C₆H₅— | C₂H₅— | C₆H₅— | H— | C₂H₅— | 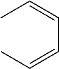 | |
| IV-141 | C₂H₅— | C₆H₅CH₂— | C₂H₅— | C₆H₅CH₂— | H— | C₂H₅— | 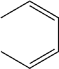 | |
| IV-142 | C₂H₅— | C₂H₅OCOCH₂— | C₂H₅— | C₂H₅OCOCH₂— | H— | C₂H₅— | 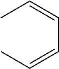 | |
| IV-143 | C₂H₅— | NC—C₂H₄— | C₂H₅— | NC—C₂H₄— | H— | C₂H₅— | 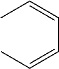 | |
| IV-144 | H— | 2-C₂H₅—C₆H₁₂— | H— | 2-C₂H₅—C₆H₁₂— | H— | C₂H₅— | 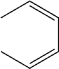 | |
| IV-145 | C₂H₅— | C₂H₅— | C₂H₅— | C₂H₅— | H— | 2-C₂H₅—C₆H₁₂— | 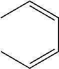 | |
| IV-146 | C₂H₅— | C₂H₅— | C₂H₅— | C₂H₅— | C₂H₅— | C₂H₅— | CF₃— | H— |
| IV-147 | C₂H₅— | C₂H₅— | C₂H₅— | C₂H₅— | C₂H₅— | C₂H₅— | F— | H— |

TABLE 26

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-148 | C₂H₅— | C₂H₅— | C₂H₅— | C₂H₅— | 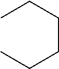 | | 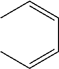 | |
| IV-149 | C₂H₅— | C₂H₅— | C₂H₅— | C₂H₅— | C₂H₅— | C₂H₅— | CH₃— | CH₃— |
| IV-150 | C₂H₅— | C₂H₅— | C₂H₅— | C₂H₅— | C₂H₅— | C₂H₅— | CH₃O— | H— |
| IV-151 | C₂H₅— | C₂H₅— | C₂H₅— | C₂H₅— | CH₃O—C₂H₄— | CH₃O—C₂H₄— | CH₃— | H— |
| IV-152 | C₂H₅— | C₂H₅— | C₂H₅— | C₂H₅— | TsO—C₂H₄— | TsO—C₂H₄— | CH₃— | H— |
| IV-153 | C₂H₅— | C₂H₅— | C₂H₅— | C₂H₅— | C₂H₅— | C₂H₅— | C₂H₅OCO— | H— |
| IV-154 | 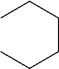 | | 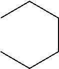 | | 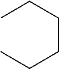 | | 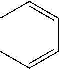 | |
| IV-155 | C₂H₅— | C₂H₅— | C₂H₅— | C₂H₅— | C₂H₅— | C₂H₅— | 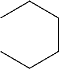 | |
| IV-156 | C₂H₅— | C₂H₅— | 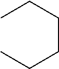 | | H— | C₂H₅— | 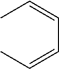 | |
| IV-157 | C₂H₅— | C₂H₅— | C₂H₅— | C₂H₅— | C₄H₉— | C₄H₉— | C₆H₅— | H— |
| IV-158 | C₂H₅— | C₆H₅— | C₂H₅— | C₆H₅— | C₄H₉— | C₄H₉— | C₆H₅— | H— |
| IV-159 | C₂H₅— | C₂H₅— | C₂H₅— | C₂H₅— | H— | 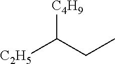 | C₆H₅— | |
| IV-160 | C₂H₅— | C₆H₅— | C₂H₅— | C₆H₅— | H— | 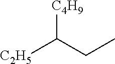 | C₆H₅— | H— |
| IV-161 | C₄H₉— | C₄H₉— | C₄H₉— | C₄H₉— | H— | C₆H₅— | C₆H₅— | H— |
| IV-162 | C₂H₅— | C₂H₅— | C₂H₅— | C₂H₅— | C₄H₉— | C₄H₉— | (CH₃)₂CH— | H— |
| IV-163 | C₂H₅— | C₂H₅— | C₂H₅— | C₂H₅— | C₄H₉— | C₄H₉— | C₆F₅— | H— |

TABLE 27

| No. | R¹¹¹ | R¹¹² | R¹¹³ | R¹¹⁴ | R¹¹⁵ | R¹¹⁶ | R¹⁰¹ | R¹⁰² |
|---|---|---|---|---|---|---|---|---|
| IV-164 | C₂H₅— | C₂H₅— | C₂H₅— | C₂H₅— | C₄H₉— | C₄H₉— | 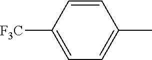 | H — |
| IV-165 | C₂H₅— | C₂H₅— | C₂H₅— | C₂H₅— | C₄H₉— | C₄H₉— | 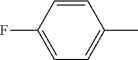 | H— |
| IV-166 | C₂H₅— | C₂H₅— | C₂H₅— | C₂H₅— | C₄H₉— | C₄H₉— | 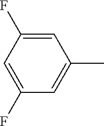 | H— |
| IV-167 | C₂H₅— | C₂H₅— | C₂H₅— | C₂H₅— | C₄H₉— | C₄H₉— | 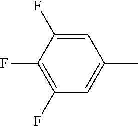 | H— |
| IV-168 | CH₃— | CH₃— | CH₃— | CH₃— | C₄H₉— | C₄H₉— | C₆H₅— | H— |

Other examples of the compound represented by general formula (I) include the following, which are compounds represented by general formula (IV) or (IV′).

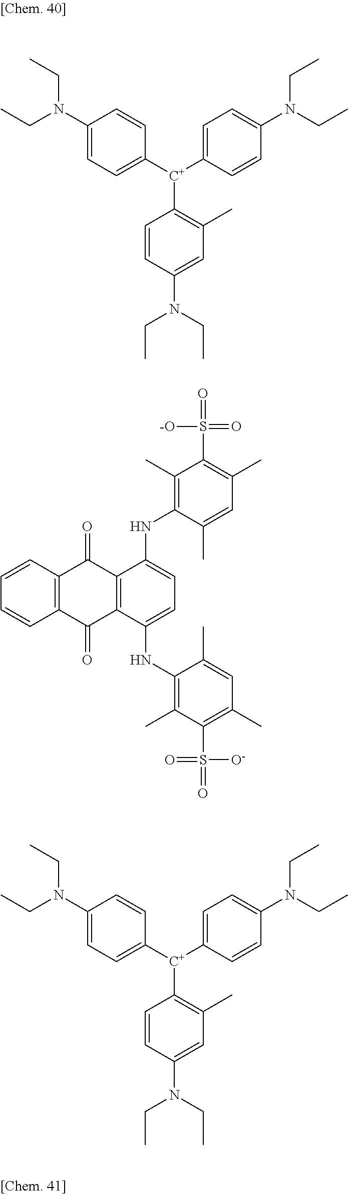

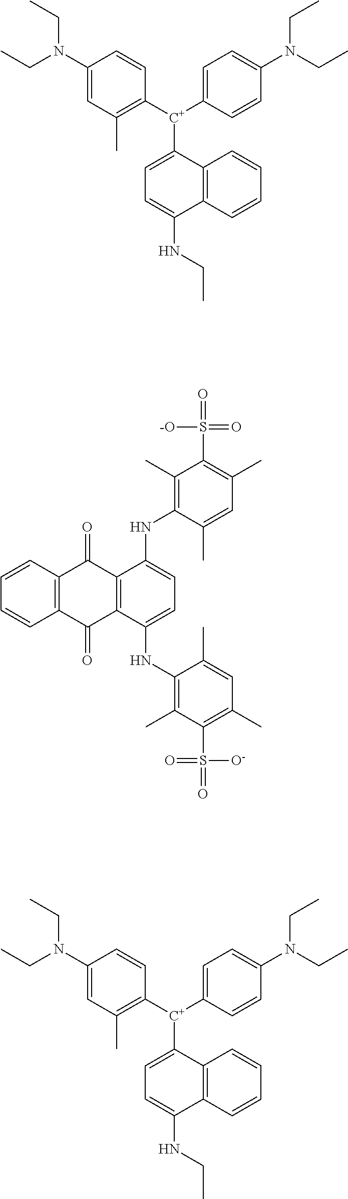

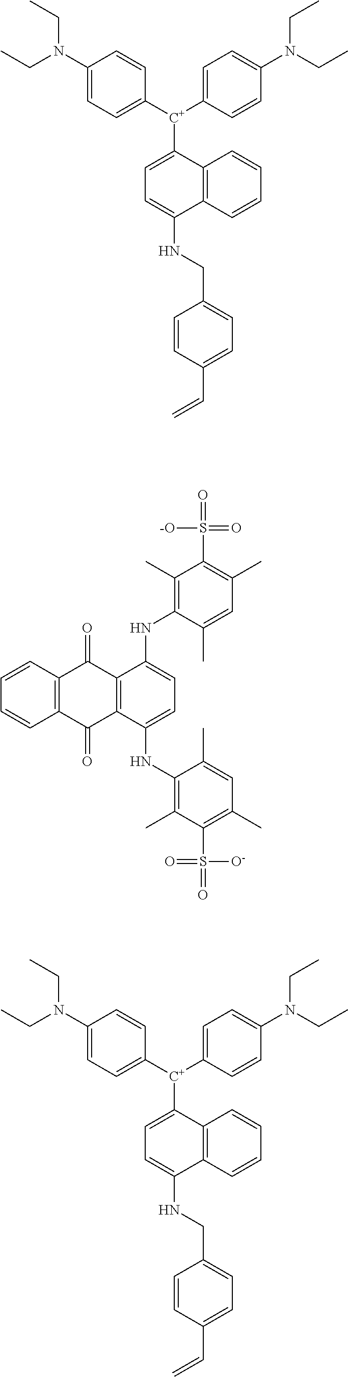

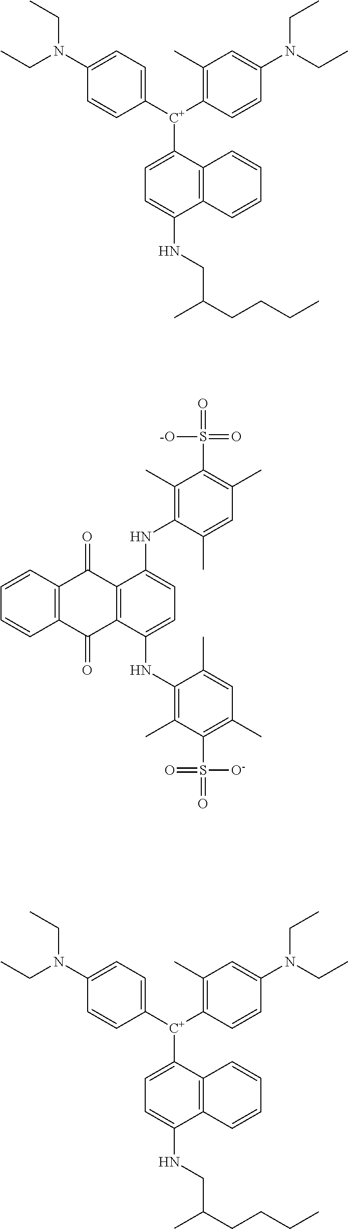

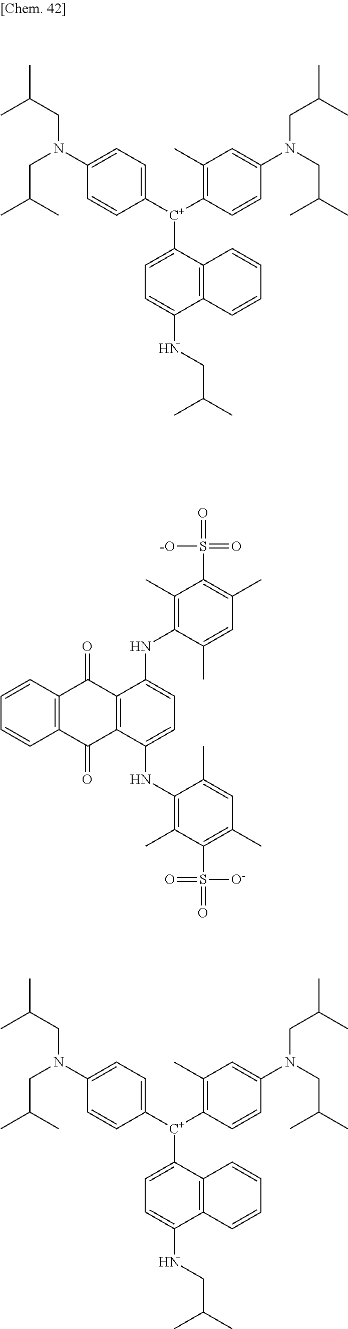

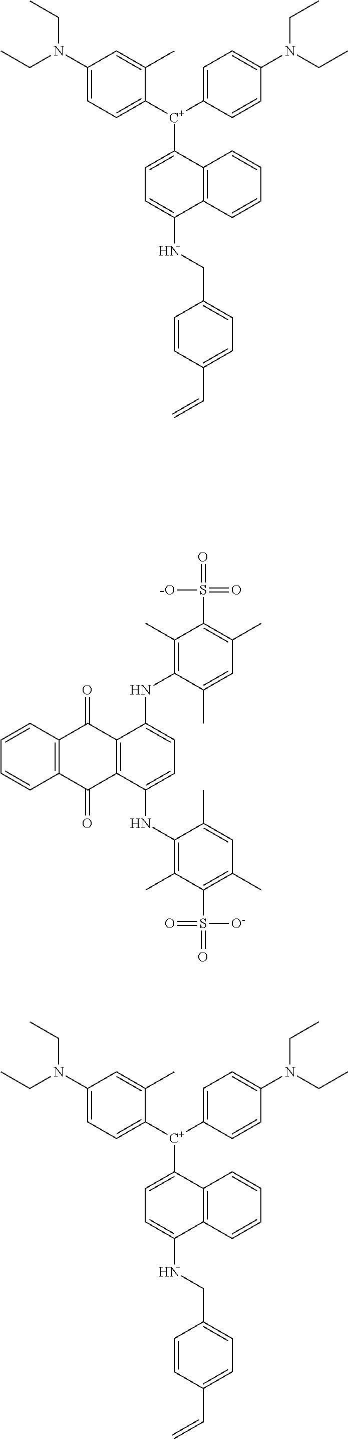

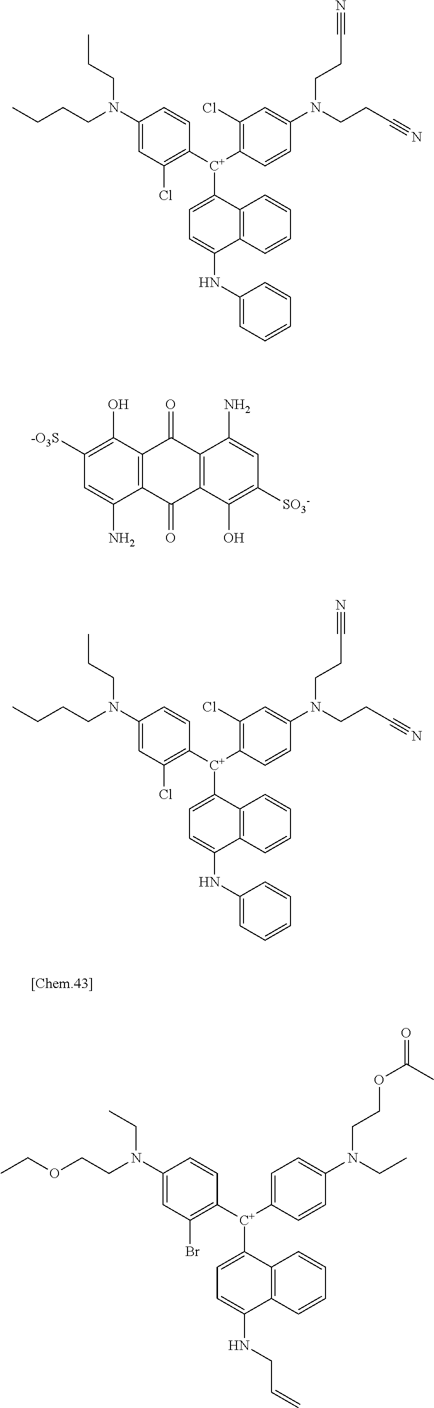

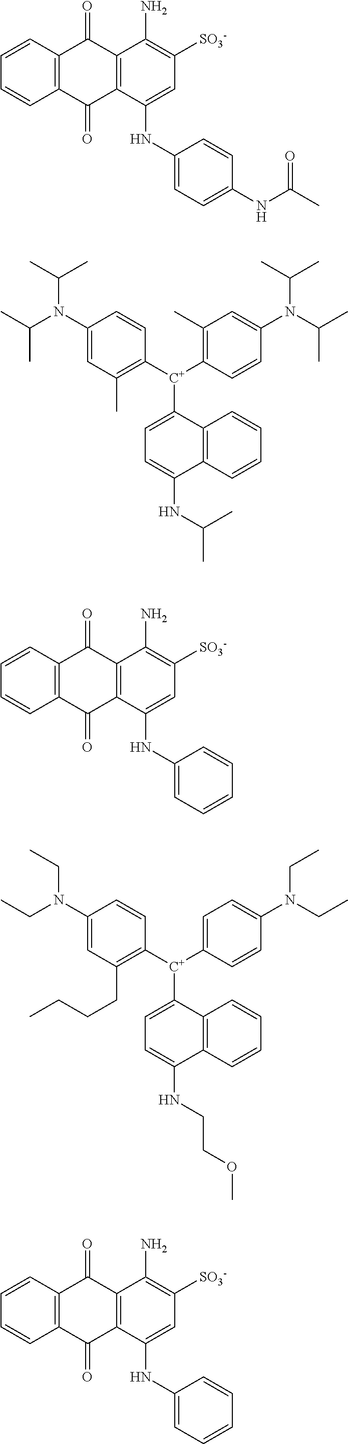

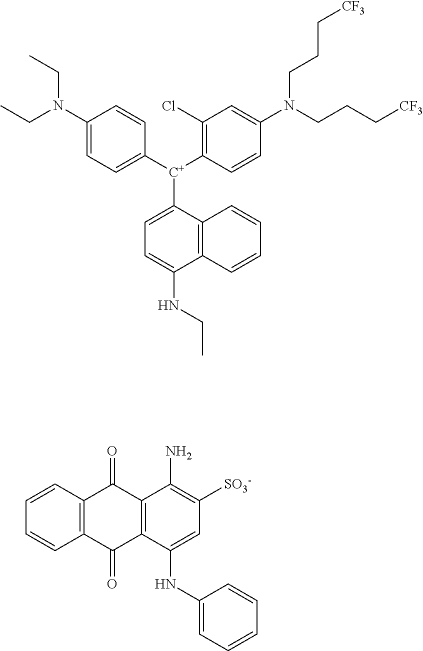

The colored resin composition for color filter according to the first aspect of the invention is a composition containing a compound represented by general formula (I) in an amount of preferably 1-50% by weight, more preferably 3-40% by weight, especially preferably 5-30% by weight, based on all solid components.

In case where the amount of the compound represented by general formula (I) contained is larger than that range, coating films have reduced curability and there is the possibility of resulting in insufficient film strength. When the amount thereof is too small, the composition has insufficient tinting strength and there are cases where a chromaticity having sufficient density is not obtained or too large a film thickness results.

When the compound represented by general formula (I) has low solubility in the colored resin composition (in particular, in the solvent contained in the composition), this compound may be dispersed in the composition using a dispersant or the like as in the case of the pigment as an optional ingredient which will be described later. However, from the standpoints of high contrast, etc. in application to liquid-crystal display devices, it is preferred that the compound represented by general formula (I) should be present in the state of being dissolved in the colored resin composition.

Incidentally, only one compound represented by general formula (I) or two or more compounds represented thereby may be contained as the colorant (c) in the colored resin composition for color filter of the invention, and one or more colorants of other kind(s) may be further contained. It is, however, preferred that the total content of the colorant (c) in the colored resin composition for color filter of the invention should be 1-30% by weight based on the composition.

### <Colorant (c) According to Second Aspect>

The colorant (c) according to the second aspect of the invention includes a compound represented by the following general formula (V). This colorant provides a colored resin composition for color filter which is capable of forming pixels having especially satisfactory properties concerning both light resistance and heat resistance.

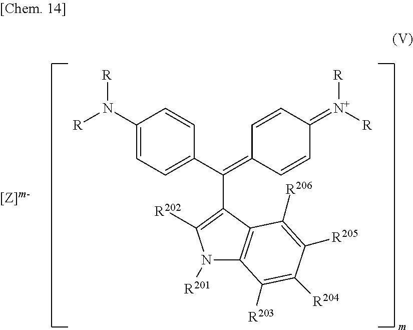

(In general formula (V), Z represents an anion having a valence of m and having an anthraquinone framework or phthalocyanine framework, and m represents an integer of 1-4.

R represents a hydrogen atom, an alkyl group which has 1-8 carbon atoms and may have a substituent, or a phenyl group which may have a substituent, or adjoining Rs are bonded to each other to form a ring. The ring may have a substituent. The Rs may be the same or different.

R²⁰¹ represents a hydrogen atom, an alkyl group which has 1-8 carbon atoms and may have a substituent, a benzyl group, a phenyl group which may have a substituent, or a naphthyl group which may have a substituent.

R²⁰² represents an alkyl group which has 1-8 carbon atoms and may have a substituent, a phenyl group which may have a substituent, a naphthyl group which may have a substituent, or an aromatic heterocyclic group which may have a substituent.

R²⁰³, R²⁰⁴, R²⁰⁵, and R²⁰⁶ each independently represent a hydrogen atom, an alkyl group which has 1-8 carbon atoms and may have a substituent, a perfluoroalkyl group having 1-8 carbon atoms, an alkoxy group having 1-12 carbon atoms, a phenoxy group, a naphthyloxy group, a fluorine atom, a phenyl group which may have a substituent, —CO₂R₄₆, —SO₃R₄₇, or —SO₂NHR₄₈ (wherein R₄₆ to R₄₈ each independently represent an alkyl group having 1-6 carbon atoms).

The two benzene rings in the cation moiety of general formula (V) each may be substituted with a group other than —NR₂.

When a plurality of groups represented by

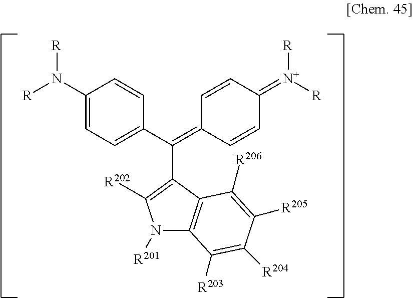

are contained in the molecule, these groups may have the same structure or may have difficult structures.)

R in general formula (V) represents a hydrogen atom, an alkyl group which has 1-8 carbon atoms and may have a substituent, or a phenyl group which may have a substituent, or adjoining Rs are bonded to each other to form a ring. The multiple Rs in general formula (V) may be the same or different. Consequently, each —NRR group may be symmetrical with respect to the nitrogen atom or may be asymmetrical.

In the case where adjoining Rs are bonded to form a ring, these Rs may be a ring formed by crosslinking with a heteroatom. Examples of this ring include the following. These rings may have a substituent.

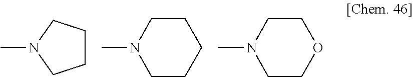

From the standpoint of chemical stability, it is preferred that the Rs each independently be a hydrogen atom, an alkyl group which has 2-8 carbon atoms and may have a substituent, or a phenyl group which may have a substituent or that adjoining Rs should be bonded to each other to form a ring. More preferably, the Rs each independently are an alkyl group which has 2-8 carbon atoms and may have a substituent or a phenyl group which may have a substituent.

Although R²⁰¹ represents a hydrogen atom, an alkyl group which has 1-8 carbon atoms and may have a substituent, a benzyl group, a phenyl group which may have a substituent, or a naphthyl group which may have a substituent, R²⁰¹ preferably is an alkyl group having 1-8 carbon atoms or a benzyl group because this compound has enhanced solubility in the solvent (b).

Although R²⁰² represents an alkyl group which has 1-8 carbon atoms and may have a substituent, a phenyl group which may have a substituent, a naphthyl group which may have a substituent, or an aromatic heterocyclic group which may have a substituent, R²⁰² preferably is phenyl which may have a substituent or naphthyl which may have a substituent, because R²⁰² plays a major role in protecting the sp2 carbon atom located at the center of the triarylmethine structure.

Although R²⁰³, R²⁰⁴, R²⁰⁵, and R²⁰⁶ each independently represent a hydrogen atom, an alkyl group which has 1-8 carbon atoms and may have a substituent, a perfluoroalkyl group having 1-8 carbon atoms, an alkoxy group having 1-12 carbon atoms, a phenoxy group, a naphthyloxy group, a fluorine atom, a phenyl group which may have a substituent, —CO₂R₄₆, —SO₃R₄₇, or —SO₂NHR₄₈ (wherein R₄₆ to R₄₈ each independently represent an alkyl group having 1-6 carbon atoms), it is preferred that R²⁰³ to R²⁰⁶ each independently be a hydrogen atom, an alkyl group having 1-8 carbon atoms, a perfluoroalkyl group having 1-8 carbon atoms, or a fluorine atom because this compound has improved solubility in the solvent (b).

In the case where R, R²⁰¹, and R²⁰³ to R²⁰⁶ each independently are an alkyl group or phenyl group and where R²⁰² is an alkyl group, phenyl group, or naphthyl group, these groups may further have a substituent. The ring formed by the bonding of adjoining Rs to each other may also have a substituent.

Examples of the substituents include those enumerated under the following substituent group W.

### (Substituent Group W)

A fluorine atom, chlorine atom, alkyl groups having 1-8 carbon atoms, alkoxy groups having 1-8 carbon atoms, phenyl, mesityl, tolyl, naphthyl, cyano, acetyloxy, alkylcarboxyl groups, sulfonamide groups, sulfonalkylamide groups, alkylcarbonyl groups, phenethyl, hydroxyethyl, acetylamide group, dialkylaminoethyl groups, trifluoromethyl, trialkylsilyl groups, nitro, alkylthio groups, and vinyl.

Of those substituents, preferred substituents which may be possessed by R, R²⁰¹, and R²⁰² are alkyl groups having 1-8 carbon atoms, trifluoromethyl, or alkoxy groups having 1-8 carbon atoms because these substituents improve solubility in the solvent (b). Preferred substituents which may be possessed by R²⁰³ to R²⁰⁶ are alkyl groups having 1-8 carbon atoms because these substituents improve solubility in the solvent (b). Preferred examples of the substituent which may be possessed by the ring formed by the bonding of adjoining Rs to each other include alkyl groups, alkoxyl groups, silyl, carboxyl, cyano, and sulfonamide groups.

In the compound represented by general formula (V), the two benzene rings in the cation moiety each may be substituted with a group other than —NR₂. Namely, the two benzene rings may have substituents other than those shown in general formula (V), unless such substituents lessen the effects of the invention.

Examples of such substituents include halogen atoms and alkyl groups having 1-8 carbon atoms.

Incidentally, when any of those benzene rings have an excessively bulky group bonded thereto in a position ortho to the carbon atom located at the center of the triarylmethine structure, then the planar configuration of the molecule is impaired, as will be described later, and this tends to reduce the color purity of the compound. It is therefore preferred that the benzene rings should have no substituents in the o-positions or be substituted in each o-position with a halogen atom or an alkyl group having 1-4 carbon atoms.

In general formula (V), m represents an integer of 1-4. There is a tendency that when the value of m is large, the compound obtained is greenish. Because of this, m is preferably 1 or 2, especially preferably 2, from the standpoint of contrast.

The compound represented by general formula (V) preferably is a compound represented by the following general formula (V′).

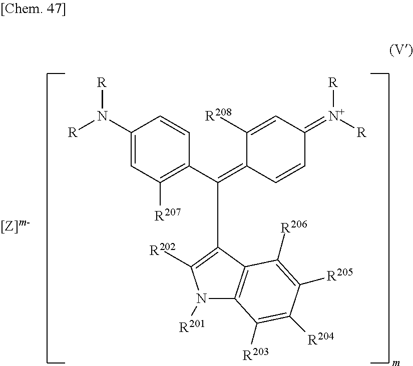

(In general formula (V′), Z, m, R, and R²⁰¹ to R²⁰⁶ each have the same meaning as in general formula (V).

R²⁰⁷ and R²⁰⁸ each independently represent a hydrogen atom, a halogen atom, or an alkyl group having 1-8 carbon atoms.

When a plurality of groups represented by

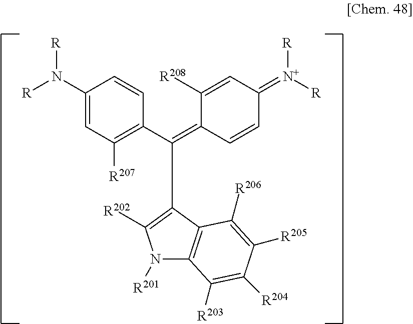

are contained in the molecule, these groups may have the same structure or may have different structures.)

Examples of R²⁰⁷ and R²⁰⁸ in general formula (V′) include the same groups as those enumerated above as examples of R¹⁰³ and R¹⁰⁴ of general formula (I′). Preferred groups and the reason for preference of the groups are also the same as described above.

The compound represented by general formula (V′) preferably is a compound represented by the following general formula (VI) or a compound represented by the following general formula (VII).

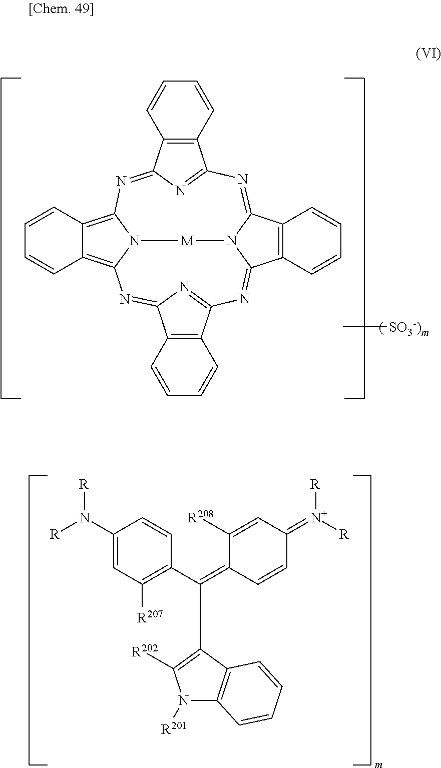

(In general formula (VI), M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom.

The —SO₃⁻ group in the formula is bonded to any of the carbon atoms constituting the benzene rings included in the phthalocyanine framework. Among the carbon atoms constituting the four benzene rings, the carbon atoms having no —SO₃⁻ group bonded thereto may be substituted with any group.

Furthermore, m, R, R²⁰¹, R²⁰², R²⁰⁷, and R²⁰⁸ have the same meanings as in general formula (V′). When a plurality of groups represented by

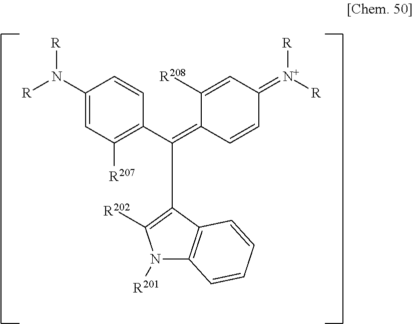

are contained in the molecule, these groups may have the same structure or may have different structures.)

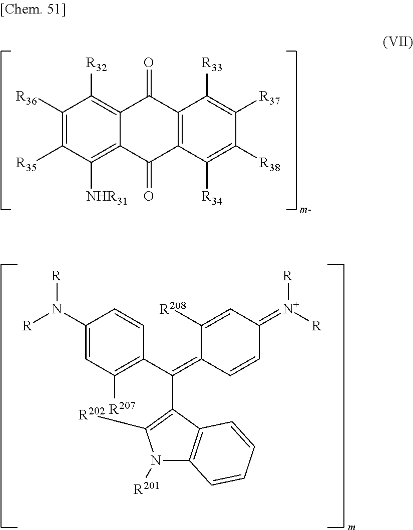

(In general formula (VII), among the substituents possessed by the anthraquinone framework,

R₃₁ represents a hydrogen atom or a phenyl group which may have a substituent.

R₃₂, R₃₃, and R₃₄ each independently are one of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ is an —NHR₄₁ group.

R₃₅, R₃₆, R₃₇, and R₃₈ each independently represent a hydrogen atom, —SO₃⁻, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms).

The number of —SO₃⁻ groups bonded to each anthraquinone framework is m.

Furthermore, m, R, R²⁰¹, R²⁰², R²⁰⁷, and R²⁰⁸ have the same meanings as in general formula (V′). When a plurality of groups represented by

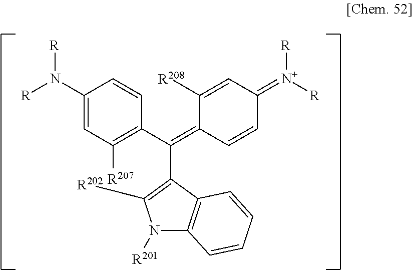

are contained in the molecule, these groups may have the same structure or may have different structures.)

In general formula (VI), M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom. Preferably, M is two hydrogen atoms, Cu, AlCl, AlOH, Ni, or Co. From the standpoint of improving the contrast of a blue display member, Cu is more preferred of these.

The —SO₃⁻ group in general formula (VI) is bonded to any of the carbon atoms constituting the benzene rings included in the phthalocyanine framework. Among the carbon atoms constituting the four benzene rings, the carbon atoms having no —SO₃⁻ group bonded thereto may be substituted with any group.

Examples of the “any desired group” include the substituent group W enumerated above as examples of the substituent which may be possessed by R when the R is an alkyl group or phenyl group. Preferred groups also are the same as those shown hereinabove. It is especially preferred that each benzene ring in the phthalocyanine framework should be unsubstituted or have no substituents other than the —SO₃⁻ group.

In general formula (VII), R₃₁ among the substituents possessed by the anthraquinone framework represents a hydrogen atom or a phenyl group which may have a substituent. That substituent is not particularly limited unless it lessens the effects of the invention. However, since the substituent serves also to aid the cationic coloring matter to have the hue thereof, R₃₁ preferably is an alkyl group having 1-8 carbon atoms, —SO₃⁻, benzyl, or —NHCOR₄₀ (R₄₀ represents an alkyl group having 1-3 carbon atoms). It is more preferred that R₃₁ should be a hydrogen atom, an alkyl group having 1-5 carbon atoms, —SO₃⁻, or —NHCOR₄₀.

R₃₂, R₃₃, and R₃₄ each independently are one of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ represents an —NHR₄₁ group. However, R₃₂, R₃₃, and R₃₄ each preferably are a hydrogen atom, hydroxyl, or —NHR₄₁ because R₃₂ to R₃₄ serve also to aid the cationic coloring matter to have the hue thereof

R₃₅, R₃₆, R₃₇, and R₃₈ each independently represent a hydrogen atom, —SO₃″, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms). However, R₃₅, R₃₆, R₃₇, and R₃₈ each preferably are a hydrogen atom or —SO₃⁻ because R₃₅ to R₃₈ serve also to aid the cationic coloring matter to have the hue thereof

Compounds represented by general formula (V) can be synthesized, for example, according to the method described in J. Chem. Soc., Perkin Trans., 1998, 2, 297 and WO 2006/120205. Because of the nature of the production process, the compounds represented by general formula (V) are necessarily obtained as a mixture of multiple kinds of compounds differing in the value of m. In the colored resin composition for color filter of the invention, a mixture of compounds represented by general formula (V) may be used as the mixture state or a single compound isolated therefrom may be used. In the case of a mixture, it is preferred that the mixture should be one in which one or more compounds satisfying the “preferred” value of m described above are contained in a largest proportion.

Specific examples of the compound represented by general formula (V) include the following compounds. However, the invention should not be construed as being limited to the following examples unless the invention departs from the spirit thereof. In the following examples, C₆H₅— and Ph- are phenyl and Tₛ represents tosyl.

TABLE 28
(VIA)

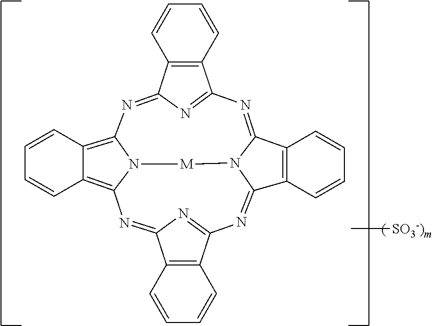

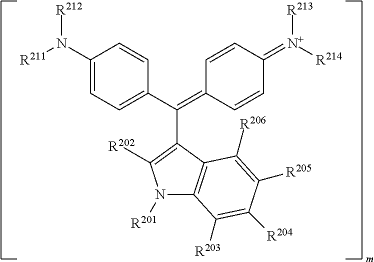

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-1 | —C₂H₅ | —C₂H₅ | —C₂H₅ | —C₂H₅ | —CH₃ | —Ph | —H | H | H | H | 1 |
| VI-2 | —C₂H₅ | —C₂H₅ | —C₂H₅ | —C₂H₅ | —CH₃ | —Ph | —H | —H | —H | —H | 2 |
| VI-3 | —C₂H₅ | —C₂H₅ | —C₂H₅ | —C₂H₅ | —C₂H₅ | —Ph | —H | —H | —H | —H | 1 |
| VI-4 | —C₂H₅ | —C₂H₅ | —C₂H₅ | —C₂H₅ | —C₂H₅ | —Ph | —H | —H | —H | —H | 2 |
| VI-5 | —C₂H₅ | —C₂H₅ | —C₂H₅ | —C₂H₅ | —C₆H₁₃ | —Ph | —H | —H | —H | —H | 1 |
| VI-6 | —C₂H₅ | —C₂H₅ | —C₂H₅ | —C₂H₅ | —C₆H₁₃ | —Ph | —H | —H | —H | —H | 2 |
| VI-7 | —C₂H₅ | —C₂H₅ | —C₂H₅ | —C₂H₅ | 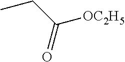 | —Ph | —H | —H | —H | —H | 1 |
| VI-8 | —C₂H₅ | —C₂H₅ | —C₂H₅ | —C₂H₅ | 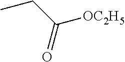 | —Ph | —H | —H | —H | —H | 2 |
| VI-9 | —C₂H₅ | —C₂H₅ | —C₂H₅ | —C₂H₅ | 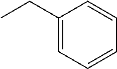 | —Ph | —H | —H | —H | —H | 1 |
| VI-10 | —C₂H₅ | —C₂H₅ | —C₂H₅ | —C₂H₅ | 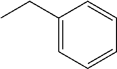 | —Ph | —H | —H | —H | —H | 2 |

TABLE 29

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-11 | —C₂H₅ | —C₂H₅ | —C₂H₅ | —C₂H₅ | 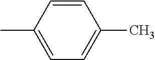 | —Ph | —H | —H | —H | —H | 1 |
| VI-12 | —C₂H₅ | —C₂H₅ | —C₂H₅ | —C₂H₅ | 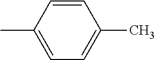 | —Ph | —H | —H | —H | —H | 2 |
| VI-13 | —C₂H₅ | —C₂H₅ | —C₂H₅ | —C₂H₅ | 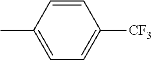 | —Ph | —H | —H | —H | —H | 1 |
| VI-14 | —C₂H₅ | —C₂H₅ | —C₂H₅ | —C₂H₅ | 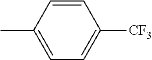 | —Ph | —H | —H | —H | —H | 2 |
| VI-15 | —C₂H₅ | —C₂H₅ | —C₂H₅ | —C₂H₅ | —C₆H₁₃ | 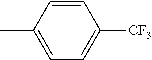 | —H | —H | —H | —H | 1 |
| VI-16 | —C₂H₅ | —C₂H₅ | —C₂H₅ | —C₂H₅ | —C₆H₁₃ | 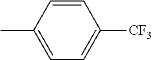 | —H | —H | —H | —H | 2 |
| IV-17 | —C₂H₅ | —C₂H₅ | —C₂H₅ | —C₂H₅ | —C₆H₁₃ | 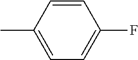 | —H | —H | —H | —H | 1 |
| VI-18 | —C₂H₅ | —C₂H₅ | —C₂H₅ | —C₂H₅ | —C₆H₁₃ | 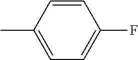 | —H | —H | —H | —H | 2 |
| VI-19 | —C₂H₅ | —C₂H₅ | —C₂H₅ | —C₂H₅ | —C₆H₁₃ | 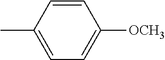 | —H | —H | —H | —H | 1 |
| VI-20 | —C₂H₅ | —C₂H₅ | —C₂H₅ | —C₂H₅ | —C₆H₁₃ | 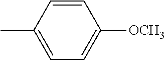 | —H | —H | —H | —H | 2 |
| VI-21 | —C₂H₅ | —C₂H₅ | —C₂H₅ | —C₂H₅ | —C₆H₁₃ | 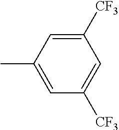 | —H | —H | —H | —H | 1 |

TABLE 30

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-22 | —C₂H₅ | —C₂H₅ | —C₂H₅ | —C₂H₅ | —C₆H₁₃ | 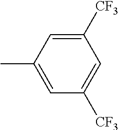 | —H | —H | —H | —H | 2 |
| VI-23 | —C₂H₅ | —C₂H₅ | —C₂H₅ | —C₂H₅ | —CH₃ | 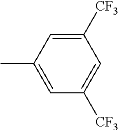 | —H | —H | —H | —H | 1 |
| VI-24 | —C₂H₅ | —C₂H₅ | —C₂H₅ | —C₂H₅ | —CH₃ | 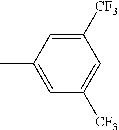 | —H | —H | —H | —H | 2 |
| VI-25 | —C₂H₅ | —C₂H₅ | —C₂H₅ | —C₂H₅ | —C₂H₅ | 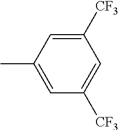 | —H | —H | —H | —H | 1 |
| VI-26 | —C₂H₅ | —C₂H₅ | —C₂H₅ | —C₂H₅ | —C₂H₅ | 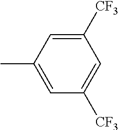 | —H | —H | —H | —H | 2 |
| VI-27 | —C₂H₅ | —C₂H₅ | —C₂H₅ | —C₂H₅ | —C₆H₁₃ | 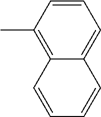 | —H | —H | —H | —H | 1 |
| VI-28 | —C₂H₅ | —C₂H₅ | —C₂H₅ | —C₂H₅ | —C₆H₁₃ | 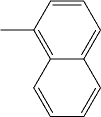 | —H | —H | —H | —H | 2 |
| VI-29 | —C₂H₅ | —C₂H₅ | —C₂H₅ | —C₂H₅ | —C₆H₁₃ | 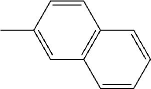 | —H | —H | —H | —H | 1 |

TABLE 31

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-30 | —C₂H₅ | —C₂H₅ | —C₂H₅ | —C₂H₅ | —C₆H₁₃ | 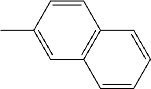 | —H | —H | —H | —H | 2 |
| VI-31 | —C₂H₅ | —C₂H₅ | —C₂H₅ | —C₂H₅ | —C₆H₁₃ | 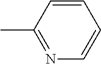 | —H | —H | —H | —H | 1 |
| VI-32 | —C₂H₅ | —C₂H₅ | —C₂H₅ | —C₂H₅ | —C₆H₁₃ | 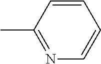 | —H | —H | —H | —H | 2 |
| VI-33 | —C₂H₅ | —C₂H₅ | —C₂H₅ | —C₂H₅ | —C₆H₁₃ | 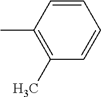 | —H | —H | —H | —H | 1 |
| VI-34 | —C₂H₅ | —C₂H₅ | —C₂H₅ | —C₂H₅ | —C₆H₁₃ | 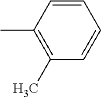 | —H | —H | —H | —H | 2 |
| VI-35 | —C₂H₅ | —C₂H₅ | —C₂H₅ | —C₂H₅ | —C₆H₁₃ | 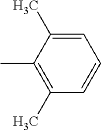 | —H | —H | —H | —H | 1 |
| VI-36 | —C₂H₅ | —C₂H₅ | —C₂H₅ | —C₂H₅ | —C₆H₁₃ | 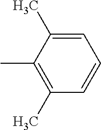 | —H | —H | —H | —H | 2 |
| VI-37 | —C₂H₅ | —C₂H₅ | —C₂H₅ | —C₂H₅ | —C₆H₁₃ | —Ph | —H | —H | —CH₃ | —H | 1 |
| VI-38 | —C₂H₅ | —C₂H₅ | —C₂H₅ | —C₂H₅ | —C₆H₁₃ | —Ph | —H | —H | —CH₃ | —H | 2 |
| VI-39 | —C₂H₅ | —C₂H₅ | —C₂H₅ | —C₂H₅ | —C₆H₁₃ | —Ph | —H | —H | —CF₃ | —H | 1 |
| VI-40 | —C₂H₅ | —C₂H₅ | —C₂H₅ | —C₂H₅ | —C₆H₁₃ | —Ph | —H | —H | —CF₃ | —H | 2 |
| VI-41 | —C₂H₅ | —C₂H₅ | —C₂H₅ | —C₂H₅ | —C₆H₁₃ | —Ph | —H | —H | —OCH₃ | —H | 1 |
| VI-42 | —C₂H₅ | —C₂H₅ | —C₂H₅ | —C₂H₅ | —C₆H₁₃ | —Ph | —H | —H | —OCH₃ | —H | 2 |

TABLE 32

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-43 | —C₂H₅ | —C₂H₅ | —C₂H₅ | —C₂H₅ | —C₆H₁₃ | —Ph | —H | —CH₃ | —H | —CH₃ | 1 |
| VI-44 | —C₂H₅ | —C₂H₅ | —C₂H₅ | —C₂H₅ | —C₆H₁₃ | —Ph | —H | —CH₃ | —H | —CH₃ | 2 |
| VI-45 | —C₂H₅ | —C₂H₅ | —C₂H₅ | —C₂H₅ | —C₆H₁₃ | —Ph | —CH₃ | —H | —H | —H | 1 |
| VI-46 | —C₂H₅ | —C₂H₅ | —C₂H₅ | —C₂H₅ | —C₆H₁₃ | —Ph | —CH₃ | —H | —H | —H | 2 |
| VI-47 | —C₂H₅ | —Ph | —C₂H₅ | —Ph | —CH₃ | —Ph | —H | —H | —H | —H | 1 |
| VI-48 | —C₂H₅ | —Ph | —C₂H₅ | —Ph | —CH₃ | —Ph | —H | —H | —H | —H | 2 |
| VI-49 | —C₂H₅ | —Ph | —C₂H₅ | —Ph | —C₂H₅ | —Ph | —H | —H | —H | —H | 1 |
| VI-50 | —C₂H₅ | —Ph | —C₂H₅ | —Ph | —C₂H₅ | —Ph | —H | —H | —14 | —H | 2 |
| VI-51 | —C₂H₅ | —Ph | —C₂H₅ | —Ph | —C₆H₁₃ | —Ph | —H | —H | —H | —H | 1 |
| VI-52 | —C₂H₅ | —Ph | —C₂H₅ | —Ph | —C₆H₁₃ | —Ph | —H | —H | —H | —H | 2 |
| VI-53 | —C₂H₅ | —Ph | —C₂H₅ | —Ph | —CH₃ | 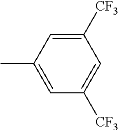 | —H | —H | —H | —H | 1 |
| VI-54 | —C₂H₅ | —Ph | —C₂H₅ | —Ph | —CH₃ | 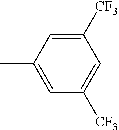 | —H | —H | —H | —H | 2 |
| VI-55 | —C₂H₅ | —Ph | —C₂H₅ | —Ph | —C₂H₅ | 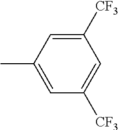 | —H | —H | —H | —H | 1 |
| VI-56 | —C₂H₅ | —Ph | —C₂H₅ | —Ph | —C₂H₅ | 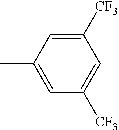 | —H | —H | —H | —H | 2 |

TABLE 33

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-57 | —C₂H₅ | —Ph | —C₂H₅ | —Ph | —C₆H₁₃ | 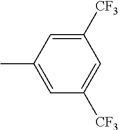 | —H | —H | —H | —H | 1 |
| VI-58 | —C₂H₅ | —Ph | —C₂H₅ | —Ph | —C₆H₁₃ | 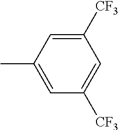 | —H | —H | —H | —H | 2 |
| VI-59 | —C₂H₅ | —Ph | —C₂H₅ | —Ph | —C₆H₁₃ | 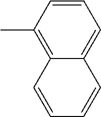 | —H | —H | —H | —H | 1 |
| VI-60 | —C₂H₅ | —Ph | —C₂H₅ | —Ph | —C₆H₁₃ | 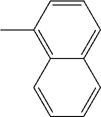 | —H | —H | —H | —H | 2 |
| V1-61 | —C₂H₅ | —Ph | —C₂H₅ | —Ph | —C₆H₁₃ | 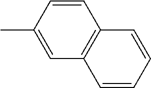 | —H | —H | —H | —H | 1 |
| VI-62 | —C₂H₅ | —Ph | —C₂H₅ | —Ph | —C₆H₁₃ | 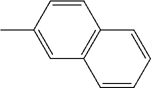 | —H | —H | —H | —H | 2 |
| VI-63 | —C₂H₅ | —Ph | —C₂H₅ | —Ph | —C₆H₁₃ | 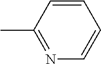 | —H | —H | —H | —H | 1 |
| VI-64 | —C₂H₅ | —Ph | —C₂H₅ | —Ph | —C₆H₁₃ | 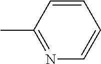 | —H | —H | —H | —H | 2 |
| VI-65 | —C₂H₅ | —Ph | —C₂H₅ | —Ph | —C₆H₁₃ | 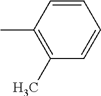 | —H | —H | —H | —H | 1 |

TABLE 34

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-66 | —C₂H₅ | —Ph | —C₂H₅ | —Ph | —C₆H₁₃ | 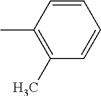 | —H | —H | —H | —H | 2 |
| VI-67 | —C₂H₅ | —Ph | —C₂H₅ | —Ph | —C₆H₁₃ | 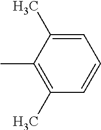 | —H | —H | —H | —H | 1 |
| VI-68 | —C₂H₅ | —Ph | —C₂H₅ | —Ph | —C₆H₁₃ | 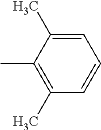 | —H | —H | —H | —H | 2 |
| VI-69 | —C₂H₅ | —Ph | —C₂H₅ | —Ph | —C₆H₁₃ | 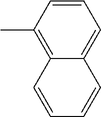 | —H | —H | —H | —H | 1 |
| VI-70 | —C₂H₅ | —Ph | —C₂H₅ | —Ph | —C₆H₁₃ | 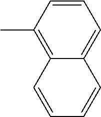 | —H | —H | —H | —H | 2 |
| VI-71 | —C₂H₅ | —Ph | —C₂H₅ | —Ph | —C₆H₁₃ | 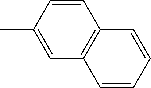 | —H | —H | —H | —H | 1 |
| VI-72 | —C₂H₅ | —Ph | —C₂H₅ | —Ph | —C₆H₁₃ | 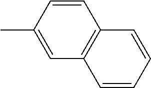 | —H | —H | —H | —H | 2 |
| VI-73 | —C₂H₅ | —Ph | —C₂H₅ | —Ph | —C₆H₁₃ | —Ph | —H | —H | —CH₃ | —H | 1 |
| VI-74 | —C₂H₅ | —Ph | —C₂H₅ | —Ph | —C₆H₁₃ | —Ph | —H | —H | —CH₃ | —H | 2 |
| VI-75 | —C₂H₅ | —Ph | —C₂H₅ | —Ph | —C₆H₁₃ | —Ph | —H | —H | —CF₃ | —H | 1 |
| VI-76 | —C₂H₅ | —Ph | —C₂H₅ | —Ph | —C₆H₁₃ | —Ph | —H | —H | —CF₃ | —H | 2 |
| VI-77 | —C₂H₅ | —Ph | —C₂H₅ | —Ph | —C₆H₁₃ | —Ph | —H | —H | —OCH₃ | —H | 1 |

TABLE 35

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-78 | —C₂H₅ | —Ph | —C₂H₅ | —Ph | —C₆H₁₃ | —Ph | —H | —H | —OCH₃ | —H | 2 |
| VI-79 | —C₂H₅ | —Ph | —C₂H₅ | —Ph | —C₆H₁₃ | —Ph | —H | —CH₃ | —H | —CH₃ | 1 |
| VI-80 | —C₂H₅ | —Ph | —C₂H₅ | —Ph | —C₆H₁₃ | —Ph | —H | —CH₃ | —H | —CH₃ | 2 |
| VI-81 | —C₂H₅ | —Ph | —C₂H₅ | —Ph | —C₆H₁₃ | —Ph | —CH₃ | —H | —H | —H | 1 |
| VI-82 | —C₂H₅ | —Ph | —C₂H₅ | —Ph | —C₆H₁₃ | —Ph | —CH₃ | —H | —H | —H | 2 |
| VI-83 | —H | —Ph | —H | —Ph | —CH₃ | —Ph | —H | —H | —H | —H | 1 |
| VI-84 | —H | —Ph | —H | —Ph | —CH₃ | —Ph | —H | —H | —H | —H | 2 |
| VI-85 | —H | —Ph | —H | —Ph | —C₂H₅ | —Ph | —H | —H | —H | —H | 1 |
| VI-86 | —H | —Ph | —H | —Ph | —C₂H₅ | —Ph | —H | —H | —H | —H | 2 |
| VI-87 | —H | —Ph | —H | —Ph | —C₆H₁₃ | —Ph | —H | —H | —H | —H | 1 |
| VI-88 | —H | —Ph | —H | —Ph | —C₆H₁₃ | —Ph | —H | —H | —H | —H | 2 |
| VI-89 | —H | —Ph | —H | —Ph | —CH₃ | 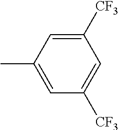 | —H | —H | —H | —H | 1 |
| VI-90 | —H | —Ph | —H | —Ph | —CH₃ | 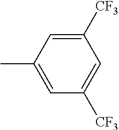 | —H | —H | —H | —H | 2 |
| VI-91 | —H | —Ph | —H | —Ph | —C₂H₅ | 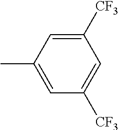 | —H | —H | —H | —H | 1 |
| VI-92 | —H | —Ph | —H | —Ph | —C₂H₅ | 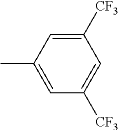 | —H | —H | —H | —H | 2 |

TABLE 36

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-93 | —H | —Ph | —H | —Ph | —C₆H₁₃ | 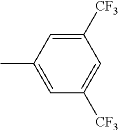 | —H | —H | —H | —H | 1 |
| VI-94 | —H | —Ph | —H | —Ph | —C₆H₁₃ | 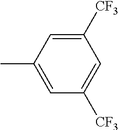 | —H | —H | —H | —H | 2 |
| VI-95 | —H | —Ph | —H | —Ph | —C₆H₁₃ | 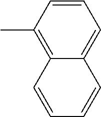 | —H | —H | —H | —H | 1 |
| VI-96 | —H | —Ph | —H | —Ph | —C₆H₁₃ | 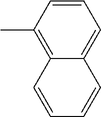 | —H | —H | —H | —H | 2 |
| VI-97 | —H | —Ph | —H | —Ph | —C₆H₁₃ | 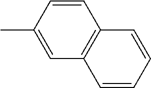 | —H | —H | —H | —H | 1 |
| VI-98 | —H | —Ph | —H | —Ph | —C₆H₁₃ | 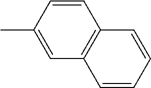 | —H | —H | —H | —H | 2 |
| VI-99 | —H | —Ph | —H | —Ph | —C₆H₁₃ | 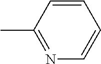 | —H | —H | —H | —H | 1 |
| VI-100 | —H | —Ph | —H | —Ph | —C₆H₁₃ | 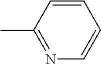 | —H | —H | —H | —H | 2 |
| VI-101 | —H | —Ph | —H | —Ph | —C₆H₁₃ | 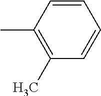 | —H | —H | —H | —H | 1 |

TABLE 37

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-102 | —H | —Ph | —H | —Ph | —C₆H₁₃ | 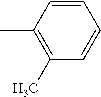 | —H | —H | —H | —H | 2 |
| VI-103 | —H | —Ph | —H | —Ph | —C₆H₁₃ | 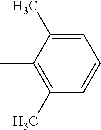 | —H | —H | —H | —H | 1 |
| VI-104 | —H | —Ph | —H | —Ph | —C₆H₁₃ | 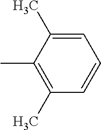 | —H | —H | —H | —H | 2 |
| VI-105 | —H | —Ph | —H | —Ph | —C₆H₁₃ | 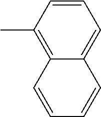 | —H | —H | —H | —H | 1 |
| VI-106 | —H | —Ph | —H | —Ph | —C₆H₁₃ | 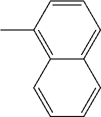 | —H | —H | —H | —H | 2 |
| VI-107 | —H | —Ph | —H | —Ph | —C₆H₁₃ | 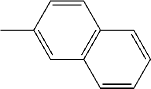 | —H | —H | —H | —H | 1 |
| VI-108 | —H | —Ph | —H | —Ph | —C₆H₁₃ | 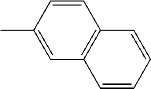 | —H | —H | —H | —H | 2 |
| VI-109 | —H | —Ph | —H | —Ph | —C₆H₁₃ | —Ph | —H | —H | —CH₃ | —H | 1 |
| VI-110 | —H | —Ph | —H | —Ph | —C₆H₁₃ | —Ph | —H | —H | —CH₃ | —H | 2 |
| VI-111 | —H | —Ph | —H | —Ph | —C₆H₁₃ | —Ph | —H | —H | —CF₃ | —H | 1 |
| VI-112 | —H | —Ph | —H | —Ph | —C₆H₁₃ | —Ph | —H | —H | —CF₃ | —H | 2 |
| VI-113 | —H | —Ph | —H | —Ph | —C₆H₁₃ | —Ph | —H | —H | —OCH₃ | —H | 1 |

TABLE 38

| No. | R²¹¹ | R²¹² | R²¹³ | R²¹⁴ | R²⁰¹ | R²⁰² | R²⁰³ | R²⁰⁴ | R²⁰⁵ | R²⁰⁶ | m |
|---|---|---|---|---|---|---|---|---|---|---|---|
| VI-114 | —H | —Ph | —H | —Ph | —C₆H₁₃ | —Ph | —H | —H | —OCH₃ | —H | 2 |
| VI-115 | —H | —Ph | —H | —Ph | —C₆H₁₃ | —Ph | —H | —CH₃ | —H | —CH₃ | 1 |
| VI-116 | —H | —Ph | —H | —Ph | —C₆H₁₃ | —Ph | —H | —CH₃ | —H | —CH₃ | 2 |
| VI-117 | —H | —Ph | —H | —Ph | —C₆H₁₃ | —Ph | —CH₃ | —H | —H | —H | 1 |
| VI-118 | —H | —Ph | —H | —Ph | —C₆H₁₃ | —Ph | —CH₃ | —H | —H | —H | 2 |
| VI-119 | 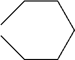 | | 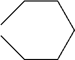 | | —C₆H₁₃ | —Ph | —H | —H | —H | —H | 1 |
| VI-120 | 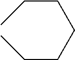 | | 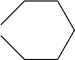 | | —C₆H₁₃ | —Ph | —H | —H | —H | —H | 2 |
| VI-121 | 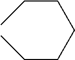 | | —C₂H₅ | —C₂H₅ | —C₆H₁₃ | —Ph | —H | —H | —H | —H | 1 |
| VI-122 | 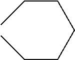 | | —C₂H₅ | —C₂H₅ | —C₆H₁₃ | —Ph | —H | —H | —H | —H | 2 |
| VI-123 | 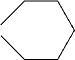 | | —C₆H₁₃ | —C₆H₁₃ | —C₆H₁₃ | —Ph | —H | —H | —H | —H | 1 |
| VI-124 | 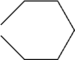 | | —C₆H₁₃ | —C₆H₁₃ | —C₆H₁₃ | —Ph | —H | —H | —H | —H | 2 |
| VI-125 | —C₂H₅ | —Ph | —C₂H₅ | —C₂H₅ | —C₆H₁₃ | —Ph | —H | —H | —H | —H | 1 |
| VI-126 | —C₂H₅ | —Ph | —C₆H₁₃ | —C₆H₁₃ | —C₆H₁₃ | —Ph | —H | —H | —H | —H | 1 |
| VI-127 | —H | —Ph | —C₆H₁₃ | —C₆H₁₃ | —C₆H₁₃ | —Ph | —H | —H | —H | —H | 1 |
| VI-128 | —C₂H₅ | 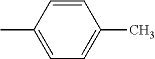 | —C₂H₅ | 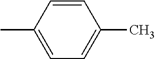 | —C₆H₁₃ | —Ph | —H | —H | —H | —H | 1 |

TABLE 39

| No. | R²¹¹ | R²¹² | R²¹³ | R²¹⁴ | R²⁰¹ | |
|---|---|---|---|---|---|---|
| VI-129 | 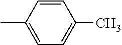 | 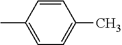 | 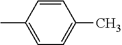 | 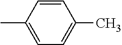 | —C₆H₁₃ | |
| VI-130 | 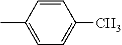 | 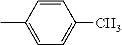 | 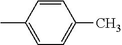 | 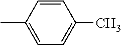 | —C₆H₁₃ | |
| VI-131 | 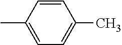 | 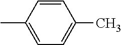 | 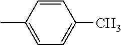 | 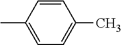 | —C₆H₁₃ | |
| VI-132 | 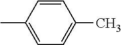 | 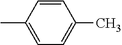 | 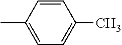 | 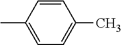 | —C₆H₁₃ | |
| VI-133 | 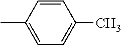 | 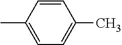 | 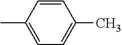 | 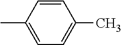 | —C₆H₁₃ | |
| VI-134 | 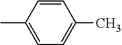 | 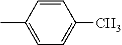 | 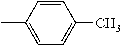 | 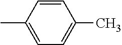 | —C₆H₁₃ | |
| VI-135 | 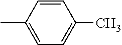 | 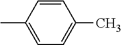 | 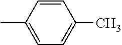 | 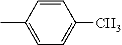 | —C₆H₁₃ | |
| VI-136 | 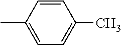 | 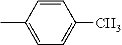 | 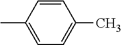 | 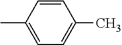 | —C₆H₁₃ | |
| VI-137 | 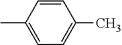 | 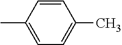 | 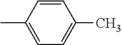 | 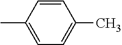 | —C₆H₁₃ | |
| VI-138 | 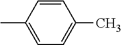 | 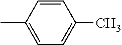 | 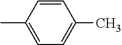 | 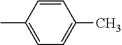 | —C₆H₁₃ | |
| VI-139 | 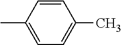 | 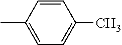 | 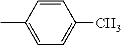 | 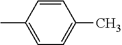 | —C₆H₁₃ | |
| No. | R²⁰² | R²⁰³ | R²⁰⁴ | R²⁰⁵ | R²⁰⁶ | m |
| VI-129 | —Ph | —H | —H | —H | —H | 1 |
| VI-130 | 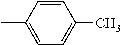 | —H | —H | —H | —H | 1 |
| VI-131 | 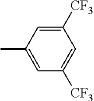 | —H | —H | —H | —H | 1 |
| VI-132 | 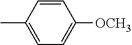 | —H | —H | —H | —H | 1 |
| VI-133 | 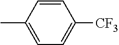 | —H | —H | —H | —H | 1 |
| VI-134 | 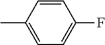 | —H | —H | —H | —H | 1 |
| VI-135 | 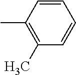 | —H | —H | —H | —H | 1 |
| VI-136 | —Ph | —CH₃ | —H | —H | —H | 1 |
| VI-137 | —Ph | —H | —H | —CH₃ | —H | 1 |
| VI-138 | —Ph | —H | —CH₃ | —H | —CH₃ | 1 |
| VI-139 | —Ph | —H | —CF₃ | —H | —CF₃ | 1 |

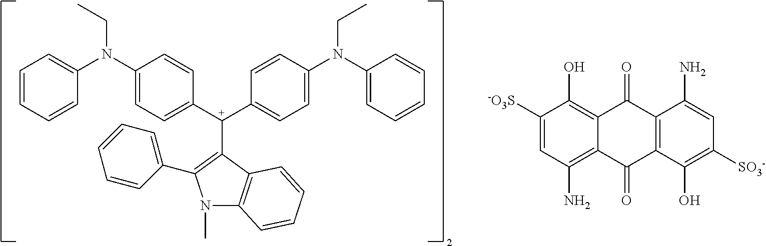

(VII-1)

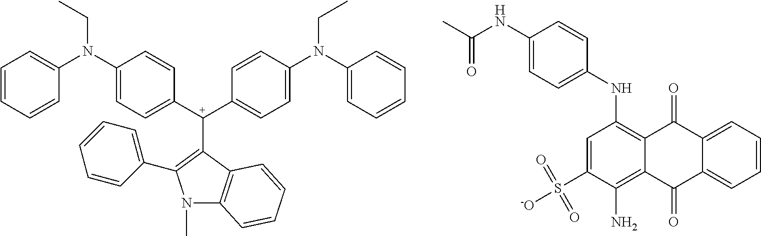

(VII-2)

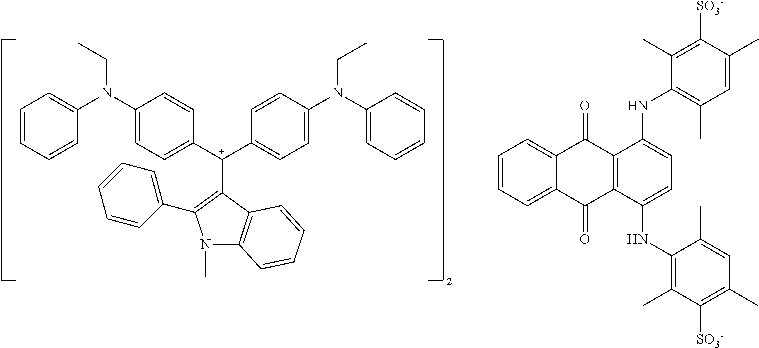

(VII-3)

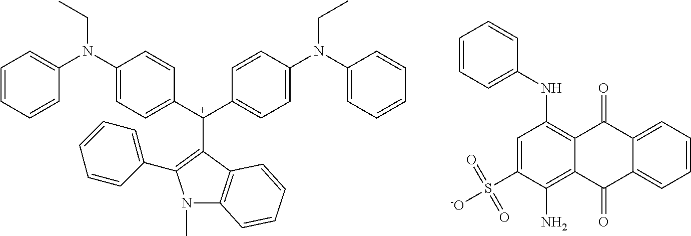

(VII-4)

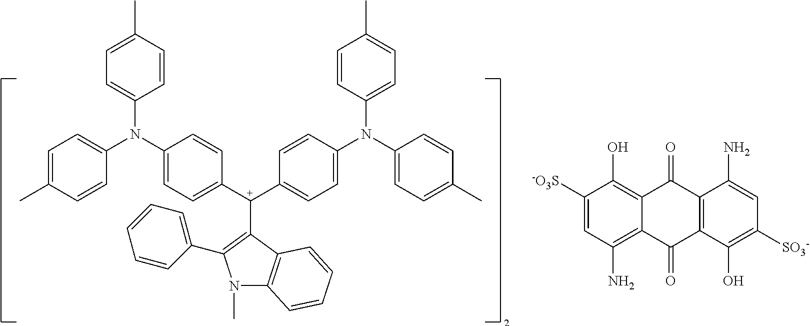

(VII-5)

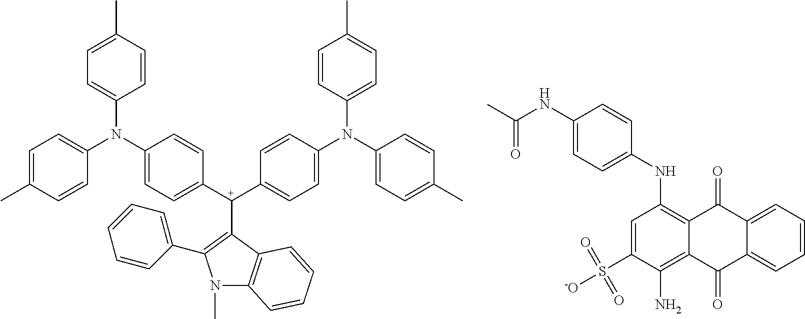

(VII-6)

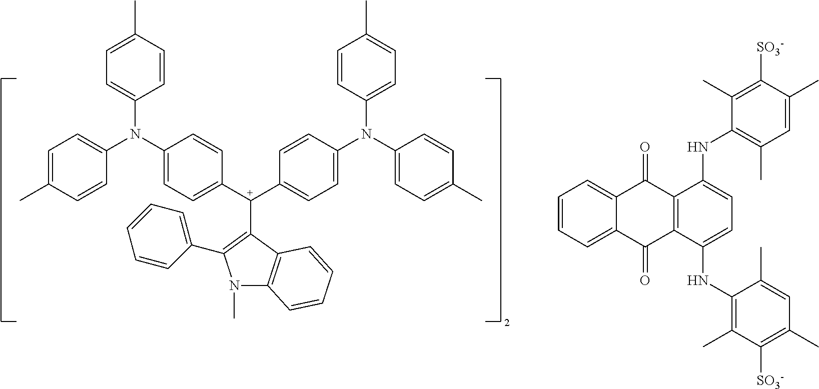

(VII-7)

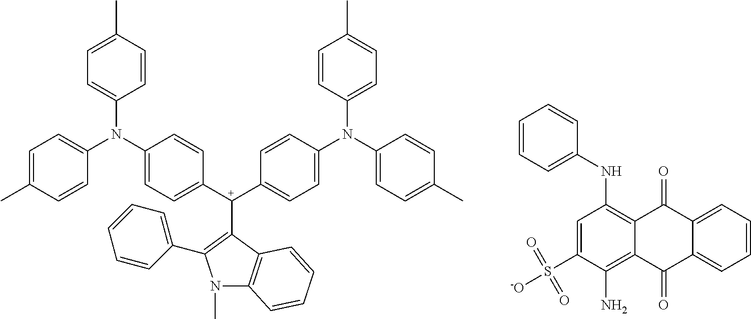

(VII-8)

Other examples of the compound represented by general formula (V) include the following, which are compounds represented by general formula (VII).

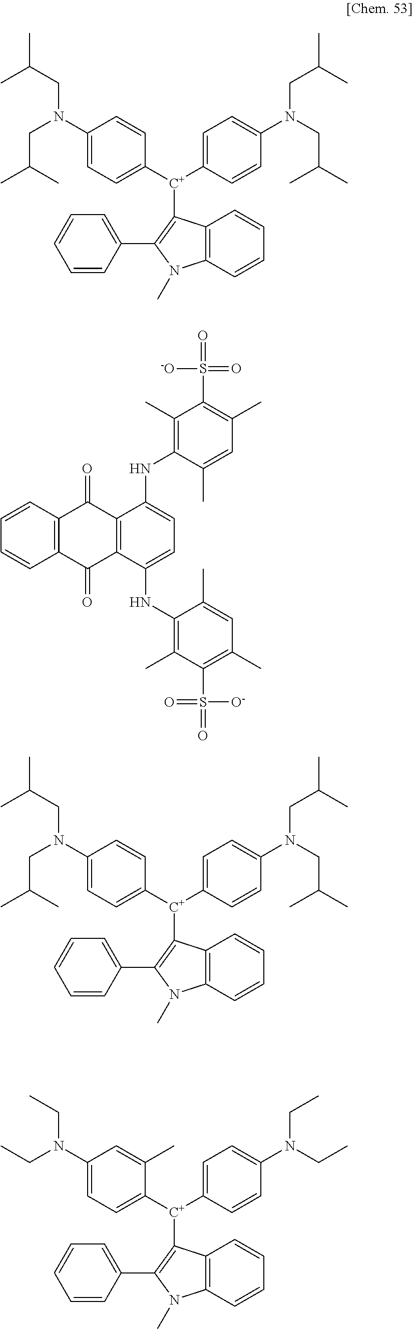

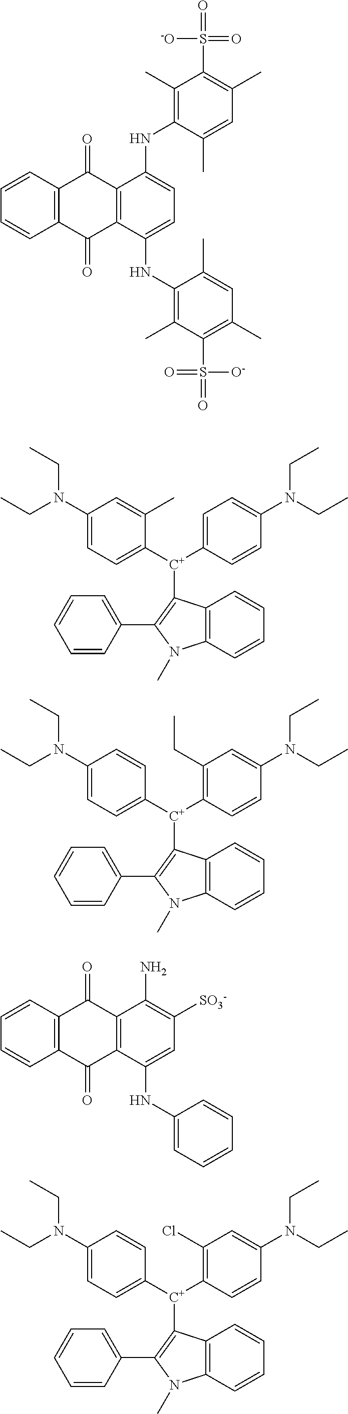

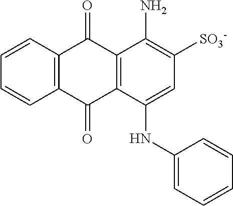

The colored resin composition for color filter according to the second aspect of the invention is a composition containing a compound represented by general formula (V) in an amount of preferably 1-50% by weight, more preferably 3-40% by weight, especially preferably 5-30% by weight, based on all solid components.

In case where the amount of the compound represented by general formula (V) contained is larger than that range, coating films have reduced curability and there is the possibility of resulting in insufficient film strength. When the amount thereof is too small, the composition has insufficient tinting strength and there are cases where a chromaticity having sufficient density is not obtained or too large a film thickness results.

When the compound represented by general formula (V) has low solubility in the colored resin composition (in particular, in the solvent contained in the composition), this compound may be dispersed in the composition using a dispersant or the like as in the case of the pigment as an optional ingredient which will be described later. However, from the standpoints of high contrast, etc. in application to liquid-crystal display devices, it is preferred that the compound represented by general formula (V) should be present in the state of being dissolved in the colored resin composition.

Incidentally, only one compound represented by general formula (V) or two or more compounds represented thereby may be contained as the colorant (c) in the colored resin composition for color filter of the invention, and one or more colorants of other kind(s) may be further contained. It is, however, preferred that the total content of the colorant (c) in the colored resin composition for color filter of the invention should be 1-30% by weight based on the composition.

### <Colorant (c) According to Third Aspect>

The colorant (c) according to the third aspect of the invention includes a compound composed of a cationic blue coloring matter (coloring matter 1) and an anionic coloring matter (coloring matter 2) (coloring matter 1/coloring matter 2 compound), and coloring matter 1 and coloring matter 2 in this coloring matter 1/coloring matter 2 compound satisfy the following (A) or (B). This colorant provides a colored resin composition for color filter which is capable of forming pixels having high light resistance.

The compound composed of coloring matter 1 and coloring matter 2 is in the form of a salt composed of coloring matter 1, which is a cationic compound, and coloring matter 2, which is an anionic compound. There is no particular limit on the number of coloring matters 1 and coloring matters 2 constituting the coloring matter 1/coloring matter 2 compound.

(A) coloring matter 2 is an even-electron compound; the excitation energy of coloring matter 1 in a minimum singlet excitation state (S₁ state) (ΔE_{S1}(coloring matter 1)) and the excitation energy of coloring matter 2 in a minimum singlet excitation state (S₁ state) (ΔE_{S1}(coloring matter 2)), each excitation energy being obtained through a time-dependent density functional (B3LYP/6-31G(d,p)) calculation, satisfy the following expression (i); and the excitation energy of coloring matter 2 in a minimum triplet excitation state (T₁ state) (ΔE_{T1}(coloring matter 2)) satisfies the following expression (ii).
(B) coloring matter 2 is an odd-electron compound, and the excitation energy of coloring matter 1 in a minimum singlet excitation state (S₁ state) (ΔE_{S1}(coloring matter 1)) and the excitation energy of coloring matter 2 in an energetically lowest excitation state (ΔE_{lowest}(coloring matter 2)), each excitation energy being obtained through a time-dependent density functional (B3LYP/6-31G(d,p)) calculation, satisfy the following expression (iii).

[Math. 3]

ΔE_{S1}(coloring matter 2)<ΔE_{S1}(coloring matter 1) (i)

ΔE_{T1}(coloring matter 2)<1.5 eV (ii)

ΔE_{lowest}(coloring matter 2)<ΔE_{S1}(coloring matter 1) (iii)

Selection of coloring matter 1 and coloring matter 2 which satisfy those relationships is preferred because the coloring matter 1 in the coloring matter 1/coloring matter 2 compound obtained can be inhibited from generating active oxygen upon optical excitation and the compound can be thereby inhibited from decomposing through a photooxidation reaction. Furthermore, in the compound composed of coloring matter 1 and coloring matter 2, a sufficient intermolecular interaction occurs between the coloring matter 1 and the coloring matter 2. It is therefore also possible to attain high light resistance and a peculiar color that have not been obtained with a compound consisting of a single coloring matter, which is not such a coloring matter 1/coloring matter 2 compound, or with a mixture of a compound corresponding to coloring matter 1 and a compound corresponding to coloring matter 2.

In the invention, the energy level of a coloring matter can be determined through optimization of the molecular structure and a subsequent TDDF calculation of B3 LYP/6-31G.

The reason why a compound constituted of a combination of coloring matters satisfying the relationships according to the third aspect produces such effects has not been elucidated in detail. However, the reason is presumed to be as follows.

When expression (i) is satisfied, the excitation energy of the cation in a minimum singlet excitation state (S₁ state) resulting from light absorption is efficiently transferred to the anion. This is effective in eliminating a path of the energy transfer to ground-state oxygen which occurs through relaxation of the cation from the singlet excitation state to a triplet state. As a result, the cation in the excitation state is inhibited from yielding singlet-state oxygen (oxygen in ¹Δ_{g} state) through energy transfer. To satisfy expression (i) is preferred in this point.

That the excitation energy for exciting the anion to a minimum triplet excitation state (T₁ state), which is determined through a calculation, satisfies expression (ii) corresponds to that the energy of the anion in the T₁ state is lower than the excitation energy for exciting oxygen to a ¹Δ_{g} state. Namely, no energy transfer occurs from the anion in the minimum triplet excitation state to ground-state oxygen, and singlet-state oxygen (oxygen in ¹Δ_{g} state) is inhibited from generating. To satisfy expression (ii) is preferred in this point.

In the case where the anion has an odd number of electrons, the excitation energy of the cation in a minimum singlet excitation state (S₁ state) resulting from light absorption is efficiently transferred to the anion. This is effective in eliminating a path of the energy transfer to ground-state oxygen which occurs through relaxation of the cation from the singlet excitation state to a triplet state. Furthermore, since the anion has an odd number of electrons, the minimum excitation state thereof is not a triplet and, hence, interaction with ground-state oxygen, which is in a triplet state, is not significant. Consequently, energy transfer from the anion in the excitation state to ground-state oxygen is less probable and singlet-state oxygen (oxygen in ¹Δ_{g} state) is inhibited from generating. To satisfy expression (iii) is preferred in this point.

Singlet-state oxygen (oxygen in ¹Δ_{g} state) in the system is a kind of active oxygen, and is thought to attack the coloring matter 1/coloring matter 2 compound, resulting in decomposition of the coloring matter 1/coloring matter 2 compound. In the invention, however, generation of singlet-state oxygen (oxygen in ¹Δ_{g} state) is prevented by contriving the structure of the coloring matter 1/coloring matter 2 compound, and the light resistance of the composition has been thereby improved.

It is preferred that the difference between ΔE_{S1}(coloring matter 1) and ΔE_{S1}(coloring matter 2) in expression (i) and the difference between ΔE_{S1}(coloring matter 1) and ΔE_{lowest}(coloring matter 2) in expression (iii) each should be about 0.2 eV or more.

The coloring matter 1 preferably is a cationic coloring matter which has a framework having a cationic moiety therein or has a cationic substituent as a substituent.

The coloring matter 2 preferably is an anionic coloring matter having an anionic substituent.

In the invention, the term cationic coloring matter means a coloring matter the whole molecule of which is in a positively charged state, while the term anionic coloring matter means a coloring matter the whole molecule of which is in a negatively charged state.

The cationic coloring matter preferably is one that has a n-conjugated structure, in which cation delocalization is apt to occur in the whole molecule, and that shows absorption in the visible wide region and has a higher molecular extinction than the anionic coloring matter.

As the anionic coloring matter which forms a salt with the cationic coloring matter, it is preferred that an anionic coloring matter having a lower LUMO than the cationic coloring matter and having a band gap narrower than the singlet-energy band gap of the cationic coloring matter should be used in combination. It is desirable that the anionic coloring matter should be one which shows absorption in a longer-wavelength region than the cationic coloring matter and has a substituent having a high acidity, such as, e.g., a sulfo group.

More specifically, examples of the cationic coloring matter include coloring matters having a cation within the framework, such as polyene, polymethine, triarylmethine, and xanthene compounds, and neutral coloring matters, such as anthraquinone, indigo, phthalocyanine, and azo compounds, that have an ammonium cation as a substituent. Preferred of these from the standpoint of the magnitude of molecular extinction are ones having a cation within the framework. From the standpoint of solubility, compounds having a radial molecular structure are preferred. Specifically, triarylmethine type coloring matters are more preferred.

Examples of the anionic coloring matter include coloring matters, such as azo, quinoline, xanthene, phthalocyanine, anthraquinone, indigo, triarylmethine, and metal complex compounds, which have an acidic group having a high acidity, such as a carboxylic acid, phosphoric acid, or sulfonic acid, and the molecules of which are anionic as a whole. Of these, phthalocyanine type coloring matters (having a phthalocyanine framework) or anthraquinone type coloring matters (having an anthraquinone framework) are preferred because the triplet excitation energy level in an excitation state is low.

From the standpoint of ease of complexation with a metal, e.g., copper, phthalocyanine type coloring matters having an acidic group are more preferred. From the standpoints of high solubility and capability of chemical modification, anthraquinone type coloring matters are more preferred.

As can be seen from the explanation given above, compounds having the same framework can be rendered cationic or anionic according to the substituent possessed thereby.

Especially preferred examples of the coloring matter 1/coloring matter 2 compound, which is composed of coloring matter 1 and coloring matter 2, in the invention include compounds represented by general formula (I) or compounds represented by general formula (V).

Among the compounds represented by general formula (I), compounds represented by general formula (I′) are more preferred and compounds represented by general formula (II) or (IV) are even more preferred. Especially preferred of the compounds represented by general formula (II) are compounds represented by general formula (III). Especially preferred of the compounds represented by general formula (IV) are compounds represented by general formula (IV′).

Among the compounds represented by general formula (V), compounds represented by general formula (V′) are more preferred and compounds represented by general formula (VI) or (VII) are especially preferred.

In this case, only one compound represented by general formula (I) or (V) may be contained as the colorant (c) in the colored resin composition for color filter of the invention, or one or more compounds represented by general formula (I) and one or more compounds represented by general formula (V) may be contained as the colorant (c) therein. The composition may further contain one or more colorants of other kind(s).

### [(a) Binder Resin]

Preferred resins for use as the binder resin (a) differ according to the means by which the colored resin compositions are to be cured.

In the case where a colored resin composition of the invention is a photopolymerizable resin composition, known high-molecular compounds described in, for example, JP-A-7-207211, JP-A-8-259876, JP-A-10-300922, JP-A-11-140144, JP-A-11-174224, JP-A-2000-56118, JP-A-2003-233179, etc. can be used as the binder resin (a). Preferred examples thereof include the following resins (a-1) to (a-5).

(a-1): A resin obtained from a copolymer of one or more (meth)acrylates containing an epoxy group with other radical-polymerizable monomer(s) by causing an unsaturated monobasic acid to add to at least part of the epoxy groups possessed by the copolymer, or an alkali-soluble resin obtained by causing a polybasic acid anhydride to add to at least part of the hydroxyl groups formed by the addition reaction (hereinafter sometimes referred to as “resin (a-1)”).

(a-2): A linear alkali-soluble resin (a-2) containing carboxyl groups (hereinafter sometimes referred to as “resin (a-2)”).

(a-3): A resin obtained by causing an unsaturated compound containing an epoxy group to add to the carboxyl group moieties of the resin (a-2) (hereinafter sometimes referred to as “resin (a-3)”).

(a-4): A (meth)acrylic resin (hereinafter sometimes referred to as “resin (a-4)”).

(a-5): An epoxy acrylate resin having carboxyl groups (hereinafter sometimes referred to as “resin (a-5)”).

These resins are explained below.

(a-1): Resin obtained from copolymer of one or more (meth)acrylates containing epoxy group with other radical-polymerizable monomer(s) by causing unsaturated monobasic acid to add to at least part of the epoxy groups possessed by the copolymer, or alkali-soluble resin obtained by causing polybasic acid anhydride to add to at least part of the hydroxyl groups formed by the addition reaction:

An especially preferred example of this resin (a-1) is a resin obtained from a copolymer of 5-90% by mole (meth)acrylate containing an epoxy group with 10-95% by mole other radical-polymerizable monomers by causing an unsaturated monobasic acid to add to 10-100% by mole of the epoxy groups possessed by the copolymer, or an alkali-soluble resin obtained by causing a polybasic acid anhydride to add to 10-100% by mole of the hydroxyl groups formed by the addition reaction.

Examples of the (meth)acrylate containing an epoxy group include glycidyl (meth)acrylate, 3,4-epoxybutyl (meth)acrylate, (3,4-epoxycyclohexyl)methyl (meth)acrylate, and 4-hydroxybutyl (meth)acrylate glycidyl ether. Preferred of these is glycidyl (meth)acrylate. One of these (meth)acrylates containing an epoxy group may be used alone, or two or more thereof may be used in combination.

The other radical-polymerizable monomers to be copolymerized with the (meth)acrylate containing an epoxy group preferably are mono(meth)acrylates having a structure represented by the following general formula (1).

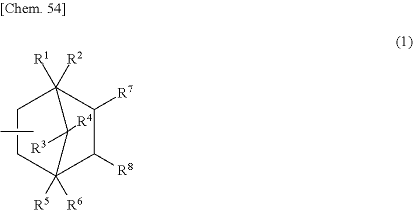

In formula (I), R¹ to R⁶ each independently represent a hydrogen atom or an alkyl group having 1-3 carbon atoms, and R⁷ and R⁸ each independently are a hydrogen atom or an alkyl group having 1-3 carbon atoms or may have been bonded to each other to form a ring.

The ring formed by the bonding of R⁷ and R⁸ to each other in formula (I) preferably is an aliphatic ring and may be saturated or unsaturated. It is preferred that the ring has 5 or 6 carbon atoms.

Preferred of the structures represented by general formula (1) is the structure represented by the following formula (1a), (1b), or (1c).

By incorporating those structures into a binder resin, the heat resistance of a colored resin composition of the invention to be used for a color filter or liquid-crystal display device can be improved or the strength of pixels formed using the colored resin composition can be enhanced.

One of mono(meth)acrylates having a structure represented by general formula (1) may be used alone, or two or more thereof may be used in combination.

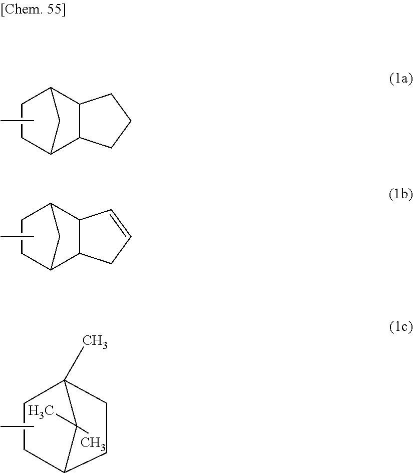

By incorporating those structures into a binder resin, the heat resistance of a colored resin composition of the invention to be used for a color filter or liquid-crystal display device can be improved or the strength of pixels formed using the colored resin composition can be enhanced.

One of mono(meth)acrylates having a structure represented by general formula (1) may be used alone, or two or more thereof may be used in combination.

As the mono(meth)acrylates having a structure represented by general formula (1), various known mono(meth)acrylates can be used so long as these acrylates have the structure. However, mono(meth)acrylates represented by the following general formula (2) are especially preferred.

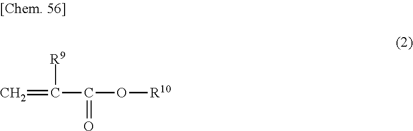

In formula (2), R⁹ represents a hydrogen atom or methyl, and R¹⁰ represents a structure of general formula (I).

In the copolymer of a (meth)acrylate containing an epoxy group with other radical-polymerizable monomers, the proportion of repeating units derived from a mono(meth)acrylate having a structure represented by general formula (1) in the repeating units derived from the “other radical-polymerizable monomers” is preferably 5-90% by mole, more preferably 10-70% by mole, especially preferably 15-50% by mole.

The “other radical-polymerizable monomers” other than the mono(meth)acrylates having a structure represented by general formula (I) are not particularly limited. Specific examples thereof include vinyl aromatics such as styrene and α-, o-, m-, and p-alkyl, nitro, cyano, amido, and ester derivatives of styrene; dienes such as butadiene, 2,3-dimethylbutadiene, isoprene, and chloroprene; (meth)acrylic esters such as methyl (meth)acrylate, ethyl (meth)acrylate, n-propyl (meth)acrylate, isopropyl (meth)acrylate, n-butyl (meth)acrylate, sec-butyl (meth)acrylate, tert-butyl (meth)acrylate, pentyl (meth)acrylate, neopentyl (meth)acrylate, isoamyl (meth)acrylate, hexyl (meth)acrylate, 2-ethylhexyl (meth)acrylate, lauryl (meth)acrylate, dodecyl (meth)acrylate, cyclopentyl (meth)acrylate, cyclohexyl (meth)acrylate, 2-methylcyclohexyl (meth)acrylate, dicyclohexyl (meth)acrylate, isobornyl (meth)acrylate, adamantly (meth)acrylate, propargyl (meth)acrylate, phenyl (meth)acrylate, naphthyl (meth)acrylate, anthracenyl (meth)acrylate, anthraninonyl (meth)acrylate, piperonyl (meth)acrylate, salicyl (meth)acrylate, furyl (meth)acrylate, furfuryl (meth)acrylate, tetrahydrofuryl (meth)acrylate, pyranyl (meth)acrylate, benzyl (meth)acrylate, phenethyl (meth)acrylate, cresyl (meth)acrylate, 1,1,1-trifluoroethyl (meth)acrylate, perfluoroethyl (meth)acrylate, perfluoro-n-propyl (meth)acrylate, perfluoroisopropyl (meth)acrylate, triphenylmethyl (meth)acrylate, cumyl (meth)acrylate, 3-(N,N-dimethylamino)propyl (meth)acrylate, 2-hydroxyethyl (meth)acrylate, and 2-hydroxypropyl (meth)acrylate; (meth)acrylamide compounds such as (meth)acrylamide, N,N-dimethyl(meth)acrylamide, N,N-diethyl(meth)acryl amide, N,N-dipropyl (meth)acrylamide, N,N-diisopropyl(meth)acrylamide, and anthracenyl(meth)acrylamide; vinyl compounds such as (meth)acrylanilide, (meth)acryloyInitrile, acrolein, vinyl chloride, vinylidene chloride, vinyl fluoride, vinylidene fluoride, N-vinylpyrrolidone, vinylpyridine, and vinyl acetate; diesters of unsaturated dicarboxylic acids, such as diethyl citraconate, diethyl maleate, diethyl fumarate, and diethyl itaconate; monomaleimides such as N-phenylmaleimide, N-cyclohexylmaleimide, N-laurylmaleimide, and N-(4-hydroxyphenyl)maleimide; and N-(meth)acryloylphthalimide.

It is effective to use, among those “other radical-polymerizable monomers”, at least one member selected from styrene, benzyl (meth)acrylate, and monomaleimides, for the purpose of imparting excellent heat resistance and strength to a colored resin composition. In particular, a copolymer in which the proportion of repeating units derived from at least one member selected from styrene, benzyl (meth)acrylate), and monomaleimides in the repeating units derived from the “other radical-polymerizable monomers” is 1-70% by mole is preferred. More preferred is a copolymer in which the proportion thereof is 3-50% by mole.

Incidentally, a known solution polymerization method is applied to the copolymerization reaction of the (meth)acrylate containing an epoxy group with the other radical-polymerizable monomers. Any solvent which is inert to the radical polymerization may be used without particular limitations, and organic solvents in common use can be employed.

Examples of the solvents include ethyl acetate, isopropyl acetate, and ethylene glycol monoalkyl ether acetates such as Cellosolve acetate and butyl Cellosolve acetate; diethylene glycol monoalkyl ether acetates such as diethylene glycol monomethyl ether acetate, Carbitol acetate, and butyl Carbitol acetate; propylene glycol monoalkyl ether acetates; acetic ester compounds such as dipropylene glycol monoalkyl ether acetates; ethylene glycol dialkyl ethers; diethylene glycol dialkyl ethers such as methyl Carbitol, ethyl Carbitol, and butyl Carbitol; triethylene glycol dialkyl ethers; propylene glycol dialkyl ethers; dipropylene glycol dialkyl ethers; ethers such as 1,4-dioxane and tetrahydrofuran; ketones such as acetone, methyl ethyl ketone, methyl isobutyl ketone, and cyclohexanone; hydrocarbons such as benzene, toluene, xylene, octane, and decane; petroleum solvents such as petroleum ether, petroleum naphtha, hydrogenated petroleum naphtha, and solvent naphtha; lactic esters such as methyl lactate, ethyl lactate, and butyl lactate; and dimethylformamide and N-methylpyrrolidone.

One of those solvents may be used alone, or two or more thereof may be used in combination.

The amount of those solvents to be used is generally 30-1,000 parts by weight, preferably 50-800 parts by weight, per 100 parts by weight of the copolymer to be obtained. In case where the amount of the solvents used is outside the range, it is difficult to regulate the molecular weight of the copolymer.

Any radical polymerization initiator capable of initiating radical polymerization may be used in the copolymerization reaction without particular limitations. Organic peroxide catalysts and azo compound catalysts in common use can be employed.

Examples of the organic peroxide catalysts include known catalysts classified as ketone peroxides, peroxyketals, hydroperoxides, diallyl peroxides, diacyl peroxides, peroxyesters, and peroxydicarbonates. Specific examples thereof include benzoyl peroxide, dicumyl peroxide, diisopropyl peroxide, di-t-butyl peroxide, t-butyl peroxybenzoate, t-hexyl peroxybenzoate, t-butyl peroxy-2-ethylhexanoate, t-hexyl peroxy-2-ethylhexanoate, 1,1-bis(t-butylperoxy)-3,3,5-trimethylcyclohexane, 2,5-dimethyl-2,5-bis(t-butylperoxy)hexyl-3,3-isopropyl hydroperoxide, t-butyl hydroperoxide, dicumyl peroxide, dicumyl hydroperoxide, acetyl peroxide, bis(4-t-butylcyclohexyl) peroxydicarbonate, diisopropyl peroxydicarbonate, isobutyl peroxide, 3,3,5-trimethylhexanoyl peroxide, lauryl peroxide, 1,1-bis(t-butylperoxy)-3,3,5-trimethylcyclohexane, and 1,1-bis(t-hexylperoxy)-3,3,5-trimethylcyclohexane.

Examples of the azo compound catalysts include azobisisobutyronitrile and azobiscarbonamide.

One or more radical polymerization initiators having an appropriate half life are selected from those initiators according to polymerization temperature and used.

The amount of the radical polymerization initiator to be used is generally 0.5-20 parts by weight, preferably 1-10 parts by weight, per 100 parts by weight of all monomers to be subjected to the copolymerization reaction.

The copolymerization reaction may be conducted by a method in which the monomers to be subjected to the copolymerization reaction and a radical polymerization initiator are dissolved in a solvent and the solution is heated with stirring, or by a method in which the monomers to which a radical polymerization initiator has been added are added dropwise to a heated solvent which is being stirred. It is also possible to conduct the reaction by a method in which the monomers are added dropwise to a heated solvent to which a radical polymerization initiator has been added.

Reaction conditions can be varied at will according to a desired molecular weight.

In the invention, the copolymer of the (meth)acrylate containing an epoxy group and the other radical-polymerizable monomers preferably is one which is constituted of 5-90% by mole repeating units derived from the (meth)acrylate containing an epoxy group and 10-95% by mole repeating units derived from the other radical-polymerizable monomers, more preferably is one constituted of 20-80% by mole the former units and 80-20% by mole the latter units, and especially preferably is one constituted of 30-70% by mole the former units and 70-30% by mole the latter units.

In case where the proportion of repeating units derived from the (meth)acrylate containing an epoxy group in the copolymer is too small, there is a possibility that the polymerizable ingredient and alkali-soluble ingredient, which will be described later, cannot be caused to add in a sufficient amount. On the other hand, in case where the proportion of repeating units derived from the (meth)acrylate containing an epoxy group is too large and the proportion of repeating units derived from the other radical-polymerizable monomers is too small, there is a possibility that heat resistance and strength might become insufficient.

Subsequently, the epoxy group moieties of the copolymer of a (meth)acrylate containing an epoxy resin with other radical-polymerizable monomers are reacted with an unsaturated monobasic acid (polymerizable ingredient) and further with a polybasic acid anhydride (alkali-soluble ingredient).

As the unsaturated monobasic acid to be caused to add to the epoxy groups, a known one can be used. Examples thereof include unsaturated carboxylic acids having an ethylenically unsaturated double bond.

Specific examples thereof include monocarboxylic acids such as (meth)acrylic acid, crotonic acid, o-, m-, and p-vinylbenzoic acids, and (meth)acrylic acid substituted in the α-position with a haloalkyl group, alkoxyl group, halogen atom, nitro group, cyano group, or the like. Preferred of these is (meth)acrylic acid. One of these may be used alone, or two or more thereof may be used in combination.

By causing such an ingredient to add to the epoxy groups, polymerizability can be imparted to the binder resin to be used in the invention.

Those unsaturated monobasic acids are caused to add to generally 10-100% by mole, preferably 30-100% by mole, more preferably 50-100% by mole, of the epoxy groups possessed by the copolymer. In case where the proportion of epoxy groups to which the unsaturated monobasic acid is caused to add is too small, there is a fear about adverse influences of residual epoxy groups on the long-term stability, etc. of the colored resin composition. For causing an unsaturated monobasic acid to add to the epoxy groups of the copolymer, a known method can be employed.

Furthermore, as the polybasic acid anhydride to be caused to add to the hydroxyl groups which generate when an unsaturated monobasic acid is caused to add to the epoxy groups of the copolymer, a known one can be used.

Examples thereof include dibasic acid anhydrides such as maleic anhydride, succinic anhydride, itaconic anhydride, phthalic anhydride, tetrahydrophthalic anhydride, hexahydrophthalic anhydride, and chlorendic anhydride; and the anhydrides of tribasic and higher-basicity acids, such as trimellitic anhydride, pyromellitic anhydride, benzophenonetetracarboxylic anhydride, and biphenyltetracarboxylic anhydride. Preferred of these is tetrahydrophthalic anhydride and/or succinic anhydride. One of these polybasic acid anhydrides may be used alone, or two or more thereof may be used in combination.

By causing such an ingredient to add to the hydroxyl groups, alkali solubility can be imparted to the binder resin to be used in the invention.

Those polybasic acid anhydrides are caused to add to generally 10-100% by mole, preferably 20-90% by mole, more preferably 30-80% by mole, of the hydroxyl groups which generate when an unsaturated monobasic acid is caused to add to the epoxy groups possessed by the copolymer. In case where the proportion of hydroxyl groups to which the anhydride is caused to add is too large, there is a fear that development may result in a reduced retention of film thickness. In case where the proportion thereof is too small, there is a possibility that the binder resin might have insufficient solubility. For causing a polybasic acid anhydride to add to the hydroxyl groups, a known method can be employed.

After the polybasic acid anhydride has been caused to add, glycidyl (meth)acrylate or a glycidyl ether compound having a polymerizable unsaturated group may be caused to add to part of the carboxyl groups yielded, for the purpose of improving photosensitivity.

Furthermore, a glycidyl ether compound having no polymerizable unsaturated group may be caused to add to part of the carboxyl groups yielded, for the purpose of improving developability.

Both of these may be caused to add.

Examples of the glycidyl ether compound having no polymerizable unsaturated group include glycidyl ether compounds having a phenyl group or an alkyl group. Examples of commercial products thereof include trade names “Denacol EX-111”, “Denacol EX-121”, “Denacol EX-141”, “Denacol EX-145”, “Denacol EX-146”, “Denacol EX-171”, and “Denacol EX-192”, manufactured by Nagase Chemicals Ltd.

The structures of such resins are described in, for example, JP-A-8-297366 and JP-A-2001-89533.

The binder resin (a-1) described above has a weight-average molecular weight (Mw), as determined through a measurement by GPC (gel permeation chromatography) and a calculation for polystyrene, of preferably 3,000-100,000, especially preferably 5,000-50,000. In case where the molecular weight thereof is lower than 3,000, there is a possibility that this binder resin is inferior in heat resistance and film strength. In case where the molecular weight thereof exceeds 100,000, this binder resin tends to have insufficient solubility in developing solutions. The weight-average molecular weight (Mw)/number-average molecular weight (Mn) ratio, as a measure of molecular weight distribution, is preferably 2.0-5.0.

The binder resin (a-1) has an acid value of generally 10-200 mg-KOH/g, preferably 15-150 mg-KOH/g, more preferably 25-100 mg-KOH/g. Too low acid values may result in cases where this binder resin has reduced solubility in developing solutions. Conversely, too high acid values thereof may result in a rough film surface.

(a-2): Linear Alkali-Soluble Resin Containing Carboxyl Groups

The linear alkali-soluble resin containing carboxyl groups is not particularly limited so long as the resin has carboxyl groups. This resin is usually obtained by polymerizing a polymerizable monomer containing a carboxyl group.

Examples of the polymerizable monomer containing a carboxyl group include vinyl monomers such as (meth)acrylic acid, maleic acid, crotonic acid, itaconic acid, fumaric acid, 2-(meth)acryloyloxyethylsuccinic acid, 2-(meth)acryloyloxyethyladipic acid, 2-(meth)acryloyloxyethylmaleic acid, 2-(meth)acryloyloxyethylhexahydrophthalic acid, 2-(meth)acryloyloxyethylphthalic acid, 2-(meth)acryloyloxypropylsuccinic acid, 2-(meth)acryloyloxypropyladipic acid, 2-(meth)acryloyloxypropylmaleic acid, 2-(meth)acryloyloxypropylhydrophthalic acid, 2-(meth)acryloyloxypropylphthalic acid, 2-(meth)acryloyloxybutylsuccinic acid, 2-(meth)acryloyloxybutyladipic acid, 2-(meth)acryloyloxybutylmaleic acid, 2-(meth)acryloyloxybutylhydrophthalic acid, and 2-(meth)acryloyloxybutylphthalic acid; monomers formed by causing a lactone, e.g., ε-caprolactone, β-propiolactone, γ-butyrolactone, or δ-valerolactone, to add to acrylic acid; and monomers formed by causing an acid or acid anhydride, e.g., succinic acid, maleic acid, phthalic acid, or the anhydride of any of these, to add to hydroxyalkyl (meth)acrylates. One of these monomers may be used alone, or two or more thereof may be used in combination.

Preferred of these are (meth)acrylic acid and 2-(meth)acryloyloxyethylsuccinic acid. More preferred is (meth)acrylic acid.

The linear alkali-soluble resin containing carboxyl groups may be one obtained by copolymerizing any of the polymerizable monomers containing a carboxyl group with another polymerizable monomer, i.e., one having no carboxyl group.

In this case, the other polymerizable monomer is not particularly limited. Examples thereof include (meth)acrylic esters such as methyl (meth)acrylate, ethyl (meth)acrylate, propyl (meth)acrylate, isopropyl (meth)acrylate, butyl (meth)acrylate, isobutyl (meth)acrylate, benzyl (meth)acrylate, phenyl (meth)acrylate, cyclohexyl (meth)acrylate, phenoxyethyl (meth)acrylate, phenoxymethyl (meth)acrylate, 2-ethylhexyl (meth)acrylate, isobornyl (meth)acrylate, 2-hydroxyethyl (meth)acrylate, glycerol mono(meth)acrylate, and tetrahydrofurfuryl (meth)acrylate; vinyl aromatics such as styrene and derivatives thereof; vinyl compounds such as N-vinylpyrrolidone; N-substituted maleimides such as N-cyclohexylmaleimide, N-phenylmaleimide, and N-benzylmaleimide; and macromonomers such as poly(methyl (meth)acrylate) macromonomers, polystyrene macromonomers, poly(2-hydroxyethyl (meth)acrylate) macromonomers, polyethylene glycol macromonomers, polypropylene glycol macromonomers, and polycaprolactone macromonomers. One of these may be used alone, or two or more thereof may be used in combination.

Especially preferred of these are styrene, methyl (meth)acrylate, cyclohexyl (meth)acrylate, benzyl (meth)acrylate, 4-hydroxybutyl (meth)acrylate, 2-hydroxyethyl (meth)acrylate, hydroxypropyl (meth)acrylate, butyl (meth)acrylate, isobutyl (meth)acrylate, N-cyclohexylmaleimide, N-benzylmaleimide, and N-phenylmaleimide.

The linear alkali-soluble resin containing carboxyl groups may further have hydroxyl groups. A resin (a-2) having carboxyl groups and hydroxyl groups can be obtained by copolymerizing a hydroxyl-containing monomer, such as, for example, a hydroxyalkyl (meth)acrylate, e.g., 2-hydroxyethyl (meth)acrylate, hydroxypropyl (meth)acrylate, or 4-hydroxybutyl (meth)acrylate, or glycerol mono(meth)acrylate, with any of the various monomers shown above.

Examples of the linear alkali-soluble resin (a-2) containing carboxyl groups include copolymers of (meth)acrylic acid, a polymerizable monomer containing no hydroxyl group, e.g., methyl (meth)acrylate, benzyl (meth)acrylate, butyl (meth)acrylate, isobutyl (meth)acrylate, cyclohexyl (meth)acrylate, or cyclohexylmaleimide, and a monomer containing a hydroxyl group, e.g., 2-hydroxyethyl (meth)acrylate, hydroxypropyl (meth)acrylate, or 4-hydroxybutyl (meth)acrylate; copolymers of (meth)acrylic acid and a (meth)acrylic ester, e.g., methyl (meth)acrylate, benzyl (meth)acrylate, butyl (meth)acrylate, isobutyl (meth)acrylate, or 2-hydroxyethyl (meth)acrylate; copolymers of (meth)acrylic acid and styrene; copolymers of (meth)acrylic acid, styrene, and α-methylstyrene; and copolymers of (meth)acrylic acid and cyclohexylmaleimide.

The resin (a-2) especially preferably is a copolymer resin containing benzyl (meth)acrylate because this resin has excellent pigment-dispersing properties.

The linear alkali-soluble resin containing carboxyl groups to be used in the invention has an acid value of generally 30-500 KOH-mg/g, preferably 40-350 KOH-mg/g, more preferably 50-300 KOH-mg/g.

The resin (a-2) has a weight-average molecular weight (Mw), as determined through a measurement by GPC and a calculation for polystyrene, of generally 2,000-80,000, preferably 3,000-50,000, more preferably 4,000-30,000. In case where the weight-average molecular weight thereof is too low, the colored resin composition tends to have poor stability. In case where the weight-average molecular weight thereof is too high, this resin tends to have impaired solubility in developing solutions when used in producing the color filter or liquid-crystal display device which will be described later.

(a-3): Resin Obtained by Causing Epoxy-Group-Containing Unsaturated Compound to Add to Carboxyl Group Moieties of Resin (a-2)

In the resin (a-3), the epoxy-group-containing unsaturated compound to be caused to add to the carboxyl group moieties of the linear alkali-soluble resin (a-2) containing carboxyl groups is not particularly limited so long as the unsaturated compound has an ethylenically unsaturated group and an epoxy group in the molecule.

Examples of the unsaturated compound containing an epoxy group include unsaturated compounds containing an acyclic epoxy group, such as glycidyl (meth)acrylate, allyl glycidyl ether, glycidyl α-ethylacrylate, crotonyl glycidyl ether, (iso)crotonic acid glycidyl ether, N-(3,5-dimethyl-4-glycidyl)benzylacrylamide, and 4-hydroxybutyl (meth)acrylate glycidyl ether. However, unsaturated compounds containing an alicyclic epoxy group are preferred from the standpoints of heat resistance and the pigment-dispersing properties which will be described later.

With respect to the unsaturated compounds containing an alicyclic epoxy group, examples of the alicyclic epoxy group include 2,3-epoxycyclopentyl, 3,4-epoxycyclohexyl, and 7,8-epoxy[tricyclo[5.2.1.0]dec-2-yl]. The ethylenically unsaturated group preferably is one derived from (meth)acryloyl. Preferred examples of the unsaturated compounds containing an alicyclic epoxy group include compounds represented by the following general formulae (3a) to (3m).

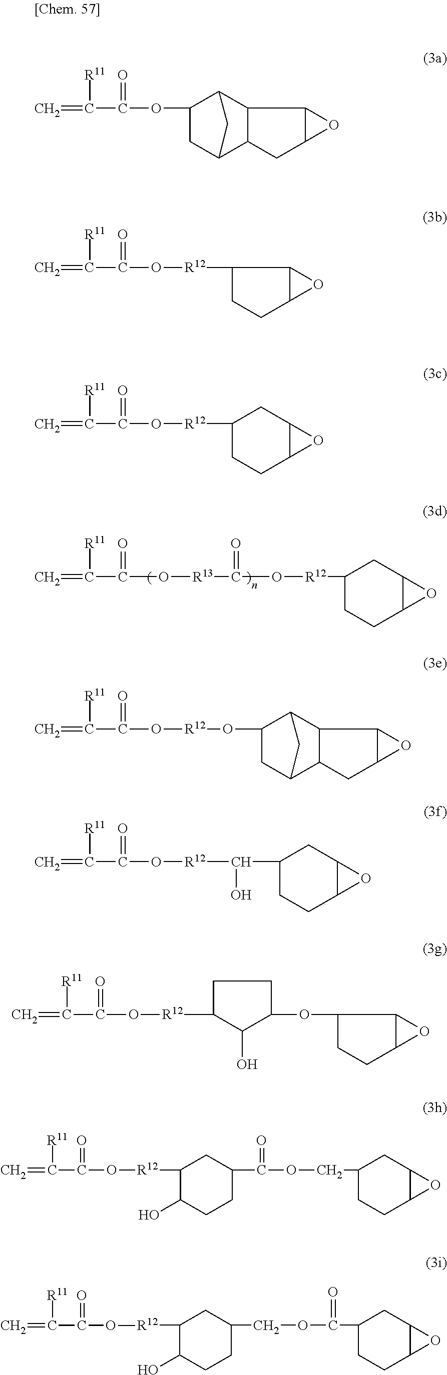

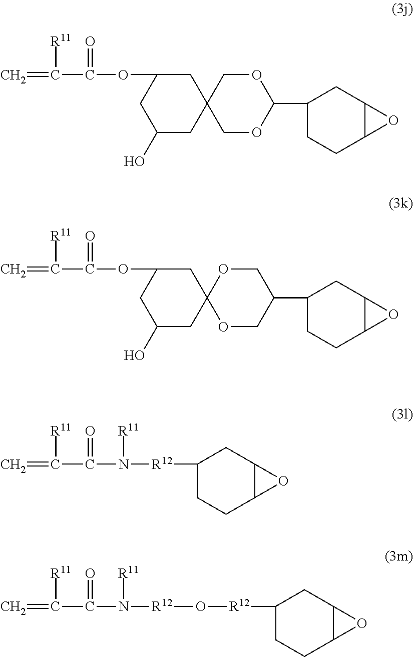

In formulae (3a) to (3m), R¹¹ represents a hydrogen atom or a methyl group; R¹² represents an alkylene group; R¹³ represents a divalent hydrocarbon group; and n is an integer of 1-10.

The alkylene group R¹² in general formulae (3a) to (3m) preferably is one having 1-10 carbon atoms. Examples thereof include methylene, ethylene, propylene, and butylene. Preferred are methylene, ethylene, and propylene. The hydrocarbon group R¹³ preferably is one having 1-10 carbon atoms, and examples thereof include alkylene groups and phenylene.

One of these unsaturated compounds containing an alicyclic epoxy compound may be used alone, or two or more thereof may be used in combination.

Preferred of those are compounds represented by general formula (3c). Especially preferred is 3,4-epoxycyclohexylmethyl (meth)acrylate.

For causing the epoxy-group-containing unsaturated compound to add to carboxyl group moieties of the resin (a-2), a known technique can be used. For example, the resin (a-2) and an unsaturated compound containing an epoxy group are reacted at a reaction temperature of 50-150° C. for several hours to tends of hours in an organic solvent in the presence of a catalyst, e.g., a tertiary amine such as triethylamine or benzylmethylamine, a quaternary ammonium salt such as dodecyltrimethylammonium chloride, tetramethylammonium chloride, tetraethylammonium chloride, tetrabutylammonium chloride, or benzyltriethylammonium chloride, pyridine, or triphenylphosphine. The unsaturated compound containing an epoxy group can be thereby incorporated into the carboxyl groups of the resin (a-2).

The carboxyl-group-containing resin (a-3) obtained by incorporating an epoxy-group-containing unsaturated compound into the resin (a-2) has an acid value of generally 10-200 KOH-mg/g, preferably 20-150 KOH-mg/g, more preferably 30-150 KOH-mg/g.

The resin (a-3) has a weight-average molecular weight (Mw), as determined through a measurement by GPC and a calculation for polystyrene, of generally 2,000-100,000, preferably 4,000-50,000, more preferably 5,000-30,000. In case where the weight-average molecular weight thereof is too low, the colored resin composition tends to have poor stability. In case where the weight-average molecular weight thereof is too high, this resin tends to have impaired solubility in developing solutions when used in producing the color filter or liquid-crystal display device which will be described later.

(a-4): (Meth)Acrylic Resin

The (meth)acrylic resin (a-4) is a polymer obtained by polymerizing monomer ingredients including a compound represented by the following general formula (4) as an essential component (hereinafter, the polymer is sometimes referred to as “resin (a-4)”).

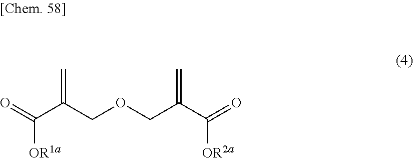

In general formula (4), R^{1a} and R^{2a} each independently represent a hydrogen atom or a hydrocarbon group which has 1-25 carbon atoms and may have a substituent.

First, the compound represented by general formula (4) is explained.

In the ether dimer represented by general formula (4), the hydrocarbon groups represented by R^{1a} and R^{2a}, which each have 1-25 carbon atoms and may have a substituent, are not particularly limited. Examples thereof include linear or branched alkyl groups such as methyl, ethyl, n-propyl, isopropyl, n-butyl, isobutyl, t-butyl, t-amyl, stearyl, lauryl, and 2-ethylhexyl; aryl groups such as phenyl; alicyclic groups such as cyclohexyl, t-butylcyclohexyl, dicyclopentadienyl, tricyclodecanyl, isobornyl, adamantly, and 2-methyl-2-adamantyl; alkoxy-substituted alkyl groups such as 1-methoxyethyl and 1-ethoxyethyl; and aryl-substituted alkyl groups such as benzyl. Especially preferred of these from the standpoint of heat resistance are substituents bonded through a primary or secondary carbon atom, such as methyl, ethyl, cyclohexyl, and benzyl, that are less apt to be eliminated by an acid or heat. R^{1a} and R^{2a} may be the same substituent or may be different substituents.

Specific examples of the ether dimer include dimethyl 2,2′-[oxybis(methylene)]bis-2-propenoate, diethyl 2,2′-[oxybis(methylene)]bis-2-propenoate, di(n-propyl) 2,2′[oxybis(methylene)]bis-2-propenoate, di(isopropyl) 2,2′-[oxybis(methylene)]bis-2-propenoate, di(n-butyl) 2,2′-[oxybis(methylene)]bis-2-propenoate, di(isobutyl) 2,2′-[oxybis(methylene)]bis-2-propenoate, di(t-butyl) 2,2′-[oxybis(methylene)]bis-2-propenoate, di(t-amyl) 2,2′-[oxybis(methylene)]bis-2-propenoate, di(stearyl) 2,2′-[oxybis(methylene)]bis-2-propenoate, di(lauryl) 2,2′-[oxybis(methylene)]bis-2-propenoate, di(2-ethylhexyl) 2,2′-[oxybis(methylene)]bis-2-propenoate, di(1-methoxyethyl) 2,2′-[oxybis(methylene)]bis-2-propenoate, di(1-ethoxyethyl) 2,2′-[oxybis(methylene)]bis-2-propenoate, dibenzyl 2,2′-[oxybis(methylene)]bis-2-propenoate, diphenyl 2,2′-[oxybis(methylene)]bis-2-propenoate, dicyclohexyl 2,2′-[oxybis(methylene)]bis-2-propenoate, di(t-butylcyclohexyl) 2,2′-[oxybis(methylene)]bis-2-propenoate, di(dicyclopentadienyl) 2,2′-[oxybis(methylene)]bis-2-propenoate, di(tricyclodecanyl) 2,2′-[oxybis(methylene)]bis-2-propenoate, di(isobornyl) 2,2′-[oxybis(methylene)]bis-2-propenoate, diadamantyl 2,2′-[oxybis(methylene)]bis-2-propenoate, and di(2-methyl-2-adamantyl) 2,2′-[oxybis(methylene)]bis-2-propenoate. Especially preferred of these are dimethyl 2,2′-[oxybis(methylene)]bis-2-propenoate, diethyl 2,2′-[oxybis(methylene)]bis-2-propenoate, dicyclohexyl 2,2′-[oxybis(methylene)]bis-2-propenoate, and dibenzyl 2,2′-[oxybis(methylene)]bis-2-propenoate. One of these ether dimers may be used alone, or two or more thereof may be used in combination.

The proportion of the ether dimer represented by general formula (4) in the monomer ingredients for obtaining the resin (a-4) is not particularly limited. However, the proportion thereof is generally 2-60% by weight, preferably 5-55% by weight, more preferably 5-50% by weight, based on all monomer ingredients. In case where the amount of this ether dimer is too large, there is a possibility that it might be difficult to obtain a low-molecular resin through polymerization or gelation might be apt to occur during polymerization. On the other hand, in case where the amount thereof is too small, there is a possibility that coating film performance such as transparency and heat resistance might be insufficient.

It is preferred that the resin (a-4) should have acid groups. When the resin (a-4) has acid groups, the colored resin composition can be obtained as a colored resin composition capable of being cured through a crosslinking reaction in which the acid groups react with epoxy groups to form ester bonds (hereinafter abbreviated to acid-epoxy curing) or as a composition in which uncured areas can be removed with an alkaline developing solution in development. The acid groups are not particularly limited. Examples thereof include a carboxyl group, phenolic hydroxyl group, and carboxylic acid anhydride groups. Such acid groups in the resin (a-4) may be of one kind or may be of two or more kinds.

For introducing acid groups into the resin (a-4), use may be made, for example, of a method in which a monomer having an acid group and/or a “monomer capable of imparting an acid group after polymerization” (hereinafter sometimes referred to as “monomer for introducing acid groups”) is used as a monomer ingredient. In the case where a “monomer capable of imparting an acid group after polymerization” is used as a monomer ingredient, it is necessary to conduct, after polymerization, a treatment for imparting acid groups, such as that which will be described later.

Examples of the monomer having an acid group include monomers having a carboxyl group, such as (meth)acrylic acid and itaconic acid; monomers having a phenolic hydroxyl group, such as N-hydroxyphenylmaleimide; and monomers having a carboxylic acid anhydride group, such as maleic anhydride and itaconic anhydride. Especially preferred of these is (meth)acrylic acid.

Examples of the monomer imparting an acid group after polymerization include monomers having a hydroxyl group, such as 2-hydroxyethyl (meth)acrylate; monomers having an epoxy group, such as glycidyl (meth)acrylate; and monomers having an isocyanate group, such as 2-isocyanatoethyl (meth)acrylate.

One of those monomers for introducing acid groups may be used alone, or two or more thereof may be used in combination.

In the case where the monomer ingredients for obtaining the resin (a-4) include such a monomer for introducing acid groups, the content of this monomer is not particularly limited. However, the content thereof is generally 5-70% by weight, preferably 10-60% by weight, based on all monomer ingredients.

The resin (a-4) may be one having radical-polymerizable double bonds.

For introducing radical-polymerizable double bonds into the resin (a-4), use may be made, for example, of a method in which a “monomer capable of imparting a radical-polymerizable double bond after polymerization” (hereinafter sometimes referred to as “monomer for introducing radical-polymerizable double bonds”) is polymerized as a monomer ingredient and the resultant polymer is subjected to a treatment for imparting radical-polymerizable double bonds, such as that which will be described later.

Examples of the monomer capable of imparting a radical-polymerizable double bond after polymerization include monomers having a carboxyl group, such as (meth)acrylic acid and itaconic acid; monomers having a carboxylic acid anhydride group, such as maleic anhydride and itaconic anhydride; and monomers having an epoxy group, such as glycidyl (meth)acrylate, 3,4-epoxycyclohexylmethyl (meth)acrylate, and o-(or m- or p-)vinylbenzyl glycidyl ether. One of these monomers for introducing radical-polymerizable double bonds may be used alone, or two or more thereof may be used in combination.

In the case where the monomer ingredients for obtaining the resin (a-4) include such a monomer for introducing radical-polymerizable double bonds, the content of this monomer is not particularly limited. However, the content thereof is generally 5-70% by weight, preferably 10-60% by weight, based on all monomer ingredients.

It is preferred that the resin (a-4) should have epoxy groups.

For introducing epoxy groups, use may be made, for example, of a method in which a monomer having an epoxy group (hereinafter sometimes referred to as “monomer for introducing epoxy groups”) is polymerized as a monomer ingredient.

Examples of the monomer having an epoxy group include glycidyl (meth)acrylate, 3,4-epoxycyclohexylmethyl (meth)acrylate, and o-(or m- or p-)vinylbenzyl glycidyl ether. One of these monomers for introducing epoxy groups may be used alone, or two or more thereof may be used in combination.

In the case where the monomer ingredients for obtaining the resin (a-4) include such a monomer for introducing epoxy groups, the content of this monomer is not particularly limited. However, the content thereof is generally 5-70% by weight, preferably 10-60% by weight, based on all monomer ingredients.

The monomer ingredients for obtaining the resin (a-4) may include other copolymerizable monomers according to need, besides the essential monomer ingredient.

Examples of the other copolymerizable monomers include (meth)acrylic esters such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, methyl 2-ethylhexyl (meth)acrylate, cyclohexyl (meth)acrylate, benzyl (meth)acrylate, and 2-hydroxyethyl (meth)acrylate; aromatic vinyl compounds such as styrene, vinyltoluene, and α-methylstyrene; N-substituted maleimides such as N-phenylmaleimide and N-cyclohexylmaleimide; butadiene or substituted butadiene compounds, such as butadiene and isoprene; ethylene or substituted ethylene compounds, such as ethylene, propylene, vinyl chloride, and acrylonitrile; and vinyl esters such as vinyl acetate.

Methyl (meth)acrylate, cyclohexyl (meth)acrylate, benzyl (meth)acrylate, and styrene are preferred among those because these monomers impart satisfactory transparency and are less apt to impair heat resistance. One of those other copolymerizable monomers may be used alone, or two or more thereof may be used in combination.

Especially when part or all of the resin (a-4) is to be used as a dispersant as will be described later, it is preferred to use benzyl (meth)acrylate. The content thereof is generally 1-70% by weight, preferably 5-60% by weight, based on all monomer ingredients.

In the case where the monomer ingredients for obtaining the resin (a-4) further include those other copolymerizable monomers, the content thereof is not particularly limited. However, the content thereof is generally preferably 95% by weight or lower, more preferably 85% by weight or lower, based on all monomer ingredients.

The resin (a-4) can be produced, for example, by the method described in International Publication Pamphlet WO 2008/156148 A1.

The weight-average molecular weight of the resin (a-4) is not particularly limited. However, the weight-average molecular weight (Mw) thereof, as determined through a measurement by GPC and a calculation for polystyrene, is preferably 2,000-200,000, more preferably 4,000-100,000. When the weight-average molecular weight thereof exceeds 200,000, there are cases where the composition has too high a viscosity and it is difficult to form a coating film therefrom. On the other hand, in case where the weight-average molecular weight thereof is lower than 2,000, this resin tends to be less apt to come to have sufficient heat resistance.

In the case where the resin (a-4) has acid groups, this resin has an acid value of preferably 30-500 mg-KOH/g, more preferably 50-400 mg-KOH/g. When the acid value thereof is lower than 30 mg-KOH/g, there are cases where application to alkali development is difficult. In case where the acid value thereof exceeds 500 mg-KOH/g, there is a tendency that the composition has too high a viscosity and coating film formation therefrom is difficult.

Examples of the resin (a-4) include compounds described in, for example, JP-A-2004-300203 and JP-A-2004-300204.

(a-5): Epoxy Acrylate Resin Having Carboxyl Groups

The epoxy acrylate resin (a-5) is synthesized by causing either an α,β-unsaturated monocarboxylic acid or an α,β-unsaturated monocarboxylic acid ester having a carboxyl group in the ester moiety to add to an epoxy resin and further reacting a polybasic acid anhydride with the addition product. The resultant reaction product has a chemical structure having substantially no epoxy group, and this product should not be limited to “acrylates”. However, the reaction product is called an “epoxy acrylate resin” according to usage, because an epoxy resin is a starting material and a representative example is “acrylates”.

Suitable examples of the epoxy resin to be used as a starting material include bisphenol A epoxy resins (e.g., “Epikote 828”, “Epikote 1001”, “Epikote 1002”, and “Epikote 1004”, manufactured by Yuka Shell Epoxy K.K.), epoxy resins obtained by reacting alcoholic hydroxyl groups of bisphenol A epoxy resins with epichlorohydrin (e.g., “NER-1302” (epoxy equivalent, 323; softening point, 76° C.), manufactured by Nippon Kayaku Co., Ltd.), bisphenol F resins (e.g., “Epikote 807”, “EP-4001”, “EP-4002”, and “EP-4004, etc.”, manufactured by Yuka Shell Epoxy K.K.), epoxy resins obtained by reacting alcoholic hydroxyl groups of bisphenol F epoxy resins with epichlorohydrin (e.g., “NER-7406” (epoxy equivalent, 350; softening point, 66° C.), manufactured by Nippon Kayaku Co., Ltd.), bisphenol S epoxy resins, biphenyl glycidyl ether (e.g., “YX-4000”, manufactured by Yuka Shell Epoxy K.K.), phenol novolac epoxy resins (e.g., “EPPN-201”, manufactured by Nippon Kayaku Co., Ltd., “EP-152” and “EP-154”, manufactured by Yuka Shell Epoxy K.K., and “DEN-438”, manufactured by The Dow Chemical Co.), (o, m, p-)cresol novolac epoxy resins (e.g., “EOCN-102S”, “EOCN-1020”, and “EOCN-104S”, manufactured by Nippon Kayaku Co., Ltd.), triglycidyl isocyanurate (e.g., “TEPIC”, manufactured by Nissan Chemical Industries, Ltd.), trisphenolmethane type epoxy resins (e.g., “EPPN-501”, “EPN-502”, and “EPPN-503”, manufactured by Nippon Kayaku Co., Ltd.), fluorene epoxy resins (e.g., cardo epoxy resin “ESF-300”, manufactured by Nippon Steel Chemical Co., Ltd.), alicyclic epoxy resins (“Celoxide 2021P” and “Celoxide EHPE”, manufactured by Daicel Chemical Industries, Ltd.), dicyclopentadiene type epoxy resins obtained by introducing glycidyl groups into phenolic resins obtained by the reaction of dicyclopentadiene with phenol (e.g., “XD-1000”, manufactured by Nippon Kayaku Co., Ltd., “EXA-7200”, manufactured by Dainippon Ink & Chemicals, Inc., and “NC-3000” and “NC-7300”, manufactured by Nippon Kayaku Co., Ltd.), and the epoxy resin represented by the following structural formula (see Japanese Patent No. 2878486).

One of these may be used alone, or two or more thereof may be used in combination.

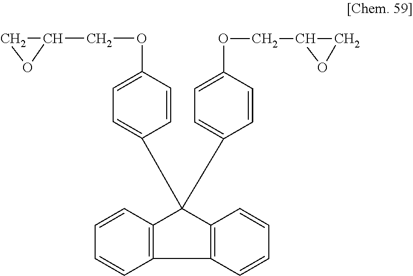

Other examples of the epoxy resin include copolymer type epoxy resins. Examples of the copolymer type epoxy resins include copolymers obtained by reacting glycidyl (meth)acrylate, (meth)acryloylmethylcyclohexene oxide, vinylcyclohexene oxide, or the like (hereinafter referred to as “first ingredient for copolymer type epoxy resins”) with one or more monofunctional compounds containing an ethylenically unsaturated group other than those monomers (hereinafter referred to as “second ingredient for copolymer type epoxy resins), such as, for example, one or more members selected from methyl (meth)acrylate, ethyl (meth)acrylate, butyl (meth)acrylate, 2-hydroxyethyl (meth)acrylate, 2-hydroxypropyl (meth)acrylate, (meth)acrylic acid, styrene, phenoxyethyl (meth)acrylate, benzyl (meth)acrylate, α-methylstyrene, glycerol mono(meth)acrylate, and compounds represented by the following general formula (8).

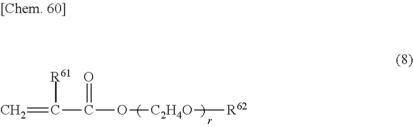

In formula (8), R⁶¹ represents a hydrogen atom or ethyl, R⁶² represents a hydrogen atom or an alkyl group having 1-6 carbon atoms, and r is an integer of 2-10.

Examples of the compounds represented by general formula (8) include polyethylene glycol mono(meth)acrylates such as diethylene glycol mono(meth)acrylate, triethylene glycol mono(meth)acrylate, and tetraethylene glycol mono(meth)acrylate; and alkoxypolyethylene glycol (meth)acrylates such as methoxydiethylene glycol mono(meth)acrylate, methoxytriethylene glycol mono(meth)acrylate, and methoxytetraethylene glycol mono(meth)acrylate. One of these may be used alone, or two or more thereof may be used in combination.

The amount of the first ingredient for copolymer type epoxy resins to be used is preferably 10% by weight or larger, especially preferably 20% by weight or larger, and is preferably 70% by weight or smaller, especially preferably 50% by weight or smaller, based on the second ingredient for copolymer type epoxy resins.

Specific examples of such copolymer type epoxy resins include “CP-15”, “CP-30”, “CP-50”, “CP-20SA”, “CP-510SA”, “CP-50S”, “CP-50M”, and “CP-20MA”, manufactured by Nippon Oil & Fats Co., Ltd.

The starting-material epoxy resin has a molecular weight in the range of generally 200-200,000, preferably 300-100,000, in terms of weight-average molecular weight (Mw) as determined through a measurement by GPC and a calculation for polystyrene. When the weight-average molecular weight thereof is lower than that range, there are often cases where film-forming properties are problematic. Conversely, a resin having a weight-average molecular weight exceeding that range is apt to gel during the addition reaction of an α,β-unsaturated monocarboxylic acid, resulting in the possibility that production is difficult.

Examples of the α,β-unsaturated monocarboxylic acid to be caused to add to the epoxy resin include itaconic acid, crotonic acid, cinnamic acid, acrylic acid, and methacrylic acid. Preferred are acrylic acid and methacrylic acid. In particular, acrylic acid is preferred because this acid is rich in reactivity.

Examples of the α,β-unsaturated monocarboxylic acid ester having a carboxyl group in the ester moiety, which is to be caused to add to the epoxy resin, include 2-succinoyloxyethyl acrylate, 2-malenoyloxyethyl acrylate, 2-phthaloyloxyethyl acrylate, 2-hexahydrophthaloyloxyethyl acrylate, 2-succinoyloxyethyl methacrylate, 2-malenoyloxyethyl methacrylate, 2-phthaloyloxyethyl methacrylate, 2-hexahydrophthaloyloxyethyl methacrylate, and 2-succinoyloxyethyl crotonate. Preferred are 2-malenoyloxyethyl acrylate and 2-phthaloyloxyethyl acrylate. Especially preferred is 2-malenoyloxyethyl acrylate. One of those may be used alone, or two or more thereof may be used in combination.

The addition reaction of the α,β-unsaturated monocarboxylic acid or ester thereof with an epoxy resin can be conducted using a known technique. For example, the reactants may be reacted at a temperature of 50-150° C. in the presence of an esterification catalyst. The addition reaction can be thus carried out. As the esterification catalyst, use can be made of one or more of: tertiary amines such as triethylamine, trimethylamine, benzyldimethylamine, and benzyldiethylamine; quaternary ammonium salts such as tetramethylammonium chloride, tetraethylammonium chloride, and dodecyltrimethylammonium chloride; and the like.

The amount of the α,β-unsaturated monocarboxylic acid or ester thereof to be used is preferably in the range of 0.5-1.2 equivalents, more preferably in the range of 0.7-1.1 equivalent, per equivalent of the epoxy groups of the starting-material epoxy resin. In case where the α,β-unsaturated monocarboxylic acid or ester thereof is used in too small an amount, the amount of unsaturated groups introduced is insufficient and the subsequent reaction with a polybasic acid anhydride is also insufficient. In addition, epoxy groups remain in a large amount, and this also is not advantageous. On the other hand, in case where the α,β-unsaturated monocarboxylic acid or ester thereof is used in too large an amount, the acid or ester partly remains unreacted. In either case, there is a tendency that the resultant epoxy acrylate resin has impaired curing properties.

Examples of the polybasic acid anhydride to be caused to add to the epoxy resin to which an α,β-unsaturated carboxylic acid or ester thereof has added include maleic anhydride, succinic anhydride, itaconic anhydride, phthalic anhydride, tetrahydrophthalic anhydride, hexahydrophthalic anhydride, pyromellitic anhydride, trimellitic anhydride, benzophenonetetracarboxylic acid dianhydride, methylhexahydrophthalic anhydride, endomethylenetetrahydrophthalic anhydride, chlorendic anhydride, methyltetrahydrophthalic anhydride, and biphenyltetracarboxylic acid dianhydride. Preferred are maleic anhydride, succinic anhydride, itaconic anhydride, phthalic anhydride, tetrahydrophthalic anhydride, hexahydrophthalic anhydride, pyromellitic anhydride, trimellitic anhydride, and biphenyltetracarboxylic acid dianhydride. Especially preferred compounds are tetrahydrophthalic anhydride and biphenyltetracarboxylic acid dianhydride. One of these may be used alone, or two or more thereof may be used in combination.

With respect to the addition reaction of the polybasic acid anhydride also, known techniques can be used. The anhydride may be successively reacted under the same conditions as in the addition reaction of the α,β-unsaturated carboxylic acid or ester thereof. This addition reaction can be thus carried out.

The polybasic acid anhydride is caused to add in such an amount that the resultant epoxy acrylate resin (a-5) has an acid value preferably in the range of 10-150 mg-KOH/g, especially preferably in the range of 20-140 mg-KOH/g. When the resin (a-5) has too low an acid value, there are cases where this resin has poor alkali developability. In case where the resin (a-5) has too high an acid value, this resin tends to have poor curability.

Other examples of the epoxy acrylate resin (a-5) having carboxyl groups include the naphthalene-containing resin described in JP-A-6-49174; the fluorene-containing resins described in JP-A-2003-89716, JP-A-2003-165830, JP-A-2005-325331, and JP-A-2001-354735; and the resins described in JP-A-2005-126674, JP-A-2005-55814, and JP-A-2004-295084.

It is also possible to use a commercial epoxy acrylate resin (a-5) having carboxyl groups. Examples of the commercial product include “ACA-200M”, manufactured by Daicel Chemical Ltd.

In the invention, the acrylic binder resin described in, for example, JP-A-2005-154708 can also be used as the binder resin (a).

Especially preferred of the various binder resins described above is the resin (a-1), i.e., a resin obtained from a copolymer of one or more (meth)acrylates containing an epoxy group with other radical-polymerizable monomer(s) by causing an unsaturated monobasic acid to add to at least part of the epoxy groups possessed by the copolymer, or an alkali-soluble resin obtained by causing a polybasic acid anhydride to add to at least part of the hydroxyl groups formed by the addition reaction.

As the binder resin (a) in the invention, one of the various binder resins described above may be used alone or two or more thereof may be used in combination. The various binder resins described above produce the effect that, when used especially in combination with, e.g., the dispersant which will be described later as an optional ingredient, the binder resins do not leave undissolved matter in nonimage areas on the substrate and are capable of forming high-density color pixels having excellent adhesion to the substrate. Those binder resins are hence preferred.

In the colored resin compositions of the invention, the content of the binder resin (a) is generally 0.1% by weight or higher, preferably 1% by weight or higher, and is generally 80% by weight or lower, preferably 60% by weight or lower, based on all solid components. When the content of the binder resin (a) is lower than that range, there are cases where the composition gives a film which is brittle and has reduced adhesion to the substrate. Conversely, when the content thereof is higher than that range, there are cases where a developing solution shows enhanced infiltration into exposed areas, resulting in pixels having impaired surface smoothness and impaired sensitivity.

### [(b) Solvent]

The colored resin compositions of the invention contain a solvent (b) as an essential component. The solvent has the functions of dissolving or dispersing therein ingredients contained in each colored resin composition and of regulating the viscosity.

This solvent (b) may be any solvent in which the ingredients constituting each colored resin composition can be dissolved or dispersed. It is preferred to select a solvent having a boiling point in the range of 100-200° C. More preferred is one having a boiling point of 120-170° C.

Examples of such solvents include the following.

Glycol monoalkyl ethers such as ethylene glycol monomethyl ether, ethylene glycol monoethyl ether, ethylene glycol monopropyl ether, ethylene glycol monobutyl ether, propylene glycol monomethyl ether, propylene glycol mono-t-butyl ether, diethylene glycol monomethyl ether, diethylene glycol monoethyl ether, methoxymethylpentanol, propylene glycol monoethyl ether, dipropylene glycol monoethyl ether, dipropylene glycol monomethyl ether, 3-methyl-3-methoxybutanol, and tripropylene glycol monomethyl ether;

glycol dialkyl ethers such as ethylene glycol dimethyl ether, ethylene glycol diethyl ether, diethylene glycol dimethyl ether, diethylene glycol diethyl ether, diethylene glycol dipropyl ether, and diethylene glycol dibutyl ether;

glycol alkyl ether acetates such as ethylene glycol monomethyl ether acetate, ethylene glycol monoethyl ether acetate, propylene glycol monomethyl ether acetate, propylene glycol monoethyl ether acetate, propylene glycol monopropyl ether acetate, methoxybutyl acetate, 3-methoxybutyl acetate, methoxypentyl acetate, diethylene glycol monoethyl ether acetate, diethylene glycol monobutyl ether acetate, dipropylene glycol monomethyl ether acetate, and 3-methyl-3-methoxybutyl acetate;

ethers such as diethyl ether, dipropyl ether, diisopropyl ether, diamyl ether, ethyl isobutyl ether, and dihexyl ether;

ketones such as acetone, methyl ethyl ketone, methyl amyl ketone, methyl isopropyl ketone, methyl isoamyl ketone, diisopropyl ketone, diisobutyl ketone, methyl isobutyl ketone, cyclohexanone, ethyl amyl ketone, methyl butyl ketone, methyl hexyl ketone, and methyl nonyl ketone;

monohydric or polyhydric alcohols such as ethanol, propanol, butanol, hexanol, cyclohexanol, ethylene glycol, propylene glycol, diethylene glycol, dipropylene glycol, and glycerol;

aliphatic hydrocarbons such as n-pentane, n-octane, diisobutylene, n-hexane, hexene, isoprene, dipentene, and dodecane;

alicyclic hydrocarbons such as cyclohexane, methylcyclohexane, methylcyclohexene, and bicyclohexyl;

aromatic hydrocarbons such as benzene, toluene, xylene, and cumene;

chain or cyclic esters such as amyl formate, ethyl formate, ethyl acetate, butyl acetate, propyl acetate, amyl acetate, methyl isobutyrate, ethylene glycol acetate, ethyl propionate, propyl propionate, butyl butyrate, isobutyl butyrate, methyl isobutyrate, ethyl caprylate, butyl stearate, ethyl benzoate, methyl 3-ethoxypropionate, ethyl 3-ethoxypropionate, methyl 3-methoxypropionate, ethyl 3-methoxypropionate, propyl 3-methoxypropionate, butyl 3-methoxypropionate, and γ-butyrolactone;

alkoxycarboxylic acids such as 3-methoxypropionic acid and 3-ethoxypropionic acid;

halogenated hydrocarbons such as butyl chloride and amyl chloride;

ether ketones such as methoxymethylpentanone; and

nitriles such as acetonitrile and benzonitrile.

Examples of commercial solvents falling under any of those kinds of solvents include Mineral Spirit, Varsol #2, Apco #18 Solvent, Apco Thinner, Socal Solvent No. 1 and No. 2, Solvesso #150, Shell TS28 Solvent, Carbitol, Ethyl Carbitol, Butyl Carbitol, Methyl Cellosolve, Ethyl Cellosolve, Ethyl Cellosolve Acetate, Methyl Cellosolve Acetate, and Diglyme (all of these being trade names).

One of these solvents may be used alone, or two or more thereof may be used in combination.

Glycol monoalkyl ethers are preferred of those solvents from the standpoint of the solubility of the colorant (c) according to the invention. Among these, propylene glycol monomethyl ether is especially preferred from the standpoint of the solubility of various components of each composition.

In the case of a composition in which the pigment (f) which will be described later is, for example, contained as an optional component, it is more preferred that the ether should be mixed with a glycol alkyl ether acetate and this mixture be used as a solvent, because this solvent attains a satisfactory balance among applicability, surface tension, etc. and because the solubility of components of the composition therein is relatively high. It is noted that in the composition containing a pigment (f), glycol monoalkyl ethers tend to aggregate the pigment because of the high polarity of the ethers and there are cases where the glycol monoalkyl ethers reduce the storage stability of the colored resin composition; for example, the ethers increase the viscosity of the composition. It is therefore preferred to use a glycol monoalkyl ether in an amount which is not excessively large. The proportion of the glycol monoalkyl ether in the solvent (b) is preferably 5-50% by weight, more preferably 5-30% by weight.

From the standpoint of suitability for slit-coater coating, which is applicable to recent large substrates, etc., it is also preferred to use a solvent mixture including a solvent having a boiling point of 150° C. or higher. In this case, the content of such a high-boiling solvent is preferably 3-50% by weight, more preferably 5-40% by weight, especially preferably 5-30% by weight, based on the whole solvent (b). When the amount of the high-boiling solvent is too small, there is a possibility that a colorant or another component might deposit/solidify, for example, at the slit nozzle tip to cause foreign-matter defects. In case where the amount thereof is too large, the composition has a reduced drying rate and there is a fear that this composition may arouse problems in the color filter production steps which will be described later, such as tact failures in the vacuum drying process and pin marks after pre-baking.

The solvent having a boiling point of 150° C. or higher may be a glycol alkyl ether acetate or a glycol alkyl ether. In this case, there is no need of separately incorporating a solvent having a boiling point of 150° C. or higher.

The colored resin compositions of the invention may be subjected to color filter production by the ink-jet method. However, in color filter production by the ink jet method, an ink is ejected from the nozzles as extremely fine particles of several picoliters to tens of picoliters and, hence, there is a tendency that solvent vaporization occurs to concentrate or dry and solidify the ink around the nozzle orifices or before the ink droplets are delivered to the pixel banks. From the standpoint of avoiding this trouble, a solvent having a higher boiling point is preferred. Specifically, it is preferred that the solvent (b) should include a solvent having a boiling point of 180° C. or higher. In particular, it is preferred that the solvent (b) should include a solvent having a boiling point of 200° C. or higher, especially 220° C. or higher. It is also preferred that the proportion of the high-boiling solvent having a boiling point of 180° C. or higher in the solvent (b) should be 50% by weight or higher. In case where the proportion of such a high-boiling solvent is lower than 50% by weight, there is a possibility that the effect of preventing solvent vaporization from ink droplets might not be sufficiently produced.

In the colored resin compositions of the invention, the content of the solvent (b) is not particularly limited. However, the upper limit thereof is generally 99% by weight. In case where the content of the solvent (b) in each composition exceeds 99% by weight, there is a possibility that the concentrations of the components other than the solvent (b) might be too low and this composition be unsuitable for coating film formation. On the other hand, the lower limit of the content of the solvent (b) is generally 75% by weight, preferably 80% by weight, more preferably 82% by weight, when viscosity suitable for application, etc. are taken into account.

### [(d) Monomer]

It is preferred that the colored resin compositions of the invention should contain a monomer (d). The monomer (d) is not particularly limited so long as the monomer is a low-molecular compound capable of polymerizing. However, an addition-polymerizable compound having at least one ethylenic double bond (hereinafter sometimes referred to as “ethylenic compound”) is preferred.

The ethylenic compound is a compound having an ethylenic double bond which enables the colored resin compositions of the invention to undergo addition polymerization and cure by the action of the photopolymerization initiation system which will be described later, upon irradiation with actinic rays. The term “monomer (d)” in the invention means a conception which is contrary to the so-called high-molecular substances, and includes dimers, trimers, and oligomers besides monomers in the narrow sense.

Examples of the ethylenic compound include unsaturated carboxylic acids such as (meth)acrylic acid; esters of a monohydroxy compound with an unsaturated carboxylic acid; esters of an aliphatic polyhydroxy compound with an unsaturated carboxylic acid; esters of an aromatic polyhydroxy compound with an unsaturated carboxylic acid; esters obtained by the esterification reaction of an unsaturated carboxylic acid and a polycarboxylic acid with a polyhydroxy compound, such as the aliphatic polyhydroxy compound or aromatic polyhydroxy compound; and ethylenic compounds having a urethane framework obtained by reacting a polyisocyanate compound with a (meth)acryloyl-containing hydroxy compound.

Examples of the esters of an aliphatic polyhydroxy compound with an unsaturated carboxylic acid include (meth)acrylic esters such as ethylene glycol di(meth)acrylate, triethylene glycol di(meth)acrylate, trimethylolpropane tri(meth)acrylate, trimethylolethane tri(meth)acrylate, pentaerythritol di(meth)acrylate, pentaerythritol tri(meth)acrylate, pentaerythritol tetra(meth)acrylate, dipentaerythritol tetra(meth)acrylate, dipentaerythritol penta(meth)acrylate, dipentaerythritol hexa(meth)acrylate, and glycerol (meth)acrylate. Examples thereof further include itaconic esters, crotonic esters, or maleic esters respectively having the structures formed by replacing the (meth)acrylic acid moiety of each of these (meth)acrylic esters with an itaconic acid moiety, crotonic acid moiety, or maleic acid moiety.

Examples of the esters of an aromatic polyhydroxy compound with an unsaturated carboxylic acid include hydroquinone di(meth)acrylate, resorcinol di(meth)acrylate, and pyrogallol tri(meth)acrylate.

The esters obtained by the esterification reaction of an unsaturated carboxylic acid and a polycarboxylic acid with a polyhydroxy compound each need not always be a single substance and may be a mixture. Representative examples thereof include condensates of (meth)acrylic acid, phthalic acid, and ethylene glycol; condensates of (meth)acrylic acid, maleic acid, and diethylene glycol; condensates of (meth)acrylic acid, terephthalic acid, and pentaerythritol; and condensates of (meth)acrylic acid, adipic acid, butanediol, and glycerol.

Examples of the ethylenic compounds having a urethane framework obtained by reacting a polyisocyanate compound with a (meth)acryloyl-containing hydroxy compound include products of the reaction of an aliphatic diisocyanate such as hexamethylene diisocyanate or trimethylhexamethylene diisocyanate, an alicyclic diisocyanate such as cyclohexane diisocyanate or isophorone diisocyanate, or an aromatic diisocyanate such as tolylene diisocyanate or diphenylmethane diisocyanate with a (meth)acryloyl-containing hydroxy compound such as 2-hydroxyethyl (meth)acrylate or 3-hydroxy [1,1,1-tri(meth)acryloyloxymethyl]propane.

Other examples of the ethylenic compound usable in the invention include (meth)acrylamide compounds such as ethylenebis(meth)acrylamide; allyl esters such as diallyl phthalate; and vinyl-group-containing compounds such as divinyl phthalate.

Preferred of these are esters of an aliphatic polyhydroxy compound with an unsaturated carboxylic acid. More preferred are (meth)acrylic esters of pentaerythritol or dipentaerythritol. Especially preferred is dipentaerythritol hexa(meth)acrylate.

The ethylenic compound may be a monomer having an acid value. For example, the monomer having an acid value preferably is a polyfunctional monomer which is an ester of an aliphatic polyhydroxy compound with an unsaturated carboxylic acid and in which the unreacted hydroxy groups of the aliphatic polyhydroxy compound have been reacted with a non-aromatic carboxylic acid anhydride to introduce acid groups into the ester. This ester especially preferably is one in which the aliphatic polyhydroxy compound is pentaerythritol and/or dipentaerythritol.

One of these monomers may be used alone. However, a mixture of two or more thereof may be used since it is difficult to obtain a single compound because of the nature of the production.

According to need, a polyfunctional monomer having no acid group and a polyfunctional monomer having acid groups may be used in combination as the monomer (d).

The acid value of the polyfunctional monomer having acid groups is preferably 0.1-40 mg-KOH/g, especially preferably 5-30 mg-KOH/g. In case where the acid value of this polyfunctional monomer is too low, developability/solubility tends to decrease. When the acid value thereof is too high, there are cases where it is difficult to produce or handle the monomer. There also are cases where use of such a polyfunctional monomer results in a decrease in photopolymerizability or in poor curability, e.g., poor surface smoothness of pixels. Consequently, in the case where two or more polyfunctional monomers differing in acid group are used in combination or where a combination including a polyfunctional monomer having no acid group is used, it is preferred to regulate the polyfunctional monomers as a whole so as to have an acid group within the range shown above.

More preferred polyfunctional monomers having acid groups in the invention are a mixture including, as main components, succinic acid esters of dipentaerythritol hexaacrylate, dipentaerythriol pentaacrylate, and dipentaerythritol pentaacrylate, this mixture being commercially available as “TO 1382”, manufactured by Toagosei Co., Ltd. It is also possible to use these polyfunctional monomers in combination with other polyfunctional monomers.

In the colored resin compositions of the invention, the content of those monomers (d) is generally 1% by weight or higher, preferably 5% by weight or higher, more preferably 10% by weight or higher, and is generally 80% by weight or lower, preferably 70% by weight or lower, more preferably 50% by weight or lower, especially preferably 40% by weight or lower, based all solid components. The proportion of the monomer (d) to the colorant (c) described above is generally 1% by weight or higher, preferably 5% by weight or higher, more preferably 10% by weight or higher, especially preferably 20% by weight or higher, and is generally 200% by weight or lower, preferably 100% by weight or lower, more preferably 80% by weight or lower.

In case where the amount of the monomer (d) in each colored resin composition is too small, there is a possibility that photocuring might be insufficient and this might cause adhesion failure during development. Conversely, when the amount thereof is too large, there are cases where the composition undergoes excessive photocuring, resulting in a developed pattern having an inversely tapered section or where the composition has reduced solubility and this is causative of a peeling phenomenon or blind spot defects.

[(e) Photopolymerization Initiation System and/or Heat Polymerization Initiation System]

It is preferred that the colored resin compositions of the invention should contain a photopolymerization initiation system and/or heat polymerization initiation system (e) for the purpose of curing a coating film. However, the compositions may be cured by a method in which neither of these initiator systems is used.

Especially in the case of a colored resin composition of the invention which contains a resin having ethylenic double bonds as ingredient (a) or contains an ethylenic compound as ingredient (d), it is preferred that this composition should contain a photopolymerization initiation system which has the function of directly absorbing light or being photosensitized to induce a decomposition reaction or hydrogen abstraction reaction and generate radicals that are active in polymerization and/or a heat polymerization initiation system which thermally generates radicals that are active in polymerization. In the invention, ingredient (e) as a photopolymerization initiation system means a mixture including a photopolymerization initiator (hereinafter occasionally referred to as ingredient (e1)) and, used in combination therewith, an additive such as a polymerization accelerator (hereinafter occasionally referred to as ingredient (e2)) or a sensitizing dye (hereinafter occasionally referred to as ingredient (e3)).

### <Photopolymerization Initiation System>

The photopolymerization initiation system which may be contained in the colored resin compositions of the invention is usually used as a mixture of a photopolymerization initiator (e) and an additive optionally added, such as a sensitizing dye (e3) or a polymerization accelerator (e2). This is an ingredient which has the function of directly absorbing light or being photosensitized to induce a decomposition reaction or hydrogen abstraction reaction and generate radicals that are active in polymerization.

Examples of the photopolymerization initiator (e1) which constitutes the photopolymerization initiation system include the titanocene derivatives described in JP-A-59-152396, JP-A-61-151197, etc.; the hexaarylbiimidazole derivatives described in JP-A-10-300922, JP-A-11-174224, JP-A-2000-56118, etc.; the halomethylated oxadiazole derivatives, halomethyl-s-triazine derivatives, radical activators such as N-aryl-α-amino acids, e.g., N-phenylglycine, N-aryl-α-amino acid salts, and N-aryl-α-amino acid esters, and α-aminoalkylphenone derivatives described in JP-A-10-39503, etc.; and the oxime ester derivatives described in JP-A-2000-80068, etc.

Specifically, examples of the titanocene derivatives include dicyclopentadienyltitanium dichloride, dicyclopentadienyltitanium bisphenyl, dicyclopentadienyltitanium bis(2,3,4,5,6-pentafluorophen-1-yl), dicyclopentadienyltitanium bis(2,3,5,6-tetrafluorophen-1-yl), dicyclopentadienyltitanium bis(2,4,6-trifluorophen-1-yl), dicyclopentadienyltitanium di(2,6-difluorophen-1-yl), dicyclopentadienyltitanium di(2,4-difluorophen-1-yl), di(methylcyclopentadienyl)titanium bis(2,3,4,5,6-pentafluorophen-1-yl), di(methylcyclopentadienyl)titanium bis(2,6-difluorophen-1-yl), and dicyclopentadienyltitanium [2,6-difluoro-3-(pyrro-1-yl)phen-1-yl].

Examples of the bisimidazole derivatives include 2-(2′-chlorophenyl)-4,5-diphenylimidazole dimer, 2-(2′-chlorophenyl)-4,5-bis(3′-methoxyphenyl)imidazole dimer, 2-(2′-fluorophenyl)-4,5-diphenylimidazole dimer, 242′-methoxyphenyl)-4,5-diphenylimidazole dimer, and (4′-methoxyphenyl)-4,5-diphenylimidazole dimer.

Examples of the halomethylated oxadiazole derivatives include 2-trichloromethyl-5-(2′-benzofuryl)-1,3,4-oxadiazole, 2-trichloromethyl-5-[β-(2′-benzofuryl)vinyl]-1,3,4-oxadiazole, 2-trichloromethyl-5-[β-(2′-(6″-benzofuryl)vinyl]-1,3,4-oxadiazole, and 2-trichloromethyl-5-furyl-1,3,4-oxadiazole.

Examples of the halomethyl-s-triazine derivatives include 2-(4-methoxyphenyl)-4,6-bis(trichloromethyl)-s-triazine, 2-(4-methoxynaphthyl)-4,6-bis(trichloromethyl)-s-triazine, 2-(4-ethoxynaphthyl)-4,6-bis(trichloromethyl)-s-triazine, and 2-(4-ethoxycarbonylnaphthyl)-4,6-bis(trichloromethyl)-s-triazine.

Examples of the α-aminoalkylphenone derivatives include 2-methyl-1-[4-(methylthio)phenyl]-2-morpholinopropan-1-one, 2-benzyl-2-dimethylamino-1-(4-morpholinophenyl)butanone-1,2-benzyl-2-dimethylamino-1-(4-morpholinophenyl)butan-1-one, 4-dimethylaminoethyl benzoate, 4-dimethylaminoisoamyl benzoate, 4-diethylaminoacetophenone, 4-dimethylaminopropiophenone, 2-ethylhexyl 1,4-dimethylaminobenzoate, 2,5-bis(4-diethylaminobenzal)cyclohexanone, 7-diethylamino-3-(4-diethylaminobenzoyl)coumarin, and 4-(diethylamino)chalcone.

Examples of the oxime ester derivatives include 1,2-octanedione, 1-[4-(phenylthio)phenyl], 2-(o-benzoyloxime), ethanone, 1-[9-ethyl-6-(2-methylbenzoyl)-9H-carbazol-3-yl], and 1-(o-acetyloxime).

Other examples include benzoin alkyl ethers such as benzoin methyl ether, benzoin phenyl ether, benzoin isobutyl ether, and benzoin isopropyl ether; anthraquinone derivatives such as 2-methylanthraquinone, 2-ethylanthraquinone, 2-t-butylanthraquinone, and 1-chloroanthraquinone; acetophenone derivatives such as 2,2-dimethoxy-2-phenylacetophenone, 2,2-diethoxyacetophenone, 1-hydroxycyclohexyl phenyl ketone, α-hydroxy-2-methylphenylpropanone, 1-hydroxy-1-methylethyl p-isopropylphenyl ketone, 1-hydroxy-1-(p-dodecylphenyl) ketone, 2-methyl-(4′-methylthiophenyl)-2-morpholino-1-propanone, and 1,1,1-trichloromethyl p-butylphenyl ketone; thioxanthone and thioxanthone derivatives such as 2-ethylthioxanthone, 2-isopropylthioxanthone, 2-chlorothioxanthone, 2,4-dimethylthioxanthone, 2,4-diethylthioxanthone, and 2,4-diisopropylthioxanthone; benzoic ester derivatives such as ethyl p-dimethylaminobenzoate and ethyl p-diethylaminobenzoate; acridine derivatives such as 9-phenylacridine and 9-(p-methoxyphenyl)acridine; phenazine derivatives such as 9,10-dimethylbenzphenazine; and anthrone derivatives such as benzanthrone.

More preferred of these photopolymerization initiators are α-aminoalkylphenone derivatives and thioxanthone and derivatives thereof.

Examples of the polymerization accelerator (e2), which is used according to need, include N,N-dialkylaminobenzoic acid alkyl esters such as ethyl N,N-dimethylaminobenzoate; mercapto compounds having a heterocycle, such as 2-mercaptobenzothiazole, 2-mercaptobenzoxazole, and 2-mercaptobenzimidazole; and mercapto compounds such as aliphatic polyfunctional mercapto compounds.

One of those photopolymerization initiators (e1) and one of those polymerization accelerators (e2) may be used alone, or two or more of the initiators (e1) or accelerators (e2) may be used in combination.

A sensitizing dye (e3) is used according to need for the purpose of heightening sensitivity. A suitable sensitizing dye is used according to the wavelength of the light source for imagewise exposure. Examples thereof include the xanthene dyes described in JP-A-4-221958, JP-A-4-219756, etc.; the coumarin dyes having a heterocycle described in JP-A-3-239703, JP-A-5-289335, etc.; the 3-ketocoumarin dyes described in JP-A-3-239703, JP-A-5-289335, etc.; the pyrromethene dyes described in JP-A-6-19240, etc.; and the dyes having a dialkylaminobenzene framework described in JP-A-47-2528, JP-A-54-155292, JP-B-45-37377, JP-A-48-84183, JP-A-52-112681, JP-A-58-15503, JP-A-60-88005, JP-A-59-56403, JP-A-2-69, JP-A-57-168088, JP-A-5-107761, JP-A-5-210240, JP-A-4-288818, etc.

Preferred of these sensitizing dyes are sensitizing dyes containing an amino group. More preferred are compounds having an amino group and a phenyl group in the same molecule. Especially preferred sensitizing dyes are benzophenone compounds such as 4,4′-dimethylaminobenzophenone, 4,4′-diethylaminobenzophenone, 2-aminobenzophenone, 4-aminobenzophenone, 4,4′-diaminobenzophenone, 3,3′-diaminobenzophenone, and 3,4-diaminobenzophenone; and compounds containing a p-dialkylaminophenyl group, such as 2-(p-dimethylaminophenyl)benzoxazole, 2-(p-diethylaminophenyl)benzoxazole, 2-(p-dimethylaminophenyl)benzo[4,5]benzoxazole, 2-(p-dimethylaminophenyl)benzo[6,7]benzoxazole, 2,5-bis(p-diethylaminophenyl)-1,3,4-oxazole, 2-(p-dimethylaminophenyl)benzothiazole, 2-(p-diethylaminophenyl)benzothiazole, 2-(p-dimethylaminophenyl)benzimidazole, 2-(p-diethylaminophenyl)benzimidazole, 2,5-bis(p-diethylaminophenyl)-1,3,4-thiazole, (p-dimethylaminophenyl)pyridine, (p-diethylaminophenyl)pyridine, (p-dimethylaminophenyl)quinoline, (p-diethylaminophenyl)quinoline, (p-dimethylaminophenyl)pyrimidine, and (p-diethylaminophenyl)pyrimidine. Most preferred of these are the 4,4′-dialkylaminobenzophenones such as 4,4′-dimethylaminobenzophenone and 4,4′-diethylaminobenzophenone.

With respect to the sensitizing dye (e3) also, one compound may be used alone or two or more compounds may be used in combination.

In the colored resin compositions of the invention, the content of the photopolymerization initiation system (e) is generally 0.1% by weight or higher, preferably 0.2% by weight or higher, more preferably 0.5% by weight or higher, and is generally 40% by weight or lower, preferably 30% by weight or lower, more preferably 20% by weight or lower, based on all solid components. When the content thereof is exceedingly low, there are cases where the low content is causative of a decrease in sensitivity to exposure light. Conversely, when the content thereof is exceedingly high, there are cases where unexposed areas have reduced solubility in a developing solution, resulting in development failures.

### <Heat Polymerization Initiation System>

Examples of the heat polymerization initiation system (heat polymerization initiator) which may be contained in the colored resin compositions of the invention include azo compounds, organic peroxides, and hydrogen peroxide. Of these, azo compounds are suitable for use.

Examples of the azo compounds include 2,2′-azobisisobutyronitrile, 2,2′-azobis(2-methylbutyronitrile), 1,1′-azobis(cyclohexene-1-carbonitrile), 2,2′-azobis(2,4-dimethylvaleronitrile), 1-[(1-cyano-1-methylethyl)azo]formamido(2-carbamoylazo)isobutyronitrile), 2,2-azobis{2-methyl-N-[1,1-bis(hydroxymethyl)-2-hydroxyethyl]propionamide}, 2,2′-azobis[N-(2-propenyl)-2-methylpropionamide], 2,2′-azobis[N-(2-propenyl)-2-ethylpropionamide], 2,2′-azobis[N-butyl-2-methylpropionamide], 2,2′-azobis(N-cyclohexyl-2-methylpropionamide), 2,2′-azobis(dimethyl-2-methylpropionamide), 2,2′-azobis(dimethyl-2-methylpropionate), and 2,2′-azobis(2,4,4-trimethylpentene. Preferred of these are 2,2′-azobisisobutyronitrile, 2,2′-azobis(2,4-dimethylvaleronitrile), and the like.

Examples of the organic peroxides include benzoyl peroxide, di-t-butyl peroxide, and cumene hydroperoxide. Specific examples thereof include diisobutyryl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, di(4-t-butylcyclohexyl) peroxydicarbonate, 1-cyclohexyl-1-methylethyl peroxyneodecanoate, di(2-ethoxyethyl) peroxydicarbonate, di(2-ethylhexyl) peroxydicarbonate, t-hexyl peroxyneodecanoate, dimethoxybutyl peroxydicarbonate, t-butyl peroxyneodecanoate, t-hexyl peroxypivalate, t-butyl peroxypivalate, di(3,5,5-trimethylhexanoyl) peroxide, di-n-octanoyl peroxide, dilauroyl peroxide, distearoyl peroxide, 1,1,3,3-tetramethylbutyl peroxy-2-ethylhexanoate, 2,5-dimethyl-2,5-di(2-ethylhexanoylperoxy)hexane, t-hexyl peroxy-2-ethylhexanoate, di(4-methylbenzoyl) peroxide, t-butyl peroxy-2-ethylhexanoate, dibenzoyl peroxide, t-butyl peroxyisobutyrate, 1,1-di(t-butylperoxy)-2-methylcyclohexane, 1,1-di(t-hexylperoxy)-3,3,5-trimethylcyclohexane, 1,1-di(t-hexylpeoxy)cyclohexane, 1,1-di(t-butylperoxy)cyclohexane, 2,2-di(4,4-di(t-butylperoxy)cyclohexyl)propane, t-hexyl peroxyisopropylmonocarbonate, t-butyl peroxymaleate, t-butyl peroxy-3,5,5-trimethylhexanoate, t-butyl peroxylaurate, 2,5-dimethyl-2,5-di(3-methylbenzoylperoxy)hexane, t-butyl peroxyisopropylmonocarbonate, t-butyl peroxy-2-ethylhexylmonocarbonate, t-hexyl peroxybenzoate, 2,5-dimethyl-2,5-di(benzoylperoxy)hexane, t-butyl peroxyacetate, 2,2-di(t-butylperoxy)butane, t-butyl peroxybenzoate, n-butyl 4,4-di(t-butylperoxy)valerate, di(2-t-butylperoxyisopropyl)benzene, dicumyl peroxide, di-t-hexyl peroxide, 2,5-dimethyl-2,5-di(t-butylperoxy)hexane, di-t-butyl peroxide, p-menthane hydroperoxide, 2,5-dimethyl-2,5-di(t-butylperoxy)hexyne-3, diisopropylbenzene hydroperoxide, 1,1,3,3-tetramethylbutyl hydroperoxide, cumene hydroperoxide, t-butyl hydroperoxide, t-butyl trimethylsilyl peroxide, 2,3-dimethyl-2,3-diphenylbutane, and mixtures of di(3-methylbenzoyl) peroxide, benzoyl 3-methylbenzoyl peroxide, and dibenzoyl peroxide.

One of these heat polymerization initiators may be used alone, or two or more thereof may be used in combination.

When the proportion of the heat polymerization initiator in each colored resin composition is too small, film curing is insufficient and there are cases where the resultant color filter has insufficient durability. In case where the proportion thereof is too large, the composition shows enhanced heat shrinkage and there is a possibility that the heat-cured film might have cracks. In addition, this composition tends to have reduced storage stability. Consequently, the content of the heat polymerization initiator is preferably regulated to a value in the range of 0-30% by weight, in particular, 0-20% by weight, based on all solid components of each colored resin composition of the invention.

### [(f) Pigment]

The colored resin compositions of the invention may contain a pigment (f) for the purpose of, for example, improving heat resistance, so long as the incorporation thereof does not lessen the effects of the invention.

As the pigment (f), pigments of various colors including blue and violet can be used, for example, in the case where pixels of a color filter or the like is formed. Examples of the chemical structure thereof include organic pigments of the phthalocyanine, quinacridone, benzimidazolone, dioxazine, indanthrene, and perylene types. Besides these, various inorganic pigments and other pigments can be used. Specific examples of usable pigments are shown below in terms of pigment number. In the following, “C.I.” means Color Index (C.I.).

Examples of the blue pigments include C.I. Pigment Blue 1, 1:2, 9, 14, 15, 15:1, 15:2, 15:3, 15:4, 15:6, 16, 17, 19, 25, 27, 28, 29, 33, 35, 36, 56, 56:1, 60, 61, 61:1, 62, 63, 66, 67, 68, 71, 72, 73, 74, 75, 76, 78, and 79. Preferred of these are C.I. Pigment Blue 15, 15:1, 15:2, 15:3, 15:4, 15:6, and the like. More preferred is C.I. Pigment Blue 15:6.

Examples of the violet pigments include C.I. Pigment Violet 1, 1:1, 2, 2:2, 3, 3:1, 3:3, 5, 5:1, 14, 15, 16, 19, 23, 25, 27, 29, 31, 32, 37, 39, 42, 44, 47, 49, and 50. Preferred of these are C.I. Pigment Violet 19, 23, and the like. More preferred is C.I. Pigment Violet 23.

Examples of the inorganic pigments include barium sulfate, lead sulfate, titanium oxide, chrome yellow, red iron oxide, and chromium oxide.

Multiple kinds of pigments selected from the various pigments may be used in combination. For example, a blue pigment and a violet pigment can be used in combination in order to regulate chromaticity.

Those pigments are used after having undergone a dispersion treatment so that the pigments in each colored resin composition have an average particle diameter of generally 1 μm or smaller, preferably 0.5 μm or smaller, more preferably 0.3 μm or smaller.

In the colored resin compositions of the invention, the content of those pigments (f) is generally 80% by weight or lower, preferably 50% by weight or lower, based on all solid components. Furthermore, the amount of the pigments (f) contained per 100 parts by weight of the colorant (c) described hereinabove is generally 2,000 parts by weight or smaller, preferably 1,000 parts by weight or smaller. In case where the proportion of the pigments (f) is too large, the effect of combining high color reproducibility and high luminance which is brought about by the colorant (c) according to the invention is lessened.

### [Optional Ingredients]

The colored resin compositions of the invention may contain surfactants, organic carboxylic acids and/or organic carboxylic acid anhydrides, plasticizers, dyes other than the colorant (c) described hereinabove according to the invention, heat polymerization inhibitors, storage stabilizers, surface-protective agents, adhesion improvers, developability improvers, and the like, besides the ingredients described above. In the case where the compositions contain the pigment (f) as a coloring agent, the compositions may contain a dispersant or dispersion aid. As those optional ingredients, use can be made of the various compounds described in, e.g., JP-A-2007-113000.

### [Method for Preparing the Colored Resin Compositions]

A method for preparing each colored resin composition of the invention is explained below.

First, the colorant (c) according to the invention described above is mixed with a binder resin (a) and a solvent (b) as essential ingredients and optionally with a monomer (d), a photopolymerization initiation system and/or heat polymerization initiation system (e), a surfactant, and other ingredients as optional ingredients to obtain a homogenous solution and thereby obtain a colored resin composition. When these ingredients are mixed together, it is preferred to stir the mixture until the colorant (c) dissolves sufficiently. It is also preferred to filter the resultant inky liquid through a filter or the like because there are cases where minute dust particles come into the mixture during the steps of mixing, etc.

In the case where a pigment (f) is also used as a coloring agent, use may be made of a method in which the colorant (c) according to the invention described above, the pigment (f), a solvent (b), and optional ingredients such as a dispersant or a dispersion aid are first weighed out in respective given amounts and subjected to a dispersion step, in which the pigment (f) is sufficiently dispersed to obtain an inky liquid. In this dispersion step, use can be made of a paint shaker, sand grinder, ball mill, roll mill, stone mill, jet mill, homogenizer, or the like. This dispersion treatment reduces the pigment (f) into fine particles. Consequently, the colored resin composition has improved applicability, and products such as color filter substrates have an improved transmittance.

When the pigment (f) is subjected to the dispersion treatment, it is preferred to use part of a binder resin (a) as a dispersant or to suitably use a dispersion aid or the like. In the case where a paint shaker or a sand grinder is used to conduct the dispersion treatment, it is preferred to use glass beads or zirconia beads having a diameter of from 0.1 mm to several millimeters. A temperature for the dispersion treatment is set at a value which is generally 0° C. or higher, preferably room temperature or higher, and is generally 100° C. or lower, preferably 80° C. or lower. With respect to the time period of dispersion, it is necessary to suitably regulate the time period because proper time period varies depending on the composition of the inky liquid and the apparatus size, etc. of the sand grinder.

The inky liquid obtained by the dispersion treatment is further mixed with a binder resin (a) and a solvent (b) as essential ingredients and optionally with a monomer (d), a photopolymerization initiation system and/or heat polymerization initiation system (e), a surfactant, and other ingredients as optional ingredients to give a homogenous dispersion solution. Thus, a colored resin composition is obtained. It is preferred to filter the resultant inky liquid through a filter or the like because there are cases where minute dust particles come into the mixture during the dispersion step and the steps of mixing.

### [Applications of the Colored Resin Compositions]

In the colored resin compositions of the invention, all components are usually in the state of being dissolved or dispersed in the solvent. Such a colored resin composition is supplied to a surface of a substrate to form a color filter or a constituent member for a liquid-crystal display device, organic EL display, or the like.

Application to pixels of a color filter and a liquid-crystal display device (panel) and an organic EL display both employing the color filter are explained below as examples of applications of the colored resin compositions of the invention.

### <Pixels of Color Filter>

Pixels of a color filter can be formed by various methods as will be described later. Here, the formation of pixels by photolithography using a photopolymerizable colored resin composition is explained in detail as an example. However, production processes should not be construed as being limited to the example.

A transparent substrate which is transparent and has appropriate strength may be used for the color filter without particular limitations on the material thereof. Examples of the material thereof include sheets made of thermoplastic resins such as polyester resins, e.g., poly(ethylene terephthalate), polyolefin resins, e.g., polypropylene and polyethylene, polycarbonate resins, acrylic resins, e.g., poly(methyl methacrylate), and polysulfone resins; sheets formed from thermosetting resins such as epoxy resins and unsaturated polyester resins; and various glasses. From the standpoint of heat resistance, glasses and heat-resistant resins are preferred of these. For the purpose of improving surface properties such as bondability, those transparent substrates may be subjected, according to need, to a surface treatment, such as corona discharge treatment or ozone treatment, or a thin-film formation treatment with a silane coupling agent or any of various resins including urethane resins. Such transparent substrates have a thickness which is generally 0.05 mm or larger, preferably 0.1 mm or larger, and is generally 10 mm or smaller, preferably 7 mm or smaller. In the case where the thin-film formation treatment with any of various resins is to be conducted, the thickness of the film is generally 0.01 μm or larger, preferably 0.05 μm or larger, and is generally 10 μm or smaller, preferably 5 μm or smaller.

A black matrix is formed on the transparent substrate described above, and pixel images of usually red, green, and blue colors are further formed thereon, whereby a color filter can be produced.

The block matrix is formed on the transparent substrate using a light-shielding metallic thin film or a colored resin composition of the invention.

As the light-shielding metallic material, use is made of chromium metal, a chromium compound such as chromium oxide or chromium nitride, an alloy of nickel and tungsten, or the like. A multilayer structure composed of superposed multiple layers of these materials may also be used. These light-shielding metallic thin films are generally formed by sputtering, and a filmy desired pattern is formed therefrom with a positive photoresist.

Chromium is etched with an etchant prepared by mixing ammonium ceric nitrate with perchloric acid and/or nitric acid, while other materials are etched with etchants suitable for the materials. Finally, the positive photoresist is removed with a remover therefor. Thus, a black matrix can be formed. In this case, a thin film of any of those metals or a metal/metal-oxide thin film is first formed on a transparent substrate by vapor deposition, sputtering, or the like. Subsequently, a coating film of a resin composition for positive photoresist is formed on the thin film. Next, a photomask having a repeated stripe, mosaic, triangle, or another pattern is used to expose the coating film, and this coating film is developed to form an image. Thereafter, this coating film is etched, whereby a black matrix can be formed.

Alternatively, a photocurable colored resin composition containing a black pigment (f) may be used to form a black matrix. For example, a colored resin composition containing one or more of black pigments, such as carbon black, graphite, iron black, and titanium black, or containing a black pigment obtained by mixing pigments, such as red, green, and blue pigments, that have been suitable selected from inorganic or organic pigments can be used to form a black matrix in the same manner as for the formation of a red, green, or blue pixel image which will be described later.

A colored resin composition of a black color is applied on a transparent substrate, while colored resin compositions of red, green, and blue colors are applied on either a resinous black matrix formed on a transparent substrate or a metallic black matrix formed from a chromium compound or another light-shielding metallic material. The colored resin compositions applied are subjected to thermal drying, imagewise exposure, development, and heat curing. Thus, pixel images of the respective colors are formed.

A colored resin composition containing a colorant of one color selected from red, green, and blue colors is applied to a transparent substrate on which a black matrix has been formed. The resin composition applied is dried. Thereafter, a photomask is superposed on the coating film, and this coating film is imagewise exposed to light through the photomask, developed, and heat-cured or photocured according to need to thereby form a pixel image. Thus, a colored layer is produced. This operation is performed with respect to each of colored resin compositions of three colors, i.e., red, green, and blue, whereby a color filter image can be formed.

The colored resin compositions of the invention are especially suitable for use in forming blue pixels here.

Examples of methods for supplying the colored resin compositions to the substrate include conventionally known methods such as the spinner method, wire-wound bar method, flow coating method, slit-and-spin method, die coating method, roll coating method, and spray coating method. Preferred of these are the slit-and-spin method and die coating method. The colored resin compositions of the invention are less apt to generate aggregates at the tip of the disperser nozzle and, hence, can provide a coating film having a smooth and beautiful surface without reducing yield. In addition, the colored resin compositions neither cause coating unevenness when applied, nor cause drying unevenness or the like through the subsequent drying step. The coating compositions can form a layer having an extremely smooth surface through an exposure step, development step, heat treatment step, etc.

Coating conditions in the slit-and-spin method and die coating method may be suitably selected according to the makeup of each colored resin composition, kind of the color filter to be produced, etc. For example, in each of the two methods, it is preferred that the nozzle tip should be regulated so as to have a lip width of 50-500 μm and the spacing between the nozzle tip and the substrate surface should be regulated to 30-300 μm.

In the die coating method, the thickness of the coating film may be regulated by regulating the lip travelling speed and the amount of the liquid colored resin composition being discharged through the lips. In the slit-and-spin method, the thickness of the coating film may be regulated mainly by changing the spin rotation speed and rotation period after slit coating.

With respect to the thickness of the coating film, too large thicknesses result in cases where pattern development is difficult and gap regulation in a liquid-crystal cell fabrication step is difficult. On the other hand, when too thin a coating film is to be formed, difficulties are encountered in heightening pigment concentration and there are cases where a desired color cannot be produced. The thickness of the coating film, in terms of film thickness on a dry basis, is generally 0.2 μm or larger, preferably 0.5 μm or larger, more preferably 0.8 μm or larger, and is generally 20 μm or smaller, preferably 10 μm or smaller, more preferably 5 μm or smaller.

It is preferred that after each colored resin composition has been applied to the substrate, the coating film should be dried by a drying method using a hot plate, IR oven, or convection oven. Usually, the coating film is subjected to predrying and is then reheated and dried.

Conditions of the predrying, including temperature and drying time, are suitably selected according to the kind of the solvent ingredient, performance of the dryer to be used, etc. Specifically, however, the drying temperature is generally 40° C. or higher, preferably 50° C. or higher, and is generally 80° C. or lower, preferably 70° C. or lower, and the drying time is generally 15 seconds or longer, preferably 30 seconds or longer, and is generally 5 minutes or shorter, preferably 3 minutes or shorter.

With respect to temperature conditions of the reheating/drying, a temperature higher than the predrying temperature is preferred. Specifically, the reheating/drying temperature is generally 50° C. or higher, preferably 70° C. or higher, and is generally 200° C. or lower, preferably 160° C. or lower, especially preferably 130° C. or lower. The drying is preferably conducted for a period which is generally 10 seconds or longer, preferably 15 seconds or longer, and is generally 10 minutes or shorter, preferably 5 minutes or shorter, although the drying time depends on heating temperature. The higher the heating temperature, the more the adhesion to the transparent substrate improves. However, too high heating temperatures may result in cases where the binder resin decomposes to induce heat polymerization and cause development failures. Incidentally, for the step of drying this coating film, a vacuum drying method may be used in which the coating film is dried in a vacuum chamber without elevating temperature.

In the imagewise exposure, a negative matrix pattern is superposed on the coating film of a colored resin composition, and the coating film is irradiated through this mask pattern with light using a light source for ultraviolet or visible rays. In this operation, before the photopolymerizable layer formed from a colored resin composition is subjected to exposure, an oxygen barrier layer, e.g., a poly(vinyl alcohol) layer, may be formed according to need on the photopolymerizable layer in order to prevent the photopolymerizable layer from being reduced in sensitivity by oxygen.

The light source to be used for the imagewise exposure is not particularly limited. Examples of the light source include lamp light sources such as a xenon lamp, halogen lamp, tungsten lamp, high-pressure mercury lamp, extra-high-pressure mercury lamp, metal halide lamp, medium-pressure mercury lamp, low-pressure mercury lamp, carbon arc, and fluorescent lamp; and laser light sources such as an argon ion laser, YAG laser, excimer laser, nitrogen laser, helium-cadmium laser, and semiconductor laser. In the case where light having a specific wavelength is to be used for irradiation, an optical filter may be utilized.

After the coating film of a colored resin composition is imagewise exposed to light using the light source, the coating film is developed with an organic solvent or an aqueous solution containing a surfactant and an alkaline compound to thereby form an image on the substrate. Thus, a color filter can be produced. The aqueous solution can further contain an organic solvent, a buffering agent, a complexing agent, and a dye or pigment.

Examples of the alkaline compound include inorganic alkaline compounds such as sodium hydroxide, potassium hydroxide, lithium hydroxide, sodium carbonate, potassium carbonate, sodium hydrogen carbonate, potassium hydrogen carbonate, sodium silicate, potassium silicate, sodium metasilicate, sodium phosphate, potassium phosphate, sodium hydrogen phosphate, potassium hydrogen phosphate, sodium dihydrogen phosphate, potassium dihydrogen phosphate, and ammonium hydroxide; and organic alkaline compounds such as mono-, di-, or triethanolamine, mono-, di-, or trimethylamine, mono-, di-, or triethylamine, mono- or diisopropylamine, n-butylamine, mono-, di-, or triisopropanolamine, ethyleneimine, ethylenediimine, tetramethylammonium hydroxide (TMAH), and choline. One of these alkaline compounds may be used alone, or two or more thereof may be used in combination.

Examples of the surfactant include nonionic surfactants such as polyoxyethylene alkyl ethers, polyoxyethylene alkylaryl ethers, polyoxyethylene alkyl esters, sorbitan alkyl esters, and monoglyceride alkyl esters; anionic surfactants such as alkylbenzenesulfonic acid salts, alkylnaphthalenesulfonic acid salts, alkylsulfuric acid salts, alkylsulfonic acid salts, and sulfosuccinic acid ester salts; and amphoteric surfactants such as alkylbetaines and amino acids. One of these surfactants may be used alone, or two or more thereof may be used in combination.

Examples of the organic solvent include isopropyl alcohol, benzyl alcohol, ethyl Cellosolve, butyl Cellosolve, phenyl Cellosolve, propylene glycol, and diacetone alcohol. One of such organic solvents may be used alone, or two or more solvents may be used as a mixture thereof. An organic solvent may be used in combination with an aqueous solution.

Conditions of the development are not particularly limited. The development is preferably conducted at a temperature which is generally 10° C. or higher, especially 15° C. or higher, in particular 20° C. or higher, and is generally 50° C. or lower, especially 45° C. or lower, in particular 40° C. or lower.

The development can be conducted by a method which is any of the immersion development method, spray development method, brush development method, ultrasonic development method, and the like.

The carbon filter obtained through the development is subjected to a heat curing treatment. Conditions of this heat curing treatment include a temperature selected from the range of from generally 100° C., preferably 150° C., to generally 280° C., preferably 250° C., and a time period selected from the range of from 5 minutes to 60 minutes.

Through the series of steps described above, the formation of an image pattern of one color is completed. This process is successively repeated to form image patterns of black (in the case where a black matrix is formed from a colored resin composition), red, green, and blue colors. Thus, a color filter is formed. Incidentally, the order of formation of image patterns of red, green, and blue colors should not be construed as being limited to the order shown above.

Besides being produced by the method described above, a color filter according to the invention can be produced by (1) a method in which a colored resin composition including a solvent, a colorant, and a polyimide resin as a binder is applied to a substrate and a pixel image is formed therefrom by etching. Furthermore, a color filter according to the invention can be produced also by: (2) a method in which a colored resin composition containing a colorant is used as a color ink to directly form a pixel image on a transparent substrate with a printing machine; (3) a method in which a colored resin composition containing a colorant is used as an electrodeposition fluid and a substrate is immersed in this electrodeposition fluid to deposit a colored film on an ITO electrode having a given pattern; (4) a method in which a film coated with a colored resin composition containing a colorant is applied to a transparent substrate and peeled therefrom, and this substrate is subjected to imagewise exposure and development to form a pixel image; (5) a method in which a colored resin composition containing a colorant is used as a color ink to form a pixel image on a substrate with an ink jet printer; or the like. For producing a color filter, a method suitable for the makeup of the colored resin composition of the invention is employed.

In the case where the color filter thus produced is to be used in a liquid-crystal display device, a transparent electrode such as ITO is directly formed on the images and this color filter is used as one of the parts of a color display, liquid-crystal display device, etc. However, a topcoat layer of a polyamide, polyimide, or the like may be formed on the images according to need in order to enhance surface smoothness and durability. For some applications, e.g., the planar alignment type operating mode (IPS mode), there are cases where the transparent electrode is not formed. For the vertical alignment type operating mode (MVA mode), there are cases where ribs are formed. There also are cases where columnar structures (photospacer) are formed by photolithography in place of disposing a scattered-bead type spacer.

### <Liquid-Crystal Display Device (Panel)>

The liquid-crystal display device according to the invention is equipped with the color filter described above (hereinafter sometimes referred to as “color filter of the invention). For example, the device can be configured so as to have a structure including the color filter of the invention described above and an opposed substrate, e.g., a thin-film transistor (TFT), that has been disposed opposite the color filter through a liquid-crystal layer. More specifically, this display device is produced by forming an alignment film on the color filter of the invention, scattering a spacer on the alignment film, subsequently bonding this color filter to an opposed substrate through a periphery-sealing material to form a liquid-crystal cell, injecting a liquid crystal into the liquid-crystal cell formed, and connecting the transparent electrode to the counter electrode.

For the alignment film, a film of a resin such as a polyimide is suitable. For forming the alignment film, the gravure printing method and/or the flexographic printing method is usually employed. After application, the alignment film is cured by thermal baking and then subjected to a surface treatment with ultraviolet irradiation and a rubbing cloth to thereby process the film surface so as to have a surface state capable of regulating the inclination of a liquid crystal. The alignment film thus formed has a thickness of generally about 10 nm.

As the spacer, use is made of one having a size corresponding to the gap between the color filter and the opposed substrate. Usually, a spacer having a size of 2-8 μm is suitable. It is also possible to form a photospacer (PS) constituted of a transparent resin film by photolithography and to use this photospacer in place of that spacer.

As the opposed substrate, an array substrate is usually used. In particular, a TFT (thin-film transistor) substrate is suitable. The gap between the color filter and the opposed substrate bonded thereto varies depending on applications of the liquid-crystal panel. However, the gap is generally selected from the range of from 2 μm to 8 μm.

After the color filter is bonded to the opposed substrate, the peripheral part excluding liquid-crystal injection openings is sealed with a sealing material such as an epoxy resin. The sealing material is cured by ultraviolet (UV) irradiation and/or heating to seal the periphery of the liquid-crystal cell.

The liquid-crystal cell the periphery of which has been sealed is cut into panel units. Thereafter, in a vacuum chamber, the liquid-crystal injection openings are immersed in a liquid crystal under vacuum and the internal pressure of the chamber is then returned to ordinary pressure to thereby inject the liquid crystal into each liquid-crystal cell. In this operation, the degree of vacuum in the liquid-crystal cell is generally 1×10⁻² Pa or higher, preferably 1×10⁻³ Pa or higher, and is generally 1×10⁻⁷ Pa or lower, preferably 1×10⁻⁶ Pa or lower. It is preferred to heat the liquid-crystal cell when the cell is placed under vacuum. The temperature at which the cell is heated is generally 30° C. or higher, preferably 50° C. or higher, and is generally 100° C. or lower, preferably 90° C. or lower. The time period for which the liquid-crystal cell is kept being heated under vacuum is generally in the range of from 10 minutes to 60 minutes. Thereafter, the liquid-crystal cell is immersed in a liquid crystal.

The liquid-crystal injection opening of each liquid-crystal cell into which the liquid crystal has been injected is sealed, for example, by curing a UV-curable resin. Thus, a liquid-crystal display device is completed.

The kind of the liquid crystal to be used is not particularly limited, and use may be made of any of conventionally known aromatic, aliphatic, polycyclic-compound, and other liquid crystals. Such liquid crystals may be any of lyotropic liquid crystals, thermotropic liquid crystals, etc. Known as thermotropic liquid crystals are nematic liquid crystals, smectic crystals, cholesteric liquid crystals, etc. Any of these may be used.

### <Organic EL Display>

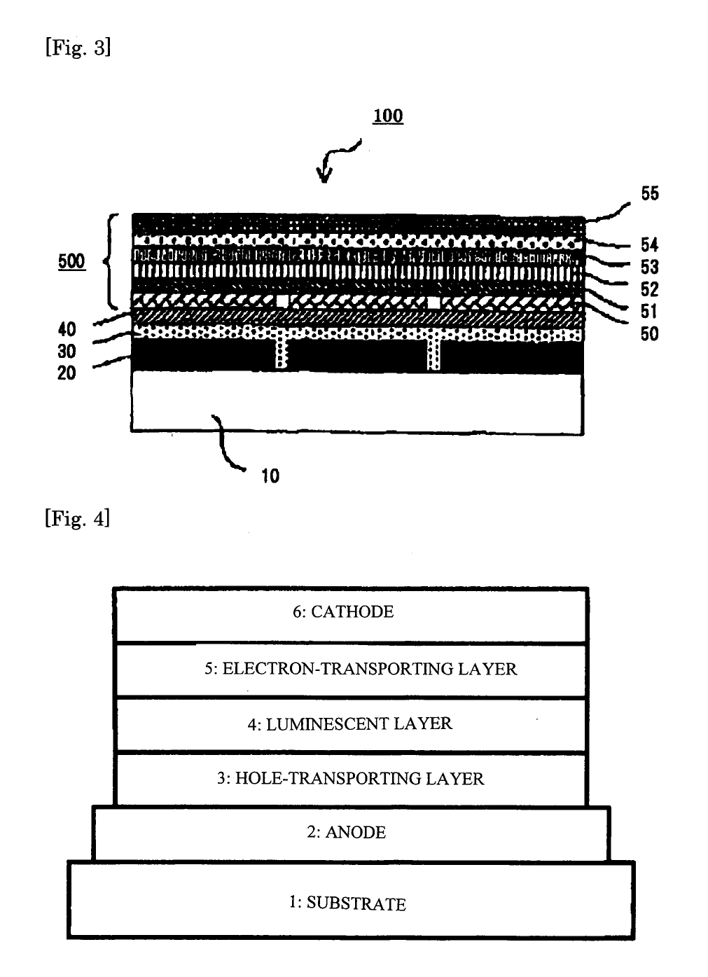

In the case where an organic EL display equipped with the color filter of the invention is to be fabricated, a multicolor organic EL device can be produced, for example, by superposing an organic light-emitting element 500 through an organic protective layer 30 and an inorganic oxide film 40 on a blue color filter constituted of a transparent substrate 10 and blue pixels 20 formed thereon from a colored resin composition of the invention, as shown in FIG. 3. Examples of methods for superposing the organic light-emitting element 500 include: a method in which a transparent anode 50, a hole injection layer 51, a hole-transporting layer 52, a luminescent layer 53, an electron injection layer 54, and a cathode 55 are successively formed on the upper surface of the color filter; and a method in which an organic light-emitting element 500 formed on another substrate is laminated to the inorganic oxide film 40. The organic EL device 100 thus produced is applicable to both organic EL displays operated in the passive-matrix mode and organic EL displays operated in the active-matrix mode.

### EXAMPLES

The invention will be explained below in more detail by reference to Synthesis Examples, Examples, and Comparative Examples. However, the invention should not be construed as being limited to the following Examples unless the invention departs from the spirit thereof.

### Synthesis Examples

### [1] Synthesis of Dyes

### Synthesis Example 1

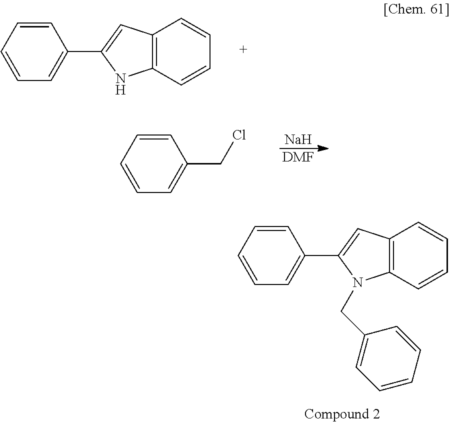

Dimethylformamide (DMF) (100 mL; manufactured by Kanto Chemical Co., Inc.) was added to phenylimidazole (3.86 g; 20 mmol; manufactured by Tokyo Kasei Kogyo Co., Ltd). Sodium hydride (1 g; 21 mmol; manufactured by Wako Pure Chemical Industries, Ltd.) was gradually added thereto at room temperature, and the mixture was stirred until hydrogen evolution ended. Thereafter, benzyl chloride (2.5 g; 20 mmol; manufactured by Tokyo Kasei Kogyo Co., Ltd.) was added thereto, and this mixture was stirred at room temperature. After completion of the reaction, water was added and the mixture was extracted with toluene. The organic layer was dried with calcium carbonate, filtered, and concentrated. The product obtained was purified by column chromatography to obtain compound 2 in an amount of 3.5 g and a yield of 62%.

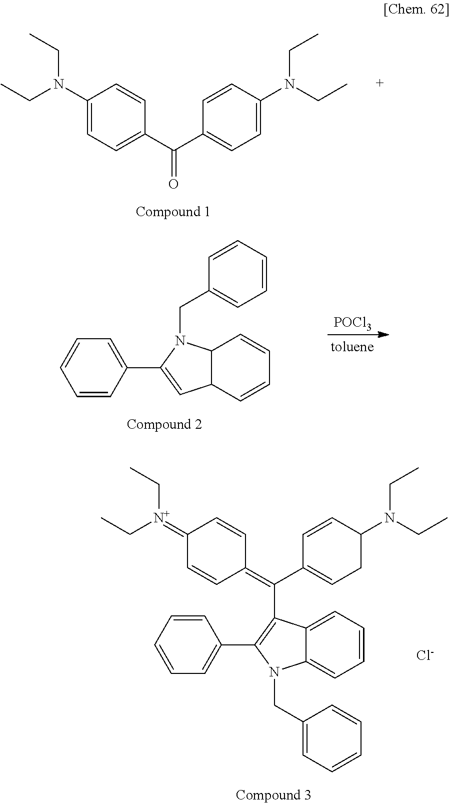

A 100-mL four-necked flask equipped with a three-way cock connected to a nitrogen line and with a Dimroth condenser, a thermometer, and a rotor was subjected to nitrogen displacement/vacuum drying. Thereinto were introduced the compound 2 obtained above (1.13 g; 4.0 mmol; 1.0 e.q.) and 10 mL of bottom toluene (manufactured by Junsei Chemical Co., Ltd.). The contents were stirred at room temperature. Phosphorus oxychloride (613 mg; 4.0 mmol; 1.0 e.q.; manufactured by Wako Pure Chemical Industries, Ltd.) was added thereto, and the resultant mixture was stirred for a while. Subsequently, compound 1 (1.30 g; 4.0 mmol; 1.0 e.q.; manufactured by Tokyo Kasei Kogyo Co., Ltd.) was added, and the mixture was stirred with heating for about 5 hours, allowed to cool, and extracted with chloroform. The product was purified by silica gel column chromatography (chloroform:methanol=15:1→10:1) to obtain compound 3 in an amount of 2.15 g and a yield of 85.5%.

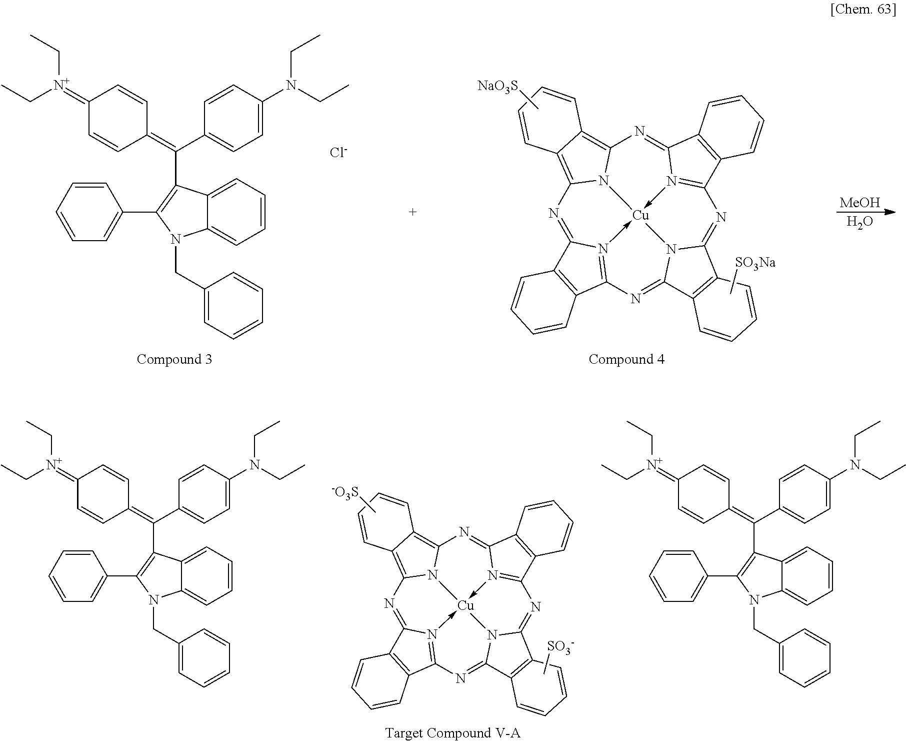

Compound 3 (1.0 g; 1.6 mmol; 2.0 e.q.) was introduced into a 200-mL Erlenmeyer flask and dissolved in methanol (20 mL; manufactured by Junsei Chemical Co., Ltd.). Compound 4 (sodium copper phthalocyaninesulfonate) (620 mg; 0.8 mmol; 1.0 e.q.) was added thereto, and the resultant mixture was stirred for a while. Forty milliliters of desalted water was added, and the mixture was further stirred at room temperature for 1 hour. Thereafter, the liquid reaction mixture was filtered, and the solid separated by the filtration was taken out. Desalted water was added thereto, and this mixture was subjected to ultrasonic cleaning and then filtered. The solid obtained was dried with an 80° C. vacuum dryer. Thus, the target compound V-A was obtained (830 mg; yield, 54.3%).

### Synthesis Example 2

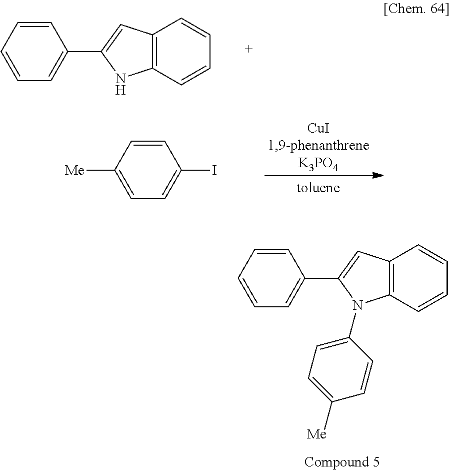

A hundred milliliters of toluene was added to phenylimidazole (5.8 g; 30 mmol; manufactured by Tokyo Kasei Kogyo Co., Ltd.), iodotoluene (9.8 g; 45 mmol; manufactured by Tokyo Kasei Kogyo Co., Ltd.), copper iodide (2.2 g; 12 mmol; manufactured by Kanto Chemical Co., Inc.), 1,9-phenanthroline (2.4 g; 12 mmol; manufactured by Tokyo Kasei Kogyo Co., Ltd.), and potassium phosphate (9.5 g; 45 mmol; manufactured by Kanto Chemical Co., Inc.). The mixture was refluxed with heating for 6 hours. After completion of the reaction, the reaction mixture was filtered. The precipitate was washed with methylene chloride, and the filtrate was concentrated. The crude product obtained was purified by column chromatography to obtain compound 5 in an amount of 2.0 g and a yield of 23%.

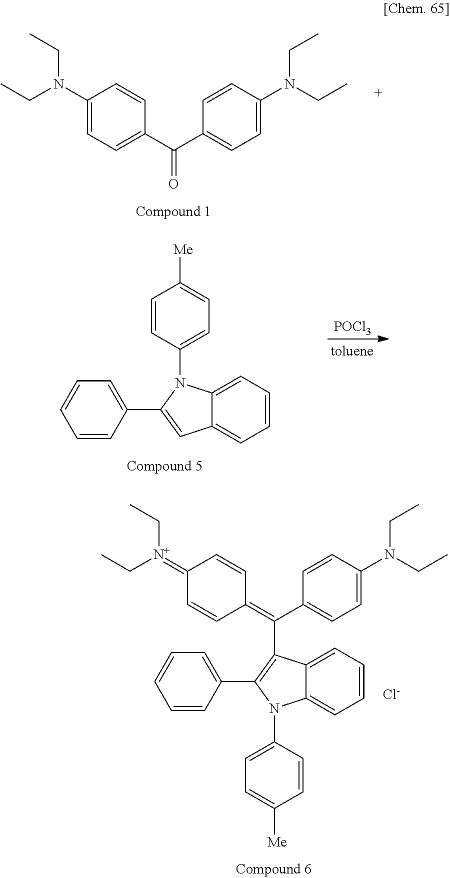

A 100-mL four-necked flask equipped with a three-way cock connected to a nitrogen line and with a Dimroth condenser, a thermometer, and a rotor was subjected to nitrogen displacement/vacuum drying. Thereinto were introduced the compound 5 obtained above (850 mg; 3.0 mmol; 1.0 e.q.) and 10 mL of bottom toluene (manufactured by Junsei Chemical Co., Ltd.). The contents were stirred at room temperature. Phosphorus oxychloride (460 mg; 3.0 mmol; 1.0 e.q.; manufactured by Wako Pure Chemical Industries, Ltd.) was added thereto, and the resultant mixture was stirred for a while. Subsequently, compound 1 (973 mg; 3.0 mmol; 1.0 e.q.; manufactured by Tokyo Kasei Kogyo Co., Ltd.) was added, and the mixture was stirred with heating for about 5 hours, allowed to cool, and extracted with chloroform. The product was purified by silica gel column chromatography (chloroform:methanol=15:1→10:1) to obtain compound 6 in an amount of 1.85 g and a yield of 98.5%.

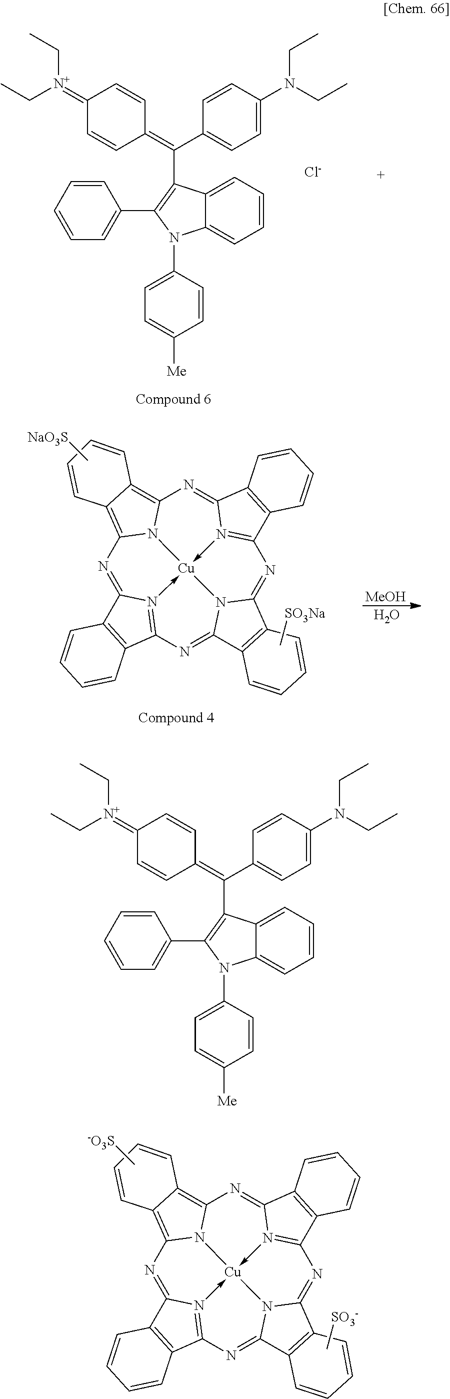

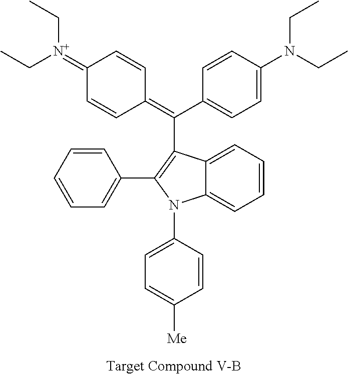

Compound 6 (925 mg; 1.64 mmol; 2.0 e.q.) was introduced into a 200-mL Erlenmeyer flask and dissolved in methanol (15 mL; manufactured by Junsei Chemical Co., Ltd.). Compound 4 (636 mg; 0.82 mmol; 1.0 e.q.) was added thereto, and the resultant mixture was stirred for a while. Forty milliliters of desalted water was added, and the mixture was further stirred at room temperature for 1 hour. Thereafter, the liquid reaction mixture was filtered, and the solid separated by the filtration was taken out. Pure water was added thereto, and this mixture was subjected to ultrasonic cleaning and then filtered. The solid obtained was dried with an 80° C. vacuum dryer. Thus, the target compound V-B was obtained (1.17 g; yield, 78.4%).

### Synthesis Example 3

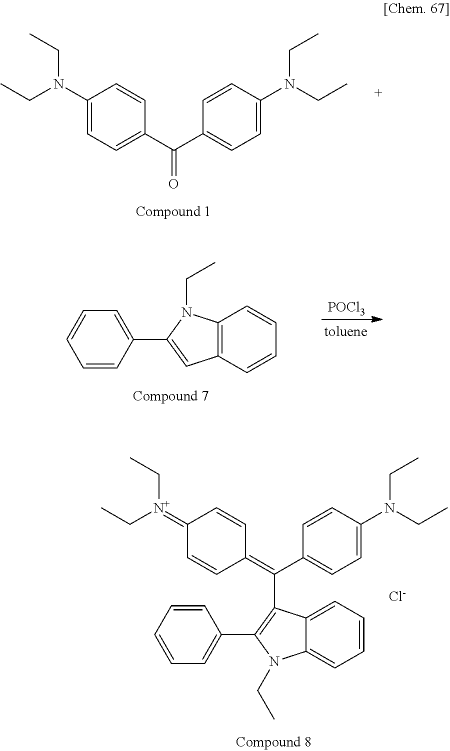

A 100-mL four-necked flask equipped with a three-way cock connected to a nitrogen line and with a Dimroth condenser, a thermometer, and a rotor was subjected to nitrogen displacement/vacuum drying. Thereinto were introduced compound 7 (1.55 g; 7.0 mmol; 1.0 e.q.; manufactured by Tokyo Kasei Kogyo Co., Ltd.) and 15 mL of bottom toluene (manufactured by Junsei Chemical Co., Ltd.). The contents were stirred at room temperature. Phosphorus oxychloride (1.07 g; 7.0 mmol; 1.0 e.q.; manufactured by Wako Pure Chemical Industries, Ltd.) was added thereto, and the resultant mixture was stirred for a while. Subsequently, compound 1 (2.27 g; 7.0 mmol; 1.0 e.q.; manufactured by Tokyo Kasei Kogyo Co., Ltd.) was added, and the mixture was stirred with heating for about 5 hours, allowed to cool, and extracted with chloroform. The product was purified by silica gel column chromatography (chloroform:methanol=15:1→10:1) to obtain compound 8 in an amount of 3.82 g and a yield of 96.7%.

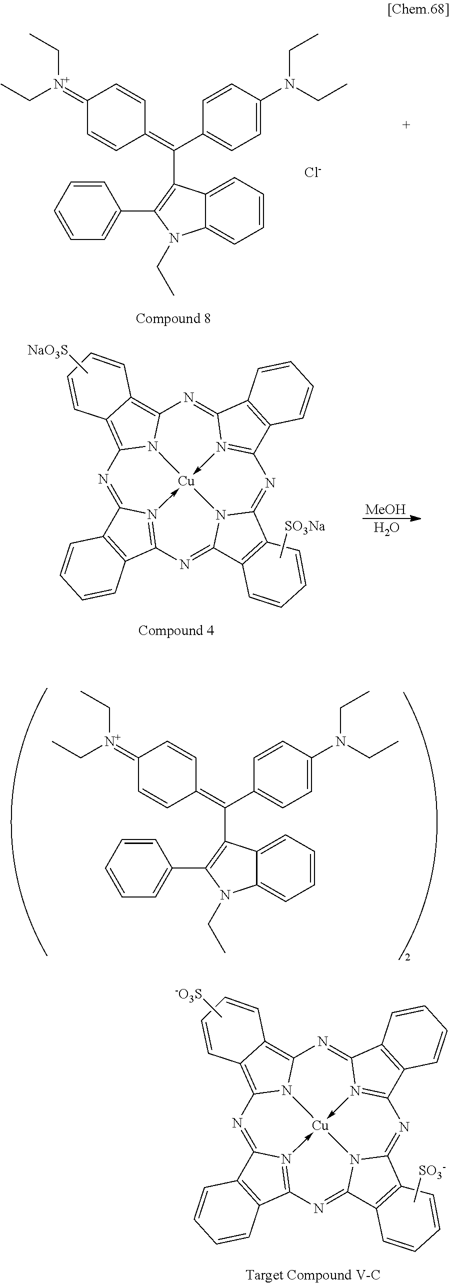

Compound 8 (1.0 g; 1.6 mmol; 2.0 e.q.) was introduced into a 200-mL Erlenmeyer flask and dissolved in methanol (15 mL; manufactured by Junsei Chemical Co., Ltd.). Compound 4 (620 mg; 0.8 mmol; 1.0 e.q.) was added thereto, and the resultant mixture was stirred for a while. Forty milliliters of desalted water was added, and the mixture was further stirred at room temperature for 3 hours. Thereafter, the liquid reaction mixture was filtered, and the solid separated by the filtration was taken out. Pure water was added thereto, and this mixture was subjected to ultrasonic cleaning and then filtered. The solid obtained was dried with an 80° C. vacuum dryer. Thus, the target compound V-C was obtained (1.25 g; yield, 80.4%).

### Synthesis Example 4

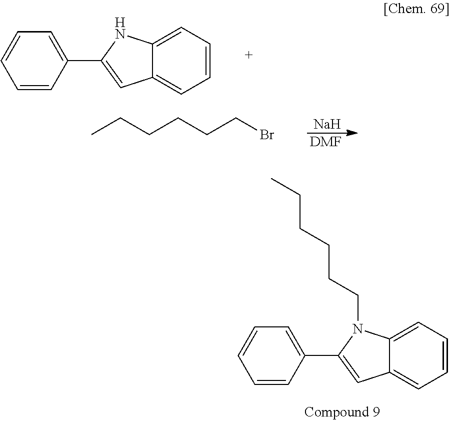

A 100-mL four-necked flask equipped with a three-way cock connected to a nitrogen line and with a Dimroth condenser, a thermometer, and a rotor was subjected to nitrogen displacement/vacuum drying. Thereinto was introduced phenylimidazole (3.87 g; 20.0 mmol; 1.0 e.q.; manufactured by Tokyo Kasei Kogyo Co., Ltd.). This compound was dissolved in dehydrated DMF (20 mL; manufactured by Kanto Chemical Co., Inc.) at room temperature. The resultant solution was cooled with ice. Subsequently, sodium hydride (960 mg; 22.0 mmol; 1.1 e.q.; manufactured by Wako Pure Chemical Industries, Ltd.) was gradually added thereto, and the mixture was stirred. Bromohexane (3 mL; 3.63 g; 22.0 mmol; 1.1 e.q.; manufactured by Wako Pure Chemical Industries, Ltd.) was gradually added dropwise thereto, and the resultant mixture was heated and stirred at room temperature for about 2 hours. The reaction vessel was cooled with ice, and the reaction mixture was quenched with water and extracted with ether. Thereafter, the product was purified by silica gel column chromatography (hexane:ethyl acetate=40:1) to obtain compound 9 in an amount of 3.91 g and a yield of 70.5%.

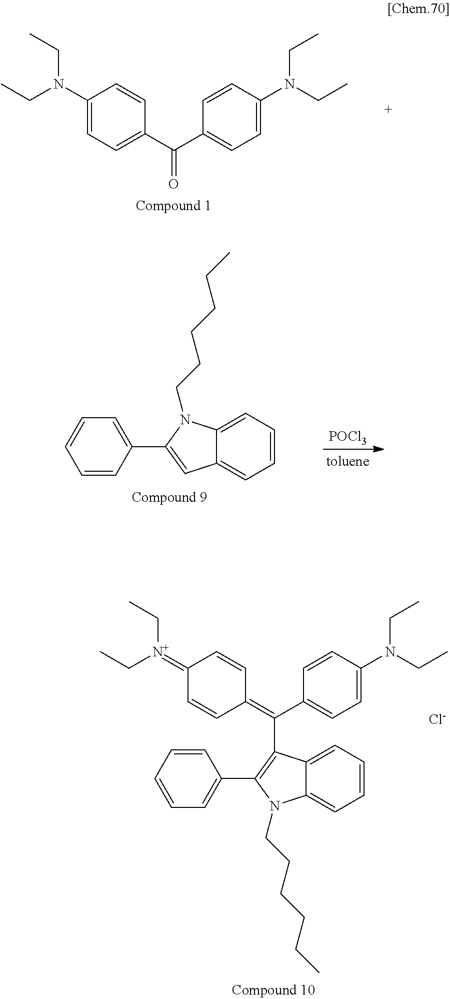

A 100-mL four-necked flask equipped with a three-way cock connected to a nitrogen line and with a Dimroth condenser, a thermometer, and a rotor was subjected to nitrogen displacement/vacuum drying. Thereinto were introduced the compound 9 obtained above (832 mg; 3.0 mmol; 1.0 e.q.) and 8 mL of bottom toluene (manufactured by Junsei Chemical Co., Ltd.). The contents were stirred at room temperature. Phosphorus oxychloride (506 mg; 3.3 mmol; 1.1 e.q.; manufactured by Wako Pure Chemical Industries, Ltd.) was added thereto, and the resultant mixture was stirred for a while. Subsequently, compound 1 (973 mg; 3.0 mmol; 1.0 e.q.; manufactured by Tokyo Kasei Kogyo Co., Ltd.) was added, and the mixture was stirred with heating for about 6.5 hours, allowed to cool, and extracted with chloroform. The product was purified by silica gel column chromatography (chloroform:methanol=15:1→10:1) to obtain compound 10 in an amount of 1.67 g and a yield of 89.7%.

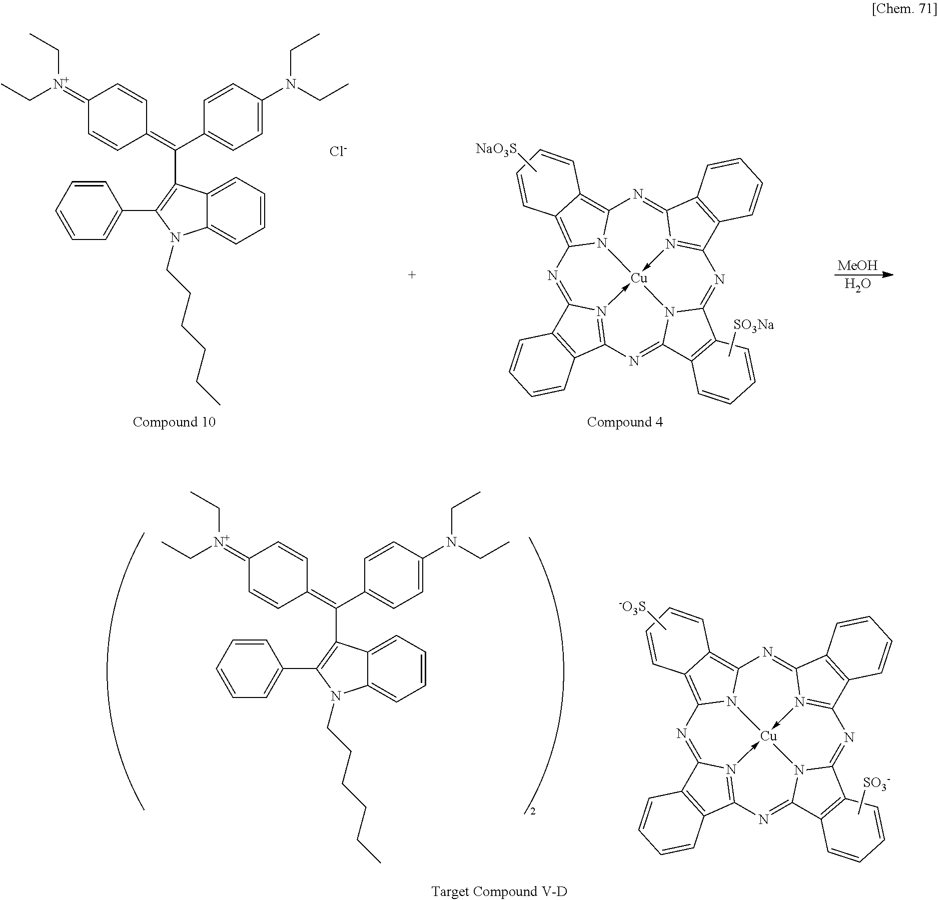

Compound 10 (800 mg; 1.29 mmol; 2.0 e.q.) was introduced into a 200-mL Erlenmeyer flask and dissolved in methanol (20 mL; manufactured by Junsei Chemical Co., Ltd.). Compound 4 (500 mg; 0.65 mmol; 1.0 e.q.) was added thereto, and the resultant mixture was stirred for a while. Forty milliliters of desalted water was added, and the mixture was further stirred at room temperature for 1.5 hours. Thereafter, the liquid reaction mixture was filtered, and the solid separated by the filtration was taken out. Pure water was added thereto, and this mixture was subjected to ultrasonic cleaning and then filtered. The solid obtained was dried with an 80° C. vacuum dryer. Thus, the target compound V-D was obtained (820 mg; yield, 65.8%).

### Synthesis Example 5

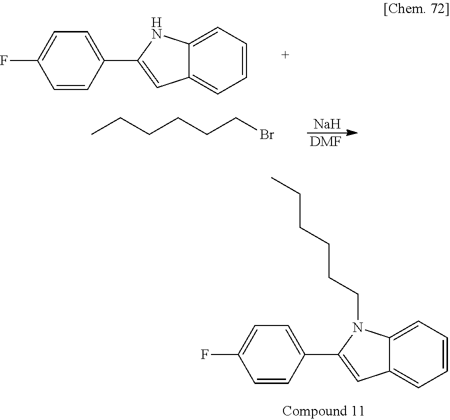

A 100-mL four-necked flask equipped with a three-way cock connected to a nitrogen line and with a Dimroth condenser, a thermometer, and a rotor was subjected to nitrogen displacement/vacuum drying. Thereinto was introduced 4-fluorophenylimidazole (6.3 g; 30 mmol; 1.0 e.q.; manufactured by Tokyo Kasei Kogyo Co., Ltd.). This compound was dissolved in dehydrated DMF (100 mL; manufactured by Kanto Chemical Co., Inc.) at room temperature, and the resultant solution was cooled with ice. Subsequently, sodium hydride (2.16 mg; 45 mmol; manufactured by Wako Pure Chemical Industries, Ltd.) was gradually added thereto, and the mixture was stirred. Bromohexane (6.6 g; 40 mmol; manufactured by Wako Pure Chemical Industries, Ltd.) was gradually added dropwise thereto. The resultant mixture was heated and stirred at room temperature for about 3 hours. The reaction vessel was cooled with ice, and the reaction mixture was quenched with water and extracted with hexane. The extract was concentrated. The crude product obtained was purified by column chromatography (hexane:methylene chloride=9:1) to obtain compound 11 in an amount of 4.6 g and a yield of 52%.

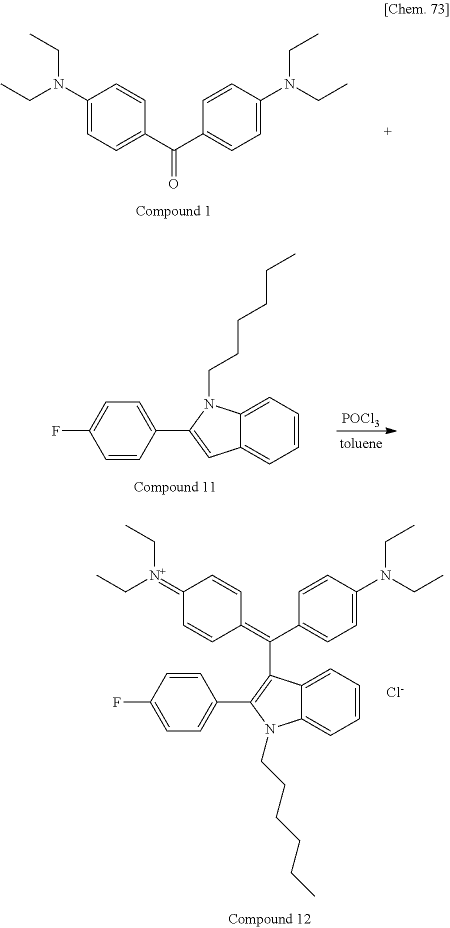

A 100-mL four-necked flask equipped with a three-way cock connected to a nitrogen line and with a Dimroth condenser, a thermometer, and a rotor was subjected to nitrogen displacement/vacuum drying. Thereinto were introduced the compound 11 obtained above (975 mg; 3.3 mmol; 1.0 e.q.) and 10 mL of bottom toluene (manufactured by Junsei Chemical Co., Ltd.). The contents were stirred at room temperature. Phosphorus oxychloride (557 mg; 3.63 mmol; 1.1 e.q.; manufactured by Wako Pure Chemical Industries, Ltd.) was added thereto, and the resultant mixture was stirred for a while. Subsequently, compound 1 (1.07 g; 3.3 mmol; 1.0 e.q.; manufactured by Tokyo Kasei Kogyo Co., Ltd.) was added, and the mixture was stirred with heating for about 4 hours, allowed to cool, and extracted with chloroform. The product was purified by silica gel column chromatography (chloroform:methanol=15:1→10:1) to obtain compound 12 in an amount of 1.27 g and a yield of 60.3%.

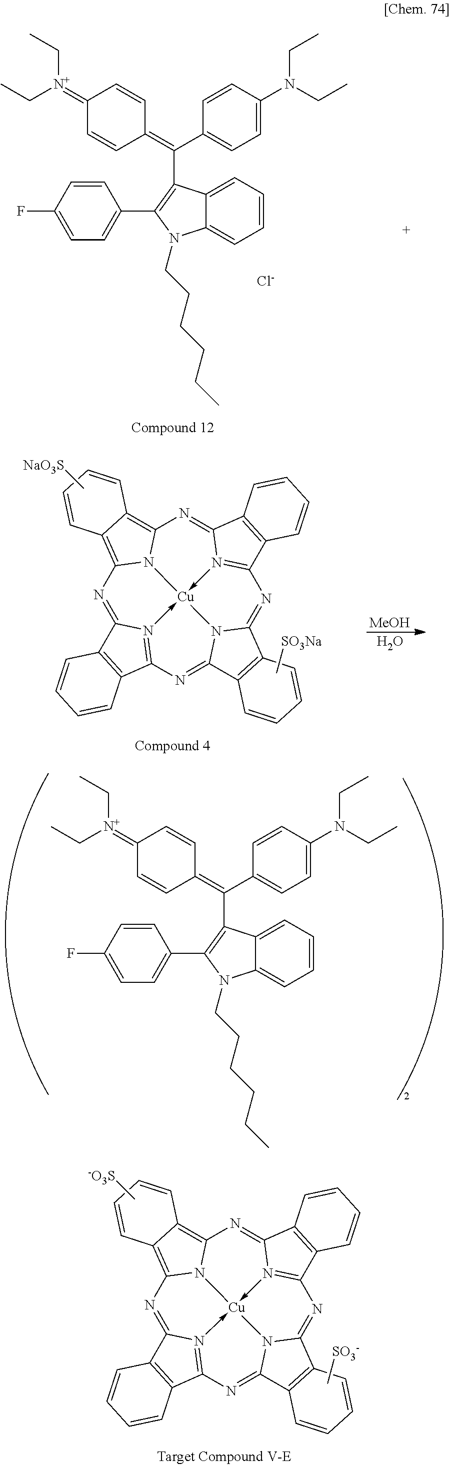

Compound 12 (638 mg; 1.0 mmol; 2.0 e.q.) was introduced into a 100-mL Erlenmeyer flask and dissolved in methanol (15 mL; manufactured by Junsei Chemical Co., Ltd.). Compound 4 (388 mg; 0.5 mmol; 1.0 e.q.) was added thereto, and the resultant mixture was stirred for a while. Fifty milliliters of desalted water was added, and the mixture was further stirred at room temperature for 3 hours. Thereafter, the liquid reaction mixture was filtered, and the solid separated by the filtration was taken out. Pure water was added thereto, and this mixture was subjected to ultrasonic cleaning and then filtered. The solid obtained was dried with an 80° C. vacuum dryer. Thus, the target compound V-E was obtained (790 mg; yield, 80.3%).

### Synthesis Example 6

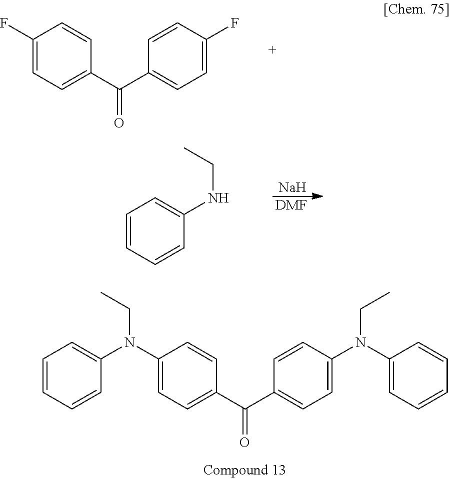

Sodium hydride (4.3 g; 90 mmol; manufactured by Kanto Chemical Co., Inc.) was added to a DMF (100 mL; manufactured by Kanto Chemical Co., Inc.) solution of N-ethylaniline (10 g; 90 mmol) at 0° C., and the mixture was stirred until hydrogen evolution ended. Thereafter, 4,4′-difluorobenzophenone (6.5 g; 30 mmol; manufactured by Tokyo Kasei Kogyo Co., Ltd.) was added little by little thereto, and the resultant mixture was heated to room temperature and stirred for 5 hours. After completion of the reaction, water was added and the mixture was extracted with dichloromethane. The organic layer was dried with calcium carbonate, filtered, and concentrated. The crude product obtained was purified by column chromatography to obtain compound 13 in an amount of 3.1 g and a yield of 24%.

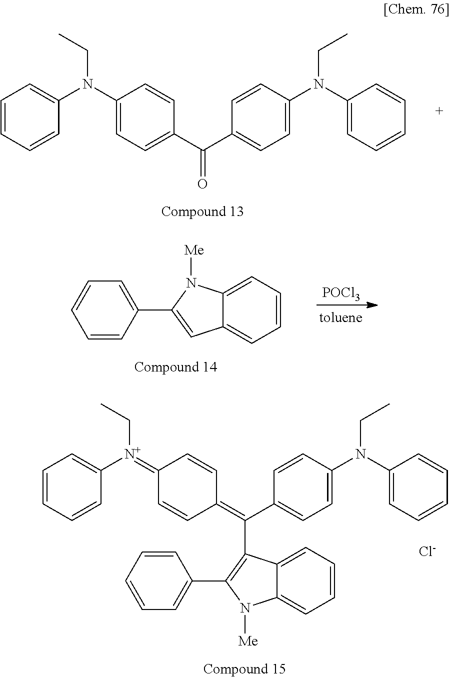

A 100-mL four-necked flask equipped with a three-way cock connected to a nitrogen line and with a Dimroth condenser, a thermometer, and a rotor was subjected to nitrogen displacement/vacuum drying. Thereinto were introduced compound 14 (622 mg; 3.0 mmol; 1.0 e.q.; manufactured by Tokyo Kasei Kogyo Co., Ltd.) and 15 mL of bottom toluene (manufactured by Junsei Chemical Co., Ltd.). The contents were stirred at room temperature. Phosphorus oxychloride (506 mg; 3.3 mmol; 1.1 e.q.; manufactured by Wako Pure Chemical Industries, Ltd.) was added thereto, and the resultant mixture was stirred for a while. Subsequently, the compound 13 obtained above (1.26 g; 3.0 mmol; 1.0 e.q.) was added, and the mixture was stirred with heating for about 4.5 hours, allowed to cool, and extracted with chloroform. The product was purified by silica gel column chromatography (chloroform:methanol=15:1→10:1) to obtain compound 15 in an amount of 1.48 g and a yield of 76.3%.

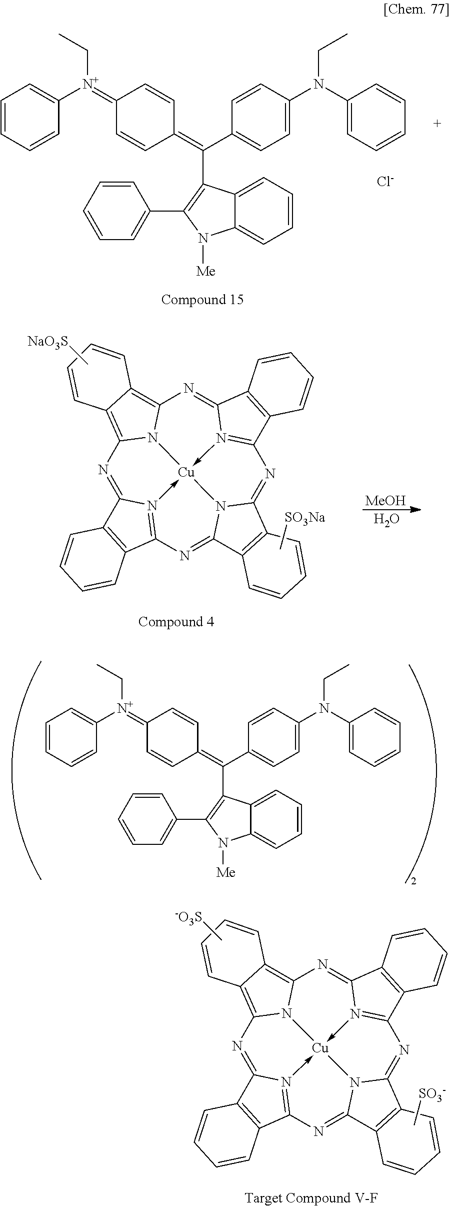

Compound 15 (982 mg; 1.52 mmol; 2.0 e.q.) was introduced into a 100-mL Erlenmeyer flask and dissolved in methanol (15 mL; manufactured by Junsei Chemical Co., Ltd.). Compound 4 (590 mg; 0.76 mmol; 1.0 e.q.) was added thereto, and the resultant mixture was stirred for a while. Fifty milliliters of desalted water was added, and the mixture was further stirred at room temperature for 3 hours. Thereafter, the liquid reaction mixture was filtered, and the solid separated by the filtration was taken out. Pure water was added thereto, and this mixture was subjected to ultrasonic cleaning and then filtered. The solid obtained was dried with an 80° C. vacuum dryer. Thus, the target compound V-F was obtained (980 mg; yield, 65.0%).

### Synthesis Example 7

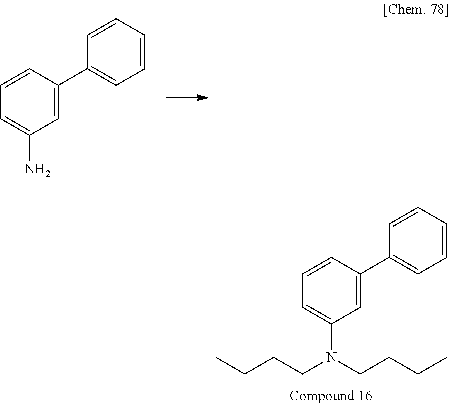

To 30 mL of an ethanol solution of 3-aminobiphenyl (5 g; 30 mmol; manufactured by Tokyo Kasei Kogyo Co., Ltd.) were added iodobutane (11.6 g; 63 mmol; manufactured by Tokyo Kasei Kogyo Co., Ltd.) and potassium carbonate (8.7 g; 63 mmol; manufactured by Junsei Chemical Co., Ltd.). This mixture was refluxed with heating for 3 days. Subsequently, the reaction mixture was filtered, and the inorganic salt was washed with toluene. Thereafter, the product was purified by column chromatography to obtain compound 16 in an amount of 7 g and a yield of 83%.

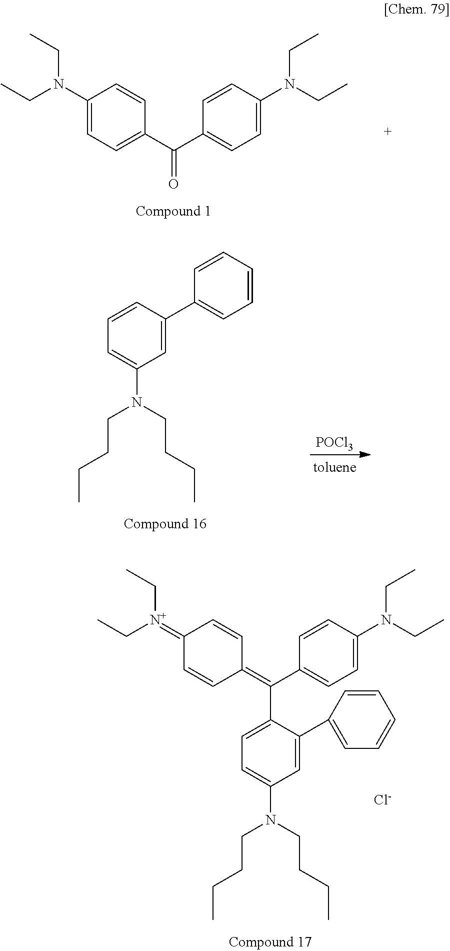

A 100-mL four-necked flask equipped with a three-way cock connected to a nitrogen line and with a Dimroth condenser, a thermometer, and a rotor was subjected to nitrogen displacement/vacuum drying. Thereinto were introduced the compound 16 obtained above (1.13 g; 4.0 mmol; 1.0 e.q.) and 10 mL of bottom toluene (manufactured by Junsei Chemical Co., Ltd.). The contents were stirred at room temperature. Phosphorus oxychloride (675 mg; 4.4 mmol; 1.1 e.q.; manufactured by Wako Pure Chemical Industries, Ltd.) was added thereto, and the resultant mixture was stirred for a while. Subsequently, compound 1 (1.30 g; 4.0 mmol; 1.0 e.q.; manufactured by Tokyo Kasei Kogyo Co., Ltd.) was added, and the mixture was stirred with heating for about 2.5 hours, allowed to cool, and extracted with chloroform. The product was purified by silica gel column chromatography (chloroform:methanol=15:1→10:1) to obtain compound 17 in an amount of 1.46 g and a yield of 58.5%.

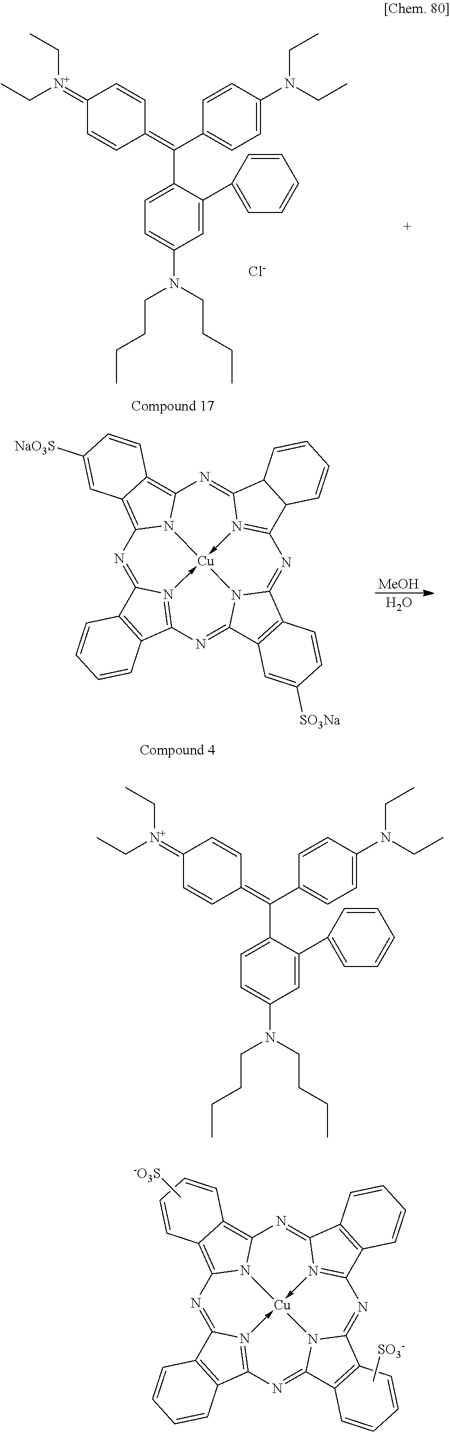

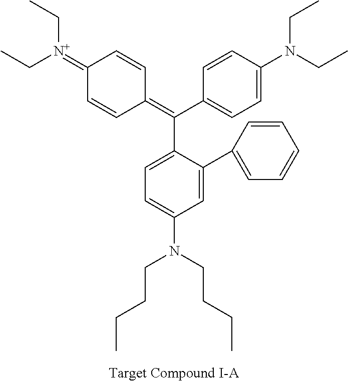

Compound 17 (1.24 g; 2.0 mmol; 2.0 e.q.) was introduced into a 200-mL eggplant type flask and dissolved in methanol (10 mL; manufactured by Junsei Chemical Co., Ltd.). Compound 4 (782 mg; 1.0 mmol; 1.0 e.q.) was added thereto, and the resultant mixture was stirred for a while. Fifty-five milliliters of desalted water was added, and the mixture was further stirred at room temperature for 1 hour. Thereafter, the liquid reaction mixture was filtered, and the solid separated by the filtration was taken out. Desalted water was added thereto, and this mixture was subjected to ultrasonic cleaning and then filtered. The solid obtained was dried with an 80° C. vacuum dryer. Furthermore, desalted water was added to the solid, and this mixture was subjected to ultrasonic cleaning. Thus, the target compound I-A was obtained (900 mg; yield, 47%).

### Synthesis Example 8

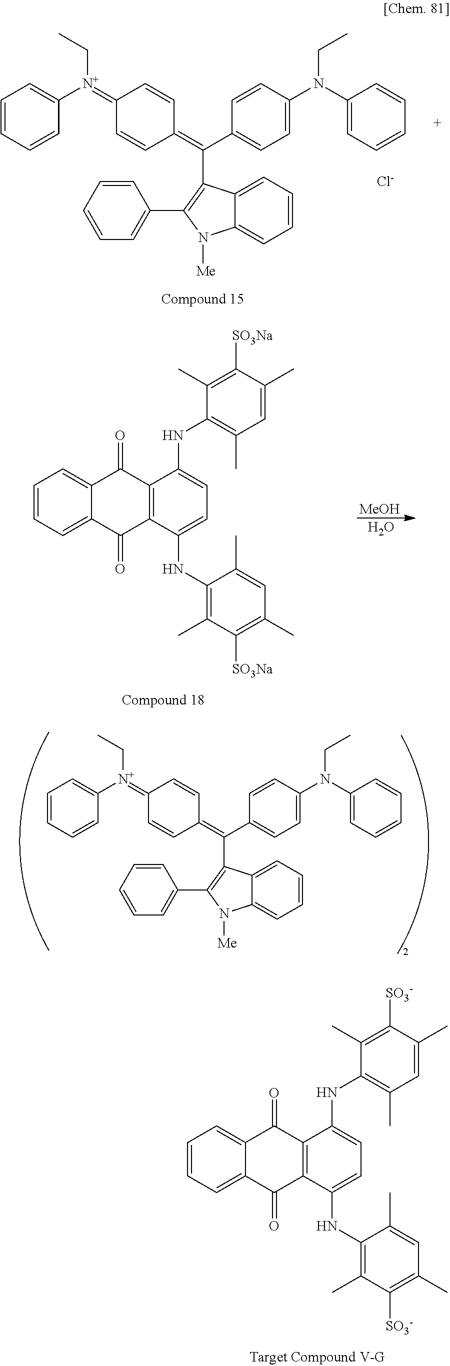

The compound 15 obtained in Synthesis Example 6 (343 mg; 0.2 mmol) was introduced into a 100-mL Erlenmeyer flask and dissolved in methanol (15 mL; manufactured by Junsei Chemical Co., Ltd.). Compound 18 (Acid Blue 80) (169 mg; 0.2 mmol; 1.0 e.q.) was added thereto, and the mixture was stirred for a while. Forty milliliters of desalted water was added thereto, and the resultant mixture was further stirred at room temperature for 3 hours. Thereafter, the liquid reaction mixture was filtered, and the solid separated by the filtration was taken out. Pure water was added thereto, and this mixture was subjected to ultrasonic cleaning and then filtered. The solid obtained was dried with an 80° C. vacuum drier. Thus, the target compound V-G was obtained (300 mg; yield, 80%).

### Synthesis Example 9

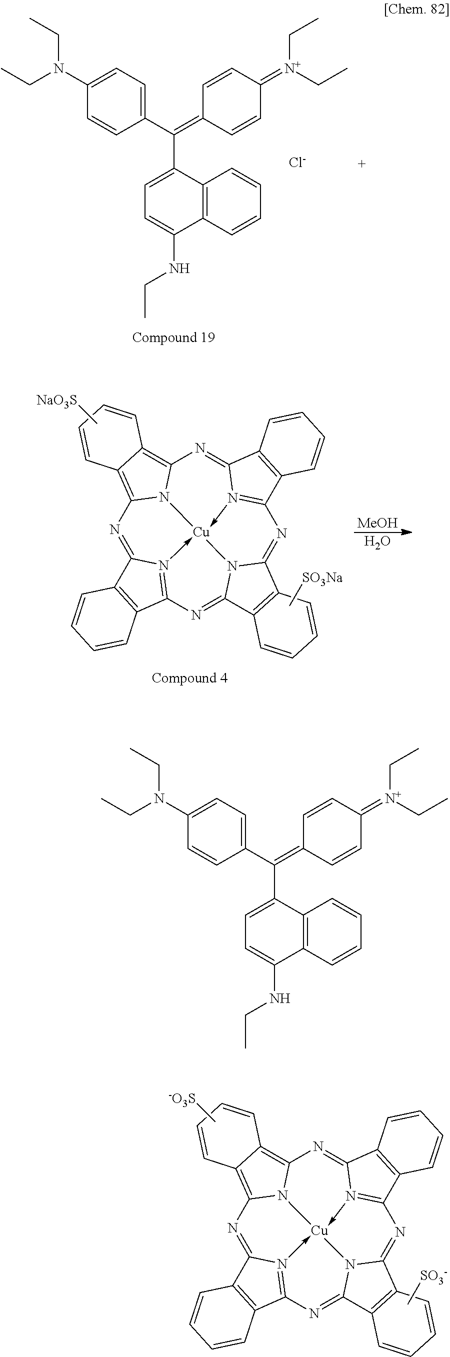

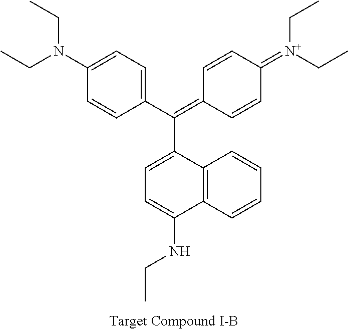

Compound 19 (Basic Blue 7) (1.03 g; 2.0 mmol; manufactured by Tokyo Kasei Kogyo Co., Ltd.) was introduced into a 200-mL Erlenmeyer flask and dissolved in methanol (20 mL; manufactured by Junsei Chemical Co., Ltd.). Compound 4 (776 mg; 1.0 mmol) was added thereto, and this mixture was stirred for about 30 minutes until the mixture became homogeneous. Seventy milliliters of desalted water was added thereto, and the resultant mixture was further stirred at room temperature for 1 hour. The liquid reaction mixture obtained was filtered, and the solid separated by the filtration was taken out. Water was added thereto, and this mixture was subjected to ultrasonic cleaning and then filtered. The solid obtained was dried with an 80° C. vacuum dryer. Thus, the target compound I-B was obtained (1.32 g; yield, 78.2%).

### Synthesis Example 10

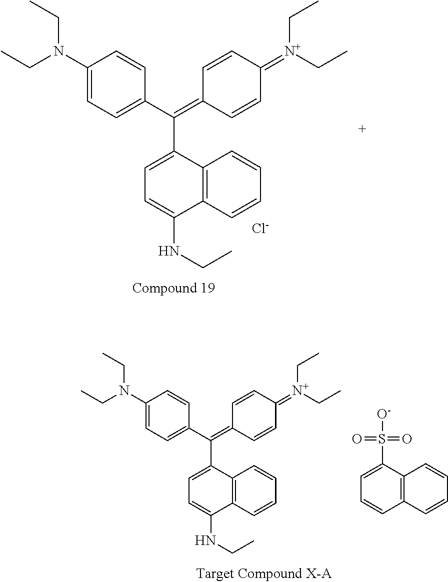

In 500 parts by weight of water was dissolved 5.14 parts by weight of compound 19 (Basic Blue 7) (manufactured by Tokyo Kasei Kogyo Co., Ltd.) (CI-42595). Thereto was added, with stirring, 4.60 parts by weight of sodium 1-naphthalenesulfonate. The mixture was stirred at room temperature for 1 hour. This mixture was cooled with ice, and the precipitate was taken out by filtration and washed with water. The cake obtained was air-dried and then vacuum-dried. Thus, the target compound X-A, which is represented by the structural formula given above, was obtained (6.11 part by weight; yield, 89%).

### Synthesis Example 11

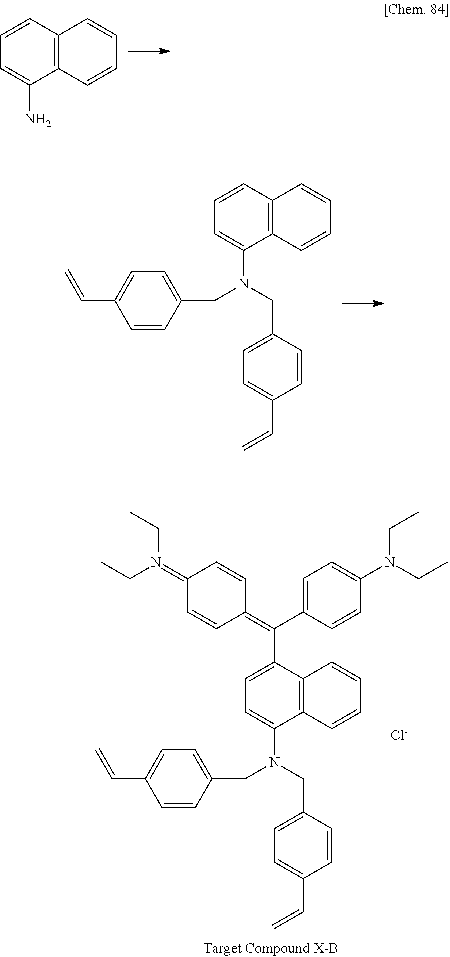

In 120 g of N-methyl-2-pyrrolidone was dissolved 11.5 g of 1-aminonaphthalene. Thereto was added, with stirring at room temperature, 3.74 g of sodium amide. Furthermore, 1.20 g of sodium iodide as a catalyst and 0.89 g of 2,5-di-t-butylhydroquinone as a polymerization inhibitor were added. Thereafter, 13.4 g of p-chloromethylstyrene was added thereto over 30 minutes, and this mixture was stirred at room temperature for 2 hours. After the stirring, 200 mL of chloroform was added thereto to dissolve the product. This mixture was washed with water three times. The chloroform layer was separated, and the solvent was distilled off to obtain a residue. This residue was purified by silica gel column chromatography to obtain 10.8 g of p-vinylbenzylnaphthylamine as an intermediate.

To 10.8 g of the intermediate obtained were added 17.6 g of 4,4′-bis(diethylamino)benzophenone, 0.46 g of 2,5-di-t-butylhydroquinone as a polymerization inhibitor, and 140 g of toluene as a solvent. In a nitrogen atmosphere, the mixture was heated to 45° C. and 8.31 g of phosphorus oxychloride was added thereto over 10 minutes. After completion of the dropwise addition, the resultant mixture was heated to 100° C. over 1 hour and stirred at 100° C. for 1 hour. After completion of the stirring, the mixture was cooled to room temperature and the toluene was distilled off at a reduced pressure. Two hundred milliliters of chloroform was added thereto to dissolve the residue, and this solution was washed with water three times. The chloroform layer was separated, and the solvent was distilled off to obtain a residue. This residue was purified by silica gel column chromatography. Thus, the target compound X-B was obtained (5.9 g).

### Synthesis Example 12

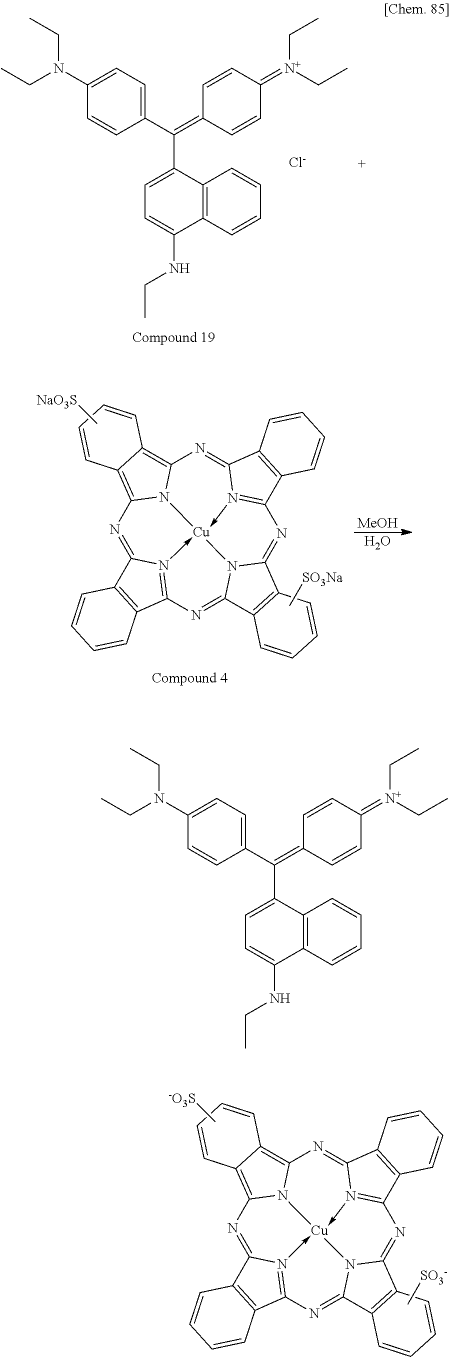

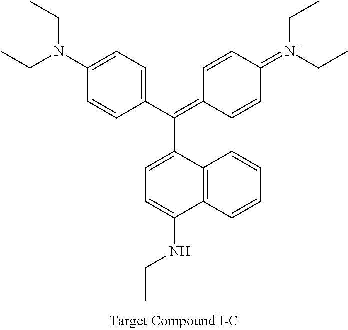

Compound 19 (Basic Blue 7) (1.03 g; 2.0 mmol; manufactured by Tokyo Kasei Kogyo Co., Ltd.) was introduced into a 200-mL Erlenmeyer flask and dissolved in methanol (20 mL; manufactured by Junsei Chemical Co., Ltd.). Compound 4 (776 mg; 1.0 mmol) was added thereto, and this mixture was stirred for a while. Seventy milliliters of desalted water was added thereto, and the resultant mixture was further stirred at room temperature for 1 hour. Thereafter, the liquid reaction mixture was filtered, and the solid separated by the filtration was taken out. Desalted water was added thereto, and this mixture was subjected to ultrasonic cleaning and then filtered. The solid obtained was dried with an 80° C. vacuum dryer. Thus, the target compound I-C was obtained (1.32 g; yield, 78.2%).

### Synthesis Example 13

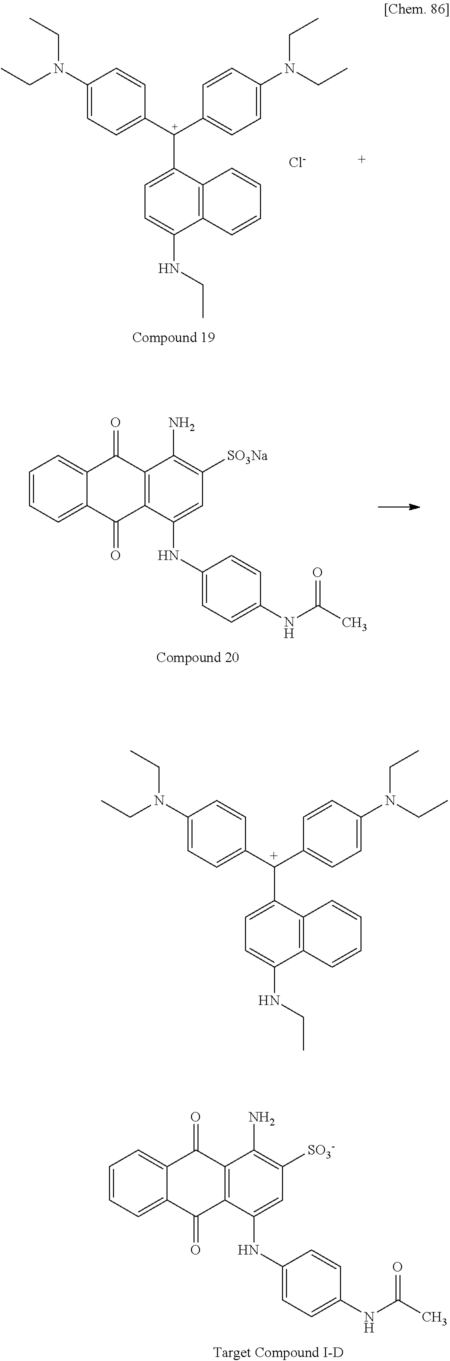

Compound 19 (Basic Blue 7) (874 g; 1.7 mmol; manufactured by Tokyo Kasei Kogyo Co., Ltd.) was introduced into a 200-mL Erlenmeyer flask and dissolved in methanol (20 mL; manufactured by Junsei Chemical Co., Ltd.). Compound 20 (Acid Blue 40) (805 mg; 1.7 mmol) was added thereto, and this mixture was stirred for a while. Seventy milliliters of desalted water was added thereto, and the resultant mixture was further stirred at room temperature for 1 hour. Thereafter, the liquid reaction mixture was filtered, and the solid separated by the filtration was taken out. Desalted water was added thereto, and this mixture was subjected to ultrasonic cleaning and then filtered. The solid obtained was dried with an 80° C. vacuum dryer. Thus, the target compound I-D was obtained (960 mg; yield, 60%).

### Synthesis Example 14

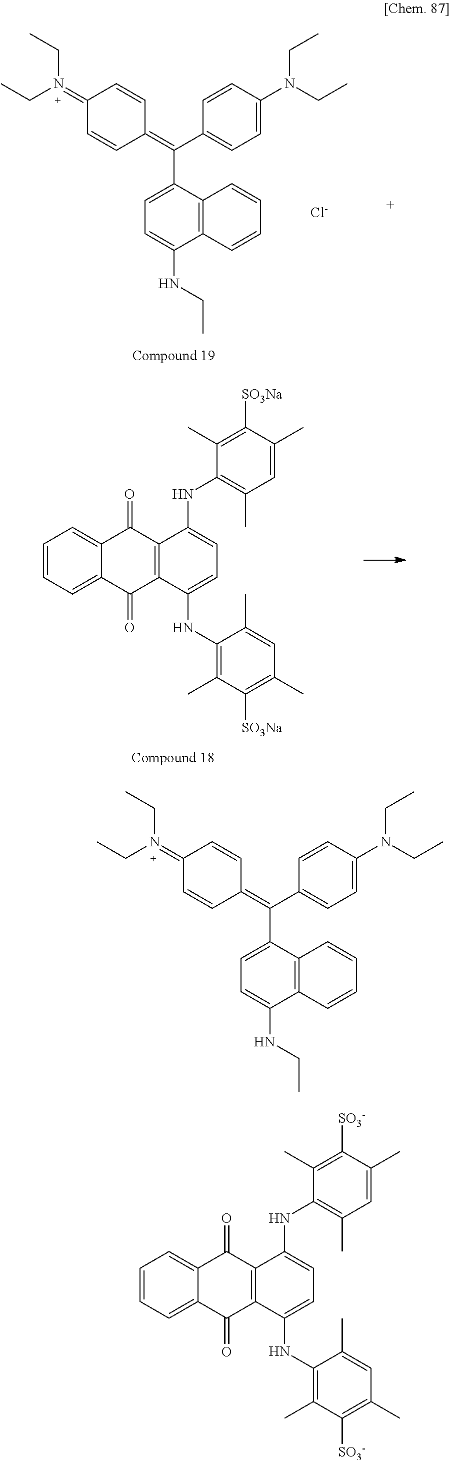

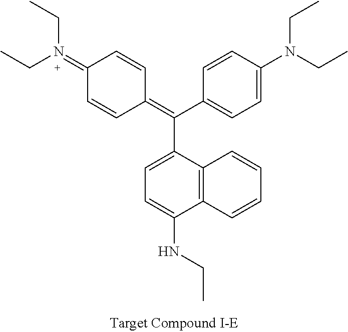

Compound 19 (Basic Blue 7) (2.06 g; 4.0 mmol) and compound 18 (Acid Blue 80) (2.47 g; 2.0 mmol) were introduced into a 300-mL Erlenmeyer flask and dissolved in methanol (20 mL; manufactured by Junsei Chemical Co., Ltd.). This solution was stirred at room temperature for 3 hours. Two hundred milliliters of desalted water was added thereto, and the resultant mixture was further stirred at room temperature for 3 hours. Thereafter, the liquid reaction mixture was filtered, and the solid separated by the filtration was taken out. Desalted water was added thereto, and this mixture was subjected to ultrasonic cleaning and then filtered again. Washing with desalted water was repeated until the mother liquor became transparent. The solid obtained was dried with an 80° C. vacuum dryer for 6 hours or more. Thus, the target compound I-E was obtained (2.87 g; yield, 90%).

### Synthesis Example 15

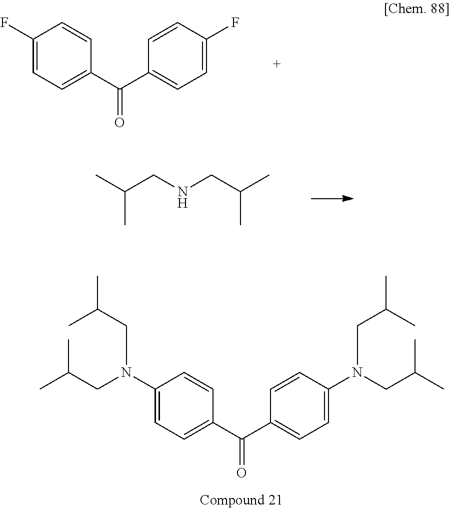

Diisobutylamine (1.62 g; 12.5 mmol; 2.5 e.q.) was dissolved in 20 mL of dehydrated toluene. Thereto were added t-butoxysodium (1.2 g; 12.5 mmol; 2.5 e.q.), 4,4-difluorobenzophenone (1.26 g; 5 mmol; 1.0 e.q.), palladium acetate (168 mg; 0.75 mmol; 0.15 e.q.), and tri-t-butylphosphine (303 mg; 1.5 mmol; 0.3 e.q.). The mixture was stirred at 100° C. for 5 hours. Thereafter, the mixture was returned to room temperature, and 1-N aqueous hydrochloric acid solution and 1-N aqueous sodium hydroxide solution were added thereto to regulate the pH. Thereafter, the mixture was extracted with toluene. The extract was washed with saturated aqueous sodium chloride solution, subsequently dried with anhydrous sodium sulfate, and then concentrated at a reduced pressure. The concentrate was purified by silica gel column chromatography (hexane:ethyl acetate=12:1) to obtain 1.86 g of compound 21 (yield, 85%).

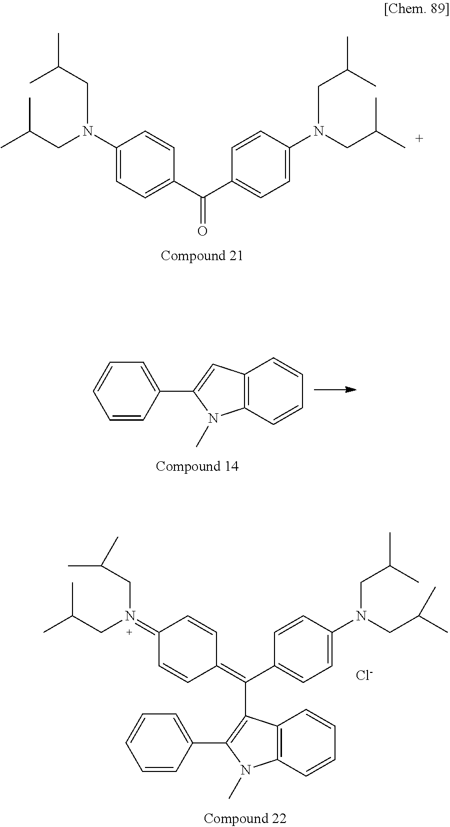

Compound 14 (573 mg; 2.77 mmol; 1.3 e.q.) was dissolved in toluene, and phosphorus oxychloride (652 mg; 4.3 mmol; 2.0 e.q.) and compound 21 (929 mg; 2.1 mmol; 1.0 e.q.) were added thereto. This mixture was refluxed with heating at 120° C. for 5 hours. Thereafter, the mixture was returned to room temperature, and 1-N hydrochloric acid was added thereto. This mixture was extracted with chloroform, and the extract was dried with anhydrous sodium sulfate and then concentrated at a reduced pressure. The concentrate was purified by silica gel column chromatography (chloroform:methanol=12:1) and washed with hexane to obtain 1.34 g of compound 22 (yield, 96%).

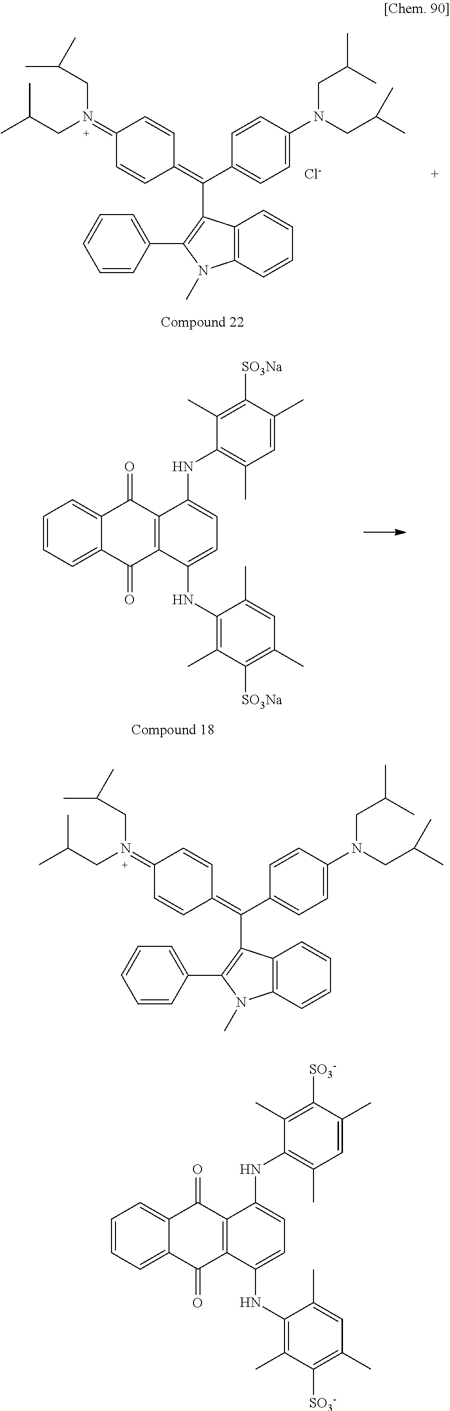

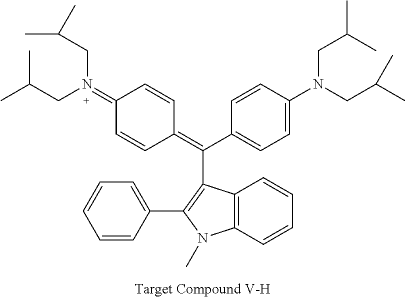

Compound 22 (662 mg; 1.0 mmol; 2.0 e.q.) and compound 18 (365 mg; 0.5 mmol; 1.0 e.q.) were introduced into a 300-mL Erlenmeyer flask and dissolved in 20 mL of methanol. This solution was stirred at room temperature for 3 hours. Two hundred milliliters of desalted water was added thereto, and the resultant mixture was further stirred at room temperature for 3 hours. Thereafter, the liquid reaction mixture was filtered, and the solid separated by the filtration was taken out. Desalted water was added thereto, and this mixture was subjected to ultrasonic cleaning and then filtered again. Washing with desalted water was repeated until the mother liquor became transparent. The solid obtained was dried with an 80° C. vacuum dryer for 6 hours or more. Thus, the target compound V-H was obtained (789 mg; yield, 84%).

### Synthesis Example 16

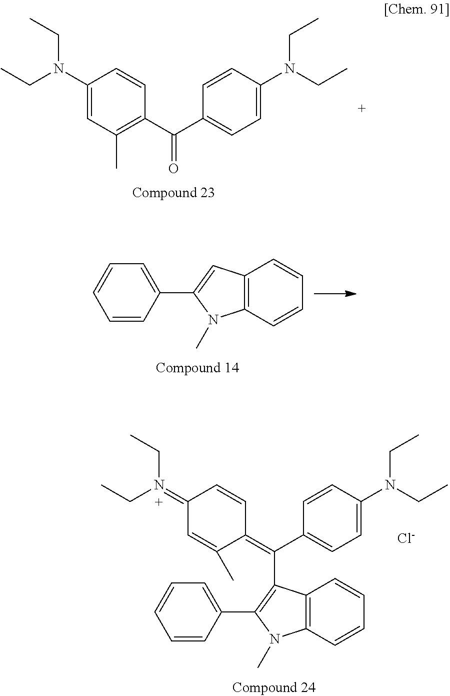

Compound 23 and Compound 14 were used as starting materials to synthesize compound 24 in the same manner as in the method of synthesizing compound 22. The compound 24 was obtained in an amount of 800 mg (yield, 71%).

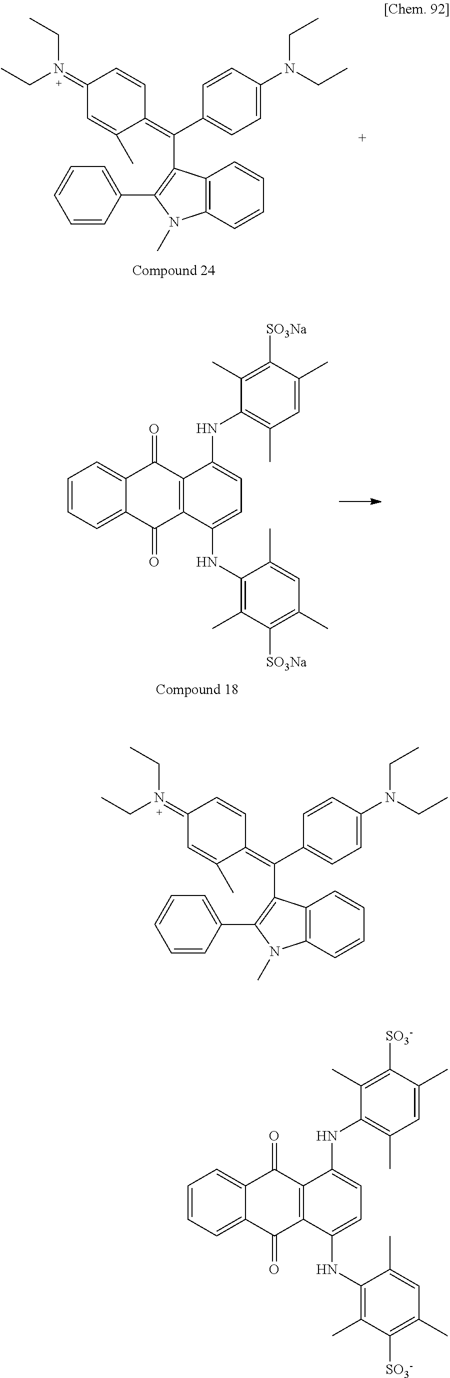

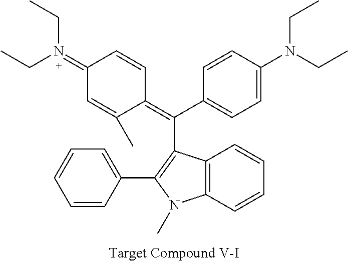

Compound 24 and compound 18 were used as starting materials to synthesize the target compound V-I in the same manner as in the method of synthesizing the target compound V-H. The target compound V-I was obtained in an amount of 990 mg (yield, 91%).

### Synthesis Example 17

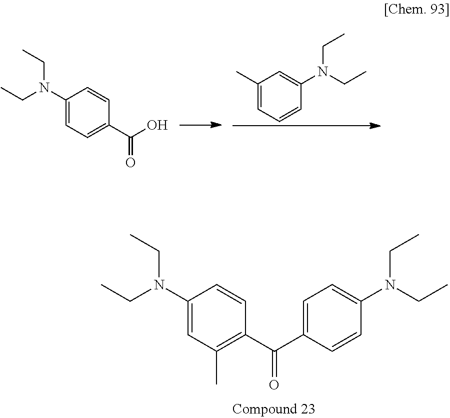

Thionyl chloride (14 mL; 200 mmol) was added to a mixture of 4-diethylaminobenzoic acid 8 (25 g; 129 mmol) and toluene (100 mL). The resultant mixture was stirred at 80° C. for 1 hour and then concentrated at a reduced pressure to obtain an acid chloride. A mixture of anhydrous aluminum chloride (20.4 g; 155 mmol) and 1,2-dichloroethane (100 mL) was placed in another vessel. While this mixture was being cooled on an ice bath, a 1,2-dichloroethane (50 mL) solution of the acid chloride was added dropwise thereto. After the resultant mixture was stirred for 15 minutes, N,N-diethyl-m-toluidine (21.1 g; 129 mmol) was added dropwise thereto. The mixture was returned to room temperature and then poured into ice water. The pH of the resultant mixture was regulated to 10 or higher with 4-N aqueous sodium hydroxide solution, and this mixture was extracted with chloroform. The chloroform layer was washed with 1-N aqueous sodium hydroxide solution and filtered through a Celite to remove insoluble matter. This chloroform layer was washed with saturated aqueous sodium chloride solution, dried with anhydrous sodium sulfate, and then concentrated at a reduced pressure. The concentrate was purified by silica gel column chromatography (silica gel, 800 g; hexane/ethyl acetate, 4/1). The crystals yielded were washed with hexane to obtain compound 23 (14.6 g; yield, 33%).

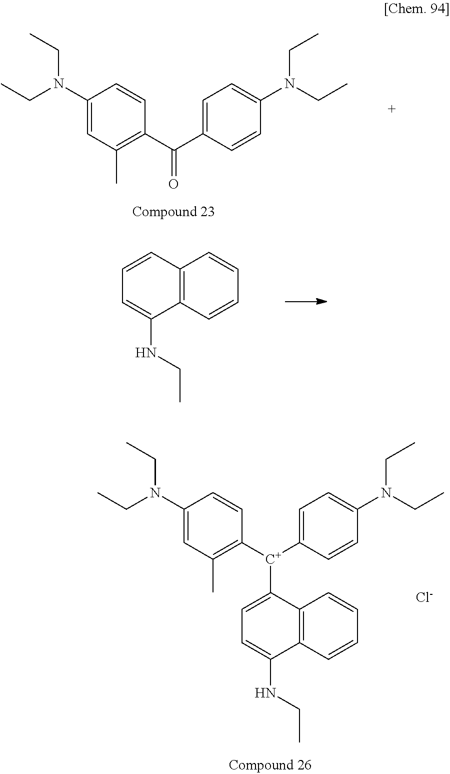

Phosphorus oxychloride (1.4 mL; 15 mmol) was added to a mixture of compound 23 (3.38 g; 10 mmol), N-ethyl-1-naphthylamine (1.71 g; 10 mmol), and toluene (15 mL). This mixture was stirred at 120° C. for 2 hours. After the mixture was cooled to room temperature, a 1-N aqueous hydrochloric acid solution was added thereto. This mixture was stirred for 15 minutes and extracted with chloroform. The chloroform layer was washed with water and saturated aqueous sodium chloride solution, dried with anhydrous sodium sulfate, and then concentrated at a reduced pressure. The concentrate was purified by silica gel column chromatography (Kanto Chemical; Silica Gel 60; spherical; 400 g; chloroform/methanol, 15/1→7/1). The solid was washed with hexane to obtain compound 26 (3.21 g; yield, 61%).

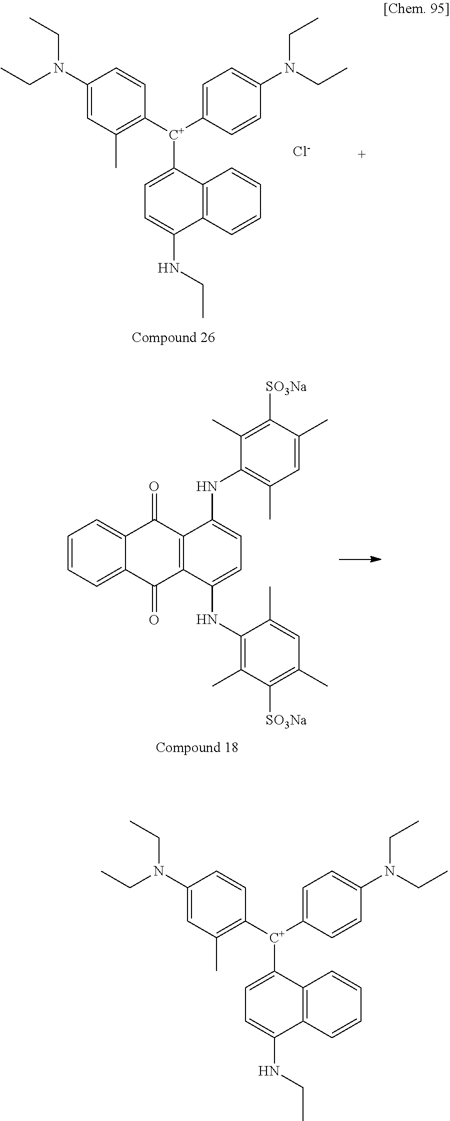

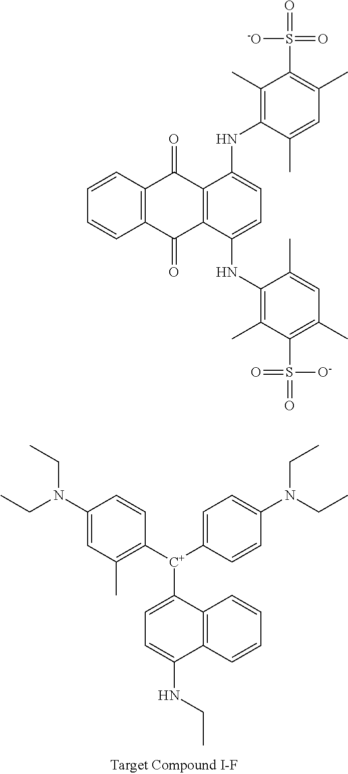

A mixture of compound 26 (1.06 g; 2.0 mmol), compound 18 (0.70 g; 1.03 mmol), and methanol (10 mL) was stirred at room temperature for 1.5 hours. Water (20 mL) was added thereto, and the agglomerates yielded were crushed. Thereafter, the resultant mixture was stirred at room temperature for 1.5 hours and then subjected to suction filtration. The solid obtained was dried. A mixture of methanol (30 mL) and water (60 mL) was added to the dried solid, and the resultant mixture was stirred for 2 hours. The precipitate was taken out by filtration and washed with water. Thus, the target compound I-F was obtained (1.34 g; yield, 83%).

### Synthesis Example 18

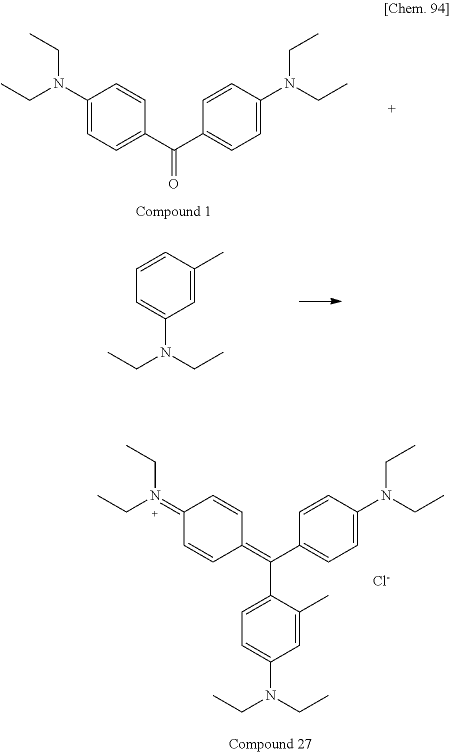

N,N-diethyl-m-toluidine (408 mg; 2.5 mmol; 1.0 e.q.) was dissolved in dehydrated toluene. Thereto were added phosphorus oxychloride (575 mg; 3.75 mmol; 1.5 e.q.) and compound 1 (973 mg; 3 mmol; 1.2 e.q.). This mixture was refluxed with heating at 120° for 5 hours. Thereafter, the mixture was returned to room temperature, and 1-N saturated aqueous sodium chloride solution was added thereto. The resultant mixture was extracted with chloroform, and the extract was dried with anhydrous sodium sulfate and then concentrated at a reduced pressure. The concentrate was purified by silica gel column chromatography (chloroform:methanol=15:1) and washed with hexane to obtain compound 27 (485 mg; yield 38%).

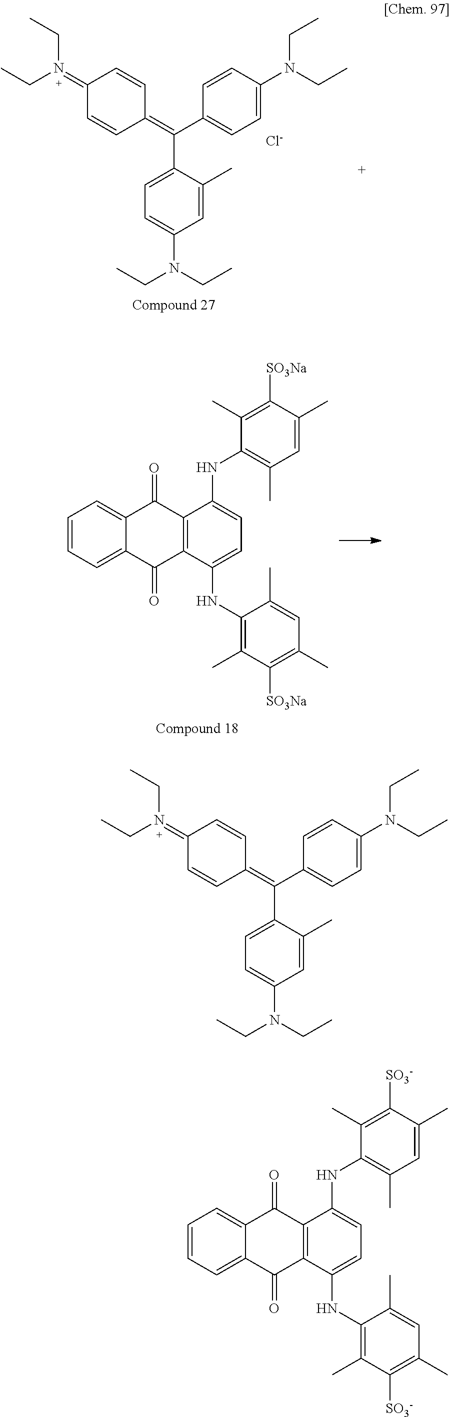

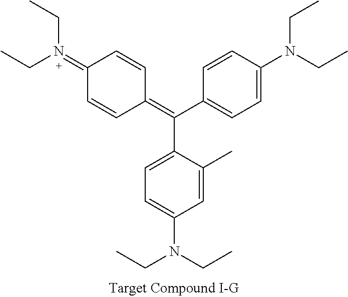

Compound 27 and compound 18 were used as starting materials to synthesize the target compound I-G in the same manner as in the method of synthesizing the target compound V-H. The target compound I-G was obtained in an amount of 578 mg (yield, 91%).

### Synthesis Example 19

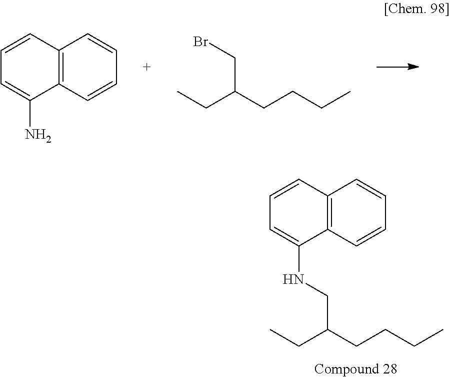

A mixture of 1-aminonaphthalene (14.3 g; 100 mmol), 2-ethylhexyl bromide (19.2 g; 100 mmol), potassium carbonate (15.2 g; 110 mmol), and N-methyl-2-pyrrolidone (100 mL) was stirred at 120° C. for 2 hours and then at 140° C. for 2 hours. The mixture was cooled to room temperature. Thereafter, toluene (100 mL) was added thereto, and this mixture was subjected to suction filtration to remove the precipitate. Toluene and water were added to the mother liquor, and the resultant mixture was subjected to liquid separation. The toluene layer was washed with water four times and then concentrated at a reduced pressure. The concentrate was purified by column chromatography (Merck 7734; 300 g; hexane/ethyl acetate, 100/1→50/1→30/1) to obtain compound 28 (8.88 g; yield, 37%).

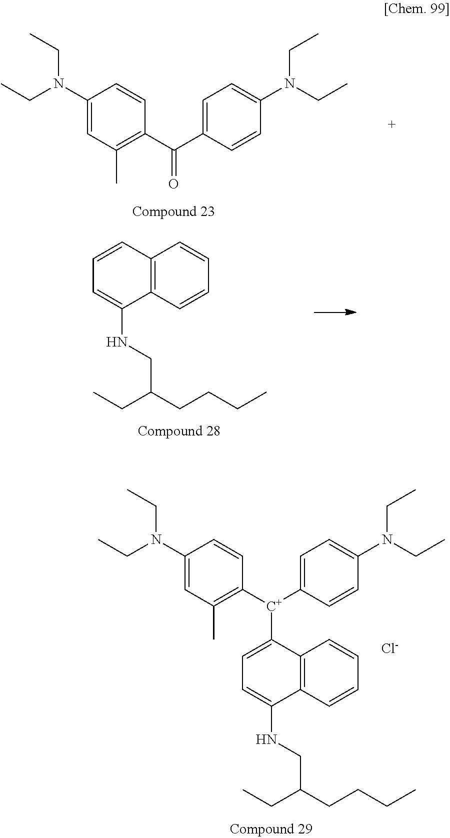

Compound 23 and compound 28 were used as starting materials to synthesize compound 29 in the same manner as in the synthesis of compound 26.

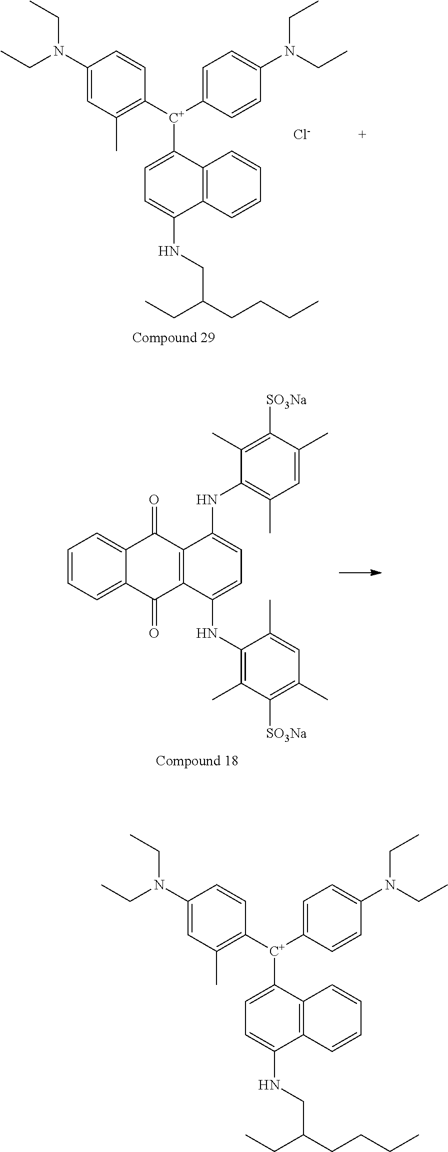

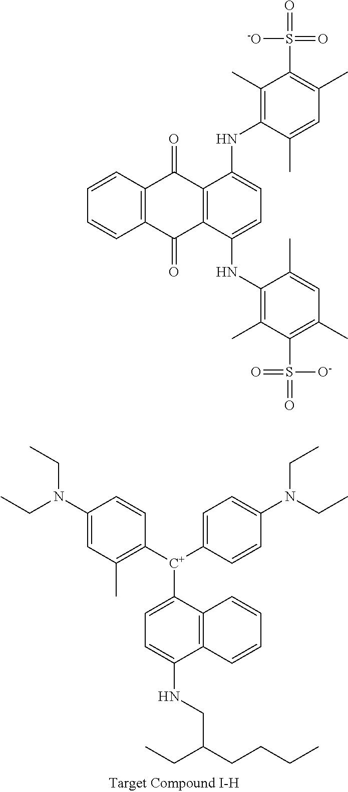

Compound 29 and compound 18 were used as starting materials to synthesize the target compound I-H in the same manner as in the synthesis of the target compound V-H. The target compound I-H was obtained in an amount of 739 mg (yield, 92%).

### Synthesis Example 20

The compound 30 shown below obtained by the method described in WO 2008/003604 A2 and commercial 4,4′-bis(diethylamino)benzophenone were used as starting materials to synthesize the target compound I-I in the same manner as in the synthesis of the target compound I-F (Synthesis Example 17) (amount obtained, 4.17 g; yield, 61%).

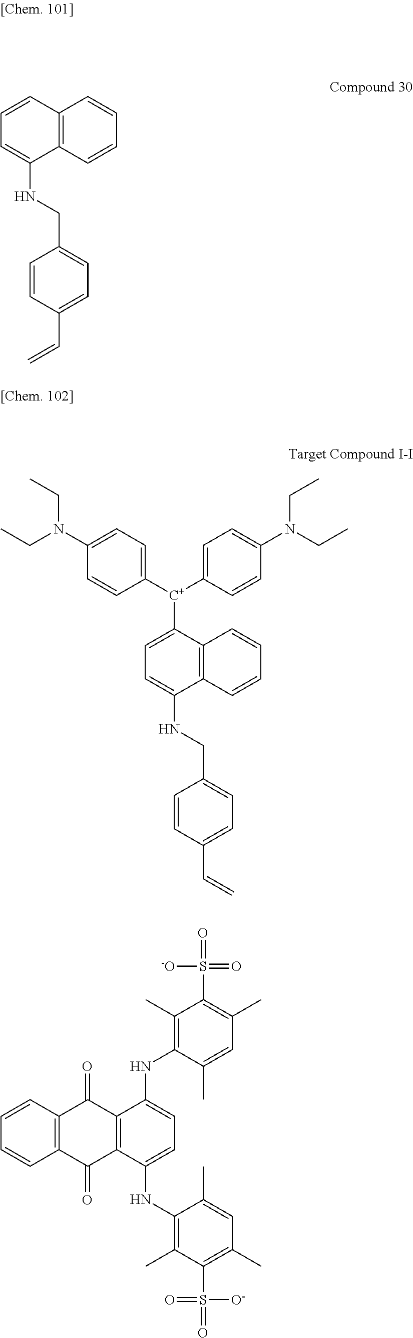

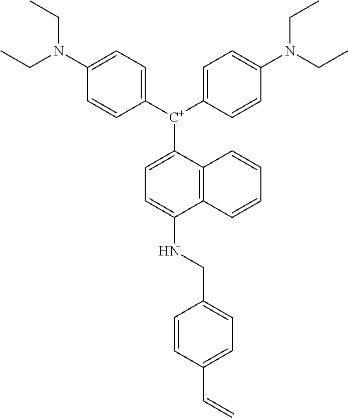

### Synthesis Example 21

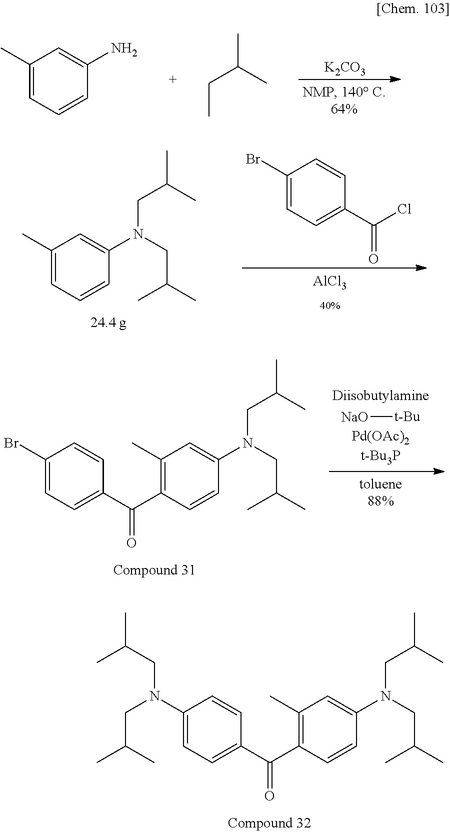

A mixture of m-toluidine (18.6 g; 174 mmol), isobutyl iodide (50 mL; 434 mmol), potassium carbonate (60 g; 435 mmol), and N-methylpyrrolidone (200 mL) was stirred at 120° C. for 3 hours and then at 140° C. for 14 hours. The mixture was cooled to room temperature and then diluted with toluene (400 mL). The resultant mixture was subjected to suction filtration, and the solid matter was washed with toluene (100 mL) so that the washings were added to the filtrate. Water was added to the filtrate, and the resultant mixture was subjected to liquid separation. The toluene layer was washed with water four times and then concentrated at a reduced pressure. The concentrate was purified by silica gel column chromatography (Merck 7734; 800 g; hexane/ethyl acetate, 100/0→100/1→50/1→30/1) to obtain 24.4 g of N,N-diisobutyl-m-toluidine (yield, 64%).

A Dimroth condenser was set on a 500-mL reaction vessel, and this vessel was subjected to nitrogen displacement and cooled with ice. Thereinto were introduced aluminum chloride (8.75 g; 65.6 mmol) and 1,2-dichloroethane (10 mL). Thereto was added dropwise over 15 minutes a 1,2-dichloroethane (20 mL) solution of 4-bromobenzoyl chloride (12.0 g; 54.7 mmol) (internal temperature of the vessel, 0° C. or lower). The contents were stirred for 20 minutes. Subsequently, a 1,2-dichloroethane (20 mL) solution of N,N-diisobutyl-m-toluidine (12.0 g; 54.7 mmol) was added dropwise thereto over 10 minutes, and the resultant mixture was further stirred for 1 hour under the same conditions. While elevating the temperature to room temperature, the mixture was continuously stirred for about 2.5 hours. This mixture was poured into ice water, and the resultant mixture was washed with chloroform. Subsequently, the pH of the mixture was regulated to 10 or higher with 4-N aqueous sodium hydroxide solution (with cooling with ice), and this mixture was extracted with chloroform. The chloroform layer was washed with 1-N aqueous sodium hydroxide solution three times, dried with anhydrous sodium sulfate, and then concentrated at a reduced pressure. The concentrate was purified by silica gel column chromatography (hexane/ethyl acetate, 15/1−10/1) to obtain compound 31 as a yellow powder (8.85 g; yield, 40%).

A Dimroth condenser was set on a 500-mL reaction vessel, and this vessel was subjected to nitrogen displacement. Compound 31 (8.5 g; 21.1 mmol) was introduced into the vessel and dissolved in dehydrated toluene (100 mL). Thereto were added diisobutylamine (7.3 mL; 42.2 mmol; Tokyo Kasei Co., Ltd.), t-butoxysodium (4.06 g; 42.2 mmol), palladium(II) acetate (284 mg; 1.27 mmol), and tri-t-butylphosphine (10% hexane solution; 552 mg; 2.53 mmol). The resultant mixture was refluxed with heating for 5.5 hours. After the mixture was cooled to room temperature, a small amount of water was added thereto. This mixture was filtered through a Celite, and the solid matter was washed with toluene so that the washings were added to the filtrate. The filtrate was extracted with toluene.

The toluene layer was washed with saturated aqueous sodium chloride solution three times, dried with anhydrous sodium sulfate, and then concentrated at a reduced pressure. The concentrate was purified by silica gel column chromatography (hexane/ethyl acetate, 15/1→10/1) to obtain compound 32 as a yellow oil (8.3 g; yield, 88%).

Compound 32 and 1-isobutylaminonaphthalene were used as starting materials to synthesize the target compound I-J in the same manner as in the synthesis of the target compound I-F (Synthesis Example 17) (amount obtained, 386 mg; yield, 92%).

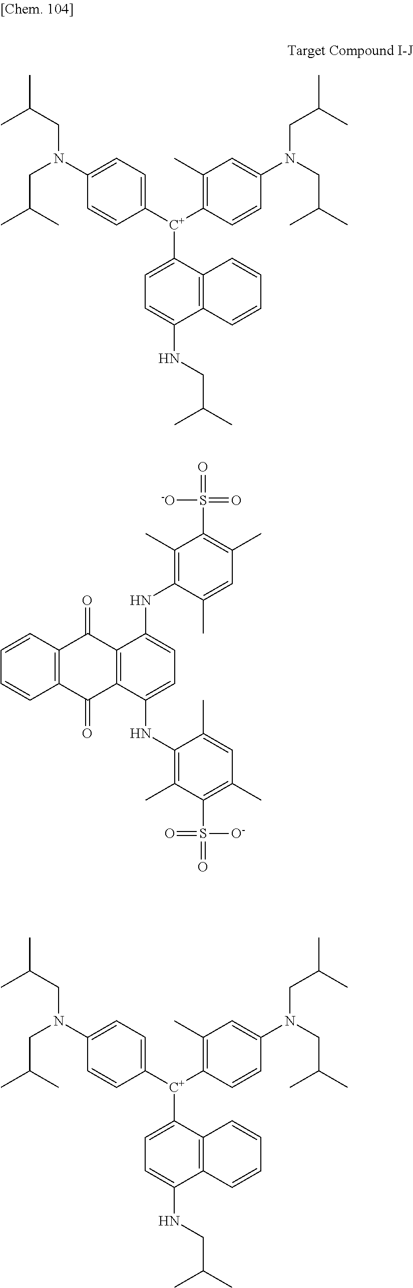

### Synthesis Example 22

Compound 23 and the compound 30 obtained by the method described in WO 2008/003604 A2 were used as starting materials to synthesize the target compound I-K in the same manner as in the synthesis of the target compound I-F (Synthesis Example 17) (amount obtained, 791 mg; yield, 88%).

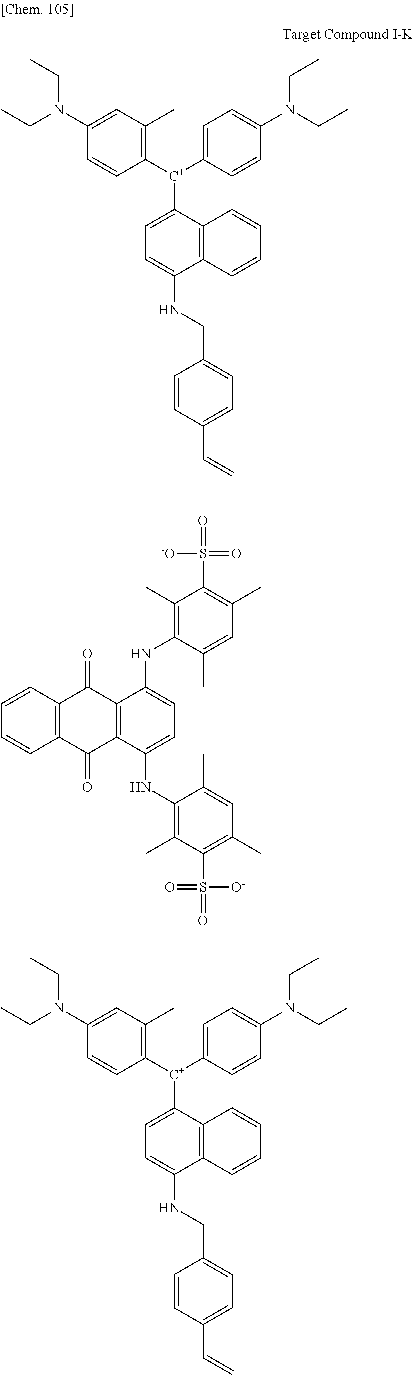

With respect to each of the target compounds obtained in Synthesis Examples 3, 5-10, and 12-22 given above, the coloring matters 1 and 2 constituting the compound, i.e., the cationic blue coloring matter having an even number of electrons (coloring matter 1) and the anionic coloring matter having an even number of electrons (coloring matter 2), were evaluated for the following properties: the excitation energy of the coloring matter 1 in a minimum singlet excitation state (S₁ state) (ΔE_{S1}(coloring matter 1)), the excitation energy of the coloring matter 2 in a minimum singlet excitation state (S₁ state) (ΔE_{S1}(coloring matter 2)), and the excitation energy of the coloring matter 2 in a minimum triplet excitation state (T₁ state) (ΔE_{T1}(coloring matter 2)), each excitation energy being obtained through a time-dependent density functional (B3LYP/6-31G(d,p)) calculation; and whether expression (i) and expression (ii) were satisfied or not. The results are shown in the following Table 41.

With respect to the coloring matter 2 having an odd number of electrons, the excitation energy of the coloring matter in a lowest excitation state (ΔE_{lowest}(coloring matter 2)) and whether expression (iii) was satisfied or not are shown in Table 41.

In each target compound, the coloring matter 2 is a phthalocyanine compound or anthraquinone compound moiety, and the coloring matter 1 is a triarylmethine compound moiety.

TABLE 41

| | | ΔE_{S1} | ΔE_{S1} | ΔE_{T1} | | | Having odd | ΔE_{lowest} | |
|---|---|---|---|---|---|---|---|---|---|
| | Compound | (coloring | (coloring | (coloring | Expression | Expression | number of | (coloring | Expression |
| | No. | matter 1) | matter 2) | matter 2) | (i) | (ii) | electrons | matter 2) | (iii) |
| Synthesis | V-C | 2.4 eV | — | — | — | — | yes | 1.0 eV | satisfied |
| Example 3 | | | | | | | | | |
| Synthesis | V-E | 2.4 eV | — | — | — | — | yes | 1.0 eV | satisfied |
| Example 5 | | | | | | | | | |
| Synthesis | V-F | 2.4 eV | — | — | — | — | yes | 1.0 eV | satisfied |
| Example 6 | | | | | | | | | |
| Synthesis | I-A | 2.3 eV | — | — | — | | yes | 1.0 eV | satisfied |
| Example 7 | | | | | | — | | | |
| Synthesis | V-G | 2.4 eV | 1.8 eV | 0.9 eV | satisfied | satisfied | — | — | — |
| Example 8 | | | | | | | | | |
| Synthesis | I-B | 2.3 eV | — | — | — | — | yes | 1.0 eV | satisfied |
| Example 9 | | | | | | | | | |
| Synthesis | X-A | 2.3 eV | 3.3 eV | 2.7 eV | not | not | — | — | — |
| Example 10 | | | | | satisfied | satisfied | | | |
| Synthesis | I-C | 2.3 eV | — | — | — | — | yes | 1.0 eV | satisfied |
| Example 12 | | | | | | | | | |
| Synthesis | I-D | 2.3 eV | 2.1 eV | 1.0 eV | satisfied | satisfied | — | — | — |
| Example 13 | | | | | | | | | |
| Synthesis | I-E | 2.3 eV | 1.8 eV | 0.9 eV | satisfied | satisfied | — | — | — |
| Example 14 | | | | | | | | | |
| Synthesis | V-H | 2.4 eV | 1.8 eV | 0.9 eV | satisfied | satisfied | — | — | — |
| Example 15 | | | | | | | | | |
| Synthesis | V-I | 2.3 eV | 1.8 eV | 0.9 eV | satisfied | satisfied | — | — | — |
| Example 16 | | | | | | | | | |
| Synthesis | I-F | 2.3 eV | 1.8 eV | 0.9 eV | satisfied | satisfied | — | — | — |
| Example 17 | | | | | | | | | |
| Synthesis | I-G | 2.4 eV | 1.8 eV | 0.9 eV | satisfied | satisfied | — | — | — |
| Example 18 | | | | | | | | | |
| Synthesis | I-H | 2.2 eV | 1.8 eV | 0.9 eV | satisfied | satisfied | — | — | — |
| Example 19 | | | | | | | | | |
| Synthesis | I-I | 2.2 eV | 1.8 eV | 0.9 eV | satisfied | satisfied | — | — | — |
| Example 20 | | | | | | | | | |
| Synthesis | I-J | 2.2 eV | 1.8 eV | 0.9 eV | satisfied | satisfied | — | — | — |
| Example 21 | | | | | | | | | |
| Synthesis | I-K | 2.2 eV | 1.8 eV | 0.9 eV | satisfied | satisfied | — | — | — |
| Example 22 | | | | | | | | | |

### Reference Example 1

One milligram of the target compound X-A obtained in Synthesis Example 10 was dissolved in a propylene glycol monomethyl ether acetate/propylene glycol monomethyl ether mixed solvent (weight ratio, 4/6). The solution obtained was examined for absorption spectrum with Hitachi Spectrophotometer UV-3500 (light source, Xe), manufactured by Hitachi High-Technonogies Corp.

The solution had a maximum absorption wavelength λₘₐₓ of 630 nm. The actual excitation energy of the target compound X-A was calculated using the following equation for conversion to excitation energy (ΔE_{obs}): ΔE_{obs} (eV)=1239.8/λₘₐₓ (nm). As a result, the actual excitation energy thereof was found to be 1.97 eV.

On the other hand, the excitation energy of the target compound X-A in a strong-absorption excitation state, as determined through a time-dependent density functional (B3LYP/6-31G(d,p), was 2.52 eV. Consequently, the difference caused by shifting between the actual value and the calculated value in the invention was estimated to be: 2.52 eV−1.92 eV=0.55 eV.

This shifting difference, i.e., 0.55 eV, is added to the found value of excitation energy for generating singlet-state oxygen, i.e., 0.92 eV. From the sum, i.e., 1.5 eV (rounded off by correcting to nearest tenth), the excitation energy in T₁ state is determined through a calculation. Thin films (e.g., pixels for color filters) having anions having a small value of the T₁-state excitation energy are expected to satisfy that the T₁-state excitation energy of the anions is lower than the excitation energy of singlet-state oxygen. Namely, the generation of singlet-state oxygen by excitation energy transfer is expected to be inhibited.

### [2] Synthesis of Binder Resin

### Synthesis Example 23

With nitrogen displacement, 145 parts by weight of propylene glycol monomethyl ether acetate was stirred and heated to 120° C. Thereto were added dropwise 20 parts by weight of styrene, 57 parts of glycidyl methacrylate, and 82 parts by weight of a monoacrylate having a tricyclodecane framework (FA-513M, manufactured by Hitachi Chemical Co., Ltd.). The mixture was continuously stirred at 120° C. for further two hours. Subsequently, the atmosphere in the reaction vessel was replaced with air. Thereinto were introduced 27 parts by weight of acrylic acid, 0.7 parts by weight of trisdimethylaminomethylphenol, and 0.12 parts by weight of hydroquinone. The resultant mixture was continuously reacted at 120° C. for 6 hours. Thereafter, 52 parts by weight of tetrahydrophthalic anhydride (THPA) and 0.7 parts by weight of triethylamine were added thereto and reacted at 120° C. for 3.5 hours to obtain a resin solution having a solid concentration of 62% by weight. The binder resin a thus obtained had a weight-average molecular weight (Mw) as determined by GPC of about 15,000. The binder resin a had the structure shown below (the resin was a high-molecular compound including the four kinds of repeating units shown below).

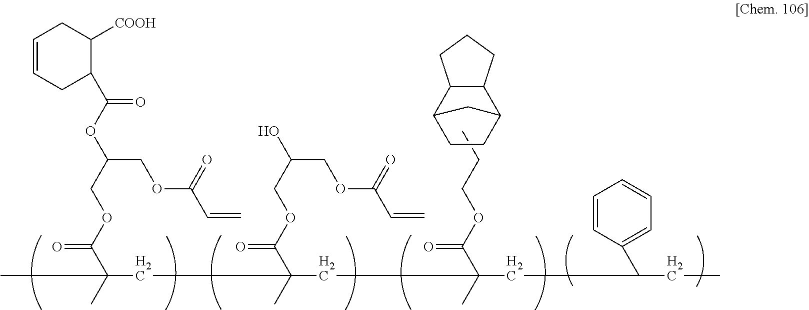

### Examples and Comparative Examples

### Preparation of Colored Resin Compositions

### Preparation of Dye-Containing Compositions

### Examples 1 to 8 and 10 to 18 and Comparative Examples 1 to 4

Table 42 shows the dyes (colorants) incorporated in Examples 1 to 8 and 10 to 18 and Comparative Examples 1 to 4.

TABLE 42

| | |
|---|---|
| Example 1 | dye A |
| | (target compound V-A obtained in Synthesis Example 1) |
| Example 2 | dye B |
| | (target compound V-B obtained in Synthesis Example 2) |
| Example 3 | dye C |
| | (target compound V-C obtained in Synthesis Example 3) |
| Example 4 | dye D |
| | (target compound V-D obtained in Synthesis Example 4) |
| Example 5 | dye E |
| | (target compound V-E obtained in Synthesis Example 5) |
| Example 6 | dye F |
| | (target compound V-F obtained in Synthesis Example 6) |
| Example 7 | dye G |
| | (target compound I-A obtained in Synthesis Example 7) |
| Example 8 | dye H |
| | (target compound V-G obtained in Synthesis Example 8) |
| Example 10 | dye L |
| | (target compound I-E obtained in Synthesis Example 14) |
| Example 11 | dye M |
| | (target compound V-H obtained in Synthesis Example 15) |
| Example 12 | dye N |
| | (target compound V-I obtained in Synthesis Example 16) |
| Example 13 | dye O |
| | (target compound I-F obtained in Synthesis Example 17) |
| Example 14 | dye P |
| | (target compound I-G obtained in Synthesis Example 18) |
| Example 15 | dye Q |
| | (target compound I-H obtained in Synthesis Example 19) |
| Example 16 | dye R |
| | (target compound I-I obtained in Synthesis Example 20) |
| Example 17 | dye S |
| | (target compound I-J obtained in Synthesis Example 21) |
| Example 18 | dye T |
| | (target compound I-K obtained in Synthesis Example 22) |
| Comparative | C.I. Acid Blue 83 |
| Example 1 | |
| Comparative | mixture of C.I. Acid Blue 83 and C.I. Solvent Blue 67 |
| Example 2 | (2:1 by weight) |
| Comparative | dye J |
| Example 3 | (target compound X-A obtained in Synthesis Example 10) |
| Comparative | dye K |
| Example 4 | (target compound X-B obtained in Synthesis Example 11) |

Each dye shown in Table 42 was mixed with the binder resin a obtained in Synthesis Example 23 and with other ingredients according to the formulation shown in Table 43 to prepare a colored resin composition. In the mixing, the ingredients were stirred for 1 hour or longer until the dye dissolved sufficiently. Finally, the mixture was filtered through a disk type filter having a pore diameter of 5 μm to remove foreign matter.

TABLE 43

| | | Amount |
|---|---|---|
| | | (parts by |
| Kind of ingredient | Details of ingredient | weight) |
| Colorant | dye shown in Table 42 | 1.17 |
| Solvent 1 | propylene glycol monomethyl ether | 23.0 |
| | acetate | |
| Solvent 2 | propylene glycol monomethyl ether | 48.0 |
| Binder resin | solution of binder resin a (solid | 14.9 |
| | concentration, 62% by weight) | |
| Photopolymerizable | dipentaerythritol hexaacrylate | 8.96 |
| monomer | | |
| Photopolymerization | 2,2′-(o-chlorophenyl)-4,4′,5,5′- | 0.73 |
| initiator system | tetraphenyl-biimidazole | |
| component 1 | | |
| Photopolymerization | 4,4′-bisdiethylaminobenzophenone | 0.22 |
| initiator system | | |
| component 2 | | |
| Photopolymerization | 2-mercaptobenzothiazole | 0.15 |
| initiator system | | |
| component 3 | | |
| Photopolymerization | 2-methyl-1-[4-(methylthio)- | 2.19 |
| initiator system | phenyl]-2-morpholinopropan-1-one | |
| component 4 | | |
| Surfactant | “F-475” manufactured by Dainippon | 0.02 |
| | Ink & Chemicals, Inc. | |

### Preparation of Compositions Containing Colorants (Dye and Pigment) Having Low Solubility in Solvent

### Example 9 and Comparative Example 5

Into a stainless-steel vessel were introduced 11.36 parts by weight of the colorant shown in Table 44 as a colorant (the amount in Comparative Example 5 being the sum of the two), 57.5 parts by weight of propylene glycol monomethyl ether acetate as a solvent, 3.02 parts by weight, on a solid basis, of “Solsperse 55000”, manufactured by Avecia, for Example 9 or of “Disperbyk 2000”, manufactured by BYK-Chemie GmbH, for Comparative Example 5 as a dispersant, and 215.7 parts by weight of zirconia beads having a diameter of 0.5 mm. The mixture was treated with a paint shaker for 6 hours to disperse the colorant. Thus, blue-colorant dispersions were prepared.

TABLE 44

| | |
|---|---|
| Example 9 | dye I |
| | (target compound I-B obtained in Synthesis Example 9) |
| Comparative | mixture of Pigment Blue 15:6 and Pigment Violet 23 |
| Example 5 | (10:1.36 by weight) |

The colorant dispersions obtained were mixed with the binder resin a obtained in Synthesis Example 23 and other ingredients according to the formulation shown in Table 45. Thus, colored resin compositions were prepared.

TABLE 45

| | | Amount |
|---|---|---|
| | | (parts by |
| Kind of ingredient | Details of ingredient | weight) |
| Colorant | colorant dispersion containing | 21.49 |
| | colorant shown in Table 44 | |
| Solvent 1 | propylene glycol monomethyl ether | 50.1 |
| | acetate | |
| Solvent 2 | propylene glycol monomethyl ether | 12.8 |
| Binder resin | solution of binder resin a (solid | 8.8 |
| | concentration, 62% by weight) | |
| Photopolymerizable | dipentaerythritol hexaacrylate | 3.87 |
| monomer | | |
| Photopolymerization | 2,4-diethylthioxanthone | 0.50 |
| initiator system | | |
| component 1 | | |
| Photopolymerization | 2-methyl-1-[4-(methylthio) | 2.48 |
| initiator system | phenyl]-2-morpholinopropan-1-one | |
| component 2 | | |
| Surfactant | “F-475” manufactured by Dainippon | 0.02 |
| | Ink & Chemicals, Inc. | |

### <Evaluation of Spectral Characteristics and Heat Resistance/Light Resistance>

Each of the colored resin compositions was applied to a glass substrate cut into a 5-cm square, by spin coating in such an amount as to result in a dry-film thickness of 1.8 μm. The coating film was vacuum-dried and then pre-baked at 80° C. for 3 minutes on a hot plate. Thereafter, the whole surface of the coating film was exposed to light in an exposure amount of 60 mJ/cm². Thereafter, the coating film was examined for spectral transmittance with spectrophotometer “U-3310”, manufactured by Hitachi, Ltd., and chromaticity coordinates in the XYZ color system (illuminant C) were calculated. The results thereof are shown in Table 46 and Table 47.

Subsequently, the substrate was sandwiched between two polarizers so that the substrate came into close contact with each polarizer without leaving a gap therebetween. A color-and-luminance meter (“BM-5A”, manufactured by Topcon Corp.) was used to measure the quantity of light A (cd/cm²) detected when the polarizers were orthogonal and the quantity of light B (cd/cm²) detected when the polarizers were parallel. Contrast ratio was calculated from the light quantities (B/A). The results thereof are shown in Table 48.

TABLE 46

| | 430 nm | 550 nm | 600 nm |
|---|---|---|---|
| Example 1 | 75.8 | 5.4 | 0.3 |
| Example 2 | 70.4 | 7.0 | 0.3 |
| Example 3 | 78.0 | 6.5 | 0.3 |
| Example 4 | 73.9 | 6.3 | 0.3 |
| Example 5 | 76.8 | 6.3 | 0.5 |
| Example 6 | 70.5 | 2.1 | 0.2 |
| Example 7 | 75.4 | 1.1 | 0.0 |
| Example 8 | 80.6 | 3.1 | 0.5 |
| Example 9 | 91.0 | 5.9 | 0.3 |
| Example 10 | 88.8 | 1.1 | 0.0 |
| Example 11 | 82.5 | 4.4 | 0.7 |
| Example 12 | 82.7 | 3.9 | 1.3 |
| Example 13 | 83.8 | 1.3 | 0.0 |
| Example 14 | 90.1 | 1.2 | 0.0 |
| Example 15 | 84.1 | 1.3 | 0.0 |
| Example 16 | 84.1 | 1.0 | 0.0 |
| Example 17 | 84.0 | 1.3 | 0.0 |
| Example 18 | 78.9 | 1.0 | 0.0 |
| Comparative Example 1 | 83.8 | 62.9 | 58.6 |
| Comparative Example 2 | 43.8 | 10.5 | 0.4 |
| Comparative Example 3 | 94.8 | 1.0 | 0.0 |
| Comparative Example 4 | 86.8 | 1.4 | 0.0 |
| Comparative Example 5 | 71.2 | 2.0 | 0.0 |

TABLE 47

| | x | y | Y |
|---|---|---|---|
| Example 1 | 0.154 | 0.097 | 11.2 |
| Example 2 | 0.154 | 0.097 | 10.2 |
| Example 3 | 0.158 | 0.097 | 11.3 |
| Example 4 | 0.154 | 0.097 | 10.8 |
| Example 5 | 0.157 | 0.097 | 11.1 |
| Example 6 | 0.143 | 0.097 | 10.9 |
| Example 7 | 0.137 | 0.097 | 11.7 |
| Example 8 | 0.153 | 0.097 | 12.2 |
| Example 9 | 0.136 | 0.097 | 12.6 |
| Example 10 | 0.138 | 0.097 | 13.0 |
| Example 11 | 0.158 | 0.097 | 12.2 |
| Example 12 | 0.155 | 0.097 | 12.3 |
| Example 13 | 0.137 | 0.097 | 12.4 |
| Example 14 | 0.146 | 0.097 | 13.2 |
| Example 15 | 0.137 | 0.097 | 12.4 |
| Example 16 | 0.138 | 0.097 | 12.5 |
| Example 17 | 0.137 | 0.097 | 12.4 |
| Example 18 | 0.137 | 0.097 | 11.8 |
| Comparative Example 1 | 0.273 | 0.288 | 68.1 |
| Comparative Example 2 | 0.138 | 0.176 | 17.6 |
| Comparative Example 3 | 0.138 | 0.097 | 13.4 |
| Comparative Example 4 | 0.139 | 0.097 | 12.0 |
| Comparative Example 5 | 0.137 | 0.097 | 11.3 |

TABLE 48

| | Contrast ratio |
|---|---|
| Example 1 | 8000 |
| Example 2 | 8200 |
| Example 3 | 8000 |
| Example 4 | 8100 |
| Example 5 | 8000 |
| Example 6 | 8200 |
| Example 7 | 8100 |
| Example 8 | 8100 |
| Example 9 | 5600 |
| Example 10 | 8000 |
| Example 11 | 8000 |
| Example 12 | 8100 |
| Example 13 | 8000 |
| Example 14 | 8100 |
| Example 15 | 8100 |
| Example 16 | 8100 |
| Example 17 | 8000 |
| Example 18 | 8000 |
| Comparative Example 1 | 8000 |
| Comparative Example 2 | 7900 |
| Comparative Example 3 | 8100 |
| Comparative Example 4 | 8000 |
| Comparative Example 5 | 5500 |

The following can be seen from Tables 46 to 48.

With respect to luminance (Y), which is required for both organic EL displays and liquid-crystal displays, a comparison in the same chromaticity (y) coordinate shows that Comparative Example 3 is the highest, followed by Examples 14, 10, 9, 16, 17, 15, 13, 12, 8, and 11, Comparative Example 4, Examples 18, 7, and 3, Comparative Example 5, and Examples 1, 5, 6, 4, and 2 in this order. Comparative Example 5 is a pigment system which has been conventionally used. Examples 1, 5, 6, 4, and 2 hence have a lower luminance than the conventional system and are less suitable for use. However, with respect to contrast, which is an exceedingly important property in liquid-crystal displays, Examples 1 to 8 and 10 to 18 and Comparative Examples 1 to 4 have a far higher value than the conventional pigment system of Comparative Example 5. It can be considered that the high-contrast characteristics overbalance the low luminance.

A comparison with the dyes described in patent document 3 (Comparative Examples 1 and 2) is as follows. When the colored resin compositions having the same dye concentration and the same film thickness are compared, the colored resin compositions of the Examples have a deep blue color, while the color of the colored resin compositions of Comparative Examples 1 and 2 is nothing but a pale blue-green color (see the chromaticity data given in Table 47). It can therefore be said that the colored resin compositions of the Examples are overwhelmingly superior.

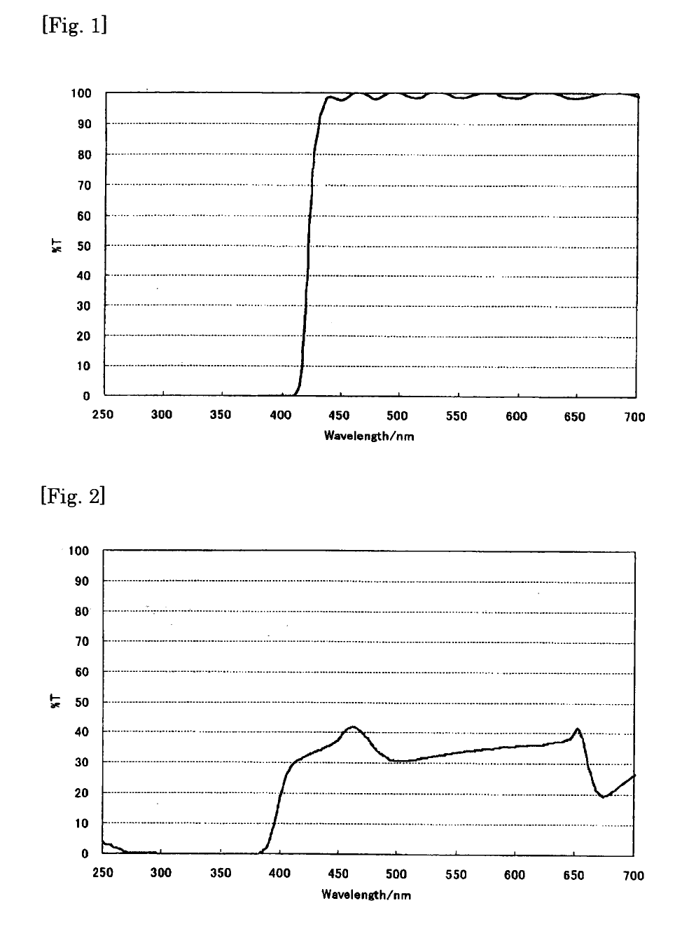

Subsequently, the substrates were burned at each of 200° C. and 230° C. for 30 minutes in a clean oven and then examined for spectral transmittance in the same manner as described above to determine a color difference (ΔE*ab). The results thereof are shown in Table 49. Furthermore, the substrates were burned at 180° C. for 30 minutes in a clean oven and then irradiated with ultraviolet rays for 16 hours using a xenon fadeometer, and a color difference (ΔE*ab) between the unirradiated and the irradiated substrates was determined. The results thereof are shown in Table 50. With respect to irradiation conditions, the following three kinds of conditions were used for evaluating light resistance: the substrates were directly irradiated; the substrates were irradiated through a UV-cut filter having the transmission spectrum shown in FIG. 1; and the substrates were irradiated through a polarizer having the transmission spectrum shown in FIG. 2.

TABLE 49

Heat resistance (ΔE*ab)

| | 200° C. | 230° C. |
|---|---|---|
| Example 1 | 0.8 | 11.2 |
| Example 2 | 2.8 | 10.1 |
| Example 3 | 1.9 | 10.4 |
| Example 4 | 1.3 | 6.7 |
| Example 5 | 0.9 | 9.7 |
| Example 6 | 3.6 | 14.0 |
| Example 7 | 3.8 | 6.1 |
| Example 8 | 1.2 | 5.3 |
| Example 9 | 6.9 | 17.3 |
| Example 10 | 2.4 | 41.9 |
| Example 11 | 1.3 | 3.3 |
| Example 12 | 1.9 | 4.4 |
| Example 13 | 6.1 | 10.1 |
| Example 14 | 3.0 | 23.4 |
| Example 15 | 2.2 | 7.3 |
| Example 16 | 5.2 | 36.1 |
| Example 17 | 3.1 | 6.8 |
| Example 18 | 12.5 | 30.0 |
| Comparative Example 1 | 29.8 | 40.2 |
| Comparative Example 2 | 31.0 | 37.8 |
| Comparative Example 3 | 1.7 | 32.8 |
| Comparative Example 4 | 73.6 | 86.4 |
| Comparative Example 5 | 1.2 | 3.5 |

TABLE 50

| | Light resistance (ΔE*ab) | | |
|---|---|---|---|
| | Polarizer | UV-cut | None |
| Example 1 | 1.6 | 1.6 | 20.2 |
| Example 2 | 0.2 | 0.2 | 11.3 |
| Example 3 | 0.8 | 0.7 | 20.6 |
| Example 4 | 0.6 | 0.5 | 11.6 |
| Example 5 | 0.4 | 0.9 | 15.7 |
| Example 6 | 1.5 | 0.7 | 15.9 |
| Example 7 | 2.7 | 3.1 | 25.1 |
| Example 8 | 4.2 | 5.5 | 25.2 |
| Example 9 | 4.9 | 8.1 | 27.6 |
| Example 10 | 3.3 | 4.9 | 42.1 |
| Example 11 | 13.5 | 18.3 | 59.1 |
| Example 12 | 7.4 | 10.6 | 52.1 |
| Example 13 | 4.9 | 6.5 | 45.2 |
| Example 14 | 7.3 | 10.6 | 55.9 |
| Example 15 | 4.9 | 6.6 | 48.0 |
| Example 16 | 5.1 | 6.4 | 50.8 |
| Example 17 | 9.3 | 10.4 | 57.9 |
| Example 18 | 5.4 | 5.1 | 39.3 |
| Comparative Example 1 | 3.9 | 5.1 | 14.4 |
| Comparative Example 2 | 7.0 | 6.4 | 9.4 |
| Comparative Example 3 | 20.7 | 38.5 | 85.5 |
| Comparative Example 4 | 16.3 | 27.8 | 63.2 |
| Comparative Example 5 | 0.1 | 0.1 | 0.1 |

It can be seen from Tables 49 and 50 that the colored resin compositions of the Examples have far higher heat resistance and light resistance than the compositions of Comparative Examples 3 and 4 (the dye in Comparative Example 3 is akin in structure to the dye described in patent document 4), which showed relatively satisfactory spectral characteristics.

Next, the coated substrates, in combination with an organic electroluminescent (EL) device, were examined for chromaticity. <Production of Organic Electroluminescent Device>

The organic electroluminescent device shown in FIG. 4 was produced by the method shown below.

A glass substrate 1 having an indium/tin oxide (ITO) transparent conductive film deposited thereon in a thickness of 150 nm (formed by sputtering; sheet resistance, 15Ω) was processed by an ordinary photolithographic technique and hydrochloric acid etching to impart thereto a pattern constituted of stripes having a width of 2 mm. Thus, an anode 2 was formed. The ITO substrate bearing the pattern was subjected to ultrasonic cleaning with acetone, rinsing with pure water, and ultrasonic cleaning with isopropyl alcohol in this order, subsequently dried with nitrogen blowing, and finally subjected to ultraviolet ozone cleaning. Subsequently, 9,9-bis[4-(N,N-bisnaphthylamino)phenyl]-9H-fluorene (LT-N121, manufactured by Luminescent Technology), which is represented by the following structural formula, was deposited as a hole-transporting layer 3 in a thickness of 40 nm under the conditions of a crucible temperature of 285-310° C. and a deposition rate of 0.1 nm/sec. The degree of vacuum during the vapor deposition was 1.7×10⁻⁴ Pa.

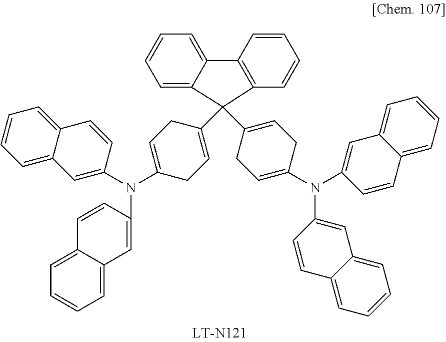

Subsequently, 2,2′-diperylenyl-9,9′-spirobifluorene (LT-N428, manufactured by Luminescent Technology) and 2,7-bis[9,9′-spirobifluorenyl]-9,9′-spirobiflorene (LT-N628, manufactured by Luminescent Technology), which are represented by the following structural formulae, were deposited as a luminescent layer 4 by coevaporation under the following conditions.

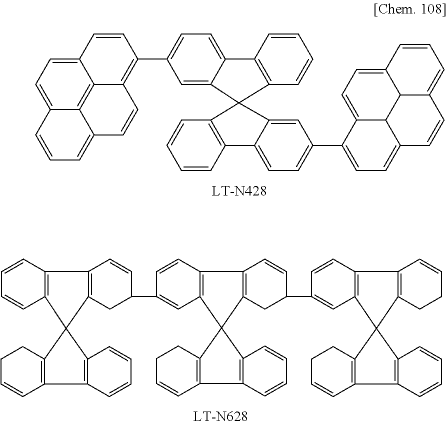

### (Vapor Deposition Conditions for Luminescent Layer)

LT-N428 crucible temperature: 320-330° C.

LT-N628 crucible temperature: 450-455° C.

Deposition rate of LT-N428: 0.1 nm/sec

Deposition rate of LT-N628: 0.05 nm/sec

Under those conditions, a film having a thickness of 30 nm was superposed to form a luminescent layer 4. The degree of vacuum during the vapor deposition was 1.7−1.9×10⁻⁴ Pa.

Subsequently, 1,3-bis[2-(2,2′-bipyridinyl)-1,3,4-oxadiazoyl]benzene (LT-N820, manufactured by Luminescent Technology), which is represented by the following structural formula, was vapor-deposited in a thickness of 30 nm as an electron-transporting layer 5 on the luminescent layer 4 in the same manner. In this operation, the temperature of the LT-N820 crucible was regulated so as to be in the range of 255-260° C., and the deposition rate of LT-N820 was regulated so as to be in the range of 0.08-0.1 nm/sec. The degree of vacuum during the vapor deposition was regulated to 1.2×10⁻⁴ Pa.

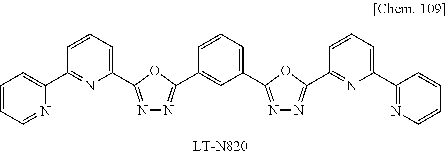

When the hole-transporting layer 3, luminescent layer 4, and electron-transporting layer 5 were deposited by vacuum evaporation, the temperature of the substrate was kept at room temperature.

The device in which the layers including the electron-transporting layer 5 had been formed was temporarily taken out of the vacuum deposition apparatus and placed in the air. Next, a shadow mask bearing stripes with a width of 2 mm was brought, as a mask for cathode deposition, into close contact with the device so that the stripes of this mask were perpendicular to the ITO stripes of the anode 2. Subsequently, this device was disposed in another vapor deposition apparatus, which was then evacuated until the degree of vacuum in the apparatus became 2.3×10⁻⁵ Pa or lower in the same manner as in the formation of the organic layers.

Next, a cathode 6 was formed in the following manner. First, using a molybdenum boat, lithium fluoride (LiF) was deposited in a thickness of 0.5 nm on the electron-transporting layer 5 at a deposition rate of 0.008-0.01 nm/sec and a degree of vacuum of 3.7×10⁻⁶ Pa. Subsequently, aluminum was heated with a molybdenum boat in the same manner to form an aluminum layer in a thickness of 80 nm at a deposition rate of 0.1-0.2 nm/sec and a degree of vacuum of 2.7×10⁻⁶ to 2.5×10⁻⁶ Pa to complete a cathode 6. When the two-layer type cathode 6 was formed by vapor deposition, the temperature of the substrate was kept at room temperature.

In the manner described above, an organic electroluminescent device having a luminescent area with a size of 2 mm×2 mm was prepared.

A voltage of 6 V was applied to this device, and the device was evaluated for luminescence caused thereby and for the color of the luminescence. The resultant EL spectrum had a maximum luminescence wavelength of 436 nm, and the CIE chromaticity coordinates (CIE chromaticity coordinates determined when front luminance was 10-1,000 cd/m²) were (0.16, 0.15).

### <Evaluation of Spectral Characteristics>

The organic electroluminescent device was used in combination with each of the coated substrates of Examples 1 to 18 and Comparative Examples 1 to 5 and examined for chromaticity. The results obtained are shown in Table 51.

TABLE 51

| | x | y | Y |
|---|---|---|---|
| Example 1 | 0.152 | 0.034 | 39.0 |
| Example 2 | 0.153 | 0.032 | 34.3 |
| Example 3 | 0.152 | 0.033 | 38.3 |
| Example 4 | 0.152 | 0.033 | 37.3 |
| Example 5 | 0.152 | 0.033 | 37.7 |
| Example 6 | 0.150 | 0.037 | 41.3 |
| Example 7 | 0.150 | 0.038 | 45.5 |
| Example 8 | 0.151 | 0.036 | 44.2 |
| Example 9 | 0.150 | 0.037 | 48.4 |
| Example 10 | 0.150 | 0.037 | 49.4 |
| Example 11 | 0.151 | 0.034 | 42.2 |
| Example 12 | 0.151 | 0.035 | 42.9 |
| Example 13 | 0.150 | 0.037 | 47.2 |
| Example 14 | 0.151 | 0.037 | 49.2 |
| Example 15 | 0.150 | 0.037 | 47.3 |
| Example 16 | 0.150 | 0.037 | 47.8 |
| Example 17 | 0.150 | 0.037 | 47.6 |
| Example 18 | 0.150 | 0.037 | 45.3 |
| Comparative Example 1 | 0.153 | 0.062 | 86.1 |
| Comparative Example 2 | 0.147 | 0.053 | 45.6 |
| Comparative Example 3 | 0.151 | 0.037 | 51.0 |
| Comparative Example 4 | 0.151 | 0.036 | 44.9 |
| Comparative Example 5 | 0.150 | 0.037 | 43.4 |

The following can be seen from Table 51. In the comparison in which the organic electroluminescent device was used as a light source, the same order as in the comparison using the illuminant C was obtained. However, because there is no concept of contrast, the Examples that are superior to Comparative Example 5, which is a conventional pigment-containing system, are considered to be Examples 7 to 18. (Incidentally, Table 51 shows that Examples 11 and 12 are lower in the value of Y than Comparative Example 5. However, when the values of y in Examples 11 and 12 are converted to the same value as in Comparative Example 5, then Examples 11 and 12 are superior.)

While the invention has been described in detail and with reference to specific embodiments thereof, it will be apparent to one skilled in the art that various changes and modifications can be made therein without departing from the spirit and scope thereof.

This application is based on a Japanese patent application filed on Feb. 27, 2008 (Application No. 2008-046323) and a Japanese patent application filed on Oct. 9, 2008 (Application No. 2008-262952), the contents thereof being herein incorporated by reference.

### INDUSTRIAL APPLICABILITY

According to the invention, a color filter satisfying light resistance, which is an extremely important item among properties concerning the long-term reliability of color filters, and further having heat resistance required in color display production steps and having blue pixels with excellent color purity and excellent transmittance can be obtained. By using such a color filter, the light emitted by an organic EL display and the light from a backlight for the color filter can be efficiently led out, and an organic EL display and a liquid-crystal display device which combine high color reproducibility and high luminance can be provided. It is also possible to improve the contrast of a liquid-crystal display device.

1. A colored resin composition for color filter which comprises (a) a binder resin, (b) a solvent, and (c) a colorant, the colorant (c) comprising a compound represented by the following general formula (I): 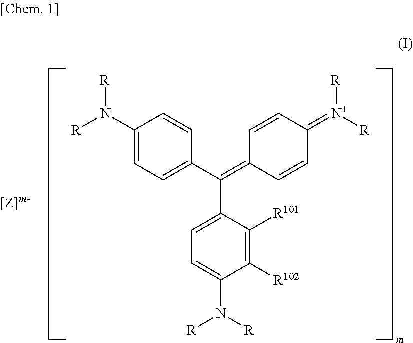
(wherein Z represents an anion having a valence of m and having an anthraquinone framework or phthalocyanine framework; m represents an integer of 1-4;
R represents a hydrogen atom, an alkyl group which has 1-8 carbon atoms and may have a substituent, or a phenyl group which may have a substituent, or adjoining Rs are bonded to each other to form a ring, and the ring may have a substituent and the Rs may be the same or different;
R¹⁰¹ represents an alkyl group which has 1-8 carbon atoms and may have a substituent, an alkenyl group which has 2-6 carbon atoms and may have a substituent, a phenyl group which may have a substituent, or a fluorine atom;
R¹⁰² represents a hydrogen atom, an alkyl group which has 1-8 carbon atoms and may have a substituent, an alkenyl group which has 2-6 carbon atoms and may have a substituent, a phenyl group which may have a substituent, or a fluorine atom;
alternatively, R¹⁰¹ and R¹⁰² may be bonded to each other to form a ring, and the ring may have a substituent; and
the three benzene rings in the cation moiety of general formula (I) each may be substituted with a group other than —NR₂, —R¹⁰¹, and —R¹⁰²;
provided that when a plurality of groups represented by 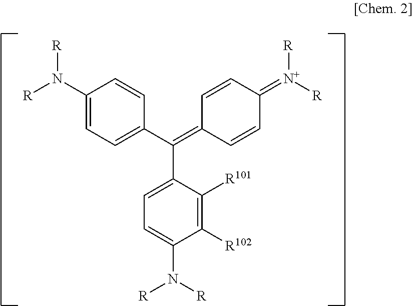
are contained in the molecule, these groups may have the same structure or may have different structures).

2. The colored resin composition for color filter according to claim 1, wherein the compound represented by general formula (I) is a compound represented by the following general formula (I′): 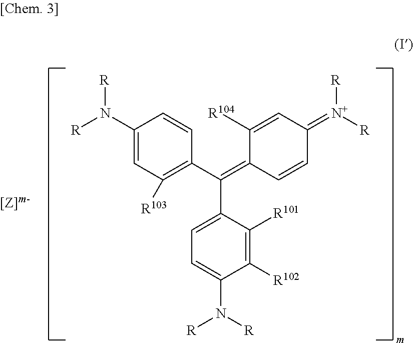
(wherein Z, m, R, R¹⁰¹, and R¹⁰² have the same meanings as in general formula (I), and
R¹⁰³ and R¹⁰⁴ each independently represent a hydrogen atom, a halogen atom, or an alkyl group having 1-8 carbon atoms,
provided that when a plurality of groups represented by 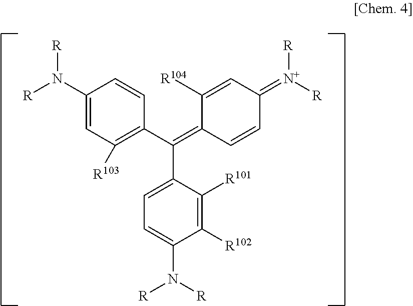
are contained in the molecule, these groups may have the same structure or may have different structures).

3. The colored resin composition for color filter according to claim 2, wherein the compound represented by general formula (I′) is a compound represented by the following general formula (II): 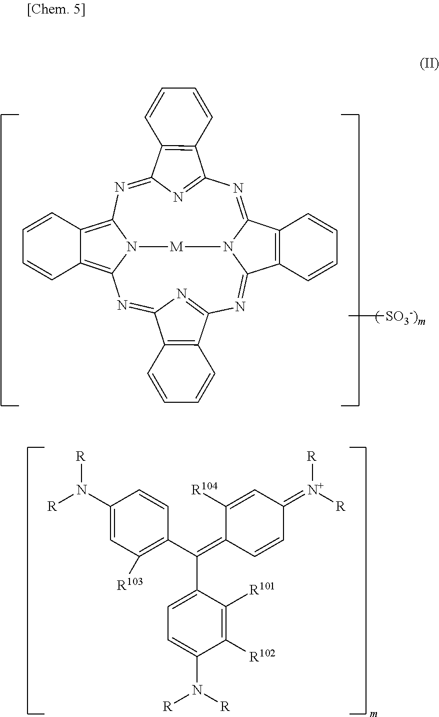
(wherein M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom;
the —SO₃⁻ group in the formula is bonded to any of the carbon atoms constituting the benzene rings included in the phthalocyanine framework; among the carbon atoms constituting the four benzene rings, the carbon atoms having no —SO₃⁻ group bonded thereto may be substituted with any group; and
m, R, and R¹⁰¹ to R¹⁰⁴ have the same meanings as in general formula (I′); provided that when a plurality of groups represented by 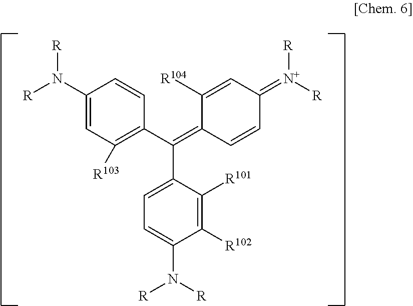
are contained in the molecule, these groups may have the same structure or may have different structures).

4. The colored resin composition for color filter according to claim 3, wherein the compound represented by general formula (II) is a compound represented by the following general formula (III): 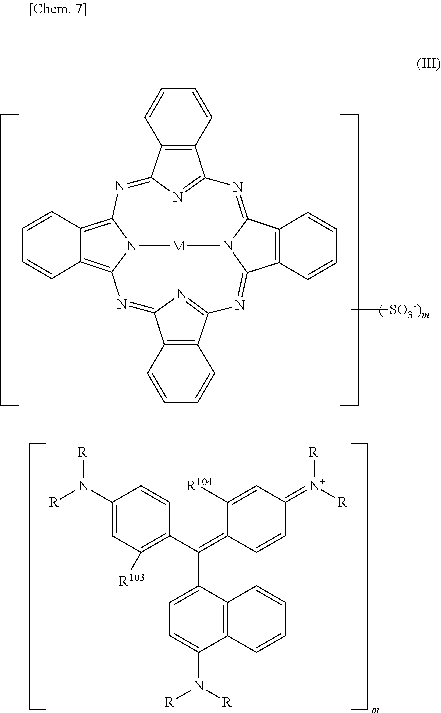
(wherein the —SO₃⁻ group is bonded to any of the carbon atoms constituting the benzene rings included in the phthalocyanine framework; the phthalocyanine framework has no substituents other than the —SO₃⁻ group; and
m, M, R, R¹⁰³, and R¹⁰⁴ have the same meanings as in general formula (II); provided that when a plurality of groups represented by 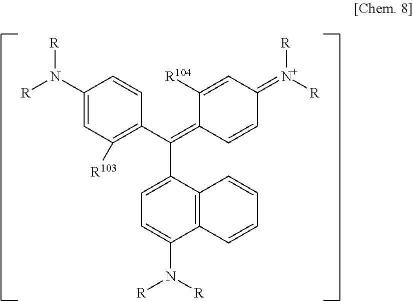
are contained in the molecule, these groups may have the same structure or may have different structures).

5. The colored resin composition for color filter according to claim 2, wherein the compound represented by general formula (I′) is a compound represented by the following general formula (IV): 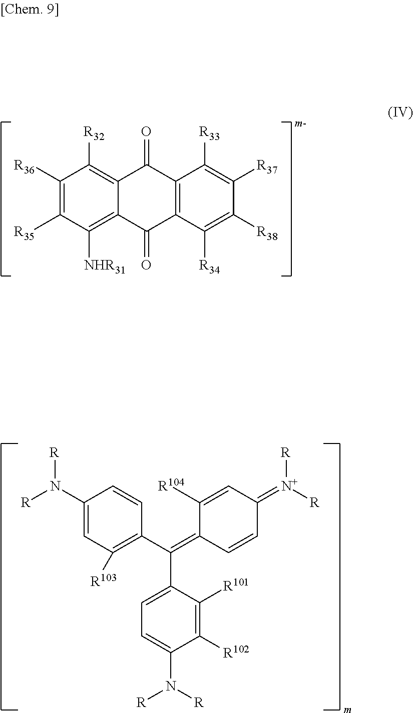
(wherein among the substituents possessed by the anthraquinone framework,
R₃₁ represents a hydrogen atom or a phenyl group which may have a substituent;
R₃₂, R₃₃, and R₃₄ each independently are one of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ is an —NHR₄₁ group;
R₃₅, R₃₆, R₃₇, and R₃₈ each independently represent a hydrogen atom, —SO₃⁻, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms);
the number of —SO₃⁻ groups bonded to each anthraquinone framework is m; and
m, R, and R¹⁰¹ to R¹⁰⁴ have the same meanings as in general formula (I′); provided that when a plurality of groups represented by 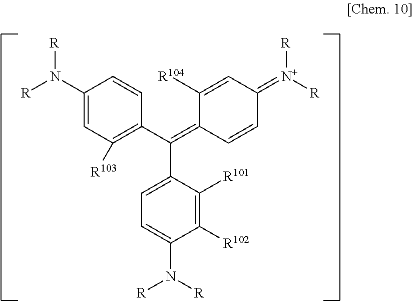
are contained in the molecule, these groups may have the same structure or may have different structures).

6. The colored resin composition for color filter according to claim 5, wherein the compound represented by general formula (IV) is a compound represented by the following general formula (IV′): 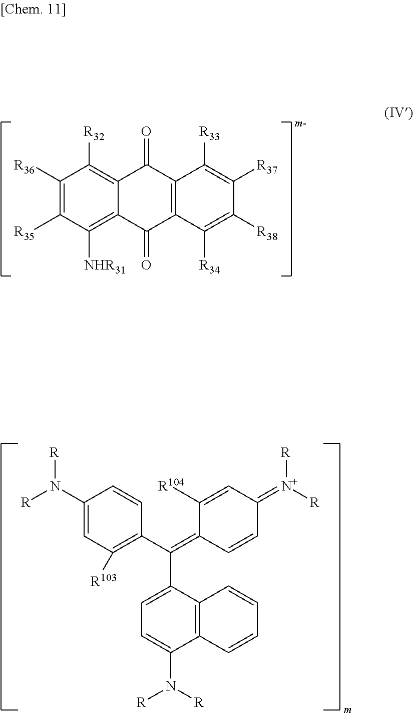
(wherein m, R, R₃₁ to R₃₈, R¹⁰³, and R¹⁰⁴ have the same meanings as in general formula (IV), provided that when a plurality of groups represented by 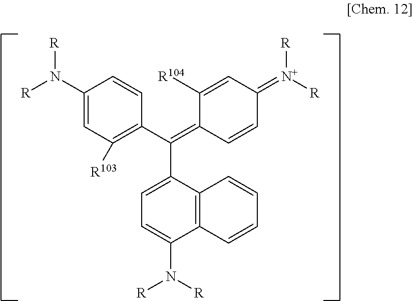
are contained in the molecule, these groups may have the same structure or may have different structures).

7. The colored resin composition for color filter according to claim 1, which contains the compound represented by general formula (I) in an amount of 1-50% by weight based on all solid components.

8. A colored resin composition for color filter which comprises (a) a binder resin, (b) a solvent, and (c) a colorant, the colorant (c) comprising a compound represented by the following general formula (V): 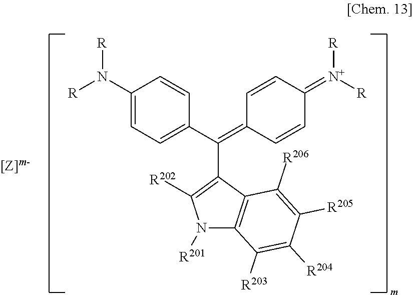
(wherein Z represents an anion having a valence of m and having an anthraquinone framework or phthalocyanine framework; m represents an integer of 1-4;
R represents a hydrogen atom, an alkyl group which has 1-8 carbon atoms and may have a substituent, or a phenyl group which may have a substituent, or adjoining Rs are bonded to each other to form a ring, and the ring may have a substituent and the Rs may be the same or different;
R²⁰¹ represents a hydrogen atom, an alkyl group which has 1-8 carbon atoms and may have a substituent, a benzyl group, a phenyl group which may have a substituent, or a naphthyl group which may have a substituent;
R²⁰² represents an alkyl group which has 1-8 carbon atoms and may have a substituent, a phenyl group which may have a substituent, a naphthyl group which may have a substituent, or an aromatic heterocyclic group which may have a substituent;
R²⁰³, R²⁰⁴, R²⁰⁵, and R²⁰⁶ each independently represent a hydrogen atom, an alkyl group which has 1-8 carbon atoms and may have a substituent, a perfluoroalkyl group having 1-8 carbon atoms, an alkoxy group having 1-12 carbon atoms, a phenoxy group, a naphthyloxy group, a fluorine atom, a phenyl group which may have a substituent, —CO₂R₄₆, —SO₃R₄₇, or —SO₂NHR₄₈ (wherein R₄₆ to R₄₈ each independently represent an alkyl group having 1-6 carbon atoms); and
the two benzene rings in the cation moiety of general formula (V) each may be substituted with a group other than —NR₂;
provided that when a plurality of groups represented by 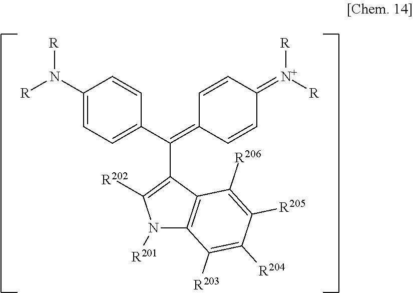
are contained in the molecule, these groups may have the same structure or may have difficult structures).

9. The colored resin composition for color filter according to claim 8, wherein the compound represented by general formula (V) is a compound represented by the following general formula (V′): 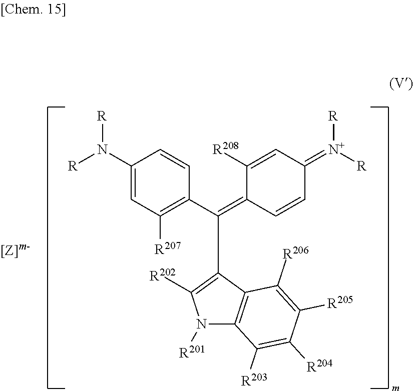
(wherein Z, m, R, and R²⁰¹ to R²⁰⁶ each have the same meaning as in general formula (V), and
R²⁰⁷ and R²⁰⁸ each independently represent a hydrogen atom, a halogen atom, or an alkyl group having 1-8 carbon atoms,
provided that when a plurality of groups represented by 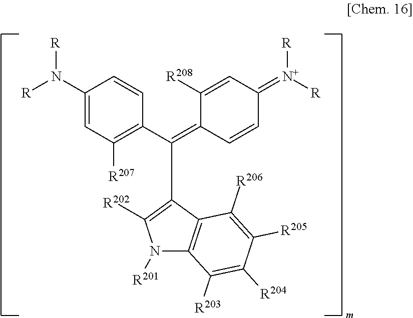
are contained in the molecule, these groups may have the same structure or may have different structures).

10. The colored resin composition for color filter according to claim 9, wherein the compound represented by general formula (V′) is a compound represented by the following general formula (VI): 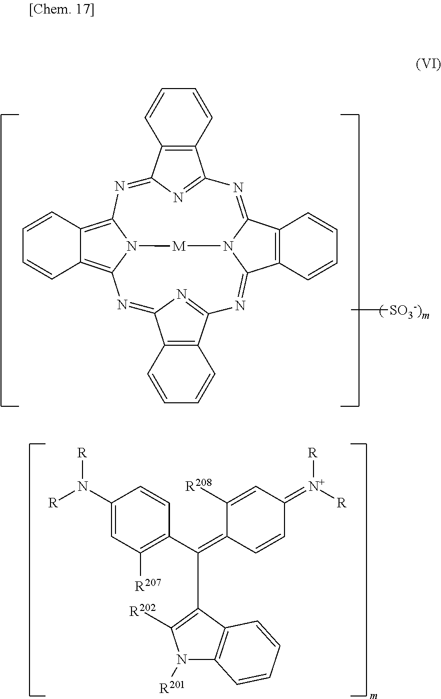
(wherein M represents two hydrogen atoms, Cu, Mg, Al, Ni, Co, Fe, Zn, Ge, Mn, Si, Ti, V, or Sn, provided that an oxygen atom, a halogen atom, a hydroxyl group, an alkoxy group, or an aryloxy group may coordinate to each metal atom;
the —SO₃⁻ group in the formula is bonded to any of the carbon atoms constituting the benzene rings included in the phthalocyanine framework; among the carbon atoms constituting the four benzene rings, the carbon atoms having no —SO₃⁻ group bonded thereto may be substituted with any group; and
m, R, R²⁰¹, R²⁰², R²⁰⁷, and R²⁰⁸ have the same meanings as in general formula (V′); provided that when a plurality of groups represented by 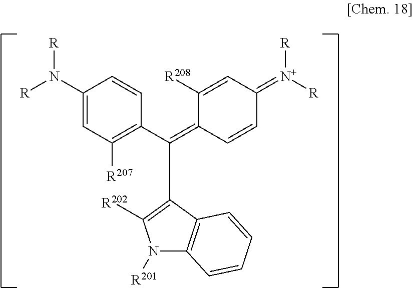
are contained in the molecule, these groups may have the same structure or may have different structures).

11. The colored resin composition for color filter according to claim 10, wherein in general formula (VI), the —SO₃⁻ group is bonded to any of the carbon atoms constituting the benzene rings included in the phthalocyanine framework, and the phthalocyanine framework has no substituents other than the —SO₃⁻ group.

12. The colored resin composition for color filter according to claim 9, wherein the compound represented by general formula (V′) is a compound represented by the following general formula (VII): 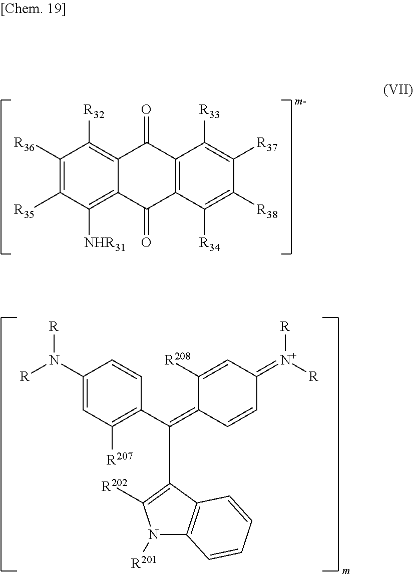
(wherein among the substituents possessed by the anthraquinone framework,
R₃₁ represents a hydrogen atom or a phenyl group which may have a substituent;
R₃₂, R₃₃, and R₃₄ each independently are any of a hydrogen atom, a hydroxyl group, —NHR₄₁ (R₄₁ has the same meaning as R₃₁), —SO₃⁻, a halogen atom, and —CO₂R₄₂ (R₄₂ represents an alkyl group having 1-3 carbon atoms), provided that at least one of R₃₂ to R₃₄ is an —NHR₄₁ group;
R₃₅, R₃₆, R₃₇, and R₃₈ each independently represent a hydrogen atom, —SO₃⁻, a halogen atom, a phenoxy group, a naphthyloxy group, an alkoxy group having 1-12 carbon atoms, —CO₂R₄₃, a phenyl group, —SO₃R₄₄, or —SO₂NHR₄₅ (wherein R₄₃ to R₄₅ each independently represent an alkyl group having 1-6 carbon atoms);
the number of —SO₃⁻ groups bonded to each anthraquinone framework is m; and
m, R, R²⁰¹, R²⁰², R²⁰⁷, and R²⁰⁸ have the same meanings as in general formula (V′); provided that when a plurality of groups represented by 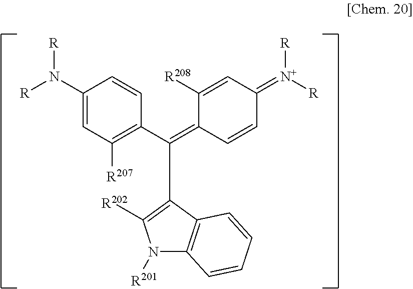
are contained in the molecule, these groups may have the same structure or may have different structures).

13. The colored resin composition for color filter according to claim 8, which contains the compound represented by general formula (V) in an amount of 1-50% by weight based on all solid components.

14. A colored resin composition for color filter, which comprises (a) a binder resin, (b) a solvent, and (c) a colorant,
the colorant (c) comprising a compound comprising a cationic blue coloring matter (coloring matter 1) and an anionic coloring matter (coloring matter 2),
the coloring matter 1 and the coloring matter 2 in the compound satisfying the following (A) or (B):
(A) the coloring matter 2 is an even-electron compound; the excitation energy of coloring matter 1 in a minimum singlet excitation state (S₁ state) (ΔE_{S1}(coloring matter 1)) and the excitation energy of coloring matter 2 in a minimum singlet excitation state (S₁ state) (ΔE_{S1}(coloring matter 2)), each excitation energy being obtained through a time-dependent density functional (B3LYP/6-31G(d,p)) calculation, satisfy the following expression (i); and the excitation energy of coloring matter 2 in a minimum triplet excitation state (T₁ state) (ΔE_{T1}(coloring matter 2)) satisfies the following expression (ii);
(B) coloring matter 2 is an odd-electron compound, and the excitation energy of coloring matter 1 in a minimum singlet excitation state (S₁ state) (ΔE_{S1}(coloring matter 1)) and the excitation energy of coloring matter 2 in an energetically lowest excitation state (ΔE_{lowest}(coloring matter 2)), each excitation energy being obtained through a time-dependent density functional (B3LYP/6-31G(d,p)) calculation, satisfy the following expression (iii).
[Math. 1]
ΔE_{S1}(coloring matter 2)<ΔE_{S1}(coloring matter 1) (i)
ΔE_{T1}(coloring matter 2)<1.5 eV (ii)
ΔE_{lowest}(coloring matter 2)<ΔE_{S1}(coloring matter 1) (iii)

15. The colored resin composition for color filter according to claim 14, wherein the coloring matter 1 is a cationic coloring matter which has a framework having a cationic moiety therein or has a cationic substituent as a substituent, and
the coloring matter 2 is an anionic coloring matter having an anionic substituent.

16. The colored resin composition for color filter according to claim 14, wherein the coloring matter 2 is an anionic coloring matter having a phthalocyanine framework or an anthraquinone framework.

17. The colored resin composition for color filter according to claim 1, which further comprises (d) a monomer.

18. The colored resin composition for color filter according to claim 1, which further comprises (e) at least one of a photopolymerization initiation system and a heat polymerization initiation system.

19. The colored resin composition for color filter according to claim 1, which further comprises (f) a pigment.

20. A color filter having pixels formed using the colored resin composition for color filter according to claim 1.

21. An organic EL display equipped with the color filter according to claim 20.

22. A liquid-crystal display device equipped with the color filter according to claim 20.
